(19) United States
(12) Patent Application Publication
(10) Pub. No.: US 2009/0316084 A1
(43) Pub. Date: Dec. 24, 2009

(54) Method of Producing Polarizing Plate, Polarizing Plate, and Liquid Crystal Display

(76) Inventors: Takatoshi Yajima, Hyogo (JP); Masayuki Kurematsu, Tokyo (JP); Takashi Murakami, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/085,845

(22) PCT Filed: Dec. 1, 2006
(86) PCT No.: PCT/JP2006/324052

§ 371 Date: May 30, 2008

(51) Int. Cl. G02F 1/1335; G02B 5/30; B32B 37/00

(52) U.S. Cl. 349/96; 359/485; 156/60

(57) ABSTRACT

Disclosed is a method for producing a polarizing plate including the steps of: laminating a polarizing plate protective film A on one side of a polarizer; and laminating a polarizing plate protective film B on the other side of the polarizer, wherein the polarizing plate protective film B contains a noncrystalline polyolefin resin; and the polarizing plate protective film A is a solidified film produced in such a manner that a melted film prepared by extruding a melted substance containing a cellulose resin from a die is conveyed while pressed against a cooling roll by a touch roll so as to have a draw ratio of 10 to 30 and to be solidified on the cooling roll, provided that the touch roll has an outer metal cylinder, an inner metal cylinder and a space formed therebetween for accommodating a cooling medium.

### TECHNICAL FIELD

The present invention relates to a method of producing a polarizing plate, the polarizing plate, and a liquid crystal display, and more specifically an object of the present invention is to prevent any decrease in the yield of the polarizing plate when types of protective films arranged on both sides of a polarizing film differ, as well as to provide a liquid crystal display exhibiting significantly improved front contrast and having reduced display non-uniformity.

### BACKGROUND ART

Liquid crystal displays have been widely used as monitors due to their small footprint and low energy consumption features, compared to old-fashioned CRT displays, and have become common in application of TV sets. For such liquid crystal displays, various optical films such as polarizing films, retardation films, antireflection films, brightness enhancement films are used.

In a polarizing film, a cellulose ester film is laminated to one or both sides of a polarizer composed of a stretched polyvinyl alcohol film. Since a polarizer does not, on its-own, exhibit adequate durability against humidity or ultraviolet rays, the required durability is imparted thereto by laminating a cellulose ester film of about 40-about 100 μm as a protective film.

These optical films, including a cellulose ester film, are required to exhibit no optical defects but to exhibit uniform retardation. Specifically, with the development of increased size of monitors and TV sets and of precise image reproduction, the required quality therefor has become even more critical.

To solve these problems, a polarizing plate protective film has begun to be used by employing a cyclic olefin resin, compared to conventional polarizing plate protective films employing cellulose triacetate. However, since the cyclic olefin resin features poor moisture permeability, any solvent such as water contained in an adhesive used to laminate a polarizer tends not to be released, and therefore one side thereof has needed to be a cellulose ester-based film. For example, a polarizing plate having polarizing plate protective films, made of different materials, laminated to both the front and the rear side thereof is described in Patent Document 1. In cases in which such a polarizing plate featuring different materials on both the front and the rear side is used, a problem is noted in that the yield of producing the polarizing plate tends to decrease, whereby improvement thereof has been demanded.

Methods of producing an optical film are roughly classified into a solution casting method and a melt casting method.

The solution casting method is one in which a polymer is dissolved in a solvent, and the resulting solution is cast onto a support. Then, the solvent is evaporated, followed by being dried to prepare a film, which, if preferable, is stretched. Any appropriate polymers soluble in the solvent are employable. From the viewpoint of enhanced uniform film thickness, a norbornene-based polymer film or a cellulose triacetate film has been commonly employed, but there have been problems that, for example, a large-scale apparatus is required to evaporate the solvent.

The melt casting method is one in which a melted substance, prepared by heat-melting a polymer, is extruded from a die into a film form, followed by being cooled and solidified to prepare a film, which, if preferable, is stretched. Since it is unnecessary to remove any solvent, there is an advantage in that a relatively compact apparatus is adequate, whereby a polarizing plate protective film employing a cyclic olefin resin has been brought into practical use. Further, various attempts to carry out melt casting employing a cellulose resin have been progressing.

For example, methods of producing a cellulose resin film via the melt casting methods described in Patent Documents 1-4 are disclosed. However, it was found that when a polarizing plate, which employs a cyclic olefin resin for one polarizing plate protective film and a cellulose resin film, produced via such a melt casting method, for the other polarizing plate protective film, was employed, the yield of the plate tended to markedly decrease. Further, there has been noted a problem of a decrease in front contrast when the polarizing plate was used for a large liquid crystal display of more than 30 diagonal inches.

Patent Document: Unexamined Japanese Patent Application Publication (hereinafter referred to as JP-A) No. 2005-181817

JP-A No. 2000-352620

JP-A No. 2005-178194

JP-A No. 2005-325258

### DISCLOSE OF THE INVENTION

Accordingly, an object of the present invention is to provide a method of enhancing a yield via a method of producing a polarizing plate employing a noncrystalline polyolefin resin for one polarizing plate protective film and a cellulose resin film produced via a melt casting method for the other polarizing plate protective film. Further, another object of the present invention is to provide a polarizing plate capable of maintaining enhanced front contrast even when applied to a large liquid crystal display and a liquid crystal display employing such a polarizing plate.

One of the embodiments of the present invention to achieve the above objects is, in a method of producing a polarizing plate wherein a polarizing plate protective film A is laminated to one side of a polarizer and a polarizing plate protective film B is laminated to the other side thereof, relates to a method of producing a polarizing plate characterized by laminating the polarizing plate protective film A, the polarizer, and the polarizing plate protective film B containing a noncrystalline polyolefin resin, wherein the polarizing plate protective film A is a polarizing plate protective film produced in such a manner that a melted film, which is prepared by extruding a melted substance containing a cellulose resin from a die, is formed via conveyance while pressed against a cooling roll by an elastic touch roll so as for the draw ratio to be from 10-30, provided that the elastic touch roll has an outer and an inner metal cylinder as well as a space accommodating a cooling medium therebetween and the line pressure of the touch roll while pressing the melted film is from 1 kg/cm-15 kg/cm.

### BRIEF DESCRIPTION OF THE DRAWINGS

FIG. 1 is an explanatory view of an apparatus producing the polarizing plate protective film of the present invention

FIG. 2 is an explanatory view of the lip clearance C of a die

FIG. 3 is a cross-sectional view of the touch roll of the present invention

### BEST MODE FOR CARRYING OUT THE INVENTION

The above objects of the present invention can be achieved via the following constitutions.

(1) In a method of producing a polarizing plate by laminating a polarizing plate protective film A on one side of a polarizer and by laminating a polarizing plate protective film B on the other side thereof, a method of producing a polarizing plate characterized by laminating a polarizing plate protective film A, a polarizer, and a polarizing plate protective film B containing a noncrystalline polyolefin resin, wherein the polarizing plate protective film A is a polarizing plate protective film produced in such a manner that a melted film, which is prepared by extruding a melted substance containing a cellulose resin from a die, is formed via conveyance while pressed against a cooling roll by a touch roll so as for the draw ratio to be from 10-30, provided that the touch roll has an outer and an inner metal cylinder as well as a space accommodating a cooling medium therebetween and the line pressure of the touch roll while pressing the melted film is from 1 kg/cm-15 kg/cm (herein, “draw ratio” refers to a value obtained by dividing the lip clearance C of a die by the average film thickness of a film solidified on a cooling roll).

(2) The method of producing the polarizing plate, described in item (1), wherein the draw ratio is from 10-20.

(3) The method of producing the polarizing plate, described in item (1) or (2), wherein the line pressure of the touch roll is from 2 kg/cm-less than 10 kg/cm.

(4) The method of producing the polarizing plate, described in any one of items (1)-(3), wherein the surface temperature T (° C.) of the film on the side of the touch roll satisfies the relationship: Tg<T<Tg+110 (herein, Tg refers to the glass transition point of the film determined via DSC measurement).

(5) The method of producing the polarizing plate, described in any one of items (1)-(4), wherein the touch roll is a crown roll.

(6) The method of producing the polarizing plate, described in any one of items (1)-(5), wherein the surface temperature of the touch roll is controlled to be uniform via any one of the following methods: (1) allowing a temperature controlling roll to be in contact with the touch roll, (2) spraying the touch roll with temperature-controlled air, and (3) allowing a heating medium such as liquid to be in contact with the touch roll.

(7) A polarizing plate characterized by being produced via the method of the polarizing plate, described in any one of items (1)-(6).

(8) A liquid crystal display characterized by laminating the polarizing plate, described in item (7), to at least one side of a liquid crystal cell.

Based on the present invention, the yield of polarizing plates can be improved wherein a noncrystalline polyolefin resin film and a cellulose ester resin film, produced via a melt casting method, are employed as polarizing plate protective films, and using such a polarizing plate, a polarizing plate and a liquid crystal display exhibiting significantly improved front contrast can be provided.

The best mode for carrying out the present invention will now be detailed that by no means limits the scope of the present invention.

In view of the above problems, the present inventors, as a result of diligent investigation, found that, in a method of producing a polarizing plate composed of a polarizer and two polarizing plate protective films which were a polarizing plate protective film A and a polarizing plate protective film B arranged on both sides of the polarizer, the yield of the polarizing plate was remarkably improved and thereby a polarizing plate and a liquid crystal display exhibiting significantly improved front contrast could be provided via a method of producing the polarizing plate by laminating the polarizing plate protective film A, the polarizer, and the polarizing plate protective film B containing a noncrystalline polyolefin resin, wherein the polarizing plate protective film A is a polarizing plate protective film A produced in such a manner that a film, having been prepared by extruding a melted substance containing a cellulose resin from a die at a draw ratio of 10-30, is conveyed while pressed against a cooling roll with an elastic touch roll which has an outer and an inner metal cylinder and a space therebetween where a liquid medium flows, provided that the line pressure of the touch roll during touch roll pressing is 1 kg/cm-15 kg/cm and the surface temperature T of the film on the side of the touch roll is allowed to satisfy the relationship: Tg<T<Tg+110° C.

The present invention will now be detailed.

### (Polarizing Plate Protective Film A)

Initially, the polarizing plate protective film A is detailed below.

The melt casting of the present invention is defined as casting conducted in the following manner: a composition containing a cellulose resin and an additive such as a plasticizer is melted by heating up to a temperature where fluidity thereof is exhibited, and then the resulting melted substance containing the cellulose resin exhibiting fluidity is cast. A forming method via heat melting may be further specifically classified into a melt extrusion forming method, a press forming method, an inflation method, an injection forming method, a blow forming method, and a stretching forming method. Of these, a melt extrusion method is preferable in order to form a polarizing plate protective film A exhibiting excellent mechanical strength and surface accuracy. Herein, the method of producing a melted film of the present invention includes, as a melt casting method, the following film forming method: a film constituent material are heated to exert fluidity, followed by film formation via extrusion of the constituent material on a roll or endless belt.

A film, produced by melt casting a cellulose resin, exhibits high melt viscosity, compared to ones produced employing other types of thermoplastic resins. Thereby, there are produced problems such that, when the melt temperature is decreased to inhibit thermal deterioration of the resin, the melt viscosity is markedly increased; and when the melt temperature is increased to decrease the melt viscosity, thermal deterioration of the resin is likely to occur. When the thermal deterioration occurs, the cellulose resin exhibits poor plasticity and brittleness. It was found that, when such a cellulose resin as affected by thermal deterioration was used for a polarizing plate protective film, the yield of a polarizing plate was markedly decreased. Further, it was found that a polarizing palate employing a polarizing plate protective film prepared from such a thermally deteriorated cellulose resin exhibited markedly decreased front contrast. The reason is not clearly understood, however being assumed to be an adverse effect due to strain remaining in the film or heat. In contrast, in view of problems such as drying of an adhesive used, a polarizing plate, prepared in combination of a common cellulose resin film produced via solution casting with a noncrystalline polyolefin resin, has been proposed. However, a problem has been noted such that a polarizing plate containing different resins on both sides thereof is hard to produce. The reason is that the resin films on the both sides may exhibit different physical properties. It is conceivable that a cellulose resin film produced via melt casting further results in a decrease in the yield or in front contrast due to deterioration or strain caused by heat. Accordingly, it was assumed that improvement might be made via the decrease of the deterioration or strain caused by heat, whereby diligent investigation was carried out.

The present inventors conducted various investigations of possible causes of occurrence of spot-like non-uniformity when applying, as a touch roll, a silicone rubber roll whose surface was covered with a thin metal sleeve as described in JP-A Nos. 2005-172940 and 2005-280217 to melt forming of a cellulose ester resin. As a result, it was found that there were problems such that, since this touch roll employed rubber exhibiting high heat insulating properties, the surface of the touch roll was not adequately cooled by cooling from the interior of the roll with a cooling medium; and since a minute gap was essentially created between the thin metal sleeve and the rubber, temperature non-uniformity on the surface of the touch roll could not be prevented. Further, through investigations in cases when using the cellulose ester resin, it was found that, when a film of a 100 μm thickness was formed using a die of a lip clearance of 800 μm which was the same as one described in JP-A No. 2005-280217, the surface quality of the thus-formed film just after casting was excellent when being cast at a low film forming speed; but as the film forming speed was increased, occurrence of rough unevenness was noted in terms of the surface quality of the film just after casting. The present inventors continued to conduct the investigation, and then found that the above various problems could be overcome via the following: the relationship between the lip clearance of the die and the average film thickness of a film cooled and solidified after casting was controlled to fall within a larger range than those conventionally known in the art when using a cellulose ester resin; and the film was extruded using a specified touch roll under certain conditions. Thus, the present invention was finally completed.

A melted substance containing a cellulose resin exhibits a high melt viscosity and is also hard to cast, compared to other thermoplastic resins. Accordingly, there are noted problems such that film thickness variation tends to occur in the conveyance direction when a draw ratio is large; and break tends to occur also when the film is stretched in a tenter process, resulting in carrying out the process at a draw ratio of at most about 7-about 8. In the present invention, a melted substance containing a cellulose resin is extruded from a die into a film, and the film thus-formed at a draw ratio of 10-30 is conveyed while pressed against a cooling roll using an elastic touch roll. The draw ratio is preferably from 10-20.

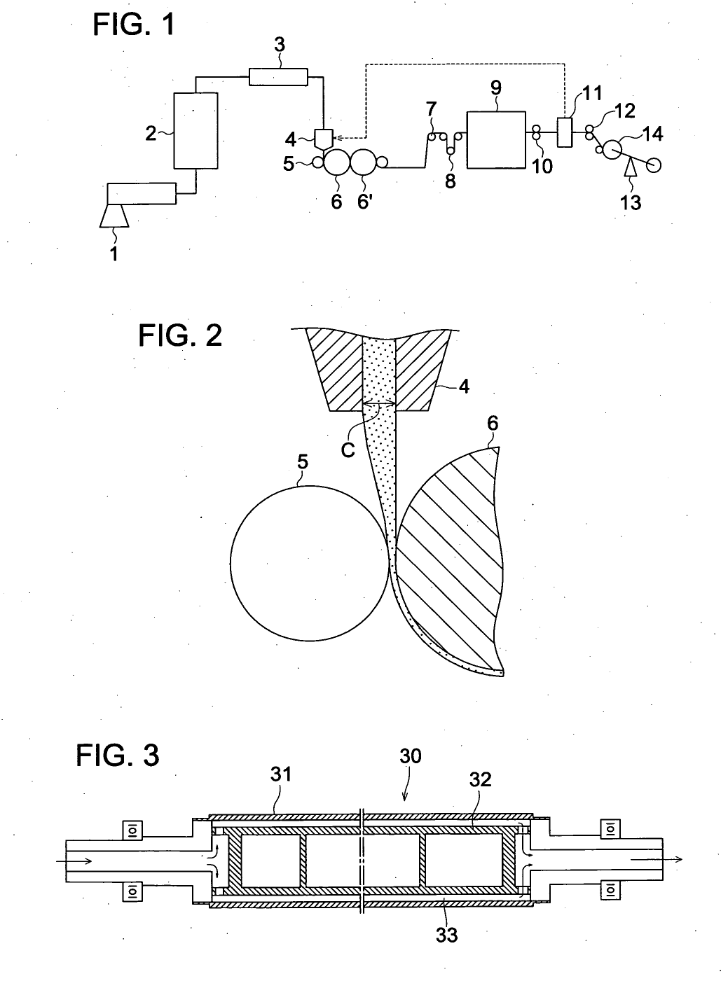

FIG. 2 is a schematic view of a state where a melted film is cast from the casting section of die 4 to first cooling roll 6. In FIG. 2, the draw ratio refers to a value obtained by dividing lip clearance C (slit clearance C) of the die by the average film thickness of the film solidified on the cooling roll. Thickness measurement section 11 shown in FIG. 1 measures the thickness of the film having been stretched, and similarly measures, prior to stretching, the thickness of the film having been solidified on the cooling roll. Based on the results, an optical film of a predetermined thickness can also be realized by controlling the thickness adjustment section of die 4. With a draw ratio of the range of 10-30, a polarizing plate protective film A, free from no light and dark lines or spot-like non-uniformity when an image is displayed on a liquid crystal display, can be obtained with enhanced productivity. The draw ratio can be controlled by the lip clearance of the die and the withdrawal rate of the cooling roll. The lip clearance of the die is preferably at least 900 μm, more preferably from 1 mm-2 mm. The spot-like non-uniformity may not be improved when the lip clearance is excessively large or small.

As shown in FIG. 3, touch roll 30 (also referred to as an elastic touch roll) used in the present invention features a double structure incorporating metal outer cylinder 31 and inner cylinder 32, and accommodates a space therebetween where a cooled liquid medium flows. Further, the metal outer cylinder which is elastic can very precisely control the surface temperature of the touch roll, and by use of its property of being elastically deformed moderately, an effect of gaining the distance needed to press the film in the longitudinal direction can be produced, resulting in no light and dark lines or spot non-uniformity and in reduced deterioration or strain due to heat. With this cylinder, the following effect of the present invention can be produced: the yield of producing a polarizing plate is improved, and when the plate is applied to a liquid crystal display, its front contrast is enhanced. The wall thickness of the metal outer cylinder is preferably in the range of 0.003≦(the wall thickness of the metal outer cylinder)/(the diameter of the metal outer cylinder)≦0.03, resulting in appropriate elasticity thereof. When the radius of the touch roll, that is, the radius of the metal outer cylinder is large, appropriate bending is created even in cases in which a wall thickness of the metal outer cylinder is large. The diameter of the metal outer cylinder is preferably from 100 mm-600 mm. The metal outer cylinder featuring an excessively small wall thickness exhibits poor strength and then may break. In contrast, an excessively large wall thickness thereof makes the weight of the roll excessively heavy, leading to possible rotational unevenness. Therefore, the wall thickness of the metal outer cylinder is preferably from 0.1-5 mm.

The surface roughness of the metal outer cylinder is preferably at most 0.1 μm, more preferably at most 0.05 μm in terms of Ra. A smoother surface of the roll makes it also possible to allow the surface of a film to be obtained to be smoother.

A material for the metal outer cylinder needs to be smooth, appropriately elastic, as well as being durable. Carbon steel, stainless steel, titanium, or nickel produced via electroforming can preferably be used. Further, surface treatment such as hard chromium plating, nickel plating, amorphous chromium plating, or ceramic spraying is preferably carried out to enhance hardness of the surface or to improve peeling properties to a resin. Then, the surface-processed surface is preferably ground to the above surface roughness.

The inner cylinder is preferably a metal inner cylinder, which is light in weight and rigid, made of carbon steel, stainless steel, aluminum, or titanium. Allowing the inner cylinder to be rigid makes it possible to prevent rotational fluctuation of the roll. When the wall thickness of the inner cylinder is twice to ten times as large as that of the outer cylinder, adequate rigidity of the former can be realized. The inner cylinder may further be covered with a resin-based elastic material such as silicone or fluorine rubber.

It is only necessary that the structure of the space, where a cooling medium flows, be one which can uniformly control the temperature of the surface of the roll. For example, a structure to allow the cooling medium to flow back and forth alternately in the transverse direction or to flow spirally makes it possible to precisely control temperature for the temperature distribution on the surface of the roll. The cooling medium is not specifically limited and water or oil can be used depending on the applied temperature range.

The surface temperature of the touch roll is preferably lower than the glass transition point Tg of a film. When the temperature is higher than the Tg, poor peeling performance between the film and the roll may result. When the surface temperature is excessively low, a volatile component evaporated from the film may be deposited on the roll, and therefore the temperature is more preferably from 10° C. to Tg−10° C.

Herein, Tg refers to Tg of the film determined via DSC measurement (at a temperature raising rate of 10° C./minute), being the temperature at which the base line begins to deviate.

A touch roll used in the present invention is preferably in the form of a crown roll wherein the diameter of the center portion of the transverse direction is larger than those of the edge portion. Both of the edge portions of the touch roll are commonly pressed against a film with pressure members. In this case, since the touch roll tends to bend, there is noted a phenomenon in that portions closer to the edge portions of the film are subjected to stronger pressure. It is possible to apply highly uniform pressure via the roll in the crown form.

When the width of the touch roll used in the present invention is allowed to be larger than the film width, the entire portion to be processed of the film is preferably brought into close contact with the cooling roll. Further, when the draw ratio is relatively large, both of the edge portions of the film may become thick (namely the film thicknesses of the edge portions become relatively large) due to a neck-in phenomenon. In this case, in order to prevent occurrence of the thickened edge portions, the width of the metal outer cylinder may be allowed to be smaller than that of the film width. The diameters of the edge portions of the metal outer cylinder may optionally be allowed to be small to prevent occurrence of the thickened edge portions.

Specific examples of the metal elastic touch roll include forming rolls described in Japanese Patent Publication Nos. 3194904 and 3422798, as well as JP-A Nos. 2002-36332 and 2002-36333.

In order to prevent the bending of the touch roll, a support roll may be arranged on the opposite side of the touch roll when observed from the cooling roll.

An appropriate device may be arranged to clean stain on the touch roll. As the cleaning device, there can be preferably employed, for example, a method of pressing a member such as a non-woven cloth, if appropriate, with a solvent absorbed therein against the surface of the roll, a method of bringing the roll into contact with a liquid, and a method of evaporating the stain on the surface of the roll via plasma discharge such as corona discharge or glow discharge.

To allow the surface temperature of the touch roll to be further uniform, a temperature controlling roll may be brought in contact with the touch roll, and temperature-controlled air may be sprayed thereon. Further, a heating medium such as liquid may be brought in contact therewith.

In the present invention, further, the line pressure of the touch roll during pressing is from 1 kg/cm-15 kg/cm, preferably from 1 kg/cm-10 kg/cm.

It is conceivable that, when the line pressure of the touch roll falls within the range, a polarizing plate protective film A can be realized free from strain caused by heat resulting from a cellulose resin film produced via a melt casting method; when a polarizing plate is produced using the thus-prepared protective film, the yield of the plate is enhanced. Front contrast when an image is displayed on a liquid crystal display is also enhanced.

The line pressure refers to a value obtained by dividing a pressing force, with which the touch roll presses the film, by the width of the film while pressed. Methods of controlling the line pressure to fall within the range are not specifically limited, including, for example, a method of pressing both edges of the roll using an air cylinder or an oil cylinder. By pressing a support roll against the touch roll, the film may indirectly be pressed.

Further, the surface temperature T of the film on the side of the touch roll preferably satisfies the relationship of Tg<T<Tg+110° C. during pressing of the touch roll in order to smooth die lines on the film surface. A higher temperature of the film while pressed with the touch roll creates less strain, but an excessively high temperature thereof may cause another strain. It is assumed that, since a volatile component evaporates from the film, no uniform pressing is carried out during pressing of the touch roll. At an excessively low temperature, no targeted effects of the present invention can be realized.

Methods of controlling the film temperature during pressing to be in the range are not specifically limited, including, for example, a method of inhibiting cooling taking place between the die and the cooling roll by shortening the distance therebetween; a method of keeping the portion between the die and the cooling roll heated by covering the portion with a heat insulating material; or a method of heating with hot air, an infrared heater, or a microwave heater. Needless to say, the extrusion temperature may optionally be set high.

The surface temperatures of the film and the roll can be determined using a non-contacting infrared thermometer. Specifically, measurement is carried out at 10 locations in the transverse direction of the film at a distance of 0.5 cm from the subject to be determined using a non-contacting handy infrared thermometer (IT2-80, produced by Keyence Corp.).

The surface temperature T of the film on the side of the touch roll refers to the surface temperature of the film which is measured from the side of the touch roll using a non-contacting infrared thermometer while the film is conveyed with the touch roll detached therefrom.

The cooling roll is a highly rigid metal roll, which is a roll provided with a structure therein where a temperature-controllable heating medium or cooling medium flows. The size thereof is not limited, and it is only necessary to be large enough to cool the film having been melt-extruded. The diameter of the cooling roll is commonly from about 100 mm-about 1 m. Materials used for the surface of the cooling roll include carbon steel, stainless steel, aluminum, or titanium. Further, to enhance surface hardness or peeling properties to the resin, surface treatment such as hard chromium plating, nickel plating, amorphous chromium plating, or ceramic spraying is preferably carried out. The surface roughness of the surface of the cooing roll is, in terms of Ra, preferably at most 0.1 μm, more preferably at most 0.05 μm. A smoother roll surface can make the surface of a film obtained smoother. Of course, it is preferable that the surface-treated surface be further ground to the above surface roughness.

A film formation method of the film will now be described.

Plural raw materials for use in melt extrusion are commonly pelletized by kneading beforehand. The pelletization can be conducted via a method known in the art. For example, a dry cellulose ester and other additives are fed by a feeder into an extruder, kneaded using a monoaxial or biaxial extruder, and extruded from the die into a strand form. Then, the resulting product is cut after being water-cooled or air-cooled. It is important that the raw materials are dried prior to the extrusion to prevent decomposition. Specifically, since a cellulose ester is hygroscopic, a moisture percentage is preferably controlled to be at most 200 ppm, more preferably at most 100 ppm by drying at 70-140° C. for at least 3 hours using a dehumidification hot air drier or a vacuum drier. The additives may be mixed before fed into the extruder or may be fed using individual feeders for each. Additives of small amounts such as antioxidants are preferably mixed beforehand for uniform mixing. In cases when mixing antioxidants, solid antioxidants may be mixed thereamong, or antioxidants, if appropriate, having been dissolved in a solvent, may be mixed with a cellulose ester via impregnation or by spraying. A vacuum Nauta mixer is preferable since drying and mixing are simultaneously conducted. Further, the feeder section and the outlet from the die, if exposed to air, are preferably controlled to be under an ambience of dehumidified air or dehumidified nitrogen gas. Still further, the feed hopper for the extruder is preferably kept heated to prevent moisture absorption. A prepared pellet may be dusted with a matting agent or a UV absorbent, which may alternatively be added into the extruder during film formation.

It is preferable that the extruder enables pelletization and processes a resin at a temperature as low as possible to control shear force and prevent the resin from deteriorating (molecular weight reduction, coloring, or gel formation). For example, in cases when using a biaxial extruder, the axes are preferably rotated in the same direction using a deep groove-type screw. From the viewpoint of kneading uniformity, a matching type is preferable. A kneader disc can enhance kneading performance, but careful attention to shear heat needs to be paid. Adequate mixing performance can be realized without the kneader disc. Suction from a vent hole may be carried out, if appropriate. The vent hole may be unnecessary since volatile components are hardly generated at low temperatures.

The b* value of color of the pellet, which is a yellowing index, is preferably in the range of −5-10, more preferably in the range of −1-8, still more preferably −1-5. The b* value can be determined using spectrophotometer CM-3700d (produced by Konica Minolta Sensing, Inc.) at a viewing angle of 10° under D65 lighting (color temperature: 6504 K).

Film formation is carried out using the thus-prepared pellet. Needless to say, it is possible to feed a raw material powder as such into the extruder using the feeder and then to directly form a film.

A polymer dried with dehumidified hot air or under vacuum or reduced pressure is melted using a monoaxial or biaxial extruder at an extrusion temperature of 200-300° C., filtered with a leaf disc-type filter to eliminate foreign substances, and then is cast into a film form from a T die, followed by being solidified on the cooling roll. When the polymer is introduced from the feed hopper into the extruder, oxidative decomposition thereof is preferably prevented under vacuum or reduced pressure or under an inert gas ambience.

It is preferable to steadily control an extrusion flow rate by introducing a gear pump. Further, as the filter to eliminate foreign substances, a stainless steel fiber-sintered filter is preferably used. The stainless steel fiber-sintered filter is prepared by compressing a stainless steel fiber body in a deeply intertwined form and then by sintering contact portions into one body. Filtering accuracy can be controlled by varying the density via the size and the compressed amount of the fiber. A filter in a multilayer form is preferable in which coarse and fine filtering accuracy continuously repeat more than once. Further, it is preferable to create a structure where the filtering accuracy is gradually increased or to employ a method of repeating the coarse and the fine filtering accuracy, since the filtering life of the filter is prolonged and also the accuracy of trapping foreign substances or gel is enhanced.

Line defects may occur due to existence of scratches on the die or deposition of foreign substances thereon. Such defects are also called die lines. To make surface defects such as die lines small, a structure is preferably employed in which a remaining area of the resin in the pipe ranging from the extruder to the die is minimized. A die having as few scratches in the interior or lip thereof as possible is preferably used. Since die lines may be caused by deposition of volatile components from the resin around the die, an ambience containing the volatile components is preferably suctioned. Further, since the volatile components may be deposited on a device which applies static electricity to bring a film extruded from the die into close contact with the cooling roll, the deposition is preferably prevented by applying alternating electric current or via other heating methods.

The interior surface of the extruder or the die in contact with a melted resin is preferably surface-treated by making the surface roughness small or by employing a material featuring a low surface energy so that the melted resin may not tend to adhere. Specifically, a material used includes one which is subjected to hard chromium plating or ceramic spraying, and ground to a surface roughness of at most 0.2 S.

Additives such as a plasticizer may be mixed with the resin beforehand, or may be incorporated in the middle of the extruder. A mixer such as a static mixer is preferably used for homogeneous adding.

Since, in cases of inadequate contact between the melted film and the cooling die, a problem may occur in that roll stains are caused by deposition of volatile components in the melted resin on the roll, there is preferably employed a method of making a close contact by applying static electricity, by using wind pressure, by nipping the entire width or edge portion, or under reduced pressure.

Further, the temperature of the film on the side of the touch roll when nipping the film with the cooing roll and the touch roll is preferably set in the range of Tg of the film−Tg+100° C., whereby strain is reduced to produce the effects of the present invention. As a roll featuring an elastic surface used to achieve such an object, any appropriate rolls known in the art can be employed. There are preferably used the rolls described in JP-A Nos. 03-124425, 08-224772, 07-100960, and 10-272676, WO 97-028950 pamphlet, and JP-A Nos. 11-235747 and 2002-36332.

When the film is peeled off the cooling roll, deformation of the film is preferably prevented by controlling tension.

In the present invention, the thus-prepared film is preferably stretched further in at least one direction by a factor of 1.01-3.0. The stretching is preferably conducted in both of the directions, that is, the longitudinal direction (the film conveyance one) and the transverse direction (the film width one) by a factor of 1.01-2.5 each.

As a stretching method, any appropriate method employing a roll stretcher or a tenter known in the art can be used. A polarizing plate protective film A is stretched in such a manner that the stretching direction corresponds to the transverse direction or the longitudinal direction, or to both of the directions. The stretching ratio is commonly from 1.1-3.0, preferably from 1.2-1.5. The stretching temperature is commonly in the range of Tg of a resin constituting the film −Tg+50° C., preferably Tg−Tg+40° C. The stretching is preferably carried out in the transverse direction under uniformly controlled temperature distribution, which is preferably at most ±2° C., more preferably at most ±1° C., and specifically preferably at most ±0.5° C.

In order to control retardation of the thus-prepared polymer film or to control the dimensional change rate thereof to be minimal, the film may be contracted in the longitudinal or transverse direction. To contract a film in the longitudinal direction, for example, a method is employed in which a film being stretched in the transverse direction is temporarily clipped out to allow the film to be relaxed in the longitudinal direction, or there is employed a method in which the film is contracted by gradually narrowing the distance between the neighboring clips of a transverse stretcher. The latter method can be carried out via a process in which, using a commonly used simultaneous biaxial stretcher, the distance between the neighboring clips in the longitudinal direction is gradually narrowed smoothly, for example, by driving the clip portions via a pantograph method or a linear drive method. Stretching in any appropriate direction (a diagonal direction) may be combined, if beneficial. The dimensional change rate of an optical film can be controlled to be minimal by contracting by 0.5%-10% both in the longitudinal direction and in the transverse direction.

Prior to winding, the edge portions of the film are cut out by slitting into a product width, and both of the resulting edge portions may be subjected to knurling processing (embossing processing) to prevent occurrence of adhesion or abrasions in the interior portion of the wound film. As a method of knurling processing, usable is a process via heating or pressurizing using a metal ring which has an uneven pattern on its side surface. Incidentally, since both of the edge portions of the film held by clips are generally deformed, no edge portions are viable for a commercial product, whereby the portions are cut off and reused for raw materials.

In the present invention, the humidity change rate and the dimensional change rate of retardation (Ro and Rt) can preferably be minimized by controlling the free volume of the film to be minimal.

To control the free volume to be minim al, heat treatment in the vicinity of Tg of the film is effectively conducted. A certain effect can be noted via heat treatment of at least 1 second, and a longer heat treatment makes the effect higher. However, since the effect plateaus when the heat treatment has been conducted for about 1000 hours, the heat treatment is preferably carried out at Tg−20° C.−Tg for 1 second-1000 hours, more preferably at Tg−15° C.−Tg for 1 minute-1 hour. Further, the heat treatment is preferably conducted via gradual cooling from Tg to Tg−−0° C. to produce the effect in a short time, compared to the heat treatment at a given temperature. The cooling rate is preferably from −0.1° C./second-−20° C./second, more preferably from −1° C./second-−10° C./second. Methods of the heat treatment are not specifically limited, and the treatment can be carried out using a temperature-controlled oven or roll group, hot air, an infrared heater, or a microwave heater. The film may be heat-treated while conveyed or in a sheet or roll form. In cases while conveying the film, the film can be conveyed while heat-treated using a roll group or a tenter. When heat-treated in the roll form, the film is wound in the form of a roll in the vicinity of Tg thereof, and may gradually be cooled by cooling as is.

It is preferable that the film of the present invention have no continuous line of a height of at least 300 nm from the mountain peak to the valley bottom which are adjacent each, as well as of an inclination of at least 300 nm/mm in the longitudinal direction of the film.

The shape of the line is determined using a surface roughness meter. Specifically, using SV-3100S4 (produced by Mitsutoyo Corp.), a sensing pin (a diamond needle), featuring a 60° conical tip shape and a tip curvature radius of 2 μm, is scanned on the film in the transverse direction at a measuring rate of 1.0 mm/second while applied with a load of a 0.75 mN measuring force to measure a profile curve at a resolution power of 0.001 μm in Z axis (in the thickness direction). From this curve, the vertical distance (H) from the mountain peak to the valley bottom is read as the line height. The line inclination is determined by reading the horizontal distance (L) from the mountain peak to the valley bottom, followed by dividing the vertical distance (H) by the horizontal distance (L).

### (Cellulose Resin)

The cellulose resin of the present invention features a structure of a cellulose ester, which is preferably an ester of a single acid or mixed acids with cellulose containing at least any structure selected from an aliphatic acyl group and a substituted or unsubstituted aromatic acyl group.

Cellulose esters suitable for achieving the objects of the present invention will now be exemplified that by no means limit the scope of the present invention.

In the aromatic acyl group, when the aromatic ring is a benzene one, examples of substituents in the benzene ring include a halogen atom, a cyano, an alkyl group, an alkoxy group, an aryl group, an aryloxy group, an acyl group, a carbonamide group, a sulfonamide group, a ureido group, an aralkyl group, a nitro, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an aryloxysulfonyl group, an alkylsulfonyloxy group, and an aryloxysulfonyl group, as well as —S—R, —NH—CO—OR, —PH—R, —P(—R)₂, —PH—O—R, —P—(—R)(—O—R), —P(—O—R)₂, —PH(═O)—R—P(═O)(—R)₂, —PH(═O)—O—R, —P(═O)(—R)(—O—R), —P(═O)(—O—R)₂, —O—PH(═O)—R, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂, and —O—Si(—R)₃. The above R represents an aliphatic group, an aromatic group, or a heterocyclic group. The number of the substituents is preferably from 1-5, more preferably from 1-4, still more preferably from 1-3, and most preferably 1 or 2. As the substituents, there are preferable a halogen atom, a cyano, an alkyl group, an alkoxy group, an aryl group, an aryloxy group, an acyl group, a carbonamide group, a sulfonamide group, and a ureido group. Of these, more preferable are a halogen atom, a cyano, an alkyl group, an alkoxy group, an aryloxy group, an acyl group, and a carbonamide group. However, of these, a halogen atom, a cyano, an alkyl group, an alkoxy group, and an aryloxy group are still more preferable, and further a halogen atom, an alkyl group, and an alkoxy group are most preferable.

The halogen atom includes a fluorine atom, a chlorine atom, a bromine atom, and an iodine atom. The alkyl group may feature a cyclic or branched structure. The number of carbon atoms in the alkyl group is preferably from 1-20, more preferably from 1-12, still more preferably from 1-6, most preferably form 1-4. Examples of the alkyl group include a methyl, an ethyl, a propyl, an isopropyl, a butyl, a t-butyl, a hexyl, a cyclohexyl, an octyl, and a 2-ethylhexyl group. The alkoxy group may feature a cyclic or branched structure. The number of carbon atoms in the alkoxy group is preferably from 1-20, more preferably from 1-12, still more preferably from 1-6, most preferably form 1-4. The alkoxy group may further be substituted with another alkoxy group. Examples of the alkoxy group include a methoxy, an ethoxy, a 2-methoxyethoxy, a 2-methoxy-2-ethoxyethoxy, a butyloxy, a hexyloxy, and an octyloxy group.

The number of carbon atoms in the aryl group is preferably from 6-20, more preferably from 6-12. Examples of the aryl group include a phenyl and a naphthyl group. The number of carbon atoms in the aryloxy group is preferably from 6-20, more preferably from 6-12. Examples of the aryloxy group include a phenoxy and a naphthoxy group. The number of carbon atoms in the acyl group is preferably from 1-20, more preferably from 1-12. Examples of the acyl group include a formyl, an acetyl, and a benzoyl group. The number of carbon atoms in the carbonamide is preferably from 1-20, more preferably from 1-12. Examples of the carbonamide group include an acetamide and a benzamide group. The number of carbon atoms in the sulfonamide group is preferably from 1-20, more preferably from 1-12. Examples of the sulfonamide group include a methanesulfonamide, a benzenesulfonamide, and a p-tolueneamide group. The number of carbon atoms in the ureido group is preferably from 1-20, more preferably from 1-12. Examples of the ureido group include an (unsubstituted) ureido group.

The number of carbon atoms in the aralkyl group is preferably from 7-20, more preferably from 7-12. Examples of the aralkyl group include a benzyl, a phenetyl, and a naphthylmethyl group. The number of carbon atoms in the alkoxycarbonyl group is preferably from 1-20, more preferably from 2-12. Examples of the alkoxycarbonyl group include a methoxycarbonyl group. The number of carbon atoms in the aryloxycarbonyl group is preferably from 7-20, more preferably from 7-12. Examples of the aryloxycarbonyl group include a phenoxycarbonyl group. The number of carbon atoms in the aralkyloxycarbonyl group is preferably from 8-20, more preferably from 8-12. Examples of the aralkyloxycarbonyl group include a benzyloxycarbonyl group. The number of carbon atoms in the carbamoyl group is preferably from 1-20, more preferably from 1-12. Examples of the carbamoyl group include an (unsubstituted) carbamoyl and an N-methylcarbamoyl group. The number of carbon atoms in the sulfamoyl group is preferably at most 20, more preferably at most 12. Examples of the sulfamoyl group include an (unsubstituted) sulfamoyl and an N-methylsulfamoyl group. The number of carbon atoms in the acyloxy group is preferably from 1-20, more preferably from 2-12. Examples of the acyloxy group include an acetoxy and a benzoyloxy group.

The number of carbon atoms in the alkenyl group is preferably from 2-20, more preferably from 2-12. Examples of the alkenyl group include a vinyl, an allyl, and an isopropenyl group. The number of carbon atoms in the alkynyl group is preferably from 2-20, more preferably from 2-12. Examples of the alkynyl group include a thienyl group. The number of carbon atoms in the alkylsulfonyl group is preferably from 1-20, more preferably from 1-12. The number of carbon atoms in the arylsulfonyl group is preferably from 6-20, more preferably from 6-12. The number of carbon atoms in the alkyloxysulfonyl group is preferably from 1-20, more preferably from 1-12. The number of carbon atoms in the aryloxysulfonyl group is preferably from 6-20, more preferably from 6-12. The number of carbon atoms in the alkylsulfonyloxy group is preferably from 1-20, more preferably from 1-12. The number of carbon atoms in the aryloxysulfonyl group is preferably from 6-20, more preferably from 6-12.

In a cellulose ester used in the present invention, when a hydrogen atom in the hydroxyl groups of the cellulose is combined with an aliphatic acyl group to form an aliphatic acid ester, the number of carbon atoms in the aliphatic acyl group is from 2-20. Specific examples thereof include an acetyl, a propionyl, a butyryl, an isobutyryl, a valeryl, a pivaloyl, a hexanoyl, an octanoyl, a lauroyl, and a stearoyl group.

The aliphatic acyl group of the present invention includes ones further having a substituent. The substituent includes those exemplified as the substituents in the benzene ring of the above aromatic acyl group when the aromatic ring is a benzene ring.

Further, when the esterified substituents in the cellulose ester are aromatic rings, the number of the substituents X bonded to the aromatic rings via substitution reaction is from 0-5, preferably from 1-3, specifically preferably 1 or 2. Still further, when the number of the substituents bonded to the aromatic ring via substitution reaction is at least 2, the substituents each may be identical or different and may join to form a condensed polycyclic compound (for example, naphthalene, indene, indane, phenanthrene, quinoline, isoquinoline, chromene, chromane, phthalazine, acridine, indole, and indoline).

In the above cellulose esters, cellulose esters, featuring at least one structure selected from a substituted or unsubstituted aliphatic acyl group and a substituted or unsubstituted aromatic acyl group, are employed for the cellulose ester of the present invention. These cellulose esters may be esters of a single acid or mixed acids with cellulose, and further at last 2 types of the cellulose esters may be used in combination.

The total substitution degree of the acyl groups in the cellulose resin of the present invention is preferably from 2-3, specifically preferably from 2.4-2.9.

The substitution degree of the acyl groups is now described. Three hydroxyl groups are contained in one glucose unit of cellulose. The substitution degree is a value expressing how many acyl groups combine with one glucose unit on average. Accordingly, the maximum substitution degree is 3.0. These acyl groups may evenly substitute the 2-position, the 3-position, and the 6-position of the glucose unit or the substitution may occur so as for the substituted positions to be distributed. The total number of the acyl group substitution degrees at the 2-position and the 3-position is preferably from 1.5-1.95, more preferably from 1.7-1.95, still more preferably from 1.73-1.93. The acyl group substitution degree at the 6-position is preferably from 0.7-1.00, more preferably from 0.85-0.98. The substitution degree at the 6-position is preferably higher than that at the 2-position or the 3-position. Further, the acyl group substitution degrees at the 2-position and the 3-position are preferably the same, but it is also preferable that one substitution degree be to some extent higher than the other one. For example, the difference between the degrees at the 2-position and the 3-position is preferably in the range of 0-±0.4.

The cellulose ester preferably used in the present invention includes, for example, a cellulose ester of a total substitution degree of 2.81 and a 6-position substitution degree of 0.84, a cellulose ester of a total substitution degree of 2.82 and a 6-position substitution degree of 0.85, a cellulose ester of a total substitution degree of 2.77 and a 6-position substitution degree of 0.94, a cellulose ester of a total substitution degree of 2.72 and a 6-position substitution degree of 0.88, a cellulose ester of a total substitution degree of 2.85 and a 6-position substitution degree of 0.92, a cellulose ester of a total substitution degree of 2.70 and a 6-position substitution degree of 0.89, a cellulose ester of a total substitution degree of 2.75 and a 6-position substitution degree of 0.90, a cellulose ester of a total substitution degree of 2.75 and a 6-position substitution degree of 0.91, a cellulose ester of a total substitution degree of 2.80 and a 6-position substitution degree of 0.86, a cellulose ester of a total substitution degree of 2.80 and a 6-position substitution degree of 0.90, a cellulose ester of a total substitution degree of 2.65 and a 6-position substitution degree of 0.80, a cellulose ester of a total substitution degree of 2.65 and a 6-position substitution degree of 0.7, a cellulose ester of a total substitution degree of 2.6 and a 6-position substitution degree of 0.75, a cellulose ester of a total substitution degree of 2.5 and a 6-position substitution degree of 0.8, a cellulose ester of a total substitution degree of 2.5 and a 6-position substitution degree of 0.65, a cellulose ester of a total substitution degree of 2.5 and a 6-position substitution degree of 0.65, a cellulose ester of a total substitution degree of 2.45 and a 6-position substitution degree of 0.7, a cellulose ester of a total substitution degree of 2.85 and a 6-position substitution degree of 0.93, a cellulose ester of a total substitution degree of 2.74 and a 6-position substitution degree of 0.84, a cellulose ester of a total substitution degree of 2.72 and a 6-position substitution degree of 0.85, a cellulose ester of a total substitution degree of 2.78 and a 6-position substitution degree of 0.92, a cellulose ester of a total substitution degree of 2.88 and a 6-position substitution degree of 0.87, a cellulose ester of a total substitution degree of 2.84 and a 6-position substitution degree of 0.87, a cellulose ester of a total substitution degree of 2.88 and a 6-position substitution degree of 0.89, a cellulose ester of a total substitution degree of 2.9 and a 6-position substitution degree of 0.95, a cellulose ester of a total substitution degree of 2.80 and a 6-position substitution degree of 0.94, a cellulose ester of a total substitution degree of 2.75 and a 6-position substitution degree of 0.87, a cellulose ester of a total substitution degree of 2.70 and a 6-position substitution degree of 0.90, a cellulose ester of a total substitution degree of 2.70 and a 6-position substitution degree of 0.82, a cellulose ester of a total substitution degree of 2.70 and a 6-position substitution degree of 0.77, a cellulose ester of a total substitution degree of 2.95 and a 6-position substitution degree of 0.9, a cellulose ester of a total substitution degree of 2.95 and a 6-position substitution degree of 0.95, a cellulose ester of a total substitution degree of 2.96 and a 6-position substitution degree of 0.98, a cellulose ester of a total substitution degree of 2.95 and a 6-position substitution degree of 0.95, a cellulose ester of a total substitution degree of 2.98 and a 6-position substitution degree of 0.98, a cellulose ester of a total substitution degree of 2.92 and a 6-position substitution degree of 0.97, and a cellulose ester of a total substitution degree of 2.92 and a 6-position substitution degree of 0.92. The above cellulose esters may be used individually or in combinations of 2 types thereof. In this case, cellulose esters each exhibiting a difference of 0-0.5 in total substitution degree are preferably used in combinations. Cellulose esters each exhibiting a difference of 0.01-0.3 are preferably used in combinations, and cellulose esters exhibiting 0.02-0.1 of the difference thereamong are more preferably used in combinations. Incidentally, the total substitution degree herein refers to the sum of the acyl group substitution degrees at the 2-position, the 3-position, and the 6-position, being identical with the total acyl group substitution degree.

With regard to the 6-position substitution degree, the ratio of the acetyl group substitution degree to the substitution degree of a group such as a propionyl group or a butyryl group except an acetyl group is preferably in the range of 0.03-4 based on 1 of the acetyl group substitution degree.

Of the above cellulose esters constituting the polarizing plate protective film A of the present invention, there is preferable at least one type selected from cellulose acetate, cellulose propionate, cellulose butyrate, cellulose acetate propionate, cellulose acetate butyrate, cellulose propionate butyrate, cellulose acetate propionate butyrate, cellulose acetate phthalate, and cellulose phthalate.

Of these, as specifically preferable cellulose esters, cellulose propionate, cellulose butyrate, cellulose acetate propionate, and cellulose acetate butyrate are listed.

Lower aliphatic acid esters such as cellulose acetate propionate and cellulose acetate butyrate, which are further preferable with regard to the substitution degree of mixed aliphatic acid esters, contain acyl groups having 2-4 carbon atoms as substituents. When the acetyl group substitution degree is X and the substitution degree of a propionyl group or a butyryl group is Y, the lower aliphatic acid esters are cellulose resins containing cellulose esters which simultaneously satisfy Formulas (I) and (II) shown below. Herein, the acetyl group substitution degree and the substitution degrees of other acyl groups are determined based on ASTM-D817-96.

2.5≦X+Y≦2.9 Formula (I)

0≦X≦2.5 Formula (II)

Of these, cellulose acetate propionate is specifically preferably used, which preferably satisfies the relationships of 0.5≦X≦2.5, 0.1≦Y≦2.0, and 2.5≦X+Y≦2.9. The total substitution degree in the polarizing plate protective film A may fall within the above range by blending cellulose esters of different acryl group substitution degrees. The portions, which are not substituted with an acyl group, normally remain as a hydroxyl group. These cellulose esters can be synthesized via appropriate methods known in the art.

A cellulose resin such as a cellulose ester used in the present invention preferably features a number average molecular weight of 70000-230000, more preferably a number average molecular weight of 75000-230000, most preferably a number average molecular weight of 78000-120000.

Further, the ratio of the weight average molecular weight Mw to the number average molecular weight Mn of the cellulose resin used in the present invention is preferably from 1.3-5.5, more preferably from 1.5-5.0, still more preferably from 1.7-3.0, yet more preferably from 2.0-3.0.

A determination method of the weight average molecular weight is as follows.

### (Molecular Weight Determination Method)

The weight average molecular weight is determined via high-performance liquid chromatography.

Measurement conditions are as follows.

Solvent: Methylene chloride

Column: Shodex K806, K805, and K803G (the three columns used were connected; produced by Showa Denko K. K.)

Column temperature: 25° C.

Sample concentration: 0.1% by weight

Detector: RI Model 504 (produced by GL sciences Inc.)

Pump: L6000 (produced by Hitachi, Ltd.)

Flow rate: 1.0 ml/minute

Calibration curve: A calibration curve, based on 13 samples of Standard Polystyrene STK, standard polystyrene (produced by Tosoh Corp.) featuring a molecular weight of 1000000-500, was utilized. The 13 samples were used for determination at almost even intervals.

The viscosity average polymerization degree (the polymerization degree) of a cellulose ester used in the present invention is preferably from 200-700, specifically preferably from 250-500. When the polymerization degree falls within the range, a polarizing plate protective film A exhibiting excellent mechanical strength can be realized.

The viscosity average polymerization degree (DP) was determined via the following method.

### [Determination of Viscosity Average Polymerization Degree (DP)]

A dry cellulose ester, weighing 0.2 g, is precisely determined and dissolved in 100 ml of a mixed solvent of methylene chloride and ethanol (weight ratio: 9:1). Falling time of the dissolved cellulose ester is measured in the unit of seconds at 25° C. using an Ostwald viscosity meter to determine the polymerization degree via the following formulas.

ηrel=T/Ts

[η]=(lnηrel)/C

DP=[η]/Km

Herein, T is the falling time in the unit of seconds of a sample to be determined; Ts is the falling time in the unit of seconds of a solvent; C is the concentration (g/l) of a cellulose ester; and Km=6×10⁻⁴.

As the cellulose resin, a mixed aliphatic acid ester of cellulose produced via the method in described in JP-A No. 2005-272749 is also preferably used. For example, there are preferably used the cellulose acetate propionate of an acetyl group substitution degree (DSace) of 2.16 and a propionyl group substitution degree (DSacy) of 0.54 in described in Example 1 of the above JP-A; the cellulose acetate propionate of an acetyl group substitution degree (DSace) of 1.82 and a propionyl group substitution degree (DSacy) of 0.78 in described in Example 2 thereof; the cellulose acetate propionate of an acetyl group substitution degree (DSace) of 1.56 and a propionyl group substitution degree (DSacy) of 1.09 in described in Example 3 thereof; the cellulose acetate propionate of an acetyl group substitution degree (DSace) of 1.82 and a propionyl group substitution degree (DSacy) of 0.78 in described in Example 4 thereof; and the cellulose acetate butyrate of an acetyl group substitution degree (DSace) of 1.82 and a butyryl group substitution degree (DSacy) of 0.78 in described in Example 5 thereof. There can optionally be used the cellulose acetate propionate of an acetyl group substitution degree (DSace) of 1.24 and a propionyl group substitution degree (DSacy) of 1.43 in described in Comparative Example 1 of the JP-A; and the cellulose acetate propionate of an acetyl group substitution degree (DSace) of 1.79 and a propionyl group substitution degree (DSacy) of 0.86 in described in Comparative Example 2 thereof.

As the cellulose resin, a cellulose ether acetate described in JP-A No. 2005-283997 can also be used. Further, as the cellulose resin, there are used a lactic acid-based copolymer described in JP-A No. 11-240942; and a cellulose graft copolymer exhibiting biodegradability and thermoplasticity described in JP-A 6-287279 prepared via ring-opening graft copolymerization of a lactide and a cellulose ester or a cellulose ether in the presence of an esterification catalyst. A graft copolymer having a cellulose derivative as the main chain and polylactic acid as the graft chain, as described in JP-A No. 2004-359840, is also preferably used. In the graft copolymer, it is possible to allow the weight ratio of the cellulose derivative to the polylactic acid (cellulose derivative/polylactic acid) to be 95/5-5/95. In this case, the cellulose derivative includes cellulose acetate propionate, cellulose diacetate, cellulose triacetate, and cellulose acetate butyrate. The graft copolymer can be used individually or in combinations of other cellulose resins such as a cellulose ester.

In addition, there can be preferably used, as the cellulose resin, a cellulose derivative-hybrid graft polymer exhibiting biodegradability prepared via ring-opening hybrid graft polymerization of a lactone and a lactide by adding a ring-opening polymerization catalyst for a cyclic ester in the presence of a cellulose derivative described in Japanese Registration Patent No. 3715100. Specifically, the lactone is preferably at least one type selected form the group including β-propiolactone, δ-valerolactone, ε-caprolactone, α,α-dimethyl-β-propiolactone, β-ethyl-δ-valerolactone, α-methyl-ε-caprolactone, β-methyl-ε-caprolactone, γ-methyl-ε-caprolactone, and 3,3,5-trimethyl-ε-caprolactone. The cellulose derivative includes cellulose esters such as cellulose diacetate, cellulose acetate butyrate, cellulose acetate propionate, cellulose acetate phthalate, and cellulose nitrate; or cellulose ethers such as ethyl cellulose, methyl cellulose, hydroxypropyl cellulose, and hydroxypropyl methyl cellulose, any of which can be produced via the method described in Japanese Registration Patent No. 3715100.

The content of an alkaline earth metal in the cellulose resin used in the present invention is preferably in the range of 1-200 ppm, specifically preferably in the range of 1-50 ppm. When the content is at most 50 ppm, stain adhering to the lip tends not to occur, or the resin in the slitting section during or after heat casting tends not to break. It is not preferable to allow the content to be less than 1 ppm, since an excessive load is applied to the washing process. The content is further preferably in the range of 1-30 ppm. The content of the alkaline earth metal described herein refers to the total content of Ca and Mg, being able to be determined using an X-ray photoelectron spectrometer (XPS)

The content of sulfuric acid remaining in the cellulose resin used in the present invention is preferably in the range of 0.1-45 ppm in terms of sulfur element. It is conceivable that the residual sulfuric acid is contained in a salt form. The content of the residual sulfuric acid is preferably at most 45 ppm, since an amount of deposits on the die lip section during heat melting is small and also the resin tends not to break when being slit during or after heat casting. Allowing the content of the residual sulfuric acid to be less than 0.1 ppm is not preferable, not only since the load applied to the washing process of the cellulose resin is excessive, but also since the resin tends to break. The reason is that an increase in the number of times of washing may adversely affect the resin, but is not clearly understood. Further, the above range is further preferably from 0.1-30 ppm. The content of the residual sulfuric acid can be determined based on ASTM-D817-96.

The content of a free acid in the cellulose resin used in the present invention is preferably from 1-500 ppm. In cases of more than 500 ppm, deposits on the die lip section increase and also the resin is likely to break. It is difficult to allow the content to be less than 1 ppm by washing. The content is more preferably in the range of 1-100 ppm, whereby the resin is less likely to break. It is specifically preferable for the range to be from 1-70 ppm. The content of the free acid can be determined based on ASTM-D817-96. The content of a free acid in the polarizing plate protective film A is commonly less than 3000 ppm, however, preferably from 1-500 ppm.

When a synthesized cellulose resin is further sufficiently washed, compared to cases in which employed for a solution casting method, the contents of the alkali metal and the residual sulfuric acid are controlled to fall within the above ranges. Thereby, when a film is produced via a melt casting method, adhesion thereof to the lip section is reduced, whereby a film exhibiting excellent flatness can be realized, also excelling in dimensional change, mechanical strength, transparency, moisture permeability resistance, Rt value, and Ro value.

A cellulose raw material for the cellulose ester used in the present invention may be either wood pulp or cotton linter. The wood pulp may be conifer pulp or broad-leaved tree pulp, but conifer pulp is preferable. Cotton linter is preferably used from the viewpoint of peeling properties during film formation. Cellulose esters produced therefrom can be used in appropriate combinations or individually.

Examples of possible use are as follows: the ratios of cotton linter-derived cellulose ester, wood pulp (conifer)-derived cellulose ester, and wood pulp (broad-leaved tree)-derived cellulose ester are 100:0:0, 90:10:0, 85:15:0, 50:50:0, 20:80:0, 10:90:0, 0:100:0, 0:0:100, 80:10:10, 85:0:15, and 40:30:30.

Further, in the present invention, in addition to the cellulose ester resin, there can be contained a cellulose ether-based resin, a vinyl-based resin (including a polyvinyl acetate-based resin and a polyvinyl alcohol-based resin), a cyclic olefin resin, a polyester-based resin (including an aromatic polyester, an aliphatic polyester, or a copolymer containing them), an acryl-based resin (including a copolymer), and an acryl-based resin (including a copolymer). The content of resins other than the cellulose ester is preferably from 0.1-30% by weight.

### (UV Absorber)

The polarizing plate protective film A of the present is preferably contain a UV absorber. The UV absorber has preferably a weight average molecular weight of 490-50,000, and preferably is a compound having at least two benzotriazole skeletons as the UV absorbing skeleton. It is preferable that the UV absorber contains a compound having a weight average molecular weight of 490-2,000 and a compound having a weight average molecular weight of 2,000-50,000.

The UV absorber relating to the present invention is described in detail below.

As the UV absorber, ones excellent in the absorbing ability for UV rays of wavelength of less than 370 nm and having low absorption for visible rays of not less than 400 nm are preferable from the viewpoint of the degradation prevention of the polarizing plate and the displaying apparatus caused by UV rays, and from the viewpoint of displaying ability of the liquid crystal. For example, an oxybenzophenone type compound, a benzotriazole type compound, a salicylate type compound, a benzophenone type compound, a cyanoacrylate type compound, a triazine type compound and a nickel complex type compound are employable. The benzophenone type compound and the benzotriazole type compound having little color are preferable. Further, there can be used, for the polarizing plate protective film A, the UV absorbents described in JP-A Nos. 10-182621 and 8-337574, the UV absorbing polymers described in JP-A No. 6-148430, the UV absorbing polymers described in JP-A No. 2002-169020, the UV absorbing polymers described in JP-A No. 2002-31715, as well as the UV absorbents represented by Formula (I) described in Formula (1) of JP-A No. 9-194740. Further, an appropriate polyester-based UV absorbent represented by Formula (a) described below is preferably contained.

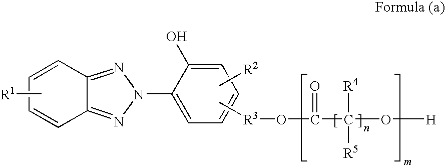

R¹: H, a halogen, or an alkyl group having 1-10 carbons

R²: H or an alkyl group having 1-10 carbons

R³: an alkylene group having 1-10 carbons

R⁴ and R⁵: H or an alkyl group having 1-10 carbons

n: an integer of 4-8; m: 1-20

The polyester-based UV absorbent can be produced via a method of allowing a lactone to react with a UV absorbing compound via ring-opening addition polymerization, as described in Japanese Registration Patent No. 3714574. Optionally, an appropriate polyester-based UV absorbent represented by Formula (b) described below is preferably contained. The polyester-based UV absorbent can be produced via a method of allowing a lactone to react with a UV absorbing compound via ring-opening addition polymerization, as described in Japanese Registration Patent No. 3714575.

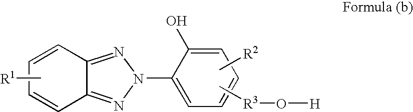

R¹: H, a halogen, or an alkyl group having 1-10 carbons

R²H or an alkyl group having 1-10 carbons

R³: an alkylene group having 1-10 carbons

Among these UV absorbers, ones having a weight average molecular weight within the range of 490-50,000 is necessary for displaying the effects of the present invention. When the weight average molecular weight is less than 490, the UV absorber tend to be oozed out from the film surface and the film tends to be colored accompanied with aging, though the UV absorber of the molecular weight of not more than 490 is usually employed. When the weight average molecular weight exceeds 50,000, the compatibility of the UV absorber with the resin of the film tends to be considerably lowered.

It is also preferable embodiment that the UV absorber relating to the present invention contains UV absorber (A) having a weight average molecular weight of from 490 to 2,00 and UV absorber (B) having a weight average molecular weight of from 2,000 to 50,000. The mixing ratio of UV absorber (A) to (B) is suitably selected from the range of from 1:99 to 99:1.

Example of the UV absorber having a weight average molecular weight being within the range of the present invention and having at least two benzotriazole skeletons is preferably a bisbenzotriazole phenol compound represented by the following Formula (1).

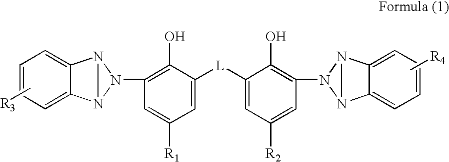

In Formula (1), R₁ and R₂ are each a hydrogen atom or a substituted or unsubstituted alkyl group having 1 to 20 carbon atoms, and R₃ and R₄ are each a hydrogen atom, a halogen atom or an alkylene group having 1 to 4 carbon atoms.

Examples of the atom or group of the substituent of the alkyl group include a halogen atom such as a chlorine atom, a bromine atom and a fluorine atom, a hydroxyl group, a phenyl group which may be substituted with an alkyl group of a halogen atom.

Concrete examples of the bisbenzotriazolephenol compound represented by Formula (1) are as follows, but the compound is not limited to the followings.

1) RUVA-100/110 manufactured by Ootsuka Kagaku. Co., Ltd.
2) RUVA-206 manufactured by Ootsuka Kagaku Co., Ltd.
3) Tinuvin-360 manufactured by Ciba Specialty Chemicals Co., Ltd.
4) Adecastab LA-31 manufactured by Asahi Denka Co., Ltd.
5) Adecastab LA-31RG manufactured by Asahi Denka Co., Ltd.

Moreover, it is preferable that at least one of the UV absorbers is a copolymer of a UV absorbing monomer having a molar absorption coefficient of not less than 4,000 at 380 nm and an ethylenic unsaturated monomer, and the ethylenic unsaturated monomer having a hydrophilic group.

According to the present invention, the optical film, in which the foregoing problems are solved, can be obtained by that the film contains the UV absorbing copolymer which is the copolymer of the UV absorbing monomer having a molar absorption coefficient of not less than 4,000 at 380 nm and the ethylenic unsaturated monomer and has a weight average molecular weight of 490-50,000.

When the molar absorption coefficient is not less than 4,000 at 380 nm, the UV absorbing ability is suitable and satisfactory UV cutting effect can be obtained. Therefore, the problem of yellow coloring of polarizing plate protective film A itself is solved and the transparency of the polarizing plate protective film A is improved.

The monomer to be employed for the UV absorbing copolymer in the present invention preferably has a molar absorption coefficient at 380 nm of not less than 4,000, more preferably not less than 8,000, and further preferably not less than 10,000. When the molar absorption coefficient at 380 nm is less than 4,000, a large adding amount of the UV absorber is necessary for obtaining the desired UV absorbing ability so that the transparency of the film is considerably lowered by increasing in the haze or precipitation of the UV absorber and the strength of the film is lowered.

The ratio of the absorbing coefficient at 380 nm to that at 400 nm of the UV absorbing monomer to be employed for the UV absorbing copolymer is preferably not less than 20.

In the present invention, it is preferable that the monomer having the UV absorbing ability as higher as possible is contained in the UV absorbing copolymer for inhibiting the light absorption at 400 nm near the visible region and obtaining the required UV absorbing ability.

a. UV Absorbing Monomer

The UV absorbing monomer (UV absorber) preferably has a molar absorption coefficient at 380 nm of less than 4,000, and a ratio of the absorption coefficient at 380 nm to that at 400 nm is not less than 20.

As the UV absorbing monomer, the following compounds have been known, for example, a salicylic acid type UV absorber such as phenyl salicylate and p-tert-butyl salicylate, a benzophenone type UV absorber such as 2,4-dihydroxybenzophenone and 2,2′-dihydroxy-4,4′-dimethoxybenzophenone, a benzotriazole type UV absorber such as 2-(2′-hydroxy-3′-tert-butyo-5′-methylphenyl)-5-chlorobenzotriazole, 2-(2′-hydroxy-3′,5′-di-tert-butylphenyl-5-chlorobenzotriazole and 2-(2′-hydroxy-3′,5′-di-tert-amylphenyl-benzotriazole, a dicyanoacrylate type UV absorber such as 2′-ethylhexyl-2-cyano-3,3-diphenyl acrylate and ethyl-2-cyano-3-(3′,4′-methylenedioxyphenyl) acrylate, a triazine type UV absorber such as 2-(2′-hydroxy-4′-hexyloxyphenyl)-4,6-diphenyltriazine and the compounds described in Japanese Patent O.P.I. Publication Nos. 58-185677 and 59-149350.

It is preferable in the present invention that basic skeletons are suitable selected from the foregoing various types of UV absorber, and a substituent having an ethylenic unsaturated bond is introduced in each of the skeletons for forming polymerizable compounds, and then ones having a absorption coefficient of not less than 4,000 at 380 nm are selected from the resultant compounds. In the present invention, the benzotriazole type compounds are preferable for the UV absorbing monomer from the viewpoint of the storage stability. Particularly preferable UV absorbing monomer is ones represented by the following Formula (3).

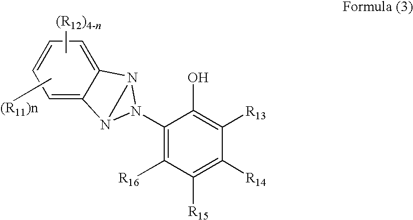

In Formula (3), the substituents represented by R₁₁ through R₁₆ each may have a substituent except that a specific limitation is applied.

In Formula (3), one of groups represented by R₁₁ through R₁₆ has the above-described polymerizable group as a partial structure.

In the above formula, L is a di-valent bonding group or a simple bonding hand, and R₁ a hydrogen atom or an alkyl group. R₁ is preferably a hydrogen atom or an alkyl group having 1 to 4 carbon atoms. Though the group containing the foregoing polymerizable group may be any one of the groups represented by R₁₁ through R₁₆, the group represented by R₁₁, R₁₃, R₁₄ or R₁₅ is preferable, and the group represented by R₁₄ is particularly preferable.

In Formula (3), R₁₁ is a halogen atom, an oxygen atom, a nitrogen atom or a group substituting on the benzene ring through a sulfur atom. As the halogen atom, a fluorine atom, a chlorine atom and a bromine atom are applicable, and the chlorine atom is preferable.

Examples of the group substituting on the benzene ring through an oxygen atom include a hydroxyl group, an alkoxy group such as a methoxy group, an ethoxy group, a t-butoxy group and a 2-ethoxyethoxy group, an aryloxy group such as a phenoxy group, a 2,4-di-t-amylphenoxy group and a 4-(4-hydroxyphenyl-sulfonyl)phenoxy group, a heterocycloxy group such as a 4-pyridyloxy group and 2-hexahydropyrranyloxy group, a carbonyloxy group, for example, an alkylcarbonyloxy group such as an acetyloxy group, a trifluoroacetyloxy group and a pivaloyloxy group, and an arylcarbonyloxy group such as a benzoyloxy group and a pentafluorobenzoyloxy group, a urethane group, for example, an alkylurethane group such as an N-dimethyluretane, and an arylurethane group such as an N-phenylurethane and an N-(p-cyanophenyl)urethane group, a sulfoxy group, for example, an alkylsulfoxy group such as a methanesulfonyloxy group, a trifluoromethanesulfonyloxy group an n-dodecanesulfonyloxy group, and an arylsulfonyloxy group such as a bebzenesulfonyloxy group and a p-toluenesulfonyloxy group. An alkoxy group having 1-6 carbon atoms is preferable and an alkyl group having 2-4 carbon atoms is particularly preferable.

Examples of the group substituting on the benzene ring through a nitrogen atom include a nitro group, an amino group, for example, an alkylamino group such as a dimethylamino group, a cyclohexylamino group and an n-dodecylamino group, and an arylamino group such as an anilino group and p-t-octylanilino group, a sulfonylamino group, for example, an alkylsuofonylamino group such as a methanesulfonylamino group, a heptafluoropropanesulfonylamino group and a hexadecylsulfonylamino group, and an arylsulfonylamino group such as a p-toluenesulfonylamino group and a pentafluorobenzenesulfonylamino group, a sulfamoylamino group, for example, an alkylsulfamoylamino group such as an N,N-dimethylsulfamoylamino group, and an arylsulfamoylamino group such as an N-phenylsulfamoylamino group, an acylamino group, for example, an alkylcarbonylamino group such as an acetylamino group and a myristoylamino group, and an arylcarbonylamino group such as a benzoylamino group, and a ureido group, for example, an alkylureido group such as an N,N-dimethylaminoureido group, and an arylureido group such as an N-phenylureido group and an N-(p-cyanophenyl)ureido group. Among them, the aminoacyl group is preferable.

Examples of the group substituting on the benzene ring through a sulfur atom include an alkylthio group such as a methylthio group and t-octylthio group, an arylthio group such as a phenylthio group, a heterocyclic-thio group such as a 1-phenylterazole-5-thio group and a 5-methyl-1,3,4-oxadiazole-2-thio group, a sulfinyl group, for example, an alkylsulfinyl group such as a methanesulfinyl group and a trifluoromethanesulfinyl group, and an arylsulfinyl group such as a p-toluenesulfinyl group, a sulfamoyl group, for example, an alkylsulfamoyl group such as a dimethylsulfamoyl group and a 4-(2,4-di-t-amylphenoxy)butylaminosulfamoyl group, and an arylsulfamoyl group such as a phenylsulfamoyl group. The sulfinyl group is preferable and an alkylsulfinyl group having 4 to 12 carbon atoms is particularly preferable.

In Formula (3), n is an integer of 1-4, and preferably 1 or 2. When n is 2 or more, plural groups represented by R₁₁ may be the same as or different from each other. Though the substituting position of the substituent represented by R₁₁ is not specifically limited, 4- or 5-position is preferable.

In Formula (3), R₁₂ is a hydrogen atom or an aliphatic group such as an alkyl group, an alkenyl group and an alkynyl group, an aromatic group such as a phenyl group and a p-chlorophenyl group, or a heterocyclic group such as a 2-tetrahydrofuryl group, a 2-thiophenyl group, a 4-imidazolyl group, an indoline-1-yl group and a 2-pyridyl group. R₁₂ is preferably a hydrogen atom or an alkyl group.

In Formula (3), R₁₃ is a hydrogen atom, an aliphatic group, an aromatic group or a heterocyclic group. R₁₃ is preferably a hydrogen atom or an alkyl group having 1 to 12 carbon atoms, or a branched alkyl group such as an i-propyl group, a t-butyl group and a t-amyl group is preferable, which is excellent in the durability.

In Formula (3), R₁₄ is an oxygen atom or a group substituting on the benzene ring through an oxygen atom or a nitrogen atom, concretely a group the same as that the group substituting on the benzene ring through an oxygen atom or a nitrogen atom represented by R₁₁. R₁₄ is preferably an acylamino group or an alkoxy group.

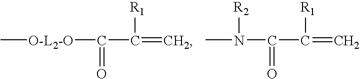

When the polymerizable group is contained in R₁₄ as a partial structure, R₁₄ is preferably the above.

In the above formula, L₂ is an alkylene group having 1-12 carbon atoms, and preferably a strait-chain alkylene group having 3-6 carbon atoms, branched-chain or cyclic alkylene group. R₁ is a hydrogen atom or a methyl group, R₂ is an alkyl group having 11-12, preferably 2-6, carbon atoms.

In Formula (3), R₁₅ is a hydrogen atom, an aliphatic group, an aromatic group or a heterocyclic group. R₁₅ is preferably a hydrogen atom or an alkyl group having 1 to 12 carbon atoms, and particularly preferably a branched-chain alkyl group such as an i-propyl group, a t-butyl group and a t-amyl group.

In Formula (3), R₁₆ is a hydrogen atom, an aliphatic group, an aromatic group or a heterocyclic group, and preferably a hydrogen atom.

Examples of UV absorbing monomer preferably employable in the present invention are listed below, but the monomer is not limited to the examples.

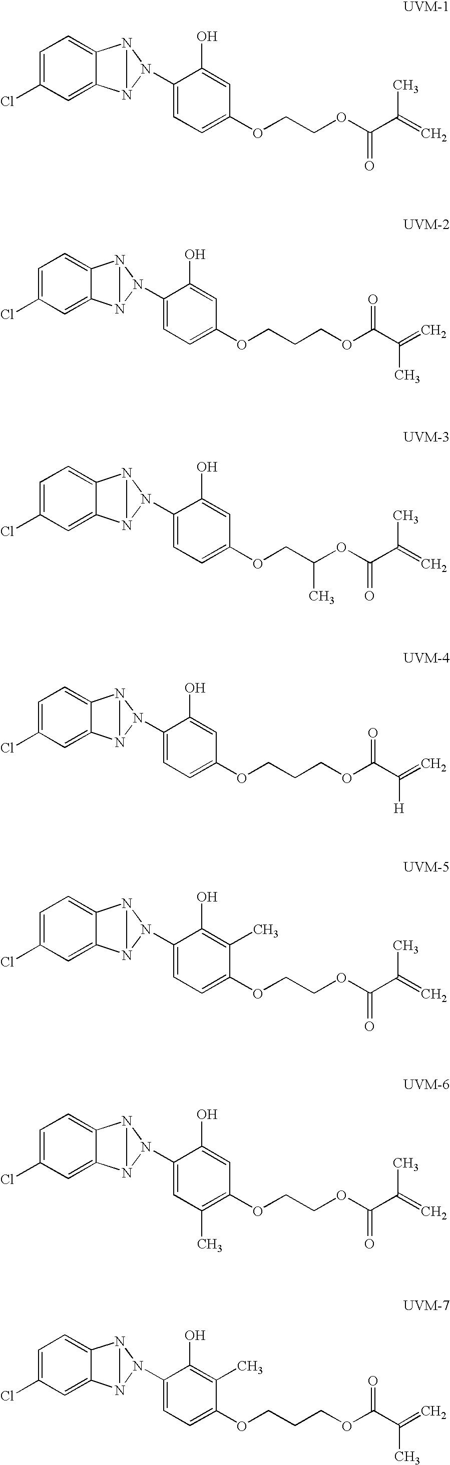

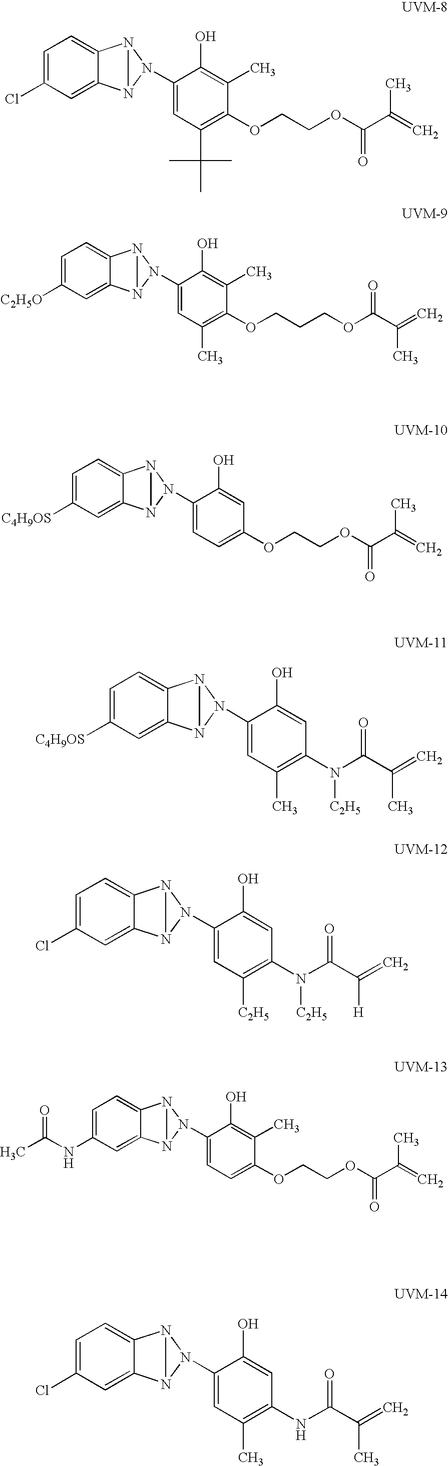

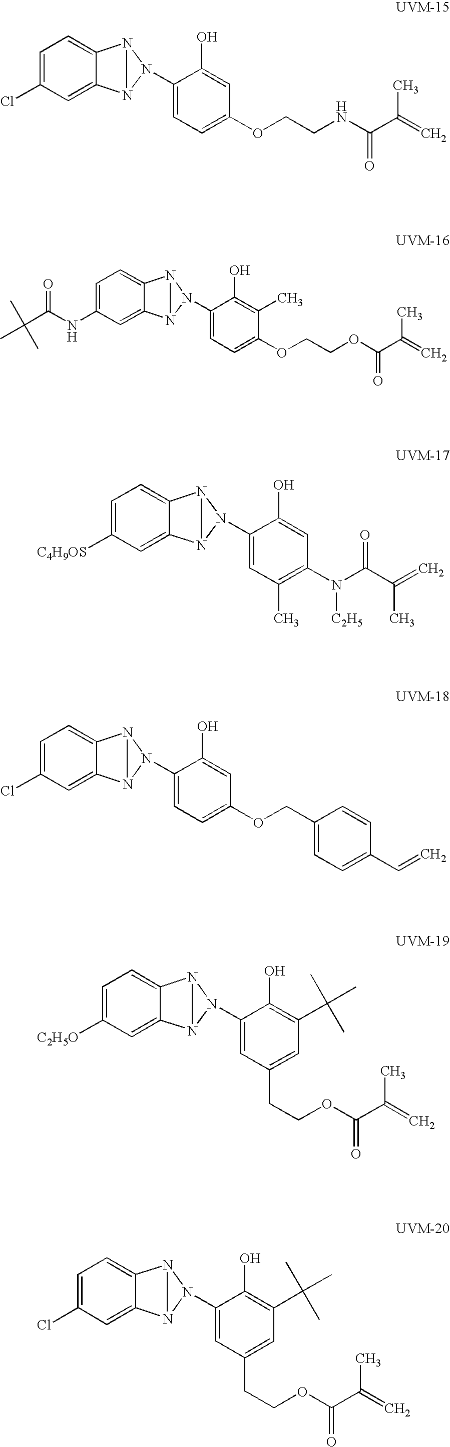

b. Description of Polymer

The UV absorbing polymer to be employed in the present invention is a copolymer of the UV absorbing monomer and the ethylenic unsaturated monomer, which is characterized in that the weight average molecular weight is within the range of 490-50,000.

The haze is reduced by the use of the UV absorber in the state of copolymer and the polarizing plate protective film A excellent in the transparency can be obtained. In the present invention, the weight average molecular weight of the copolymer is within the range of 490-50,000, preferably 2,000-20,000, and more preferably 7,000-15,000. When the weight average molecular weight is less than 490, the copolymer tends to be oozed out on the film surface and colored during the passing of time. When the weight average molecular weight is more than 50,000, the compatibility of the copolymer with the resin tends to be lowered.

Examples of the ethylenic unsaturated monomer capable of copolymerizing with the UV absorbing monomer include methacrylic acid and a ester thereof such as methyl methacrylate, ethyl methacrylate, propyl methacrylate, butyl methacrylate, i-butyl methacrylate, t-butyl methacrylate, octyl methacrylate, cyclohexyl methacrylate, 2-hydroxyhexyl methacrylate, 2-hydroxypropyl methacrylate, tetrahydroxyfurfuryl methacrylate, benzyl methacrylate, dimethylaminoethyl methacrylate and diethylaminoethyl methacrylate, and acrylic acid and an ester thereof such as methyl acrylate, ethyl acrylate, propyl acrylate, butyl acrylate, i-butyl acrylate, t-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, Diethylene glycol ethoxylate acrylate, 3-methoxybutyl acrylate, benzyl acrylate and dimethylaminoethyl acrylate, an alkyl vinyl ether such as methyl vinyl ether, ethyl vinyl ether and butyl vinyl ether, an alkyl vinyl ester such as vinyl formate, vinyl butylate, vinyl capronate and vinyl stearate, acrylonitrile, vinyl chloride and styrene.

Among the ethylenic unsaturated monomers, an acrylate and a methacrylate each having a hydroxyl group or an ether bond such as 2-hydroxyethyl methacrylate, 2-hydroxypropyl methacrylate, tetrahydrofurfuryl methacrylate, 2-hydroxyethyl acrylate, 2-hydroxypropyl acrylate, tetrahydrofurfuryl acrylate, 2-ethoxyethyl acrylate, diethylene glycol ethoxylate acrylate and 3-methoxybutyl acrylate are preferable. These monomers can be copolymerized solely or in combination with the UV absorbing monomer.

The ratio of the UV absorbing monomer to the copolymerizable ethylenic unsaturated monomer is determined considering the compatibility of the formed copolymer with the transparent resin, the influence on the transparency and the mechanical strength of the optical film. It is preferably to combine them so that the copolymer contains 20-70%, more preferably 30-60%, by weight of the UV absorber monomer. When the content of the UV absorbing monomer is less than 20% by weight, a large adding amount of the UV absorber is necessary for obtaining desired UV absorbing ability so that the transparency of the film is considerably lowered by increasing in the haze or precipitation of the UV absorber and the strength of the film tends to be lowered. When the content of the UV absorbing monomer is more than 70% by weight, the compatibility with the transparent resin tends to lowered and the production efficiency of the film is degraded.

c. Description of Polymerization Method

In the present invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutyronitrile (AIBN), a diester of azobisisobutylic acid and benzoyl peroxide, are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated and emulsion polymerization in which the polymerization is carried out in a micelle state are also performed according to selection of the solvent.

The weight average molecular weight of the UV absorbing copolymer can be controlled by known molecular weight controlling methods. For controlling the molecular weight, for example, a method can be applied in which adding a chain transfer agent such as carbon terachloride, laurylmercptane and octyl thioglycolate is employed. The polymerization is usually performed at a temperature of from a room temperature to 130° C., and preferably 50-100° C.

The UV absorbing copolymer is mixed with the transparence resin constituting the polarizing plate protective film A preferably in a ratio of 0.01-40%, more preferably 0.1-10%, by weight. On this occasion, the mixing ratio is not limited when the haze is not more than 0.5; the haze is preferably not more than 0.2. It is more preferable that formed polarizing plate protective film A has a haze of not more than 0.2 and has a transparency at 380 nm of not more than 10%.

Moreover, it is also preferable that at least one of the UV absorbers contains a polymer derived from a UV absorbing monomer represented by Formula (2).

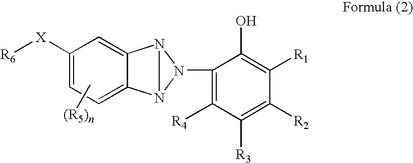

In Formula (2), n is an integer of 0-3, and when n is 2 or more, plural groups represented by R₅ may be the same as or different from each other and may be bonded together with to form a 5- through 7-member ring.

R₁ through R₅ are each a hydrogen atom, a halogen atom or a substituent. Examples of the halogen atom include a fluorine atom, a chlorine atom, a bromine atom and an iodine atom, and preferably the fluorine atom and the chlorine atom. Examples of the substituent include an alkyl group such as a methyl group, an ethyl group, an isopropyl group, a hydroxyethyl group, a methoxymethyl group, a trifluoromethyl group and a t-butyl group, an alkenyl group such as a vinyl group, an allyl group and a 3-butene-1-yl group, an aryl group such as a phenyl group, a naphthyl group, a p-tolyl group and a p-chlorophenyl group, a heterocyclic group such as a pyridyl group, a benzimidazolyl group, a benzothiazolyl group and a benzoxazolyl group, an alkoxy group such as a methoxy group, an ethoxy group, an isopropoxy group and an n-butoxy group, an aryloxy group such as a phenoxy group, a heteocycloxy group such as a 1-phenyltetrazole-5-oxy group, a 2-tetrahydropyranyloxy group, an acyloxy group such as an acetoxy group, pivaloyloxy group and a benzoyloxy group, an acyl group such as an acetyl group, an isopropanoyl group and a butyloyl group, an alkoxycarbonyl group such as a methoxycarbonyl group and an ethoxycarbonyl group, an aryloxycarbonyl group such as a phenoxycarbonyl group, a carbamoyl group such as a methylcarbamoyl group, an ethylcarbamoyl group and a dimethylcarbamoyl group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a nitro group, a sulfonamido group such as a methanesulfonamido group and a benzenesulfonamido group, a sulfamoylamino group such as a dimethylsulfamoylamino group, a sulfonyl group such as a methanesulfonyl group, a butanesulfonyl group and a phenylsulfonyl group, a sulfamoyl group such as an ethylsulfamoyl group and dimethylsulfamoyl group, a sulfonylamino group such as a methanesulfonylamino group and a benzenesulfonylamino group, a ureido group such as a 3-methylureido group, a 3,3-dimethylureido group and a 1,3-dimethylureido, an imido group such as a phthalimido group, a silyl group such as a trimethylsilyl group, a triethylsilyl group and t-butyldimethylsilyl group, an alkylthio group such as a methylthio group, an ethylthio group and an n-butylthio group, an arylthio group such as a phenylthio group, and the alkyl group and aryl group are preferable.

In Formula (2), the groups represented by R₁ through R₅ each may have a substituent when the group can be substituted, and adjacent R₁ through R₄ may be bonded to for a 5- to 7-member ring.

R₆ is a hydrogen atom, an alkyl group, an alkenyl group, an alkynyl group, an aryl group or a heterocyclic group. The alkyl group is, for example, a methyl group, an ethyl group, a propyl group, an isopropyl group, an n-butyl group, an isobutyl group, a t-butyl group, an amyl group, an isoamyl group and a hexyl group. The alkyl group may further have a halogen atom or a substituent. The halogen atom is, for example, a fluorine atom, a chlorine atom, a bromine atom and an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the alkenyl group include a vinyl group, an allyl group, a 1-methyl-2-propenyl group, a 3-butenyl group, a 2-butenyl group, a 3-methyl-2-butenyl group and an oleyl group, and the vinyl group, and the 1-methyl-2-propenyl group is preferable.

Examples of the alkynyl group include an ethynyl group, a butynyl group, a phenylethynyl group, a propargyl group, a 1-methyl-2-propynyl group, a 2-butynyl group and a 1,1-dimethyl-2-propynyl group, and the ethynyl group and the propargyl group are preferable.

Examples of the aryl group include a phenyl group, a naphthyl group and an anthranyl group. The aryl group may have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionyl amino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₆ is preferably the alkyl group.

In Formula (2), X is a —COO— group, a —CONR₇— group, a —OCO— group or an —NR₇CO— group.

R₇ is a hydrogen atom, an alkyl group, a cycloalkyl group an aryl group or a heterocyclic group. The alkyl group is, for example, a methyl group, an ethyl group, a propyl group, an isopropyl group, an n-butyl group, an isobutyl group, a t-butyl group, an amyl group, an isoamyl group or a hexyl group. The alkyl group may further have a halogen atom or a substituent. The halogen atom is, for example, a fluorine atom, a chlorine atom, a bromine atom or an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the aryl group include a phenyl group, a naphthyl group and an anthranyl group. The aryl group may further have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₇ is preferably the hydrogen atom.

In the present invention, the polymerizable group is a unsaturated ethylenic polymerizable group or a di-functional condensation-polymerizable group, and preferably the unsaturated ethylenic polymerizable group. Concrete examples of the unsaturated ethylenic polymerizable group include a vinyl group, an allyl group, an acryloyl group, a methacryloyl group, a styryl group, an acrylamido group, a methacrylamido group, a vinyl cyanide group, a 2-cyanoacryloxy group, a 1,2-epoxy group, a vinylbenzyl group and a vinyl ether group and preferably the vinyl group, the acryloyl group, the methacryloyl group, the acrylamido group and the methacrylamido group. The UV absorbing monomer having the polymerizable group as the partial structure thereof is the monomer in which the polymerizable group is bonded directly or through two or more bonding groups to the UV absorber, for example an alkylene group such as a methylene group, a 1,2-ethylene group, a 1,3-propylene group, a 1,4-butylene group and a cyclohexane-1,4-diyl group, an alkenylene group such as an ethane-1,2-diyl group and a butadiene-1,4-diyl group, an alkynylene group such as a etyne-1,2-diyl group, a butane-1,3-diine-1,4-diyl, a bonding group derived from a compound including an aromatic group such as a substituted or unsubstituted benzene, a condensed polycyclic hydrocarbon, an aromatic heterocyclic rings, a combination of aromatic hydrocarbon rings and a combination of aromatic heterocyclic rings, and bonding by a hetero atom such as an oxygen atom, a sulfur atom, a nitrogen atom, a silicon atom and a phosphor atom. The bonding group is preferably the alkylene group and the bonding by the hetero atom. These bonding groups may be combined for forming a composite bonding group. The weight average molecular weight of the polymer derived from the UV absorbing monomer is 2,000-30,000, and preferably 5,000-20,000.

The weight average molecular weight of the UV absorbing copolymer can be controlled by known molecular weight controlling methods. For controlling the molecular weight, for example, a method can be applied in which a chain transfer agent such as carbon terachloride, laurylmercptane and octyl thioglycolate is employed. The polymerization is usually performed at a temperature of from a room temperature to 130° C., and preferably 50-100° C.

The UV absorbing polymer to be employed in the present invention is preferably a copolymer of the UV absorbing monomer and another polymerizable monomer. Examples of the other monomer capable of polymerizing include a unsaturated compound, for example, a styrene derivative such as styrene, α-methylstyrene, o-methylstyrene, m-methylstyrene, p-methylstyrene and vinylnephthalene, an acrylate derivative such as methyl acrylate, ethyl acrylate, propyl acrylate, butyl acrylate, i-butyl acrylate, t-butyl acrylate, octyl acrylate, cyclohexyl acrylate and benzyl acrylate, a methacrylate derivative such as methyl methacrylate, ethyl methacrylate, propyl methacrylate, butyl methacrylate, i-butyl methacrylate, t-butyl methacrylate, octyl methacrylate, cyclohexyl methacrylate and benzyl methacrylate, an alkyl vinyl ether such as methyl vinyl ether, ethyl vinyl ether and butyl vinyl ether, an alkyl vinyl ester such as vinyl formate, vinyl acetate, vinyl butylate, vinyl capronate and vinyl stearate, crotonic acid, maleic acid, fumaric acid, itaconic acid, acrylonitrile, methacrylonitrile, vinyl chloride, vinylidene chloride, acrylamide and methacrylamide. Methyl acrylate, methyl methacrylate and vinyl acetate are preferred.

It is also preferable that the component other than the UV absorbing monomer in the polymer derived from the UV absorbing monomer contains a hydrophilic ethylenic unsaturated monomer.

As the hydrophilic ethylenic unsaturated monomer, a hydrophilic compound having a polymerizable unsaturated double bond in the molecular thereof is employable without any limitation. For example, a unsaturated carboxylic acid such as acrylic acid and methacrylic acid, an acrylate and methacrylate each having a hydroxyl group or an ether bond such as 2-hydroxyethyl methaceylate, 2-hydroxypropyl methacrylate, tetrahydrofurfuryl methacrylate, 2-hydroxyethyl acrylate, 2-hydroxypropyl acrylate, 2,3-dihydroxy-2-methylpropyl methacrylate, tetrahydrofurfuryl acrylate, 2-ethoxyethyl acrylate, diethylene glycol ethoxylate acrylate and 3-methoxybutylbutyl acrylate, acrylamide, an N-substituted (meth)acrylamido such as N,N-dimethyl(meth)acrylate, N-vinylpyrrolidone and N-vinyloxazolidone are employable.

As the hydrophilic ethylenic unsaturated monomer, a (meth)acrylate having a hydroxyl group or a carboxyl group in the molecule thereof is preferable, and 2-hydroxyethyl methacrylate, 20hydroxypropyl methacrylate, 2-hydroxyethyl acrylate and 2-hydroxypropyl acrylate are particularly preferable.

These polymerizable monomers can be copolymerized solely or in combination of two or more kinds together with the UV absorbing monomer.

In the present invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutylnitrile (AIBN), a diester of azobisisobutylic acid, benzoyl peroxide and hydrogen peroxide are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated, emulsion polymerization in which the polymerization is carried out in a micelle state and suspension polymerization carried out in a suspended state can be performed according to selection of the solvent.

The using ratio of the UV absorbing monomer, the polymerizable monomer capable of polymerizing with the UV absorbing monomer and the hydrophilic unsaturated monomer is suitably determined considering the compatibility of the obtained UV absorbing copolymer with the other transparent polymer and the influence on the transparency and the mechanical strength of the optical compensating film.

The content of the UV absorbing monomer in the polymer derived from the UV absorbing monomer is preferably 1-70%, and more preferably 5-60%, by weight. When the content of the UV absorber monomer in the UV absorbing polymer is less than 1%, addition of a large amount of the UV absorbing polymer is necessary for satisfying the desired UV absorbing ability so that increasing in the haze or lowering in the transparency and the mechanical strength by the precipitation is caused. On the other hand, when the content of the UV absorbing monomer in the UV absorbing polymer exceeds 70% by weight, the transparent polarizing plate protective film A is difficultly obtained sometimes since the compatibility of the polymer with another polymer is lowered.

The hydrophilic ethylenic unsaturated monomer is preferably contained in the UV absorbing copolymer in a ratio of from 0.1 to 50% by weight. When the content is less than 0.1%, the improvement effect on the compatibility of the hydrophilic ethylenic unsaturated monomer cannot be obtained and when the content is more than 50% by weight, the isolation and purification of the copolymer becomes impossible. More preferable content of the hydrophilic ethylenic unsaturated monomer is from 0.5 to 20% by weight. When the hydrophilic group is substituted to the UV absorbing monomer itself, it is preferable that the total content of the hydrophilic UV absorbing monomer and the hydrophilic ethylenic unsaturated monomer is within the above-mentioned range.

For satisfying the content of the UV absorbing monomer and the hydrophilic monomer, it is preferable that the an ethylenic unsaturated monomer having no hydrophilicity is further copolymerized additionally to the above two monomers.

Two or more kinds of each of the UV absorbing monomer and hydrophilic or non-hydrophilic ethylenic unsaturated monomer may be mixed and copolymerized.

Typical examples of the UV absorbing monomer to be preferably employed in the present invention are listed below, but the monomer is not limited to these samples.

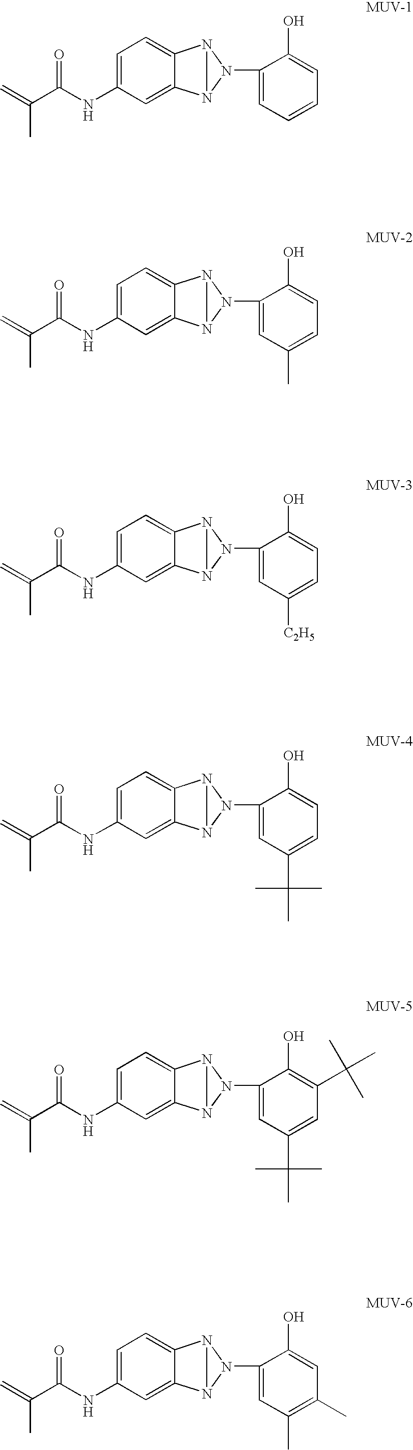

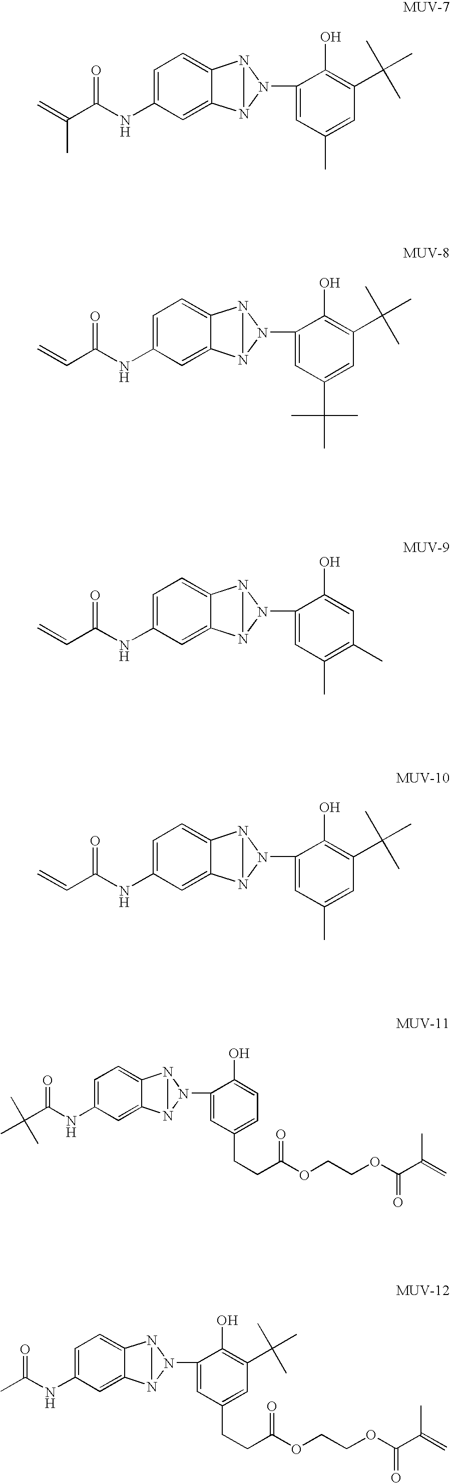

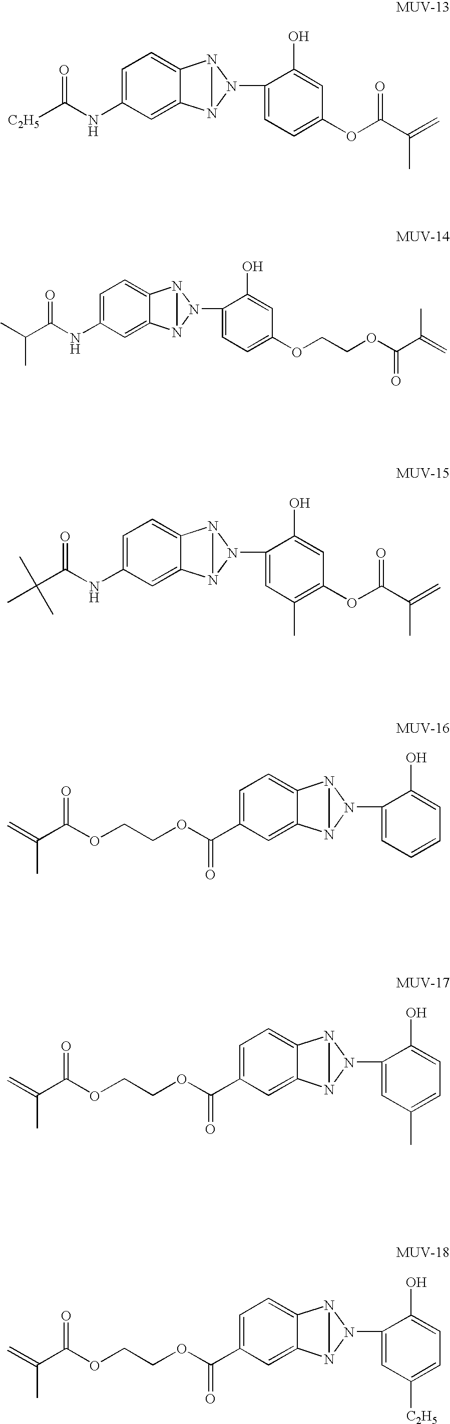

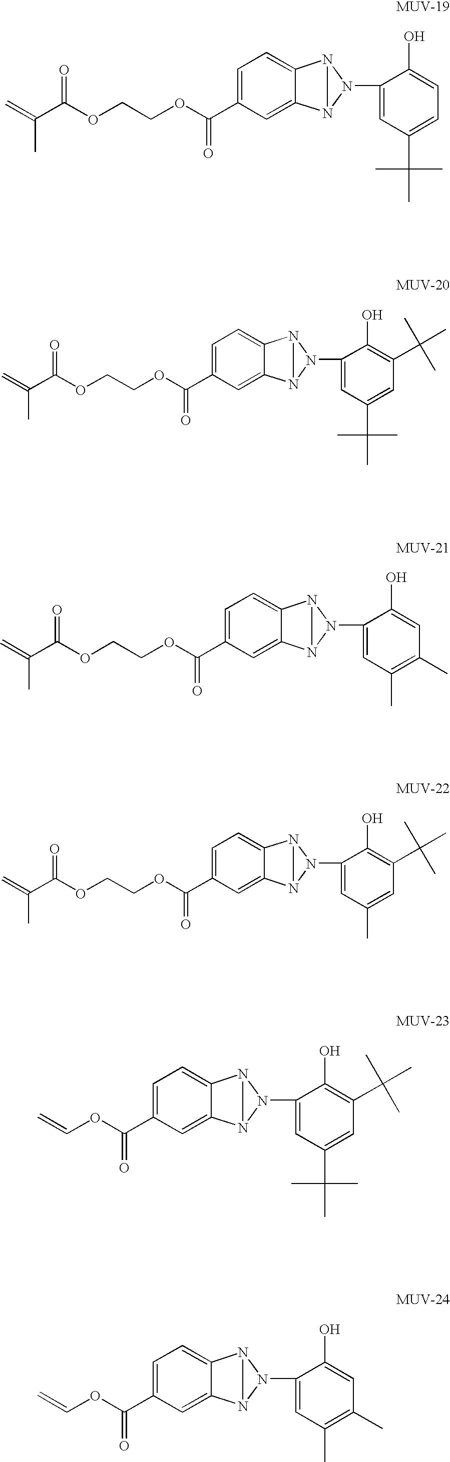

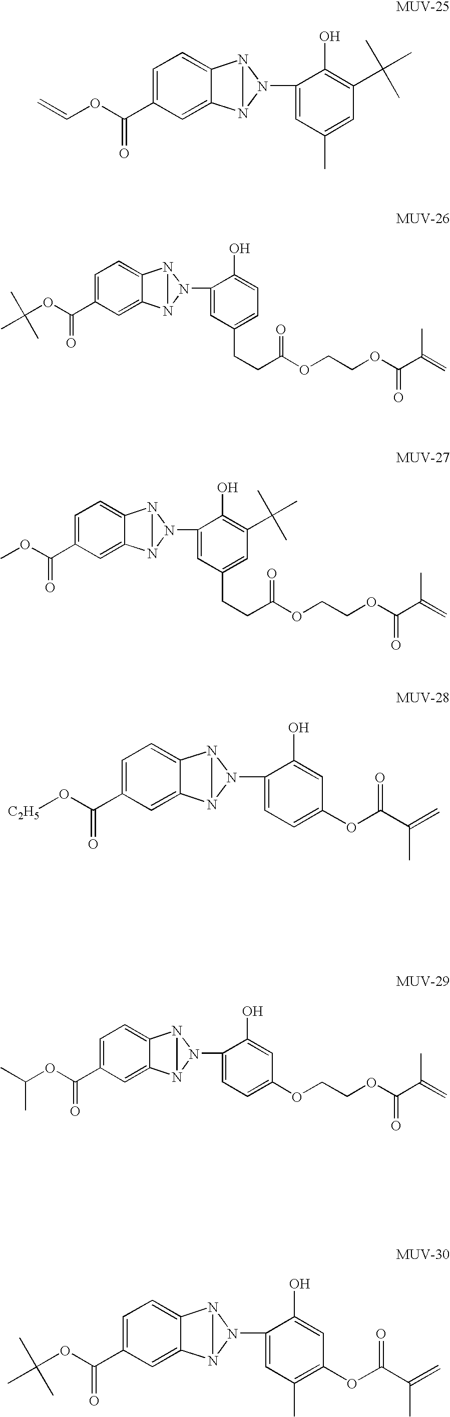

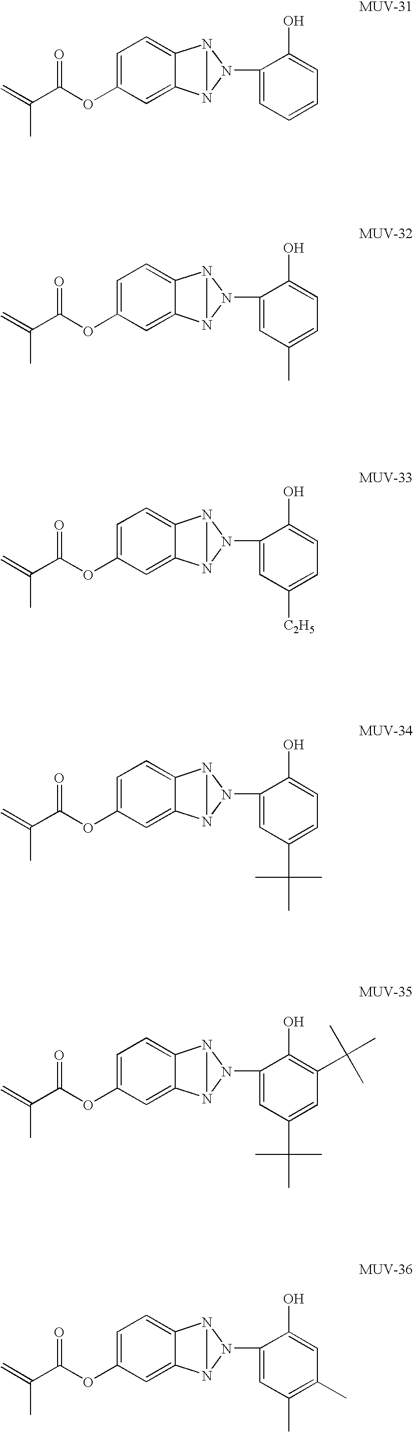

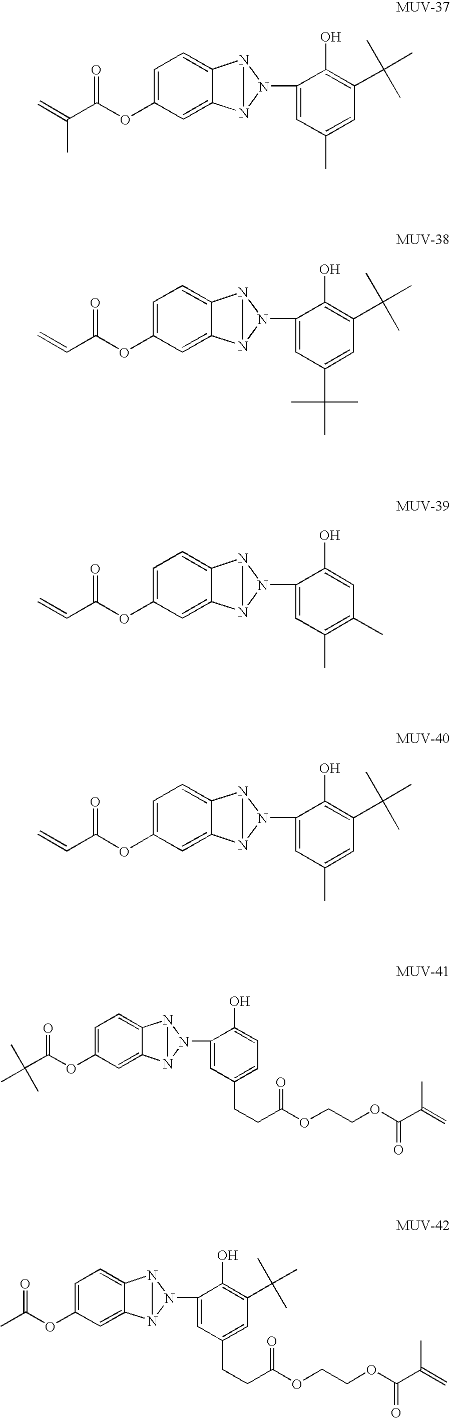

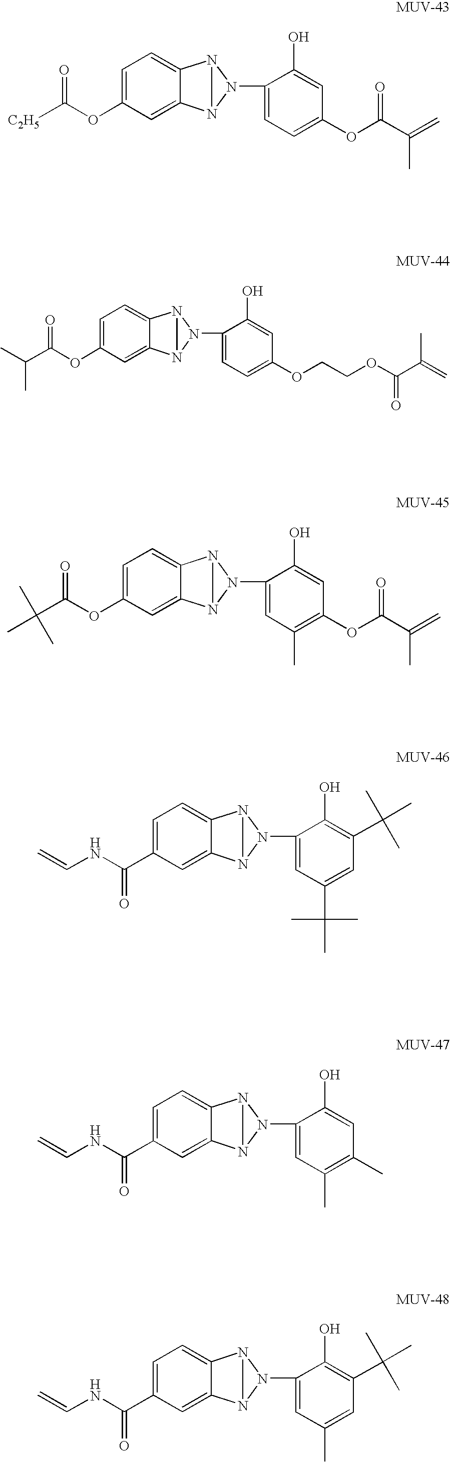

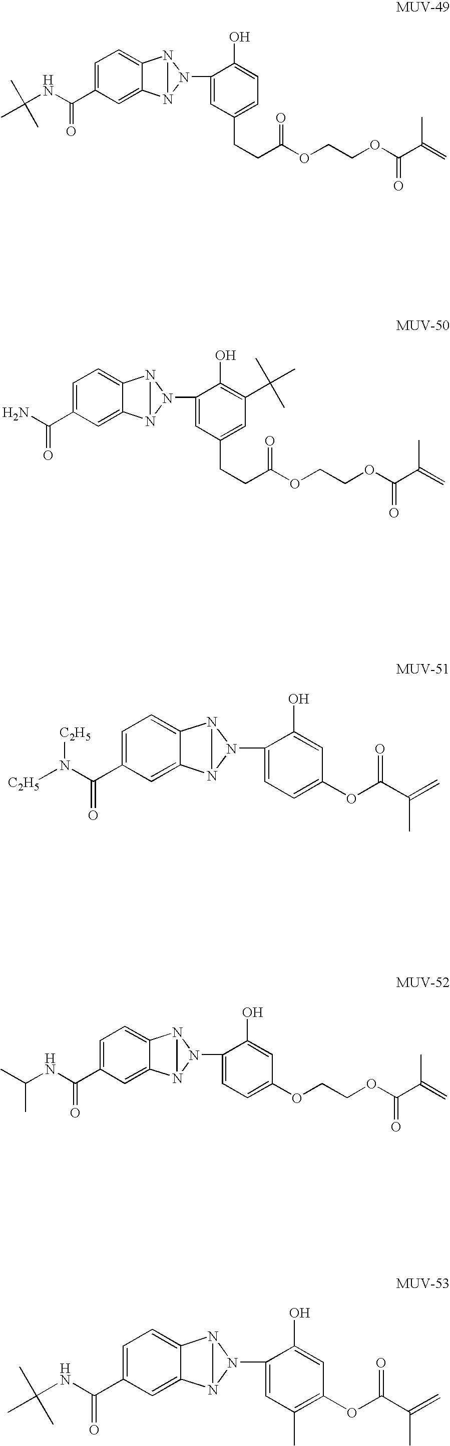

The UV absorbers, UV absorbing monomers and their intermediates to be employed in the present invention can be synthesized by referring published documents. For example U.S. Pat. Nos. 3,072,585, 3,159,646, 3,399,173, 3,761,272, 4,028,331 and 5,683,861, European Patent No. 86,300,416, Japanese Patent O.P.I. Publication Nos. 63-227575 and 63-185969, “Polymer Bulletin” V. 20 (2), 169-176, and “Chemical Abstracts V. 109, No. 191389 can be referred for synthesizing.

The UV absorber and the UV absorbing polymer to be used in the present invention can be employed together with a low or high molecular weight compound or an inorganic compound according to necessity on the occasion of mixing with the other transparent polymer. For example, it is one of preferable embodiments that the UV absorber polymer and another relatively low molecular weight UV absorber are simultaneously mixed with the other transparent polymer. Moreover, simultaneously mixing of an additive such as an antioxidant, a plasticizer and a flame retardant is also one of preferable embodiments.

The UV absorber or the UV absorbing polymer to be employed in the present invention may be added in a state of kneaded with the rein or a solidified state by drying a solution of that together with the resin, though the adding method is not specifically limited.

Though the using amount of the UV absorber and the UV absorbing polymer is varied depending on the kind of compound and the employing conditions, the amount of the UV absorber is preferably 0.1-5.0 g, more preferably 0.1-3.0 g, further preferably 0.4-2.0 g, and particularly preferably 0.5-1.5 g, per square meter of the optical film. In the case of the UV polymer, the adding amount is preferably 0.1-10 g, more preferably 0.6-9.0 g, further preferably 1.2-6.0 g, and particularly preferably 1.5-3.0 g, per square meter of the optical film.

As described above, ones are preferable, which have superior absorbing ability to UV rays of not more than 380 nm for preventing degradation of the liquid crystal and low absorbing ability to visible light of not less than 400 nm for displaying ability of the liquid crystal display. In the present invention, the transparency at a wavelength of 380 nm is preferably not more than 8%, more preferably not more than 4%, and particularly preferably not more than 1%.

As UV absorber monomers available on the market, 1-(2-bezotriazole)-2-hydroxy-5-(vinyloxycarbonylethyl)-benzene UVM-1 and a reactive type UV absorber 1-(2-benzotriazole)-2-hydroxy-5-(2-methacryloyloxyethyl)-benzene UVA-93, each manufactured by Ootsuka Kagaku Co., Ltd., and similar compounds are employable in the present invention. They are preferably employed solely or in a state of polymer or copolymer but not limited to them. For example, a polymer UV absorber available on the market PUVA-30M, manufactured by Ootsuka Kagaku Co., Ltd., is preferably employed. The UV absorber may be used in combination of two or more kinds thereof.

### (Plasticizer)

The addition of a plasticizer in combination with the foregoing polymer to the polarizing plate protective film A of the present invention is desired for improving the film properties such as mechanical properties, softness, anti-moisture absorbing ability. The object of the addition of the plasticizer in the melt-cascading method according to the present invention further includes to make the melting point of the film constituting materials to lower than the glass transition point of the independent cellulose and to make the viscosity of the film constituting material containing the plasticizer to lower than that of the cellulose resin at the same temperature.

In the present invention, the melting point of the film constituting material is the temperature of the heated material at the time when the fluidity of the material is appeared.

The independent cellulose resin is not fluidized at a temperature lower than the glass transition point since the cellulose resin becomes film state. However, the elasticity or viscosity of the cellulose resin is lowered by heating at a temperature of higher than the glass transition point so that the cellulose resin is fluidized. It is preferable that the plasticizer to be added has a melting point or glass transition point lower than that of the cellulose resin for melting the film constituting material and satisfying the above objects.

Though the plasticizer relating to the present invention is not specifically limited, the plasticizer has a functional group capable of interacting by a hydrogen bond with the cellulose derivative or the other additives so that the haze or the bleeding out or evaporation of the plasticizer from the film does not occur.

Examples of such the functional group include a hydroxyl group, an ether group, a carbonyl group, an ester group, a residue of carboxylic acid, an amino group, an imino group, an amido group, a cyano group, a nitro group, a sulfonyl group, a residue of sulfonic acid, a phosphonyl group and a residue of phosphoric acid. The carbonyl group, ester group and phosphonyl group are preferable.

Examples of preferably usable plasticizer include a phosphate type plasticizer, a phthalate type plasticizer, a trimelitate type plasticizer, a pyromelitate type plasticizer, a polyvalent alcohol ester type plasticizer, a glycolate type plasticizer, a citrate type plasticizer, an aliphatic acid ester type plasticizer, a calboxylate type plasticizer and a polyester type plasticizer, and the polyvalent alcohol ester type plasticizer, polyester type plasticizer and citrate type plasticizer are particularly preferable. The addition of these plasticizers to the UV absorber having a molecular weight of 490-50,000 is preferable for the compatibility.

The poly-valent alcohol ester is the ester of a di- or more-valent alcohol and a mono-carboxylic acid and preferably has an aromatic ring or a cycloalkyl ring in the molecular thereof.

The poly-valent alcohol is represented by the following Formula (4).

R₁—(OH)ₙ Formula (4)

In the above, R₁ is an n-valent organic group, and n is an integer of 2 or more.

Examples of preferable poly-valent alcohol include adonitol, arabitol, ethylene glycol, Diethylene glycol, triethylene glycol, tetraethylene glycol, 1,2-propanediol, 1,3-propanediol, dipeopylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol, but the present invention is not limited to them. Particularly, triethylene glycol, tetraethylene glycol, triethylol propane and xylitol are preferred.

Among them, the poly-valent alcohol esters using a poly-valent alcohol having 5 or more, particularly 5 to 20 carbon atoms are preferable.

As the monocarboxylic acid to be used in the poly-valent alcohol ester, a known aliphatic monocarboxylic acid, alicyclic monocarboxylic acid and aromatic monocarboxylic acid can be employed though the monocarboxylic acid is not limited. The alicyclic monocarboxylic acid and aromatic monocarboxylic acid are preferable for improving the moisture permeability ability and storage ability.

Examples of the preferable monocarboxylic acid are listed below but the present invention is not limited to them.

A straight or side chain fatty monocarboxylic acid having 1-32 carbon atoms is preferably employed. The number of carbon atoms is more preferably 1-20, and particularly preferably 1-10. The addition of acetic acid is preferable for raising the compatibility with the cellulose derivative, and the mixing of acetic acid with another carboxylic acid is also preferable.

As the preferable aliphatic monocarboxylic acid, a saturated fatty acid such as acetic acid, propionic acid, butylic acid, valeric acid, caproic acid, enantic acid, caprylic acid, pelargonic acid, capric acid, 2-ethyl-hexane carboxylic acid, undecylic acid, lauric acid, dodecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid and lacceric acid, and a unsaturated fatty acid such as undecylenic acid, oleic acid, sorbic acid, linolic acid, linolenic acid and arachidonic acid can be exemplified.

Examples of preferable alicyclic carboxylic acid include cyclopentene carboxylic acid, cyclohexane carboxylic acid, cyclooctane carboxylic acid and derivatives thereof.

Examples of preferable aromatic carboxylic acid include ones formed by introducing an alkyl group onto the benzene ring of benzoic acid such as benzoic acid and toluic acid, an aromatic monocarboxylic acid having two or more benzene rings such as biphenylcarboxylic acid, naphthalene carboxylic acid and tetralin carboxylic acid and derivatives of them, and benzoic acid is particularly preferable.

The molecular weight of the poly-valent alcohol is preferably 300-3,000, and more preferably 350-1,500 though the molecular weight is not specifically limited. Larger molecular weight is preferable for low volatility and smaller molecular weight is preferable for the moisture permeability and the compatibility with the cellulose derivative.

The carboxylic acid to be employed in the poly-valent alcohol ester may be one kind or a mixture of two or more kinds of them. The hydroxyl group in the polyvalent alcohol may be entirely esterified or partially leaved.

Concrete compounds of the poly-valent alcohol ester are listed below.

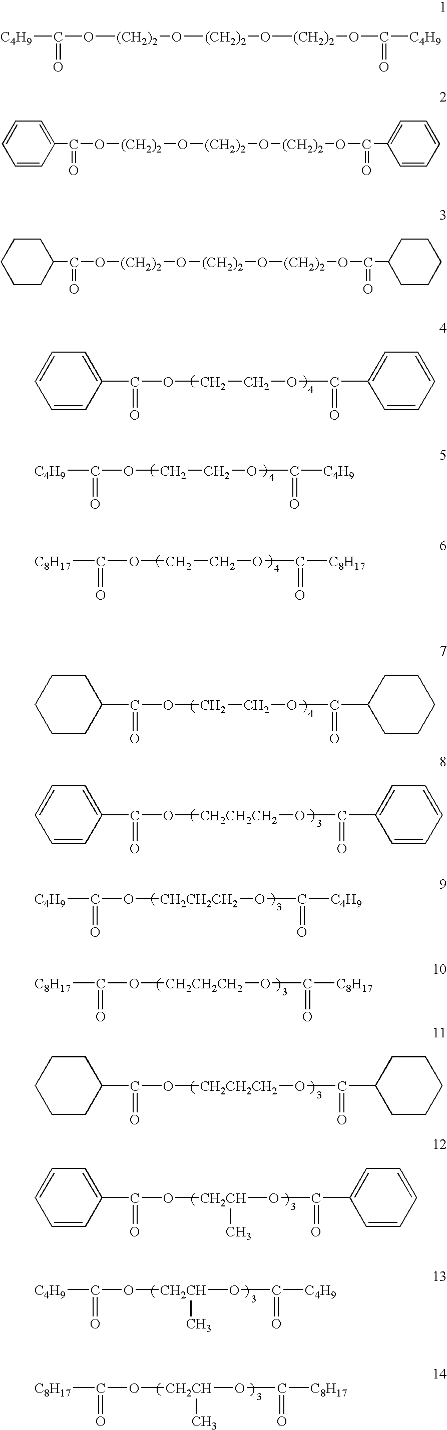

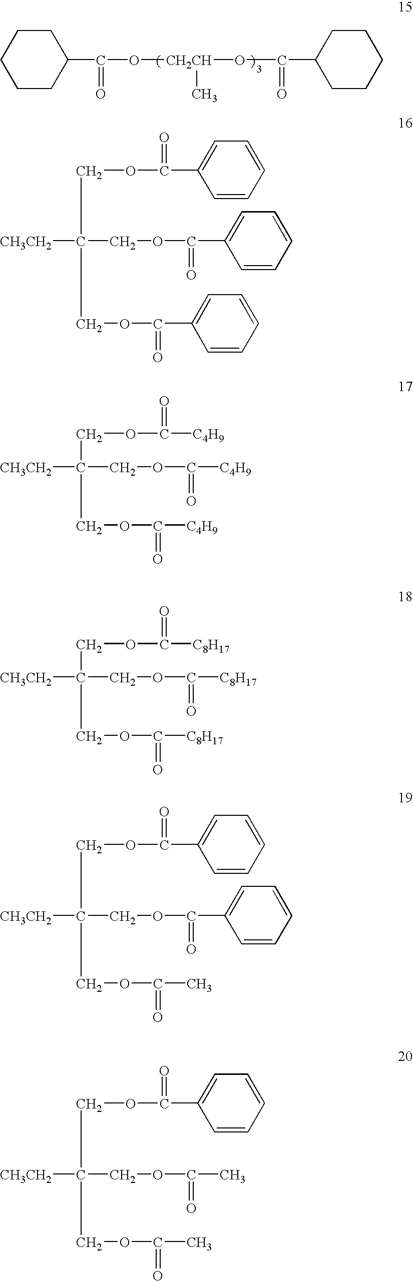

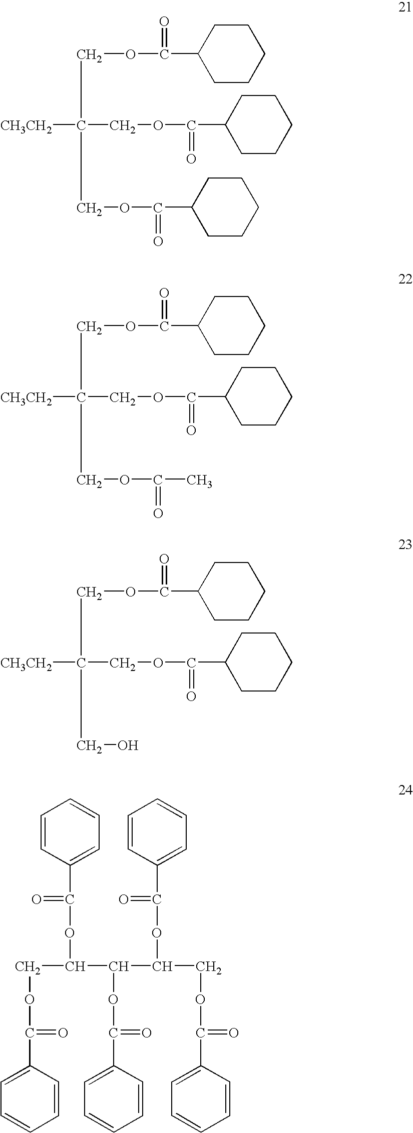

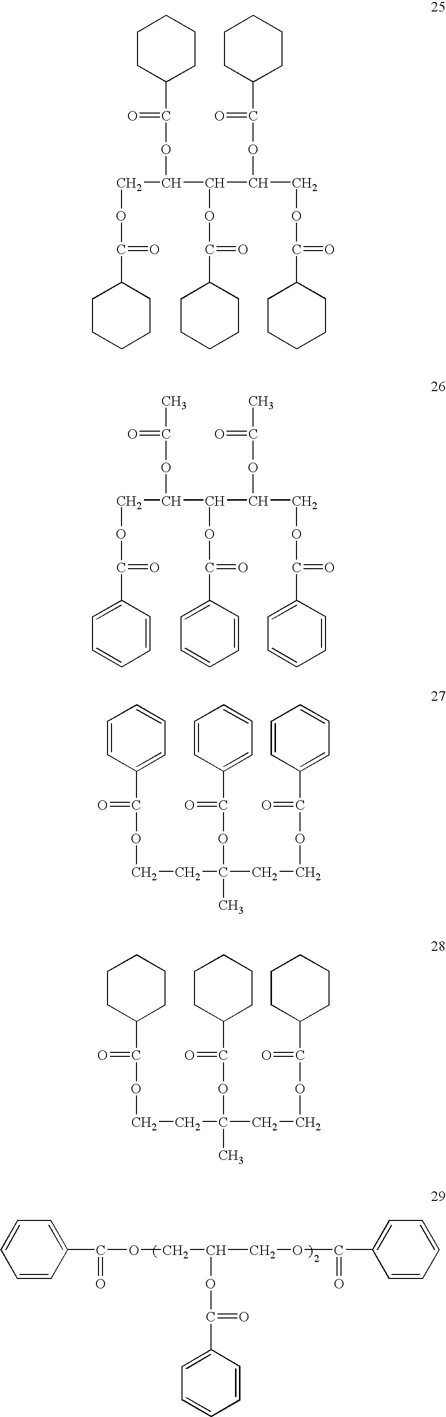

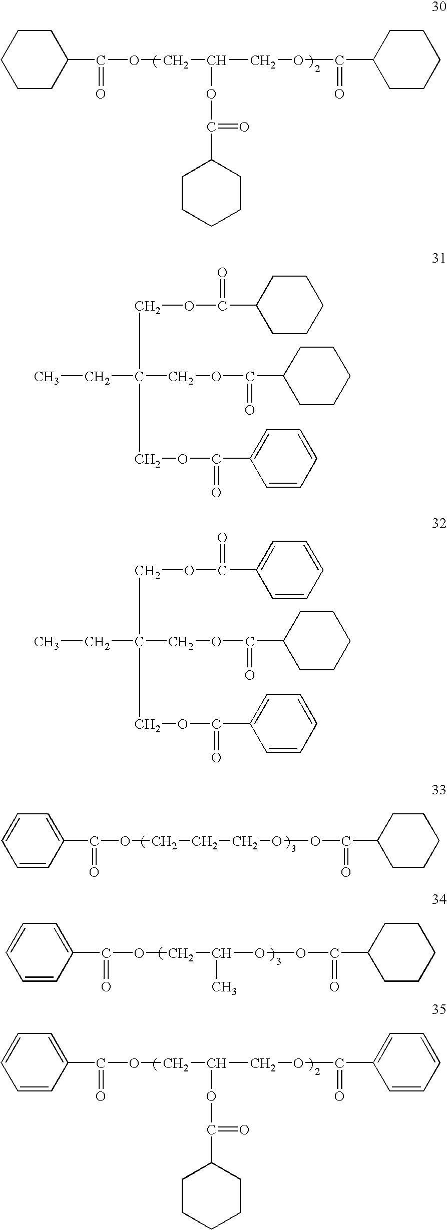

Moreover, a polyester type plasticizer having a cycloalkyl group in the molecule thereof is preferably employed. For example, compounds represented by the following Formula (5) are preferable though the polyester type plasticizer is not specifically limited.

B-(G-A)ₙ-G-B Formula (5)

In the above formula, B is a benzene monocarboxylic acid residue, G is an alkylene glycol residue having 2-12 carbon atoms, an aryl glycol residue having 6-12 carbon atoms or an oxyalkylene glycol residue having 4-12 carbon atoms, A is an alkylenecarboxylic acid residue having 4-12 carbon atoms or an aryldicarboxylic acid residue having 6-12 carbon atoms, and n is an integer of 0 or more.

The polyester type plasticizer of Formula (5) is constituted by the benzene monocarboxylic acid residue represented by B, the alkylene glycol residue, the aryl glycol residue or the oxyalkylene glycol residue represented by G, and an alkylenecarboxylic acid residue or an aryldicarboxylic acid residue represented by A; the plasticizer can be obtained by a reaction similar to that for obtaining usual polyester type plasticizer.

As the benzene monocarboxylic acid component of the polyester type plasticizer employed in the present invention, for example, benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid and acetoxybenzoic acid are applicable. They can be employed solely or in combination.

Examples of the alkylene glycol with 2-12 carbon atoms as the component of the polyester type plasticizer of the present invention include ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. These glycols are employed solely or in mixture of two or more kinds thereof.

Examples of the oxyalkylene glycol component with 4-12 carbon atoms forming the terminal aromatic ester structure include Diethylene glycol, triethylene glycol, tetraethylene glycol, dipropylene glycol and tripropylene glycol. These glycols can be employed solely or in combination of two or more kinds.

Examples of the alkylenedicarboxylic acid component with 4-12 carbon atoms forming the terminal aromatic ester structure include succinic acid, maleic acid, fumaric acid, glutaric acid, adipic acid, azelaic acid, sebacic acid and dodecanedicarboxylic acid. These acids can be employed solely or in a combination of two or more kinds. The examples of the arylenedicarbbxylic acid component having 6 to 12 carbon atoms include phthalic acid, tetraphthalic acid, 1,5-naphthalenedicarboxylic acid and 1,4-naphthalenedicarboxylic acid.

The suitable number average molecular weight of the polyester type plasticizer to be employed in the present invention is preferably 250-2,000, and more preferably 300-1,500. The acid value of that is 0.5 mg KOH/g or less, and the hydroxy group value of that is 25 mg KOH/g. More preferably, the acid value is 0.3 mg KOH/g or less, and the hydroxyl group value is 15 mg KOH/g or less.

Examples of synthesizing of the aromatic terminal ester type plasticizer are described below.

### Sample No. 1 (Sample of Aromatic Terminal Ester)

In a reaction vessel, 365 parts (2.5 moles) of adipic acid, 418 parts (5.5 moles) of 1,2-propylene glycol, 610 parts of (5 moles) of benzoic acid and 0.30 parts of tetraisopropyl titanate as a catalyst were charged at once and stirred in nitrogen gas stream, and heated at a temperature of 130-250° C. until the acid value becomes not more than 2 while formed water was continuously removed and excessive mono-valent alcohol was refluxed by a reflux condenser. After that, distillate was removed under a reduced pressure of not more than 1.33×10⁴ Pa, finally not more than 4×10² Pa at a temperature of 200-230° C., and then the content of the vessel was filtered to obtain an aromatic terminal ester having the following properties.

Viscosity (mPa·s at 25° C.): 815
Acid value: 0.4

### Sample No. 2 (Sample of Aromatic Terminal Ester)

An aromatic terminal ester having the following properties was obtained in the same manner as in Sample 1 except that 365 parts (2.5 moles) of adipic acid, 610 parts (5 moles) of benzoic acid, 583 parts (5.5 moles) of diethylene glycol and 0.45 parts of tetraisopropyl titanate as a catalyst were employed.

Viscosity (mPa·s at 25° C.): 90
Acid value: 0.05

### Sample No. 3 (Sample of Aromatic Terminal Ester)

An aromatic terminal ester having the following properties was obtained in the same manner as in Sample 1 except that 410 parts (2.5 moles) of phthalic acid, 610 parts moles) of benzoic acid, 737 parts (5.5 moles) of dipropylene glycol and 0.40 parts of tetraisopropyl titanate as a catalyst were employed.

Viscosity (mPa·s at 25° C.): 43,400
Acid value: 0.2

Concrete compounds of the aromatic terminal ester type plasticizer are listed below; the present invention is not limited to the listed compounds.

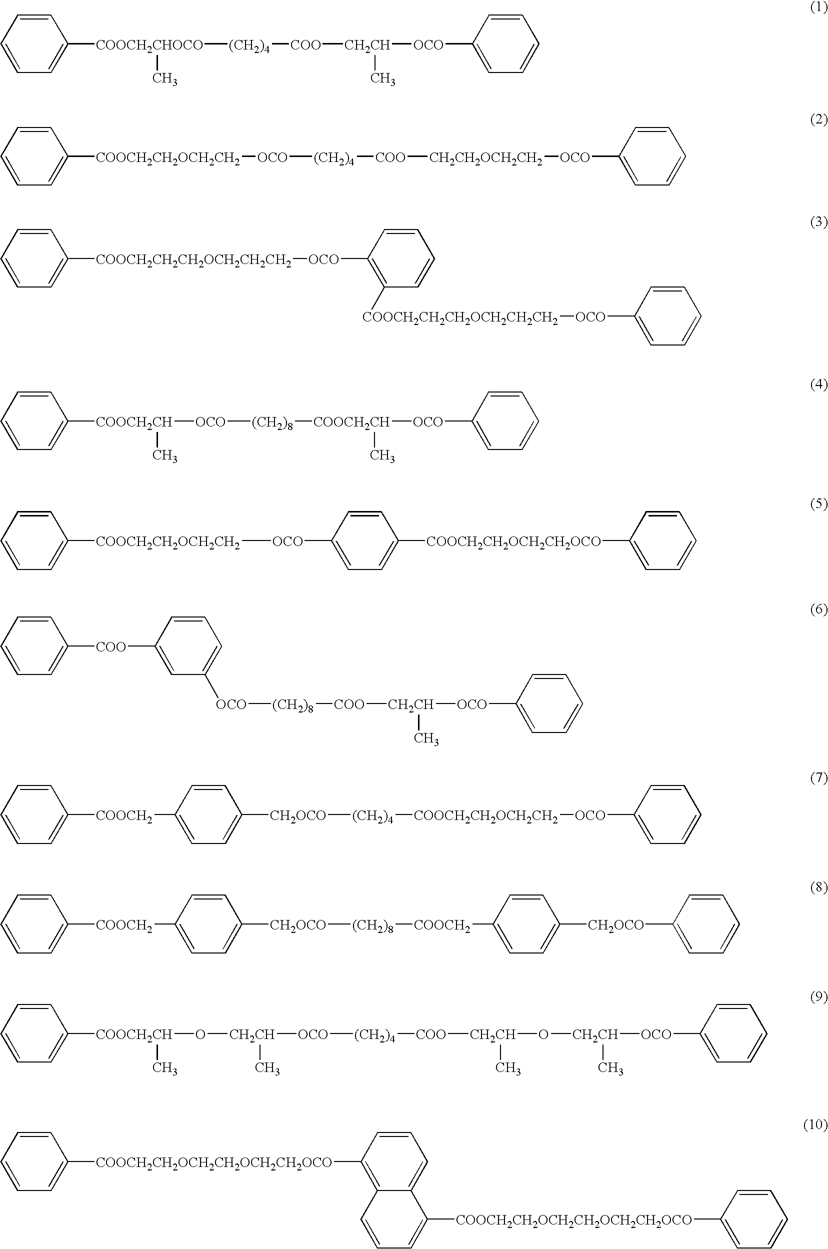

The content of the polyester type plasticizer in the polarizing plate protective film A is preferably 1-200, and particularly preferably 3-11%, by weight.

The polarizing plate protective film A of the present invention preferably contains also a plasticizer other than the above-described plasticizer.

The dissolving out of the plasticizer can be reduced by containing two or more kinds of the plasticizer. Tough the reason of such the effect is not cleared; it is supposed that the dissolving out is inhibited by the interaction between the two kinds of the plasticizer and the cellulose resin.

Glycolate type plasticizers for the present invention are not limited. Glycolate plasticizers having an aromatic ring or a cycloalkyl ring in the molecule are preferably used. Examples of preferred glycolate plasticizers that may be used are, butylphthalylbutyl glycolate, ethylphthalyletyl glycolate, and methylphthalylethyl glycolate.

Examples of phthalate type plasticizer include diethyl phthalate, dimethoxethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

Moreover, a phthalate dimer represented by Formula (1) described in Japanese Patent Application Publication No. 11-349537 is preferably employed. In concrete, Compound-1 and Compound-2 described in paragraphs 23 and 26 of the patent document are preferably employable.

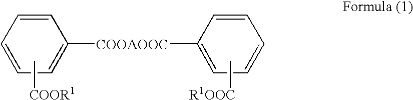

A: —(CH₂)ₙ— or —(CH₂CH₂O)ₙ—
n: Integer of 1-10
R¹ An alkyl group having the number of carbon atoms of 1-12, which may be substituted by an alkoxycarbonyl group

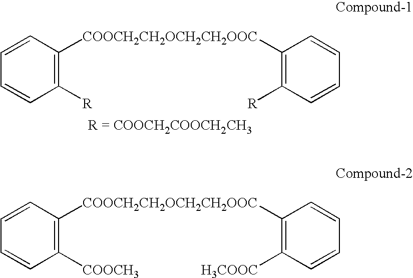

The phthalate type dimer compound is a compound represented by Formula (1), which can be obtained by dehydrating esterification reaction by heating a mixture of two phthalic acids and a di-valent alcohol. The average molecular weight of the phthalate type dimer or the bisphenol type compound having a hydroxyl group at the terminal thereof is preferably 250-3,000, and particularly preferably 300-1,000. When the molecular weight is less than 250, problems are caused in the thermal stability and the volatility and the mobility of the plasticizer. When the molecular weight exceeds 3,000, the compatibility and the plasticizing ability of the plasticizer are lowered and the processing suitability, transparency and the mechanical property of the aliphatic cellulose ester type resin are received bad influences.

As the citrate type plasticizer, acetyltrimethyl citrate, acetyltriethyl citrate and acetyltributyl acetate can be exemplified without any limitation, and the citrate compounds represented by Formula (6) are preferred.

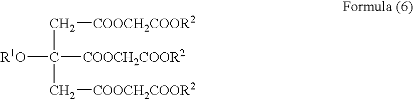

[Where R¹ is a hydrogen atom or an aliphatic acyl group, and R² is an alkyl group.]

In Formula (6), the aliphatic acyl group represented by R¹ is preferably one having 1-12, particularly 1-5, carbon atoms though the acyl group is not specifically limited. In concrete, a formyl group, an acetyl group, a propionyl group, a butylyl group, a varelyl group, a parmitoyl group and oleyl group can be exemplified. The alkyl group represented by R² is not specifically limited and may be one having a straight chain or a branched chain. The alkyl group is preferably one having 1-24, and particularly 1-4, carbon atoms. In concrete, a methyl group, an ethyl group, an n-propyl group, an isopropyl group, an n-butyl group, an isobutyl group, a sec-butyl group and a t-butyl group are exemplified. Particularly, one in which R¹ is a hydrogen atom, R² is a methyl group or an ethyl group, and one in which R¹ is an acetyl group and R² is a methyl group or an ethyl group are preferable as the plasticizer for the cellulose ester type resin.

<Production of Citrate Compound in which R¹ is a Hydrogen Atom>

Among the citrate compounds usable in the present invention, ones in which R¹ is a hydrogen atom can be produced by known methods. As the known method, for example, a method described in British Patent No. 931,781 is applicable, in which phthalyl glycolate is produced from a half ester of phallic acid and an alkyl α-halogenized acetate. In concrete, an amount of larger than the stoichlometric amount, preferably 1-10 moles, and more preferably 2-5 moles of an alkyl monohalogenized acetate corresponding to R² such as a methyl monochloroacetate trisodium citrate or ethyl monochloroacetate reacts with tripotassium acetate or citric acid, hereinafter referred to as citric acid raw material, preferably 1 mole of trisodium citrate. The presence of water in the reaction system lowers the yield of the objective compound. Therefore, dehydrated material is employed as long as possible. For the reaction, a chain or a cyclic aliphatic tertiary amine such as trimethylamine, triethylamine, tri-n-propylamine, triisopropylamine, tri-n-butylamine and dimethylcyclohexylamine can be employed as a catalyst. Among them, triethylamine is preferred. The using amount of the catalyst is 0.01-1.0 moles, preferably 0.2-0.5 moles, per mole of the raw material citric acid. The reaction is performed at a temperature of 60-150° C. for a time of 1-24 hours. A solvent such as toluene, benzene xylene and methyl ethyl ketone may be employed, though it is not essential. After the reaction, for example, byproducts and the catalyst are removed by adding water, and the oil layer is washed by water. And then the leaving raw compounds are separated by distillation to isolate the objective compound.

<Production of Citrate Compound in which R¹ is an Aliphatic Acyl Group>

The citrate compounds of the present invention in which R¹ is an aliphatic acyl group and R² is an alkyl group can be produced by employing the foregoing compound in which R¹ is a hydrogen atom. Namely, 1 mole of the citrate compound reacts with 1-10 moles a halogenized acyl compound corresponding to the aliphatic acyl group represented by R¹ such as formyl chloride or an acetyl chloride. As a catalyst, 0.1-2 moles of a basic compound such as pyridine can be employed per moles of the citrate compound. The reaction can be performed without any solvent for a time of 1-5 hours at a temperature of 80-100° C. After the reaction, water and a water insoluble organic solvent such as toluene are added to the reacting mixture so that the objective compound is dissolved in the organic solvent, and then the organic solvent layer is separated from the aqueous layer and the organic solvent layer is washed. Thereafter, the objective compound can be isolated by a usual method such as distillation.

The citrate compound employed in the present invention is particularly preferable because occurrences of the chalking and the line-shaped defects in the active radiation hardenable resin layer are inhibited when it is employed in the combination with the UV absorber having a weight average molecular weight of 490-50,000.

The content of the citrate compound in the film is preferably 1-30%, and particularly 2-20%, by weight.

As the phosphate type plasticizer, for example, triphenyl phosphate, tricresyl phosphate, cresyl diphenyl phosphate, octyl diphenyl phosphate, diphenyl biphenyl phosphate, trioctyl phosphate and tributyl phosphate are employable, and as the phthalate type plasticizer, for example, diethyl phthalate, dimethoxyethyl phthalate, dimethyl phthalate, dioctyl phthalate, dibutyl phthalate, di-2-ethylhexyl phthalate and dicyclohexyl phthalate are employable.

Ethylene glycol ester type plasticizer: In concrete, this type of plasticizer includes an ethylene glycol ester type plasticizer such as ethylene glycol diacetate and ethylene glycol dibutylate, a ethylene glycol cycloalkyl ester type plasticizer such as ethylene glycol dicyclopropylcarboxylate, ethylene glycol dicyclohexyl-carboxylate, and an ethylene glycol aryl ester plasticizer such as ethylene glycol dibenzoate and ethylene glycol 4-methylbenzoate. In the above compounds, the alkylate group, the cycloalkylate group and the allylate group may be the same or different, and may further have a substituent. A mixed ester of the alkylate group, the cycloalkylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorber.

Glycerol ester type plasticizer: In concrete, this type of plasticizer includes a glycerol alkyl ester such as triacetine, tributine, glycerol diacetate caprylate and glycerol oleate propionate, a glycerol cycloalkyl ester such as glycerol tricycropropylpropionate and glycerol tricyclohexylcarboxylate, a glycerol aryl ester such as glycerol tribenzoate and glycerol 4-methylbenzoate, a diglycerol alkyl ester such as diglycerol tetraacetylate, diglycerol tetrapropionate, diglycerol acetate tricaprylate and diglycerol tetralaurate, diglycerol tetracyclobutylcarboxylate and diglycerol tetrapentylcarboxylate, and a diglycerol aryl ester such as diglycerol tetrabenzoate and diglycerol 3-methylbenzoate. In the above compounds, the alkylate group, the cycloalkycarboxylate group and the allylate group may be the same or different, and may further have a substituent. A mixed ester of the alkylate group, the cycloalkylcarboxylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorber.

Dicarboxylate type plasticizer: In concrete, this type of plasticizer includes an alkyl alkyldicarboxylate type plasticizer such as dodecyl marinate (C1), dioctyl adipate (C4) and dibutyl sebacate (C8), a cycloalkyl alkyldicarboxylate type plasticizer such as dicyclopentyl succinate and cyclohexyl adipate, an aryl alkyldicarboxylate plasticizer such as diphenyl succinate and di-4-methylphenyl glutamate, an alkyl cycloalkyldicarboxylate such as Dihexyl 1,4-cyclohexanedicarboxylate and decyl bicyclo[2.2.1]heptane-2,3-dicarboxylate, a cycloalkyl cycloalkyldicarboxylate type plasticizer such as dicyclohexyl 1,2-cyclobutanedicarboxylate and dicyclopropyl 1,2-cyclohexyldicarboxylate, an aryl cycloalkyldicarboxylate type plasticizer such as diphenyl 1,1-cyclopropyl-dicarboxylate and di-2-naphthyl 1,4-cyclohexane-dicarboxylate, an alkyl aryldicarboxylate type plasticizer such as diethyl phthalate, dimethyl phthalate, dioctyl phthalate, dibutyl phthalate and di-2-ethylhexyl phthalate, a cycloalkyl aryldicarboxylate type plasticizer such as dicyclopropyl phthalate and dicyclohexyl phthalate, and an aryl aryldicarboxylate type plasticizer such as diphenyl phthalate and di-4-methylphenyl phthalate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorber.

Polyvalent-carboxylate type plasticizer: In concrete, this type of plasticizer includes an alkyl alkylpolycarboxylate type plasticizer such as tridodecyl tricabalate and tributyl meso-butane-1,2,3,4-tetrecarboxylate, a cycloalkyl alkylpolycarboxylate type plasticizer such as tricyclohexyl tricarbalate, tricyclopropyl 2-hydroxy-1,2,3-propane-tricarboxylate, an aryl alkylpolycarboxylate type plasticizer such as triphenyl 2-hydroxy-1,2,3-propanetricarboxylate and tetra-3-methylphenyl tetrahydrofuran-2,3,4,5-tetracarboxylate, an alkyl cycloalkylpolycarboxylate type plasticizer such as tetrahexyl 1,2,3,4-cyclobutane-teracarboxylate and tetrabutyl 1,2,3,4-cyclopentane-tetracarboxylate, a cycloalkyl cycloalkylpolycarboxylate type plasticizer such as tetracyclopropyl 1,2,3,4-cyclobutane-tetracarboxylate and tricyclohexyl 1,3,5-cyclohexyl-tricarboxylate, an aryl cycloalkylpolycarboxylate and hexa-4-methylphenyl 1,2,3,4,5,6-cyclohexylhexacarboxylate, an alkyl arylpolycarboxylate type plasticizer such as tridodecyl benznene-1,2,4-tricarboxylate and tetraoctyl benzene-1,2,4,5-tetracarboxylate, a cycloalkyl arylpolycarboxylate type plasticizer such as tricyclopentyl benzene-1,3,50tricarboxylate and tetracyclohexyl benzene-1,2,3,5-tetracarboxylate, and a aryl arylpolycarboxylate type plasticizer such as triphenyl benzene-1,3,5-tetracarboxylate and hexa-4-methylphenyl benzene 1,2,3,4,5,6-hexacarboxylate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorber.

Polymer plasticizer: In concrete, this type of plasticizer includes an aliphatic hydrocarbon type polymer, an alicyclic hydrocarbon type polymer, an acryl type polymer such as poly(ethyl acrylate) and poly(methyl methacrylate), a vinyl type polymer such as poly(vinyl isobutyl ether) and poly(N-vinylpyrrolidone), a styrene type polymer such as polystyrene and poly(4-hydroxystyrene), a polyeater such as poly(butylene succinate), poly(ethylene terephthalate) and poly(ethylene naphthalate), a polyether such as polytethylene oxide) and poly(propylene oxide), polyamide, polyurethane and polyurea. The preferable number average molecular weight of these compounds is approximately from 500 to 500,000, and particularly from 1,000 to 200,000. The molecular weight of more than 500 is preferable because of its low volatility, and that of less than 500,000 is preferable because of the increased mechanical property of the cellulose ester derivative composition. These polymer plasticizers may be either a homopolymer composed of one kind of repeating unit or a copolymer having plural kinds of repeating unit. Two or more kinds of the polymer may be employed in combination and another additive such as another plasticizer, an antioxidant, an acid scavenger, a UV absorber, a slipping agent and a matting agent may be contained.

The polarizing plate protective film A of the present invention may also incorporate an appropriate ester compound described in Japanese Registration Patent No. 3421769. Further, as an ester-based plasticizer, there can also preferably be used methyldiglycol butyldiglycol adipate, benzyl methyldiglycol adipate, benzyl butyldiglycol adipate, or ethoxycarbonyl methyldibutyl citrate.

Based on Japanese Registration Patent No. 3690060, the polarizing plate protective film A preferably incorporates a benzoxazole compound. The benzoxazole compound has a structure represented by the following formula.

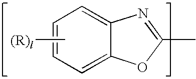

wherein R represents an alkyl group and 1 is 0-4, representing the number of functional groups of R bonded to the benzene ring via substitution reaction. Specifically, a benzoxazole compound represented by the following formula is preferable.

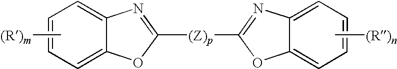

wherein R′ and R″ each represent an alkyl group; R′ and R″ may be identical or different; m and n are 0-4, representing the number of functional groups of R′ and R″ bonded to the benzene ring via substitution reaction; Z represents at least one group selected from 1,3-phenylene, 1,4-phenylene, 2,5-furan, 2,5-thiophene, 2,5-pyrrole, 4,4′-biphenyl, and 4,4′-stilbene; and p is 0 or 1. Specific examples of R, R′, and R″ in the above formula include hydrogen, a methyl, an ethyl, a propyl, a butyl, an isopropyl, and a tert-butyl group, and any of which is used individually or in combination thereof. Of these, a methyl and a tert-butyl group are preferable but a methyl group is specifically preferable. R′ and R″ each may be identical or different, and a plurality thereof may be bonded to the same benzene ring via substitution reaction. Specific examples of Z include 1,3-phenylene, 1,4-phenylene, 2,5-furan, 2,5-thiophene, 2,5-pyrrole, 4,4′-biphenyl, and 4,4′-stilbene. However, 2,5-thiophene and 4,4′-stilbene are preferable, and of these, 4,4′-stilbene is specifically preferable. Specific examples of R′ and R″ include hydrogen, a methyl, an ethyl, a propyl, a butyl, an isopropyl, and a tert-butyl group, and any of which is used individually or in combination thereof. Of these, a methyl and a tert-butyl group are preferable but a methyl group is specifically preferable. R′ and R″ each may be identical or different, and a plurality thereof may be bonded to the same benzene ring via substitution reaction. Specific examples of the benzoxazole compound used in the present invention include 1,3-phenylenebis-2-benzoxazoline, 1,4-phenylenebis-2-benzoxazoline, 2,5-bis(benzoxazol-2-yl)thiophene, 2,5-bis(5-tert-butylbenzoxazol-2-yl)thiophene, 4,4′-bis(benzoxazol-2-yl)stilbene, and 4-(benzoxazol-2-yl)-4′-(5-methylbenzoxazol-2-yl)stilbene. However, 2,5-bis(5-tert-butylbenzoxazol-2-yl)thiophene and 4-(benzoxazol-2-yl)-4′-(5-methylbenzoxazol-2-yl)stilbene are preferable. Of these, 4-(benzoxazol-2-yl)-4′-(5-methylbenzoxazol-2-yl)stilbene is specifically preferable. The content of the benzoxazole compound is from 0.001-10 parts by weight, preferably from 0.01-3 parts by weight based on 100 parts by weight of the cellulose resin.

Further, the polarizing plate protective film A of the present invention also preferably incorporates an acryl polymer as described below.

The acryl polymer is not specifically limited. However, for example, a polymer featuring a weight average molecular weight of 500-30000 is preferably incorporated, which is prepared by polymerizing an ethylenically unsaturated monomer. Specifically, the acryl polymer is preferably an acryl polymer having an aromatic ring in its side chain or an acryl polymer having a cyclohexyl group in its side chain.

When the composition of the polymer is controlled by allowing the weight average molecular weight thereof to be from 500-30000, compatibility between a cellulose resin and the polymer can be enhanced. In addition to the above advantageous effect, specifically, when an acryl polymer such as an acryl polymer having an aromatic ring or cyclohexyl group in its side chain features a weight average molecular weight, preferably, of 500-10000, the polarizing plate protective film A after film formation exhibits excellent transparency and extremely low moisture permeability, resulting in excellent performance as a polarizing plate protective film.

This polymer has a weight average molecular weight of 500 or more, but not exceeding 30,000, and the weight is assumed to be between an oligomer and a low molecular weight polymer. To synthesize such a polymer, the molecular weight cannot be easily controlled by conventional methods of polymerization. It is preferred to use a method which assures uniform molecular weight without requiring excessive molecular weight. Such a polymerization method includes one using a peroxide polymerization initiator such as cumene peroxide or t-butylhydroperoxide; a method using a greater amount of polymerization initiator than conventional polymerization; a method using a chain-transfer agent such as a mercapto compound and carbon tetrachloride, in addition to the polymerization initiator; a method of using a polymerization terminator such as benzoquinone and dinitrobenzene in addition to the polymerization initiator; and a bulk polymerization method using a compound containing one thiol group and secondary hydroxyl group and/or a polymerization catalyst making a concurrent use of this compound and an organic metallic compound, as disclosed in the Unexamined Japanese Patent Application Publication No. 2000-128911 or 2000-344823. Any of these methods may be preferably utilized in the present invention. Specifically, the method disclosed in the above Unexamined Japanese Patent Application Publication is preferably used.

The following describes monomer units which constitute useful polymers for the present invention, without the present invention being restricted thereto.

The ethylenic unsaturated monomer unit constituting the polymer obtained by polymerization of the ethylenic unsaturated monomer is exemplified by: a vinyl ester such as acetic acid vinyl, propionic acid vinyl, vinyl butyrate, vinyl valerate, vinyl pivalate, vinyl caproate, vinyl caproate, vinyl laurate, vinyl myristate, palmitic acid vinyl, vinyl stearate, vinyl cyclohexacarboxylate, vinyl octoate, vinyl methacrylate, vinyl crotonate, vinyl sorbate, vinyl benzoate, and vinyl cinnamate; an acrylic acid ester such as methyl acrylate, ethylacrylate, (i-, n-)propyl acrylate, (n-, i-, s-, t-)butyl acrylate, (n-, i-, s-)pentyl acrylate, (n-, i-)hexyl acrylate, (n-, i-)acrylic acid heptyl acrylate, (n-, i-)octyl acrylate, (n-, i-)nonyl acrylate, (n, i-)myristyl acrylate, cyclohexyl acrylate, (2-ethylhexyl) acrylate, benzyl acrylate, phenethyl acrylate, (ε-caprolactone) acrylate, (2-hydroxy ethyl) acrylate, (2-hydroxy propyl) acrylate, (3-hydroxy propyl) acrylate, (4-hydroxy butyl) acrylate, (2-hydroxy butyl) acrylate, p-hydroxy methylphenyl acrylate, and p-(2-hydroxy ethyl)phenyl acrylate; a methacrylic acid ester wherein the aforementioned acrylic acid ester is replaced by methacrylic acid ester; and an unsaturated acid such as acrylic acid, methacrylic acid, anhydrous maleic acid, crotonic acid, and itaconic acid. The polymer made up of the above monomer may be either a copolymer or a homopolymer. A vinyl ester homopolymer, a vinyl ester copolymer, a copolymer between vinyl ester and acrylic acid or methacrylic acid ester, are preferable.

In the present invention, the acryl polymer (hereinafter, simply called “acryl polymer”) refers to the homopolymer or copolymer of acrylic acid or methacrylic acid alkyl ester that does not contain a monomer unit provided with an aromatic ring or cyclohexyl group. The acryl polymer having an aromatic ring on the side chain basically refers to an acryl polymer containing an acrylic acid or a methacrylic acid ester monomer unit further containing an aromatic ring. Further, the acryl polymer having a cyclohexyl group on the side chain refers to a acryl polymer containing an acrylic acid or methacrylic acid ester monomer unit including a cyclohexyl group.

Examples of the acrylic acid ester monomer which do not contain an aromatic ring and cyclohexyl group include methylacrylate, ethylacrylate, propylacrylate (i-, n-), butylacrylate (n-, i-, s-, t-), pentylacrylate (n-, i-, s-), hexylacrylate (n-, i-), heptylacrylate (n-, i-), octylacrylate (n-, i-), nonylacrylate (n-, i-), myristylacrylate (n-, i-), (2-ethylhexyl) acrylate, (ε-caprolactone) acrylate, (2-hydroxy ethyl) acrylate, (2-hydroxy propyl) acrylate, (3-hydroxy propyl) acrylate, (4-hydroxy butyl) acrylate, (2-hydroxy butyl) acrylate, (2-methoxyethyl) acrylate, (2-ethoxyethyl) acrylate, and the above acrylic acid ester replaced by methacrylic acid ester.

The acryl polymer is the homopolymer or copolymer of the above monomer. 30% or more by mass of methyl acrylate ester monomer unit is preferably contained, and 40% or more by mass of methacrylic acid methyl ester monomer unit is more preferably contained. The homopolymer of methyl acrylate or methacrylic acid methyl is specifically preferred.

Examples of the acrylic acid or methacrylic acid ester monomer containing an aromatic ring include; phenyl acrylate, phenyl methacrylate, (2- or 4-chlorophenyl) acrylate, (2- or 4-chlorophenyl) methacrylate, (2-, 3- or 4-ethoxycarbonyl phenyl) acrylate, (2-, 3- or 4-ethoxycarbonyl phenyl) methacrylate, acrylic acid (6-, m- or p-tolyl), methacrylic acid (o-, m- or p-tolyl), benzyl acrylate, benzyl methacrylate, phenethyl acrylate, phenethyl methacrylate, and (2-naphthyl) acrylate, of which the benzyl acrylate, benzyl methacrylate, phenethyl acrylate and phenethyl methacrylate are preferable.

The acryl polymer having an aromatic ring on the side chain preferably contains 20-40% by mass of the acrylic acid or methacrylic acid ester monomer unit also containing an aromatic ring, and 50-80% by mass of the acrylic acid or methacrylic acid methyl ester monomer unit. This polymer preferably contains 2-20% by mass of the acrylic acid or methacrylic acid ester monomer unit containing a hydroxyl group.

Examples of acrylic acid ester monomer containing the cyclohexyl group include: cyclohexyl acrylate, cyclohexyl methacrylate, (4-methylcyclohexyl) acrylate, (4-methylcyclohexyl) methacrylate, (4-ethylcyclohexyl) acrylate, (4-ethylcyclohexyl) methacrylate, and cyclohexyl acrylate, of which cyclohexyl methacrylate is preferable.

The acryl polymer with a cyclohexyl group on the side chain preferably contains 20-40% by mass of acrylic acid or methacrylic acid ester monomer unit containing a cyclohexyl group, and 50-80% by mass of the acrylic acid or methacrylic acid methyl ester monomer unit. Further, this polymer preferably contains 2-20% by mass of acrylic acid or methacrylic acid ester monomer unit having a hydroxyl group.

The polymer and acryl polymer obtained by polymerization of the above ethylenic unsaturated monomer, the acryl polymer with an aromatic ring on the side chain, and the acryl polymer with a cyclohexyl group on the side chain are all characterized by excellent compatibility with a cellulose resin.

The acrylic acid or methacrylic acid ester monomer containing the hydroxyl group is based on a copolymer composition unit, not a homopolymer composition unit. In this case, 2-20% by mass of the acrylic acid or methacrylic acid ester monomer unit containing the hydroxyl group is preferably included in the acryl polymer.

In this invention, preferably utilized is a polymer containing a hydroxyl group on the side chain. The monomer unit containing a hydroxyl group is the same as the aforementioned monomer, but the acrylic acid or methacrylic acid ester is preferred, of which the preferred examples are: (2-hydroxy ethyl) acrylate, (2-hydroxy propyl) acrylate, (3-hydroxy propyl) acrylate, (4-hydroxy butyl) acrylate, (2-hydroxy butyl) acrylate, p-hydroxy methylphenyl acrylate, and p-(2-hydroxy ethyl) phenyl acrylate, and similar compounds wherein “acrylate” is replaced with “methacrylate”. The above 2-hydroxyethyl acrylate and 2-hydroxyethyl methacrylate are preferably used. The polymer preferably contains 2-20% by mass of the acrylic acid ester or methacrylic acid ester monomer unit containing a hydroxyl group, but more preferably 2-10% by mass.

Needless to say, the aforementioned polymer containing 2-20% by mass of the monomer unit containing the above hydroxyl group is characterized by excellent compatibility with the cellulose ester, retentivity, and dimensional stability. Not only that, such a polymer is further characterized by reduced moisture permeability, excellent adhesion to a polarizer as a polarizing plate protective film A, which enhances durability of the polarizing plate.

There is no specific limitation to the method wherein at least one of the terminals of the main chain of the acryl polymer is provided with a hydroxyl group, if the terminal of the main chain in particular has a hydroxyl group. It is possible to employ a method of using a radial polymerization initiator containing a hydroxyl group such as azobis(2-hydroxy ethylbutylate); a method of using a chain-transfer agent containing a hydroxyl group such as 2-mercaptoethanol; a method of using a polymerization terminator containing a hydroxyl group; a method of having a hydroxyl group on the terminal via living ion polymerization; or a method of bulk polymerization using a compound containing one thiol group and a secondary hydroxyl group, or a polymerization catalyst making concurrent use of this compound and an organic metallic compound, as disclosed in Unexamined Japanese Patent Application Publication No. 2000-128911 or 2000-344823. The methods disclosed in these publications are specifically preferred. Some polymers prepared in accordance with the methods described in these publications are available on the market through Soken Chemical & Engineering Co. Ltd., under the name of ACTFLOW series. The polymer having a hydroxyl group on the terminal of the above and/or the polymer having a hydroxyl group on the side chain provides remarkable enhancement of polymer compatibility and transparency in the present invention.

Further, a polymer using styrene is usable as the ethylenic unsaturated monomer exhibiting negative orientation birefringer to drawn direction. This is preferable in that it exhibits negative refringency. Examples of styrene include styrene itself, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, and methyl vinyl benzoate ester, without being restricted thereto. The monomer may be copolymerized with the monomers cited as the above unsaturated ethylenic monomer, or may be mixed with the cellulose ester using two or more of the above polymers for the purpose of controlling birefringency.

Further, the polarizing-plate protective film utilized in the present invention preferably contains:

polymer X obtained by copolymerization between ethylenic unsaturated monomer Xa without an aromatic ring and the hydrophilic group contained inside of the molecule, and the ethylenic unsaturated monomer Xb containing a hydrophilic group but not an aromatic ring in the molecule wherein the polymer X has a weight average molecular weight of 2,000 or more without exceeding 30,000, polymer Y obtained by polarization of ethylenic unsaturated monomer Ya, more preferably, without containing an aromatic ring wherein this polymer Y has a weight average molecular weight 500 or more without exceeding 3,000.

### <Polymer A and Polymer Y>

There are known several method to control Ro and Rth of the present invention and they can be used in the present invention. The following are preferable by considering the transparency. Polymer X is a polymer obtained by copolymerization of ethylenic unsaturated monomer Xa without an aromatic ring and the hydrophilic group contained inside the molecule, and the ethylenic unsaturated monomer Xb containing a hydrophilic group but not an aromatic ring in the molecule, wherein this polymer X has a weight average molecular weight of 5,000 or more but not exceeding 30,000.

It is known that a substance, made of a monomer specifically having an aromatic ring in the main chain of the monomer, exhibits positive birefringence, similarly to birefringence which a cellulose ester exhibits. Accordingly, since the retardation value Rth of a cellulose ester film is not counteracted, an appropriate material exhibiting negative birefringence is preferably added in the film.

The polymer X of the present invention is a polymer of a weight average molecular weight of 5000-30000, which is prepared by copolymerizing the ethylenically unsaturated monomer Xa having neither an aromatic ring nor a hydrophilic group in the molecule and the ethylenically unsaturated monomer Xb having a hydrophilic group in the molecule.

Preferably, Xa is an acryl or a methacryl monomer without an aromatic ring or a hydrophilic group contained in the molecule, and Xb is an acryl or a methacryl monomer containing a hydrophilic group but not an aromatic ring in the molecule.

Polymer X is expressed by the following Formula (X):

—(Xa)m-(Xb)xn-(Xc)p- Formula (X):

More preferably, polymer X of the present invention is expressed by the following Formula (X-1):

—[CH₂—C(—R₁)(—CO₂R₂)]m-[CH₂—C(—R₃)(—CO₂R₄—OH)—]n-[Xc]p- Formula (X-1):

In the formula, R₁ and R₃ are H or CH₃. R₂ is an alkyl group or a cycloalkyl group having 1-12 carbon atoms. R₄ is CH₂—, —C₂H₄—, or —C₃H₆—. Xc is a monomer unit polymerizable with Xa and Xb. “m”, “n”, and “p” are mole composition ratios. Herein, m and n are never 0, and m+n+p=100. The monomer as the monomer unit constituting polymer X is exemplified below, without being restricted thereto.

In X, the hydrophilic group refers to a group containing a hydroxyl group or an ethylene oxide chain.

Above ethylenic unsaturated monomer Xa without an aromatic ring or a hydrophilic group contained in the molecule is exemplified by: methylacrylate; ethylacrylate; propyl acrylate (i-, n-); butylacrylate (n-, i-, s-, t-); pentylacrylate (n-, i-, s-); hexylacrylate (n-, i-); heptyl acrylate (n-, i-); octyl acrylate (n-, i-); nonylacrylate (n-, i-); myristylacrylate (n-, i-); (2-ethylhexyl) acrylate; (ε-caprolactone) acrylate; (2-ethoxyethyl) acrylate; or those, wherein the above acrylic acid ester is replaced with methacrylic acid ester. Of these, methyl acrylate, ethyl acrylate, methyl methacrylate, ethyl methacrylate, and propyl methacrylate (i-, n-), are specifically preferred.

Ethylenic unsaturated monomer Xb containing a hydrophilic group but not an aromatic ring in the molecule is preferably an acrylic acid or a methacrylic acid ester as a monomer unit containing the above hydroxyl group. Examples of such include: (2-hydroxyethyl) acrylate, (2-hydroxypropyl) acrylate, (3-hydroxypropyl) acrylate, (4-hydroxybutyl) acrylate, (2-hydroxybutyl) acrylate, and those wherein the acrylate is replaced with the methacrylate. The preferred examples are (2-hydroxyethyl) acrylate, (2-hydroxyethyl) methacrylate, (2-hydroxypropyl) acrylate and (3-hydroxypropyl) acrylate.

There is no particular restriction to Xc if it is a copolymerizable ethylenic unsaturated monomer other than Xa and Xb, however, it is preferred not to contain an aromatic ring.

Mole composition ratio m:n of Xa, Xb and Xc is preferably in the range of 99:1-65:35, but is more preferably in the range of 95:5-75:25. “p” of Xc is typically in the range of 0-10. It is allowed that Xc is a plurality of monomer units.

If the mole composition ratio of Xa is excessively high, compatibility with cellulose ester tends to be improved, however, retardation value Rt of film thickness direction will increase. If the mole composition ratio of Xb is excessively high, compatibility with cellulose ester tends to be deteriorated, however, the retardation value Rt will decrease. Further, if the mole composition ratio of Xb exceeds the above range, haze tends to appear on the film at the time of film production. It is preferred that these conditions are optimized to determine the mole composition ratio of the Xa and Xb.

The molecular weight of polymer X has a weight average molecular weight of 5,000 or more but not exceeding 30,000, but more preferably 8,000 or more but not exceeding 25,000.

When the weight average molecular weight is 5,000 or more, it enables a cellulose ester film characterized by minimum dimensional variation under conditions of high temperature and high humidity, and a polarizing plate protective film characterized by negligible curling. When the weight average molecular weight is kept below 30,000, compatibility with cellulose ester is enhanced, while bleed-out under conditions of high temperature and high humidity, and further haze immediately after film production can be reduced.

The weight average molecular weight of polymer X can be adjusted by any conventionally known molecular weight adjusting method. An example of a molecular weight adjusting method is to add a chain-transfer agent, such as carbon tetrachloride, lauryl mercaptan, and octyl thioglycolate. Further, the polymerization temperature is normally in the range of room temperature to 130° C., preferably 50° C. to 100° C. The molecular weight can be adjusted by changing this temperature or polymerization reaction time.

The following describes the method of measuring the weight average molecular weight.

(Weight Average Molecular Weight Measuring Method)

The weight average molecular weight Mw is measured by gel permeation chromatography.

The following describes the conditions for measurement:
Solvent: Methylene chloride
Column: Shodex K806, K805 and K803G (produced by Showa Denko K. K.: three columns are connected)
Column temperature: 25° C.
Sample density: 0.1% by mass
Detector: RI Model 504 (manufactured by GL Science Co., Ltd.)
Pump: L6000 (manufactured by Hitachi, Ltd.)
Flow rate: 1.0 mL/min

Calibration curve: Standard Polystyrene STK (Standard polystyrene produced by Tosoh Corporation): Calibration curves based on 13 samples of Mw=1,000,000-500 are used. These 13 samples are used at an almost equally spaced interval.

Polymer Y is a polymer having a weight average molecular weight 500 or more but not exceeding 3,000 obtained by polymerization ethylenic unsaturated monomer Ya without containing an aromatic ring. When the weight average molecular weight of polymer Y is 500 or more, the residual monomer of polymer is preferably reduced. Further, when it does not exceed 3,000, the performance of reducing retardation value Rt is preferably maintained. Ya is preferably an acryl or a methacryl monomer without containing an aromatic ring.

Polymer Y is expressed by the following Formula (Y)—.

—(Ya)k(Yb)q- Formula (Y)

More preferably, polymer Y of the present invention is expressed by following Formula (Y-1):

—[CH₂—C(—R₅)(—CO₂R₆)]k-[Yb]q- Formula (Y-1)

In the formula, R₅ is H or CH₃, and R₆ is an alkyl group or a cycloalkyl group having 1-12 carbon atoms. Yb is a monomer unit copolymerizable with Ya. “k” and “q” are mole composition ratios, wherein k≠0 and k+q=100.

There is no particular restriction to Yb, as long as it is an ethylenic unsaturated monomer copolymerizable with Yb. The number of Yb's may be more than one. k+q=100, and q is preferably in the range of 0-30.

Ethylenic unsaturated monomer Ya constituting polymer Y obtained by polymerization of the ethylenic unsaturated monomer without an aromatic ring is exemplified by: an acrylic acid ester such as methyl acrylate; ethyl acrylate; propyl acrylate (i-, n-); butyl acrylate (n-, i-, s-, t-); pentyl acrylate (n-, i-, s-); hexyl acrylate (n-, i-); heptyl acrylate (n-, i-); octyl acrylate (n-, i-); nonyl acrylate (n-, i-); myristyl acrylate (n-, i-); cyclohexyl acrylate; (2-ethylhexyl) acrylate; (ε-caprolactone) acrylate; (2-hydroxy ethyl) acrylate, (2-hydroxy propyl) acrylate; (3-hydroxy propyl) acrylate; (4-hydroxy butyl) acrylate; and (2-hydroxy butyl) acrylate; a methacrylic acid ester wherein the above acrylate is replaced with a methacrylate; and an unsaturated acid such as acrylic acid, methacrylic acid, anhydrous maleic acid, crotonic acid, and itaconic acid.

There is no particular restriction to Yb, as long as it is an ethylenic unsaturated monomer copolymerizable with Yb. The preferred examples of the vinyl ester include vinyl acetate, vinyl propionate, vinyl butyrate, vinyl valerate, vinyl pivalate, vinyl caproate, vinyl caproate, vinyl laurate, vinyl myristate, vinyl palmitate, vinyl stearate, vinyl cyclohexanecarboxylate, vinyl octylate, vinyl methacrylate, vinyl crotonate, vinyl sorbate and vinyl cinnamate. The number of Yb's may be more than one.

To synthesize polymers X and Y, a conventional polymerization is not sufficient to control the molecular weight. It is preferred to use a method wherein the uniform molecular weight can be achieved without the molecular weight being excessively increased. Such a polymerization method is exemplified by: a method of using a peroxide polymerization initiator such as cumene peroxide or t-butylhydroperoxide; a method of using a greater amount of polymerization initiator than in the conventional polymerization technique; a method of using a chain-transfer agent such as a mercapto compound and carbon tetrachloride in addition to the polymerization initiator; a method of using a polymerization terminator such as a benzoquinone and dinitrobenzene in addition to the polymerization initiator; and a method of bulk polymerization using a compound containing one thiol group and a secondary hydroxyl group or a polymerization catalyst making concurrent use of this compound and organic metallic compound, as disclosed in the Unexamined Japanese Patent Application Publication No. 2000-128911 or 2000-344823. Any of these methods can be used preferably. Especially preferable is the method of polymerization using a compound containing a thiol group and a secondary hydroxyl group in the molecule as a chain-transfer agent. In this case, the terminals of polymer X and polymer Y contain the hydroxyl group and thio ether derived from a polymerization catalyst and a chain-transfer agent. Compatibility between polymers X and Y, and cellulose ester may be adjusted by this terminal residual group.

The hydroxyl value of polymer X and Y is preferably 30-150 [mg KOH/g].

### (Measurement Method of Hydroxyl Value)

This measurement is based on JIS K 0070 (1992). This hydroxyl value is defined as a mg number of potassium hydroxide which is required to neutralize acetic acid bonding to a hydroxyl group when 1 g of a sample is acetylated. Specifically, X g (approximately 1 g) of a sample is precisely weighed in a flask, which is supplied with exactly 20 ml of an acetylation agent (20 ml of acetic anhydride is supplied pyridine to make 400 ml). The flask is equipped with an air condenser at the mouth and the mixture is heated in a glycerin bath of 95-100° C. After 1 hour and 30 minutes, the mixture is cooled and is supplied with 1 ml of pure water through the air condenser to decompose acetic anhydride into acetic acid. Next, titration with a 0.5 mol/L ethanol solution of potassium hydroxide is performed via a potentiometric titrator to determine the inflection point of the obtained titration curve as an end point. Further, as a blank test, titration without a sample is performed to determine the inflection point of a titration curve. A hydroxyl value is calculated by the following equation.

Hydroxyl value=[(B−C)×f×28.05/X]+D

In the equation, B is quantity (ml) of a 0.5 mol/L ethanol solution of potassium hydroxide utilized for a blank test, C is quantity (ml) of a 0.5 mol/L ethanol solution of potassium hydroxide utilized for titration, f is a factor of a 0.5 mol/L ethanol solution of potassium hydroxide, D is an acid value, and 28.05 is ½ of molar quantity 56.11 of potassium hydroxide.

Both of Polymer X and Polymer Y described above exhibit excellent compatibility with cellulose ester, excellent productivity without evaporation or vaporization, good reservability, small moisture permeability and excellent dimensional stability, as a polarizing plate protective film.

The content of polymer X and Polymer Y in a cellulose ester film is preferably in a range to satisfy following equations (i) and (ii). When a content of polymer X is X g, [% by mass (mass of polymer X/mass of cellulose ester)×100] and a content of Polymer Y is Y g (% by mass)],

5≦Xg+Yg≦35 (% by mass) Equation (i)

0.05≦Yg/(Xg+Yg)≦0.4 Equation (ii)

The preferable range of equation (i) is 10-25% by mass.

When the total amount of polymer X and polymer Y is not less than 5 by mass, a sufficient effect to decrease retardation value, Rt can be achieved. Further, when the total amount is not more than 35% by mass, adhesion to a polarizer PVA will be enhanced.

When an amount of polymer X is increased, retardation value Rt has a tendency to be increased. Therefore, the above-described range for Rt satisfying Equation (II) is preferable to achieve the effects of the present invention.

Polymer X and polymer Y can be directly added and dissolved as materials to constitute a dope solution which will be described later, or can be added into a dope solution after having been dissolved in an organic solvent to dissolve cellulose ester in advance.

The polarizing plate protective film A utilized in the present invention preferably incorporates the following polyester.

### (Polyester Represented by Formula (A) or Formula (B))

The polarizing plate protective film A of the present invention preferably incorporates the polyester represented by the following Formula (A) or (B):

B1-(G−A-)mG-B1 Formula (A)

wherein B1 is monocarboxylic acid, G is divalent alcohol and A is dibasic acid. None of B1, G and A contains an aromatic ring. “m” is a repeating number.

B2-(A−G-)nA-B2 Formula (B)

wherein B2 is monoalcohol, G is divalent alcohol and A is dibasic acid. None of B2, G and A contains an aromatic ring. “n” is a repeating number.

In Formulas (A) and (B), B1 is a monocarboxylic acid component, B2 is a monoalcohol component, G is a divalent alcohol component, and A is a dibasic acid component. These components are used for synthesis. None of B1, B2, G and A is characterized by the absence of an aromatic ring. “m” and “n” are repeating numbers.

There is no particular restriction to the monocarboxylic acid represented by B1. The conventionally known aliphatic monocarboxylic acid, alicyclic monocarboxylic acid and others can be used.

The following describes the preferred examples of the monocarboxylic acid without being restricted thereto:

The fatty acid provided with a straight chain or a side chain and having 1-32 carbon atoms can be used preferably as aliphatic monocarboxylic acid. In this case, the number of carbon atoms is more preferably 1-20, still more preferably 1-12. The acetic acid is preferably incorporated because compatibility with cellulose ester is improved. It is also preferred to utilize a mixture of acetic acid with other monocarboxylic acid.

Preferable examples of the aliphatic monocarboxylic acid include:

saturated fatty acid such as formic acid, acetic acid, propionic acid, butyric acid, valeric acid, caproic acid, enanthic acid, caprylic acid, pelargonic acid, capric acid, 2-ethyl-hexane carboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid; and

unsaturated fatty acid such as undecylenoic acid, oleic acid, sorbic acid, linoleic acid, linolenic acid and arachidic acid.

There is no particular restriction to the monoalcohol component represented by B2. Alcohols well known in the art can be utilized. For example, aliphatic saturated alcohol or aliphatic unsaturated alcohol provided with straight chain or side chain and having 1-32 carbon atoms can be preferably utilized. The number of carbons is more preferably 1-20, and still more preferably 1-12.

A divalent alcohol component represented by G includes the following examples, without the present invention being restricted thereto: These examples are ethylene glycol, diethylene glycol, 1,2-propylene glycol, 1,3-propylene glycol, 1,2-butylene glycol, 1,3-butylene glycol, 1,4-butylene glycol, 1,5-pentanediol, 1,6-hexanediol, 1,5-pentylene glycol, diethylene glycol, triethylene glycol and tetraethylene glycol. Among them, ethylene glycol, 1,2-propylene glycol, 1,3-propylene glycol, 1,2-butylene glycol, 1,3-butylene glycol, 1,4-butylene glycol, 1,6-hexanediol, diethylene glycol and triethylene glycol are preferable. Further, 1,3-propylene glycol, 1,4-butylene glycol, 1,6-hexanediol and diethylene glycol are also preferably utilized.

Preferred examples of the dibasic acid (dicarboxylic acid) component represented by A include aliphatic dibasic acid and alicyclic dibasic acid. The aliphatic dibasic acid is exemplified by malonic acid, succinic acid, glutalic acid, adipic acid, pimeritic acid, suberic acid, azeric acid, sebacic acid, undecane dicarboxylic acid and dodecane dicarboxylic acid. Specifically, the component having 4-12 carbons, or at least one selected therefrom is used as aliphatic dicarboxylic acid. That is, two or more dibasic acids can be utilized in combination.

m and n are repeating numbers and are preferably 1 or more without exceeding 170.

The polarizing plate protective film A of the present invention preferably contains the polyester represented by Formula (C) or (D);

B1-(G-A-)mG−B1 Formula (C)

wherein B1 is a monocarboxylic acid containing 1-12 carbon atoms, G is a divalent alcohol containing 2-12 carbon atoms, and A is a dibasic acid containing 2-12 carbon atoms. None of B1, G and A contains an aromatic ring. “m” is a repeating number.

B2-(A-G-)nA-B2 Formula (D)

wherein B2 is a monoalcohol containing 1-12 carbon atoms, G is a divalent alcohol containing 2-12 carbon atoms and A1 is a dibasic acid containing 2-12 carbon atoms. None of B2, G and A contains an aromatic ring. “n” is a repeating number.

In Formulas (C) or (D), B1 is a monocarboxylic acid component containing 1-12 carbon atoms, B2 is a monoalcohol component containing 1-12 carbon atoms, G is a divalent alcohol component containing 2-12 carbon atoms, and A is a dibasic acid component containing 2-12 carbon atoms. These components are used for synthesis. None of B1, G and A is characterized by the absence of an aromatic ring. “m” and “n” are repeating numbers.

The above-described B1 and B2 are synonymous with B1 and B2 in Formula (A) and Formula (B), respectively.

G and A are alcohol components or dibasic acid components containing 2-12 carbon atoms in G and A of aforementioned Formula (A) or (B).

The weight average molecular weight of the polyester is preferably 20,000 or less, more preferably 10,000 or less. Especially the polyester having a weight average molecular weight of 500-10,000 is preferably used for its excellent compatibility with cellulose ester.

A normal method is used for polycondensation of the polyester. For example, synthesis can be easily achieved by either the hot melting condensation method by direction reaction between the aforementioned dibasic acid and glycol; or esterification reaction or ester replacement reaction between the aforementioned dibasic acid or the alkyl esters thereof (e.g., methyl ester of dibasic acid) and glycols; or the method by dehalogenated hydrogen reaction between the chlorides of these acids and glycol. Polyester prefers the direct reaction method wherein the weight average molecular weight is not excessively increased. The polyester having thicker distribution on the low molecular weight side provides excellent compatibility with cellulose ester. This arrangement yields a cellulose ester film characterized by reduced moisture permeability and excellent transparency after film formation. There is no particular restriction to the molecular weight adjusting method. The conventional method can be used. For example, this adjustment can be made by sequestering the molecule terminal with monovalent acid or monovalent alcohol, or by adjusting the added weight of the monovalent acid or alcohol, although it depends on polymerization conditions. In this case, the monovalent acid is preferably used for its polymer stability. Acetic acid, propionic acid, and butyric acid can be mentioned as examples. Selection is made of those which are not evaporated out of the system during condensed polymerization but can be easily evaporated out of the system when the reaction is stopped and such a monovalent acid is removed out of the system. These may be utilized as a mixture. Further, in the case of a direct reaction, the weight average molecular weight can be controlled also by judging the timing to stop the reaction based on the quantity of water evaporated out during the reaction. In addition, the molecular weight control is possible also by biasing a mol number of glycol or dibasic acid which are charged, as well as by controlling the reaction temperature.

Preferably 1-40% by mass of the polyester according to the present invention is contained in the cellulose ester. More preferably 2-30% by mass, still more preferably 5-15% by mass, of the polyester expressed by Formula (C) or (D) is contained therein.

When a polyester-added film is employed, a polarizing plate, which tends to be degraded only to a minor extent even in high temperature and high humidity conditions, can be realized.

These plasticizers may be used individually or in combination. It is not preferable that the total content of plasticizers in the film is less than 1% by weight based on a cellulose resin due to only a small effect of reducing moisture permeability of the film. In cases of more than 30% by weight, a problem such as compatibility or bleed-out tends to be produced, resulting in deterioration of physical properties of the film. Therefore, the content is preferably from 1-30% by weight, more preferably 5-25% by weight, specifically preferably from 8-20% by weight.

(Mixing of a Cellulose Resin with Additives)

In the present invention, a cellulose resin and additives such as a plasticizer or a UV absorbent are preferably mixed prior to heat melting.

As a method of mixing additives, exemplified is a method conducted by dissolving the cellulose resin in a solvent, and then by dissolving or minutely dispersing additives in the resulting solution, followed by removing the solvent. As the method of removing a solvent, any appropriate method known in the art can be applicable, including, for example, an in-liquid drying method, an in-air drying method, a solvent coprecipitation method, a freeze-drying method, and a solution casting method. A mixture of the cellulose resin and the additives after solvent removal may be prepared into a powdery, granular, pellet, or film form.

Additives are mixed by dissolving a solid cellulose resin as described above. However, mixing may be carried out simultaneously along with precipitation and solidification in the synthesizing process of a cellulose resin.

In the in-liquid drying method, for example, an aqueous solution containing an activator such as sodium lauryl sulfate is added in a solution prepared by dissolving a cellulose resin and an additive, followed by being emulsion dispersed. Then, the solvent is removed via distillation under ordinary or reduced pressure to give a dispersed substance of the cellulose resin mixed with the additive. Further, to remove the activator, centrifugation or decantation is preferably conducted. As the emulsifying method, various methods may be used, preferably employing emulsion dispersing apparatuses employing ultrasound waves, high-speed rotary shearing, or high pressure.

For emulsion dispersion via ultrasound waves, 2 types which are, what are called, a batch and a continuous type may be used. The batch type is suitable to prepare a relatively small amount of a sample while the continuous type is suitable to prepare a large amount thereof. As the continuous type, an apparatus such as UH-600SR (produced by SMT Co., Ltd.) may be used. When such a continuous type is used, irradiation time of ultrasound waves can be determined by the relationship: dispersing chamber volume/flow rate×the number of circulation times. In cases of plural ultrasound irradiation apparatuses employed, irradiation time is determined as the sum total of each irradiation time. The irradiation time of ultrasound waves is practically at most 10000 seconds. In contrast, when at least 10000 seconds of the irradiation time are required, an excessive load is applied to the process. Thereby, it is necessary to shorten the emulsion dispersion time by reselecting an emulsifier from a practical standpoint. As a result, at least 10000 seconds of the irradiation time are unnecessary, and the time is more preferably form 10-2000 seconds.

As an emulsion dispersion apparatus via high-speed rotary shearing, a disper-type mixer, a homomixer, or an ultra mixer may be used. These types can be employed depending on liquid viscosity during emulsion dispersion.

For emulsion dispersion via high pressure, LAB2000 (produced by SMT Co., Ltd.) may be used. The emulsion-dispersion performance depends on pressure applied to a sample. The pressure is preferably in the range of 10⁴ kPa-5×10⁵ kPa.

As the activator, a cationic, anionic, or amphoteric surfactant, as well as a polymer dispersing agent can be used, being able to be determined depending on a solvent and the particle size of a targeted emulsified substance.

The in-air drying method is one in which a solution dissolving a cellulose resin and an additive is sprayed and dried using, for example, a spray drier such as GS310 (produced by Yamato Scientific Co., Ltd.).

The solvent coprecipitation method is one in which a solution dissolving a cellulose resin and an additive is added in a solvent which is poor therefor to carry out precipitation. Any amount of the poor solvent may be mixed with the solvent dissolving the cellulose resin and the additive described above. The poor solvent may be a mixed solvent. Further, the poor solvent may optionally be added in the solution of the cellulose resin and the additive.

The precipitated mixture of the cellulose resin and the additive can be filtered, dried, and separated.

In the mixture of the cellulose resin and the additive, the particle diameter of the additive therein is preferably at most 1 μm, more preferably at most 500 nm, specifically preferably at most 200 nm. A smaller particle diameter of the additive is preferable, since a formed product by melting exhibits uniform distribution of mechanical and optical properties.

The mixture of the cellulose resin and the additive and an additive added during heat melting need to be dried prior to or during heat melting. Herein, the drying refers to removal of any of the following: moisture which is absorbed in any of the melted materials; water or a solvent used during preparation of the mixture of the cellulose resin and the additive; and solvents incorporated in the additives during synthesis thereof.

As the removing method, any appropriate method known in the art is employable, including a heating method, a reduced pressure method, and a reduced pressure heating method. Any of the methods may be conducted in the air or under an ambience of nitrogen selected as an inert gas. From the viewpoint of film quality, any of these drying methods known in the art is preferably carried out in a temperature range where the materials do not decompose.

Water or a solvent remaining after the removing procedure in the above drying process is each allowed to be, based on the total weight of the film constituent materials, at most 10% by weight, preferably at most 5% by weight, more preferably at most 1% by weight, and still more preferably at most 0.1% by weight. In this case, the drying temperature is preferably from 100° C.−Tg of each material to be dried. From the viewpoint of preventing fusion among the materials, the drying temperature is more preferably from 100° C.−(Tg−5)° C., still more preferably from 110° C.−(Tg−20)° C. The drying time is preferably from 0.5-24 hours, more preferably from 1-18 hours, still more preferably from 1.5-12 hours. When a selected range is narrower than the above ones, dryness may become insufficient or an extended drying time may be required. Further, in cases in which a material to be dried exhibits Tg, fusion caused thereby may result in difficult handling when heating is conducted at a higher drying temperature than the Tg.

The drying process may be separated into at least 2 stages. For example, melt film formation may be carried out via a predrying process storing a material and an immediately preceding drying process conducted from just before to one week before the melt film formation.

### (Additives)

Additives used include, in addition to a plasticizer and a UV absorbent described above, an antioxidant, an acid scavenger, a light stabilizer, a peroxide decomposer, a radical scavenger, a metal deactivator, a metal compound such as a matting agent, a retardation regulator, a dye, and a pigment. Any appropriate additives, which are not classified thereinto, may optionally be used provided that the additives exhibit any of the above functions.

These additives are employed to prevent formation of volatile components due to alteration such as coloring or molecular reduction or due to decomposition of materials, including due to decomposition reaction having not yet been figured out, by preventing oxidation of film constituent materials, by scavenging acids which are generated via decomposition, or by preventing or inhibiting decomposition reaction caused by radical species due to light or heat; as well as being employed to provide a function such as moisture permeability or slipping properties.

In contrast, when film constituent materials are heat melted, decomposition reaction is markedly conducted. The decomposition reaction may result in coloring or strength degradation of the constituent materials due to molecular weight reduction. In conjunction therewith, an unfavorable volatile composition may also be generated due to the decomposition reaction of the film constituent materials.

When the film constituent materials are heat melted, appropriate additives described above are preferably incorporated therein, which is an excellent method from the viewpoint of preventing deterioration of the materials or strength degradation due to decomposition, or from the viewpoint of maintaining strength inherently possessed by the materials.

Further, the presence of the above additives makes it possible to prevent formation of a colored substance in the visible light region during heat melting or to prevent a decrease in transmittance or a haze value caused by incorporation of a volatile composition into the film. The haze value of the polarizing plate protective film A of the present invention is preferably less than 1%, more preferably less than 0.5%.

With regard to color of the polarizing plate protective film A of the present invention, the b* value thereof, which is a yellowing index, is preferably in the range of −5-10, more preferably in the range of −1-8, still more preferably −1-5. The b* value can be determined using spectrophotometer CM-3700d (produced by Konica Minolta Sensing, Inc.) at a viewing angle of 10° under D65 lighting (color temperature: 6504K).

In the storage or film formation process of the film constituent materials, deteriorative reaction due to oxygen in the air may occur simultaneously. In this case, it is preferable to stabilize the above additives and also to decrease the oxygen concentration in the air. This includes use of nitrogen or oxygen as an inert gas, deaeration under reduced pressure or vacuum, and operation under a closed ambience to be employed as techniques known in the art. Of the three techniques, at least one technique may be employed in combination with a method of allowing the additives to exist. By decreasing the possibility that the film constituent materials are exposed to oxygen in the air, deterioration of the materials can be prevented, which is preferable for the objects of the present invention.

In the polarizing plate protective film A of the present invention, the additives are preferably present in the film constituent materials also from the viewpoint of enhancing temporal stability of the polarizing plate of the present invention and a polarizer constituting the polarizing plate.

In a liquid crystal display employing the polarizing plate of the present invention, the additives are present in the polarizing plate protective-film A, whereby temporal stability of the film can be enhanced since the above alteration or deterioration is prevented. Thereby, there is an excellent advantage in that from the viewpoint of display quality enhancement of the liquid crystal display, an optical compensation design provided with the polarizing plate protective film A can exert its function for a long time.

The additives are further described in detail.

### (Antioxidant)

The antioxidant to be employed in the present invention is described below.

As the antioxidant, a phenol type antioxidant, a phosphoric acid type antioxidant, a sulfur type antioxidant, a stabilizer against heat processing and an oxygen scavenger are employable, and among them the phenol type antioxidant, and particularly an alkyl-substituted phenol type antioxidant are preferable. The coloring and the lowering in the strength of the formed product caused by the heating and the oxidation on the occasion of the formation can be prevented without any decreasing in the transparence and the anti-heating ability. These antioxidants may be employed solely or in combination of two or more kinds thereof. The adding amount can be optionally determined within the range in which the object of the present invention is not disturbed, and is preferably from 0.001 to 5, and more preferably from 0.01 to 1, parts by weight per 100 parts by weight of the polymer relating to the present invention.

As the antioxidant, a hindered phenol antioxidant is preferred, which includes 2,6-dialkylphenol derivatives described in U.S. Pat. No. 4,839,405, columns 12 to 14. Such the compounds include ones represented by Formula (7).

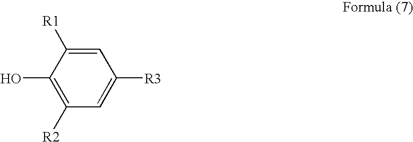

In the above formula, R¹, R² and R³ are each a substituted or unsubstituted alkyl group. Concrete examples of the hindered phenol compound include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neododecyl 3-(dodecyl β-(3,5-di-t-butyl-4-hydroxyphenyl)propionate, ethyl α-(4-hydroxy-3,5-di-t-butylphenyl)isobutylate, octadecyl α-(4-hydroxy-3,5-di-t-butylphenyl)isobutylate, octadecyl α-(4-hydroxy-3,5-di-t-butyl-4-hydroxyphenyl)propionate, 2-(n-octyl)ethyl 3,5-di-t-butyl-e-hydroxybenzoate, 2-(n-octyl)ethyl 3,5-di-t-butyl-4-hydroxyphenylacetate, 2-(n-octadecylthio)ethyl 3,5-di-t-butyl-4-hydroxyphenyl-acetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis-(3,5-di-t-butyl-4-hydroxyphenyl)propionate, 2-(n-octadecylthio)ethyl 3-(3,5-di-t-butyl-4-hydroxyphenyl)propionate, stearylamido N,N-bis[ethylene 3-(3,5-di-t-butyl-4-hydroxyphenyl) propionatel, n-butylimino N,N-bis-[ethylene 3-(3,5-di-t-butyl-4-hydroxyphenyl)propionate], 2-(2-stearoylo-xyethylthio)ethyl-3,5-di-t-butyl-4-hydroxybenzoate, 2-(2-stearoylo-xyethylthio)ethyl 7-(3-methyl-5-t-butyl-4-hydroxyphenyl)heptanoate, 1,2-propylene glycol bis-[3-(3,5-di-t-butyl-4-hydroxyphenyl)propionate], ethylene glycol bis-[3-(3,5-di-t-butyl-4-hydroxyphenyl)-propionate], neopentyl glycol bis-[3-(3,5-di-t-butyl-4-hydroxyphenyl)propionate], ethylene glycol bis-(3,5-di-t-butyl-4-hydroxyphenylacetate), glycerol 1-n-octadecanoate-2,3-bis-(3,5-di-t-butyl-4-hdyroxyphenylacetate), pentaerythrytol tetrakis[3-(3,5-di-t-butyl-4′-hydroxyphenyl)propionate], 1,1,1-trimethylolethane, tris[3-(3,5-di-t-butyl-hydroxyphenyl)propionate], sorbitol hexa-[3-(3,5-di-t-butyl-hydroxyphenyl)propionate], 2-hydroxyethyl 7-(3,5-di-t-butyl-hydroxyphenyl)propionate, 2-stearoyloxyethyl 7-(3,5-di-t-butyl-hydroxyphenyl)-heptanoate, 1,6-n-hexanediol bis-[(3,5-di-t-butyl-4-hydroxyphenyl)propionate] and pentaerythrytol tetrakis(3,5-di-t-butyl-4-hydroxycinnamate). The above-described type hindered phenol antioxidant is, for example, available on the market under the commercial name of Irganox 1076 and Irganox 1010 of Ciba Specialty Chemicals.

Further, compounds having a phenol or phosphorous acid structure in their molecule are also preferably used. For example, compounds represented by following Formula (1) can preferably be used.

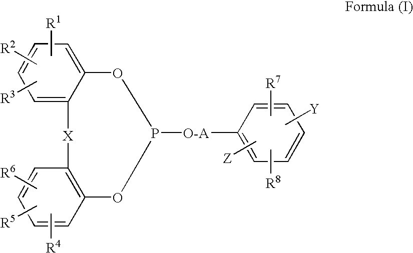

Of these compounds having a phenol or phosphorous acid structure in their molecule, specific examples of compounds specifically preferably used include phosphites represented by Formula (1).

In a phosphite represented by Formula (1) according to the present invention, substituents R¹, R², R⁴, R⁵, R⁷, and R⁸ each individually represent a hydrogen atom, an alkyl group having 1-8 carbons, a cycloalkyl group having 5-8 carbons, an alkylcycloalkyl group having 6-12 carbons, an aralkyl group having 7-12 carbons, or a phenyl group. R¹, R², R⁴ are preferably an alkyl group having 1-8 carbons, a cycloalkyl group having 5-8 carbons, or an alkylcycloalkyl group having 6-12 carbons, and R⁵ is preferably a hydrogen atom, an alkyl group having 1-8 carbons, or a cycloalkyl group having 5-8 carbons.

Herein, typical examples of the alkyl group having 1-8 carbons include, for example, a methyl, an ethyl, a n-propyl, an i-propyl, a n-butyl, an i-butyl, a sec-butyl, a t-butyl, a t-pentyl, an i-octyl, a t-octyl, and a 2-ethylhexyl group. Further, typical examples of the cycloalkyl group having 5-8 carbons include, for example, a cyclopentyl, a cyclohexyl, a cycloheptyl, and a cyclooctyl group, and typical examples of the alkylcycloalkyl group having 6-12 carbons include, for example, a 1-methylcyclopentyl, a 1-methylcyclohexyl, and a 1-methyl-4-i-propylcyclohexyl group. Typical examples of the aralkyl group having 7-12 carbons include, for example, a benzyl, an α-methylbenzyl, and an α,α-dimethylbenzyl group.

Of these, R¹ and R⁴ are preferably a t-alkyl group such as a t-butyl group, a t-pentyl group, or a t-octyl group, a cyclohexyl group, or a 1-methylcyclohexyl group. R² is preferably an alkyl group having 1-5 carbons such as a methyl, ethyl, n-propyl, i-propyl, n-butyl, i-butyl, sec-butyl, t-butyl, or t-pentyl group, specifically preferably a methyl, t-butyl, or t-pentyl group. R⁵ is preferably a hydrogen atom or an alkyl group having 1-5 carbons such as a methyl, ethyl, n-propyl, i-propyl, n-butyl, i-butyl, sec-butyl, t-butyl, or t-pentyl group.

R³ and R⁶ represent a hydrogen atom or an alkyl group having 1-8 carbons. The alkyl group having 1-8 carbons includes, for example, the same alkyl groups as described above. A hydrogen atom or an alkyl group having 1-5 carbons is preferable but a hydrogen atom or a methyl group is specifically preferable.

Further, X represents a mere bond, a sulfur atom, or a methylene group, which may be substituted with an alkyl group having 1-8 carbons or a cycloalkyl group having 5-8 carbons. Herein, the alkyl group having 1-8 carbons or the cycloalkyl group having 5-8 carbons, which is bonded to a methylene group via substitution, each includes the same alkyl groups or cycloalkyl groups as described above. X is preferably a mere bond, a methylene group, or a methylene group which is substituted with a methyl, ethyl, n-propyl, i-propyl, n-butyl, i-butyl, or t-butyl group.

A represents an alkylene group having 2-8 carbons or *—COR¹⁰— group (R¹⁰ represents a mere bond or an alkylene group having 1-8 carbons and symbol * represents bonding on an oxygen side). Herein, typical examples of the alkylene group having 2-8 carbons include, for example, ethylene, propylene, butylene, pentamethylene, hexamethylene, octamethylene, and 2,2-dimethyl-1,3-propylene. Of these, propylene is preferably used. Further, symbol * in *—COR¹⁰— group represents that a carbonyl group bonds to an oxygen atom of a phosphite. Typical examples of the alkylene group having 1-8 carbons in R¹⁰ include, for example, methylene, ethylene, propylene, butylene, pentamethylene, hexamethylene, octamethylene, and 2,2-dimethyl-1,3-propylene. As R¹⁰, a mere bond or ethylene is preferably employed.

One of Y and Z represents a hydroxyl group, an alkoxy group having 1-8 carbons, or an aralkyloxy group having 7-12 carbons and then the other one represents a hydrogen atom or an alkyl group having 1-8 carbons. Herein, the alkyl group having 1-8 carbons includes, for example, the same alkyl groups as described above and the alkoxy group having 1-8 carbons includes, for example, an alkoxy group whose alkyl portion is similar to the above alkyl group having 1-8 carbons. Further, the aralkyloxy group having 7-12 carbons includes aralkyloxy group whose aralkyl portion is similar to the above aralkyl group having 7-12 carbons.

The phosphite represented by Formula (1) can be produced, for example, via reaction of a bisphenol represented by following Formula (II), phosphorous trichloride, and a hydroxy compound represented by following Formula (III).

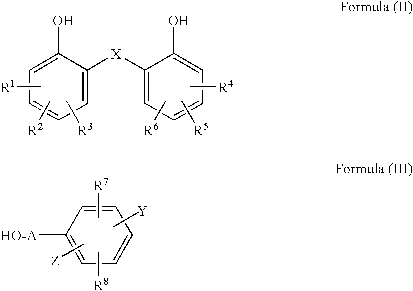

wherein R¹, R², R³, X, R⁴, R⁵, R⁶, R⁷, R⁸, A, Y, and Z are identical with ones as described above.

The bisphenol (II) includes, for example, 2,2′-methylenebis(4-methyl-6-t-butylphenol), 2,2′-methylenebis(4-ethyl-6-t-butylphenol), 2,2′-methylenebis(4-n-propyl-6-t-butylphenol), 2,2′-methylenebis(4-i-propyl-6-t-butylphenol), 2,2′-methylenebis(4-n-butyl-6-t-butylphenol), 2,2′-methylenebis(4-i-butyl-6-t-butylphenol), 2,2′-methylenebis(4,6-di-t-butylphenol), 2,2′-methylenebis(4-t-pentyl-6-t-butylphenol), 2,2′-methylenebis(4-nonyl-6-t-butylphenol), 2,2′-methylenebis(4-t-octyl-6-t-butylphenol), 2,2′-methylenebis(4-methyl-6-t-pentylphenol), 2,2′-methylenebis(4-methyl-6-cyclohexylphenol), 2,2′-methylenebis[4-methyl-6-(α-methylcyclohexyl)phenol], 2,2′-methylenebis(4-methyl-6-nonylphenol), 2,2′-methylenebis(4-methyl-6-t-octylphenol), 2,2′-methylenebis(4,6-di-t-pentylphenol), 2,2′-methylenebis[4-nonyl-6-(α-methylbenzyl)phenol], 2,2′-methylenebis[4-nonyl-6-(α,α-dimethylbenzyl)phenol], and 2,2′-ethylidenebis(4-methyl-6-butylphenol).

Typical examples of the hydroxy compound (III) when A is an alkylene group having 2-8 carbons include, for example, 2-(3-t-butyl-4-hydroxyphenyl)ethanol, 2-(3-t-pentyl-4-hydroxyphenyl)ethanol, 2-(3-t-octyl-4-hydroxyphenyl)ethanol, 2-(3-cyclohexyl-4-hydroxyphenyl)ethanol, 2-[3-(1-methylcyclohexyl)-4-hydroxyphenyl]ethanol, 2-(3-t-butyl-4-hydroxy-5-methylphenyl)ethanol, 2-(3-t-pentyl-4-hydroxy-5-methylphenyl)ethanol, 2-(3-t-octyl-4-hydroxy-5-methylphenyl)ethanol, 2-(3-cyclohexyl-4-hydroxy-5-methylphenyl)ethanol, 2-[3-(1-methylcyclohexyl)-4-hydroxy-5-methylphenyl]ethanol, 2-(3-t-butyl-4-hydroxy-5-ethylphenyl)ethanol, 2-(3-t-pentyl-4-hydroxy-5-ethylphenyl)ethanol, 2-(3-t-octyl-4-hydroxy-5-ethylphenyl)ethanol, 2-(3-cyclohexyl-4-hydroxy-5-ethylphenyl)ethanol, and 2-[3-(1-methylcyclohexyl)-4-hydroxy-5-ethylphenyl]ethanol.

Typical examples of the hydroxy compound (III) when A is *—COR¹⁰— group includes, for example, 3-t-butyl-2-hydroxybenzoic acid, 3-t-butyl-4-hydroxybenzoic acid, 5-t-butyl-2-hydroxybenzoic acid, 3-t-pentyl-2-hydroxybenzoic acid, 3-t-octyl-4-hydroxybenzoic acid, 3-cyclohexyl-4-hydroxybenzoic acid, 3-(1-methylcyclohexyl)-4-hydroxybenzoic acid, 3-t-butyl-2-hydroxy-5-methylbenzoic acid, 3-t-butyl-4-hydroxy-5-methylbenzoic acid, 5-t-butyl-2-hydroxy-3-methylbenzoic acid, 3-t-pentyl-4-hydroxy-5-methylbenzoic acid, 3-t-octyl-4-hydroxy-5-methylbenzoic acid, 3-cyclohexyl-4-hydroxy-5-methylbenzoic acid, 3-(1-methylcyclohexyl)-4-hydroxy-5-methylbenzoic acid, 3-t-butyl-4-hydroxy-5-ethylbenzoic acid, 3-t-pentyl-4-hydroxy-5-ethylbenzoic acid, 3-t-octyl-4-hydroxy-5-ethylbenzoic acid, and 3-cyclohexyl-4-hydroxy-5-ethylbenzoic acid.

Specific examples of such compounds as represented by Formula (1) will now be described.

Compound 1: 6-[3-(3-tert-butyl-4-hydroxy-5-methylphenyl)propoxy]-2,4,8,10-tetrakis-tert-butyldibenzo[d,f][1.3.2]dioxaphosphepine

Compound 2: 6-[3-(3,5-di-tert-butyl-4-hydroxyphenyl)propoxy]-2,4,8,10-tetrakis-tert-butyldibenzo[d,f][1.3.2]dioxaphosphepine

The amount of each of the compounds represented by Formula (1) added to a cellulose resin is commonly from 0.001-10.0 parts by weight, preferably from 0.01-5.0 parts by weight, more preferably from 0.1-3.0 parts by weight based on 100 parts by weight of the cellulose ester.

The polarizing plate protective film A of the present invention also preferably incorporates a phosphite-based compound. When the phosphite-based compound is incorporated, a significantly enhanced effect of coloring prevention is produced even at high forming temperatures and also a polymer to be prepared exhibits a preferable color tone. As a specific phosphite-based compound, phosphite-based compounds represented by following Formulas (a), (b), and (c) are preferably used.

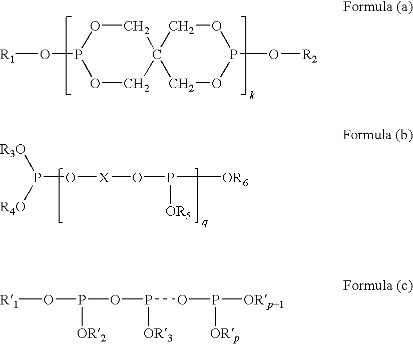

wherein R₁, R₂, R₃, R₄, R₅, R₆, R′₁, R′₂, R′₃, . . . , R′ₙ, and R′ₙ₊₁ represent a hydrogen atom, or a group selected from the group including an alkyl having 4-23 carbons, an aryl, an alkoxyalkyl, an aryloxyalkyl, an alkoxyaryl, an arylalkyl, an alkoxyaryl, a polyaryloxyalkyl, a polyalkoxyalkyl, and a polyalkoxyaryl group. Herein, each of the symbols never represents a hydrogen atom at the same time in individual Formula (a), (b), or (c). X in the phosphite-based compound represented by Formula (b) represents a group selected from the group including an aliphatic chain, an aliphatic chain having an aromatic nucleus in its side chain, an aliphatic chain having an aromatic nucleus in its chain, and a chain containing oxygen atoms at most two of which are not continuously present in any of the above chains. Further, k and q each represent an integer of at least 1 and p represents an integer of at least 3.

The number allocated to k and q in the phosphite-based compounds is preferably from 1-10. By allowing the number of k and q to be at least 1, volatility tends not to occur during heating. In cases of at most 10, compatibility with cellulose acetate propionate of the present invention is enhanced. Further, the number allocated to p is preferably from 3-10. By allowing the number of p to be at least 3, volatility tends not to occur during heating. In cases of at most 10, compatibility of the cellulose acetate propionate with a plasticizer is enhanced. Specific examples of the preferable phosphite-based compound represented by Formula (a) include those represented by following Formulas (d)-(g).

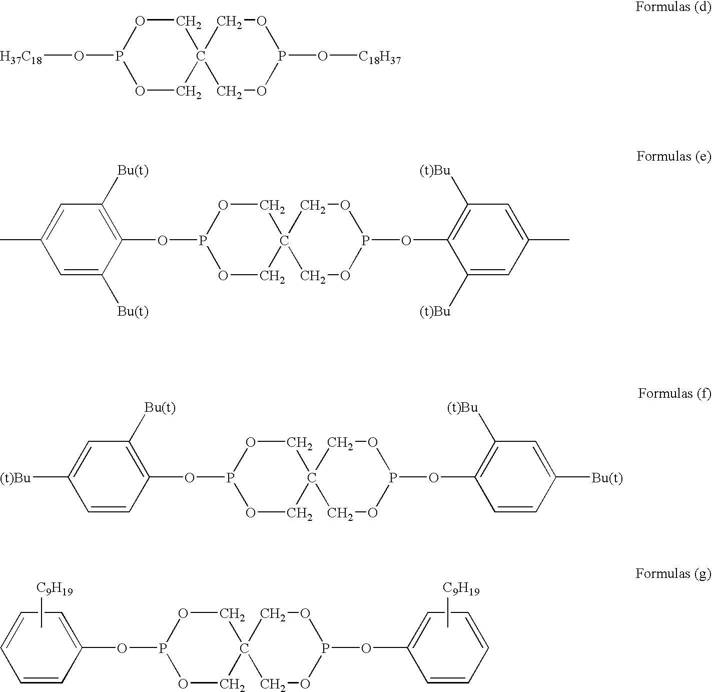

Further, specific examples of the preferable phosphite-based compound represented by Formula (b) include those represented by following Formulas (h), (i), and (j).

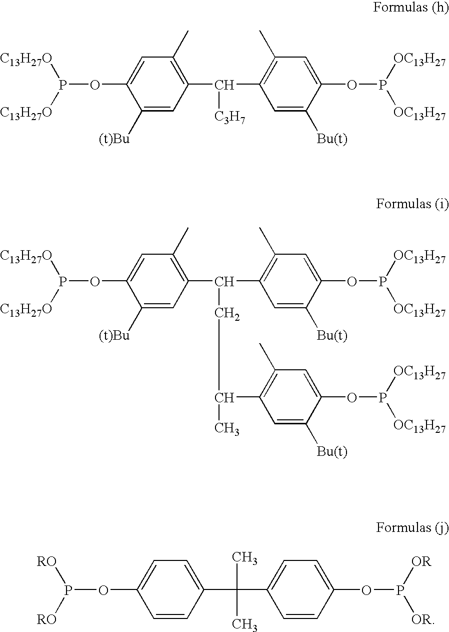

R=an alkyl group having 12-15 carbons

The amount of a phosphite-based coloring inhibitor blended is preferably from 0.005-0.5% by weight based on the total composition. By allowing the blended amount to be at least 0.005% by weight, coloring of the compositions during heating can be prevented. The blended amount is more preferably at least 0.01% by weight, still more preferably 0.05% by weight. In contrast, by allowing the blended amount to be at most 0.5% by weight, deterioration caused by a decrease in the polymerization degree of the cellulose acetate propionate due to cutting of its molecular chain can be prevented. The blended amount is more preferably at most 0.2% by weight, still more preferably at most 0.1% by weight.

In addition, an appropriate phosphonite compound is preferably incorporated.

Other antioxidants specifically include a phosphor-based antioxidant such as trisnonylphenyl phosphite, triphenyl phosphite, or tris(2,4-di-tert-butylphenyl)phosphite; a sulfur-based antioxidant such as dilauryl-3,3′-thiodipropionate, dimyristyl-3,3′-thiodipropionate, distearyl-3,3′-thiodipropionate, or pentaerythrityltetrakis(3-laurylthiopropionate); a heat resistance process stabilizer such as 2-tert-butyl-6-(3-tert-butyl-2-hydroxy-5-methylbenzyl)-4-methylphenylacrylate, 2-[1-(2-hydroxy-3,5-di-tert-pentylphenyl)ethyl]-4,6-di-tert-pentylphenylacrylate; a 3,4-dihydro-2H-1-benzopyran-based compound, a 3,3′-spirodichromane-based compound, a 1,1-spiroindane-based compound, a compound having a morpholine, thiomorpholine, thiomorpholine oxide, thiomorpholine dioxide, or piperazine skeleton as a partial structure as described in Examined Japanese Patent Application Publication No. 8-27508; and an oxygen scavenger such as a dialkoxybenzene-based compound as described in JP-A No. 3-174150. A partial structure of the above antioxidant may be a part of a polymer or a pendant regularly bonding to the polymer, and also may be introduced into a part of the molecular structure of an additive such as a plasticizer, acid remover, or UV absorbent.

### (Acid Scavengers)

Specific examples of acid scavengers include an epoxy compounds described in the specification of U.S. Pat. No. 4,137,201. The epoxy compounds which are trapping agents include those known in the technological field, and examples include polyglycols derived by condensation such as diglyceril ethers of various polyglycols, especially those having approximately 8-40 moles of ethylene oxide per mole of polyglycol, diglyceril ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxyified natural glycerides or unsaturated fatty acids and these fatty acids generally have 12 to 22 carbon atoms)). Particularly preferable are commercially available epoxy resin compounds, which include an epoxy group such as EPON 815c, and other epoxyified ether oligomer condensates such as those represented by the Formula (8).

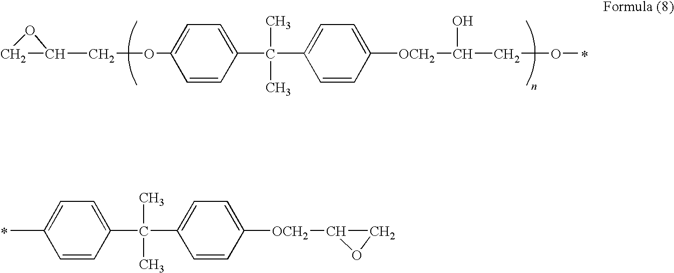

In the formula n is equal to 0-12. Other examples of acid trapping agents that can be used include those described in paragraphs 87-105 in JP-A 5-194788.

### (Light Stabilizer)

The hindered amine light stabilizers (HALS) can be used as a light stabilizer in the invention. These are known compounds and examples include 2,2,6,6-tetraalkyl piperidine compounds and the acid addition salts or the metal salt complexes thereof which are described in columns 5-11 of the specification of U.S. Pat. No. 4,619,956 and columns 3-5 of the specification of U.S. Pat. No. 4,839,405. Examples of these compounds include those represented by the Formula (9) below.

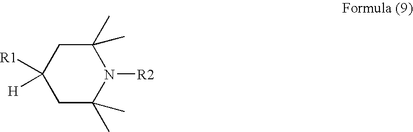

In the formula, R¹ and R² represent H or a substituent group. Specific examples of the hindered amine light stabilizers include 4-hydroxy-2,2,6,6-tetramethyl piperidine, 1-aryl-4-hydroxy 2,2,6,6-tetramethyl piperidine, 1-benzyl-4-hydroxy-2,2,6,6-tetramethyl piperidine, 1-(4-t-butyl-2-butenyl)-4-hydroxy-2,2,6,6-tetramethyl piperidine, 4-stearoyl oxy-2,2,6,6-tetramethyl piperidine, 1-ethyl-4-saliscyloyoxy, 2,2,6,6-tetramethyl piperidine, 4-metacryloyloxy-1,2,2,6,6-pentamethyl piperidine, 1,2,2,6,6-pentamethyl piperidine-4-yl-β(3,5-di-t-butyl-4-hydroxyphenyl)-propionate, 1-benzyl-2,2,6,6-tetramethyl-4-piperidinyl maleinate, (di-2,2,6,6-tetramethyl piperidine-4-yl)-adipate, (di-2,2,6,6-tetramethyl piperidine-4-yl)-sepacate, (di-1,2,3,6-tetramethyl-2,6-diethyl-piperidine-4-yl)-sepacate, (di-1-aryl-2,2,6,6-tetramethyl-piperidine-4-yl)-phthalate, 1-acetyl-2,2,6,6-tetramethyl-piperidine-4-yl acetate, trimellitic acid-tri-(2,2,6,6-tetramethyl piperidine-4-yl)ester, 1-acryloyl-4-benzyloxy-2,2,6,6-tetramethyl-piperidine, dibutyl-malonic acid-di-(1,2,2,6,6-pentamethyl-piperidine-4-yl)-ester, dibenzyl-malonic acid-di-(1,2,3,6-tetramethyl-2,6-diethyl-piperidine-4-yl)-ester, dimethyl-bis-2,2,6,6-tetramethyl piperidine-4-oxy)-silane, tris-(1-propyl-2,2,6,6-tetramethyl piperidine-4-yl)-phosphite, tris-(1-propyl-2,2,6,6-tetramethyl piperidine-4-yl)-phosphate, N,N′-bis-(2,2,6,6-tetramethyl piperidine-4-yl)-hexamethylene-1,6-diamine, N,N′-bis-2,2,6,6-tetramethyl piperidine-4-yl)-hexamethylene-1,6-diacetamide, 1-acetyl-4-(N-cyclohexyl acetoamide)-2,2,6,6-tetramethyl-piperidine, 4-benzylamino-2,2,6,6-tetramethyl piperidine, N,N′-bis-2,2,6,6-tetramethyl piperidine-4-yl)-N,N′-dibutyl-adipamide, N,N′-bis-(2,2,6,6-tetramethyl piperidine-4-yl)-N,N′-dicyclohexyl-(2-hydroxypropylene), N,N′-bis-(2,2,6,6-tetramethyl piperidine-4-yl)-p-xylelene-diamine, 4-(bis-2-hydroxyethyl)-amino-1,2,2,6,6-pentamethyl piperidine, 4-methacrylamide 1,2,2,6,6-pentamethyl piperidine, α-cyano-β-methyl-β-[N-(2,2,6,6-tetramethyl piperidine-4-yl)]-amino-methyl ester acrylate. Examples of the preferable hindered amine light stabilizers include those represented by HALS-1 and HALS-2 below.

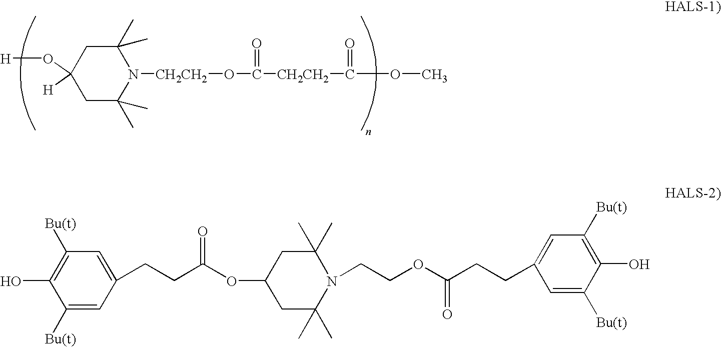

The hindered amines represented by Formula (1) described in JP-A 2004-352803 can also be preferably used for the polarizing plate protective film A of the present invention.

These hindered amine light stabilizers may be used singly or in combinations of 2 or more, and they may also be used with additives such as plasticizers, acid scavengers, ultraviolet light absorbers, or introduced into a part of the molecular structure of the additive.

### (Matting Agent)

Fine particles such as a matting agent or the like may be added to the polarizing plate protective film of the present invention in order to impart a matting effect, and fine particles of inorganic compounds as well as fine particles of organic compounds may be used. The particles having shapes of spherical, planer, needle, layered, or amorphous can be used.

The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of high molecular weigh polymers of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halogens, alkoxysilanes, silazanes, and siloxanes. Particles having a larger average particle diameter have a greater matting effect, while particles having a smaller average particle diameter have excellent transparency. The secondary particles should have an average primary particle diameter in the range of 0.05 to 1.0 μm. The secondary particles preferably have an average primary particle diameter in the range of 5 to 50 nm, and more preferably 7 to 14 nm. These fine particles are preferable because they create unevenness of 0.01 to 1.0 μm in the plane of the cellulose ester film. The amount of the fine particles included in the cellulose ester is preferably 0.005-0.3 weight % of the cellulose ester.

Examples of the silicon dioxide particles include Aerosil 200, 200V, 300, R972, R972V, R974, R202, R812, OX50, or TT600 each manufactured by Nippon Aerosil Co., Ltd., and of these, Aerosil 200V, R972, R972V, R974, R202, and R812, are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1:99.9-99.9:0.1

The presence of the fine particles used as the matting agent in the film can also serve another purpose of improving the strength of the film.

These fine particles can be added by kneading with a resin and further can be kneaded with a plasticizer, a hindered amine compound, a hindered phenol compound, a phosphorous acid compound, a UV absorbent, or an acid scavenger. Optionally, there may be used those prepared by mixing and then drying a cellulose resin sprayed with fine particles having been previously dispersed in a solvent such as methanol or ethanol, and also there may be used, as a raw material for melt casting, a pelletized substance prepared as follows: fine particles, having been dissolved in a solvent, are added into a cellulose resin solution whose solvent is mainly methylene chloride or methyl acetate, followed by mixing and drying for solidification. The cellulose resin solution containing the fine particles preferably contains, additionally, some or all substances selected from a plasticizer, a hindered amine compound, a hindered phenol compound, a phosphorous acid compound, a UV absorbent, or an acid scavenger.

Optionally, there may be used, as a raw material (preferably in the pellet form) containing fine particles for melt casting, a thermoplastic resin composition prepared by adding a dispersion, having been prepared by dispersing 0.1-20 parts by weight of the fine particles in 10-100 parts by weight of a solvent such as methanol, ethanol, isopropanol, or butanol, to 100 parts by weight of a cellulose resin, followed by being kneaded while removing the solvent. The dispersion may also contain a surfactant, a dispersing agent, or an antioxidant.

A pellet may be produced via the method described in JP-A No. 2005-67174. Namely, it is also possible to produce a pallet via a particle production method in which a melted polymer containing a cellulose resin is cooled and solidified, followed by being cut.

A raw material containing fine particles prepared via any of the above methods may be used individually or by mixing a raw material containing no fine particles, if appropriate.

By forming a film via a co-extrusion method or a sequential extrusion method, a film featuring a surface layer incorporating fine particles can be produced. A structure can be realized in which a surface layer incorporating fine particles of an average particle diameter of 0.01-1.0 μm is arranged on at least either side of the film. When the surface layer incorporates fine particles, the fine particles may be incorporated in any layer constituting the lower portion of the film.

### (Retardation Regulator)

In order to enhance liquid crystal display quality, optical compensation performance may be imparted to the polarizing plate protective film A of the present invention by adding a retardation regulator in the film or via a method in which a liquid crystal layer is provided by forming an orientation film to realize combined retardation by combining retardation resulting from the polarizing plate protective film A with one resulting from the liquid crystal layer. With regard to compounds added to adjust retardation, aromatic compounds having at least 2 aromatic rings, as described in European Patent No. 911,656 A2 specification, may also be used as a retardation regulator. For example, rod-like compounds described below are listed. Further, at least 2 types of aromatic compounds may simultaneously be used. Aromatic rings of the aromatic compounds include aromatic heterocycles in addition to aromatic hydrocarbon rings. Aromatic heterocycles are specifically preferable, which are commonly unsaturated heterocycles. Of these, a 1,3,5-triazine ring is specifically preferable.

### (Rod-Shaped Compound)

The polarizing plate protective film A according to the present invention preferably contains a rod-shaped compound which has the maximum absorption wavelength (λₘₐₓ) in UV absorption spectrum at a wavelength of not longer than 250 nm.

The rod-shaped compound preferably has one or more, and preferably two or more, aromatic rings from the viewpoint of the retardation controlling function. The rod-shaped compound preferably has a linear molecular structure. The linear molecular structure means that the molecular structure of the rod-shaped compound is linear in the thermodynamically most stable structure state. The thermodynamically most stable structure can be determined by crystal structure analyzing or molecular orbital calculation. The molecular structure, by which the heat of formation is made minimum, can be determined on the calculation by, for example, a software for molecular orbital calculation WinMOPAC2000, manufactured by Fujitsu Co., Ltd. The linear molecular structure means that the angle of the molecular structure is not less than 140° in the thermodynamically most stable structure calculated as the above. The rod-shaped compound is preferably one displaying a liquid crystal property. The rod-shaped compound more preferably displays a crystal liquid property by heating (thermotropic liquid crystal property). The phase of the liquid crystal is preferably a nematic phase or a smectic phase.

As the rod-shaped compound, trans-1,4-cyclohexane-dicarboxylic acid esters represented by the following Formula (10) are preferable.

Ar¹-L¹-Ar² Formula (10)

In Formula (10), Ar¹ and Ar² are each independently an aromatic group. The aromatic group includes an aryl group (an aromatic hydrocarbon group), a substituted aryl group, an aromatic heterocyclic group and a substituted heterocyclic group. The aryl group and the substituted alkyl group are more preferable than the aromatic heterocyclic group and the substituted aromatic heterocyclic group. The heterocycle of the aromatic heterocyclic group is usually unsaturated. The aromatic heterocyclic group is preferably a 5-, 6- or 7-member ring, and more preferably a 5- or 6-member ring. The heterocyclic ring usually has the largest number of double bond. The hetero atom is preferably a nitrogen atom, an oxygen atom or a sulfur atom and the nitrogen atom or the oxygen atom is more preferable. Examples of the aromatic heterocyclic ring include a furan ring, a thiophene ring, a pyrrole ring, an oxazole ring, in isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring and a 1,3,5-triazine ring. As the aromatic ring of the aromatic group, a benzene ring, a furan ring, a thiophene ring, a pyrrole ring, an oxazole ring, a thiazole ring, a thiazole ring, an imidazole ring, a triazole ring, a pyridine ring, a pyrimidine ring and pyrazine ring are preferable and the benzene ring is particularly preferable.

Examples of the substituent of the substituted aryl group and the substituted aromatic heterocyclic group include a halogen atom such as a fluorine chlorine atom, a chlorine atom, a bromine atom and an iodine atom, a hydroxyl group, a carboxyl group, a cyano group, an amino group, an alkylamino group such as a methylamino group, an ethylamino group, a utylamno group and a dimethylamino group, a nitro group, a sulfo group, a carbamoyl group, an alkylcarbamoyl group such as an N-methylcarbamoyl group and an N,N-dimethylcarbamoyl group, a sulfamoyl group, an alkylsulfamoyl group such as an N-methylsulfamoyl group, an N-ethylsulfamoyl group and an N,N-dimethylsulfamoyl group, a ureido group, an alkylureido group such as an N-methylureido group, an N,N-dimethylureido group and N,N,N-trimethylureido group, an alkyl group such as a methyl group, an ethyl group, a propyl group, a butyl group, a pentyl group, a heptyl group, an octyl group, an isopropyl group, an s-butyl group, a t-amyl group, a cyclohexyl group and a cyclopentyl group, an alkenyl group such as a vinyl group, an allyl group and a hexenyl group, an alkynyl group such as an ethynyl group and a butynyl group, an acyl group such as a formyl group; an acetyl group, a butylyl group, a hexanoyl group and a lauryl group, an acyloxy group such as an acetoxy group, a butylyloxy group, a hexanoyloxy group and lauryloxy group, an alkoxy group such as a methoxy group, an ethoxy group, a propoxy group, a butoxy group, a pentyloxy group, a heptyloxy group and an octyloxy group, an aryloxy group such as a phenoxy group, an alkoxycarbonyl group such as a methoxycarbonyl group, an ethoxycarbonyl group, a propoxycarbonyl group, a butoxycarbonyl group, a pentyloxycarbonyl group and a heptyloxycarbonyl group, an aryloxycarbonyl group such as a phenoxycarbonyl group, a an alkoxycarbonylamino group such as a butoxycarbonylamino group and a hexyloxycarbonylamino group, an alkylthio group such as a methylthio group, an ethylthio group, a propylthio group, butylthio group, a pentylthio group, a heptylthio group and an octylthio group, an arylthio group such as a thiophenyl group, an alkylsulfonyl group such as a methylsulfonyl group, an ethylsulfonyl group, a propylsulfonyl group, a butylsulfonyl group, a pentylsulfonyl group, a heptylsulfonyl group and an octylsulfonyl group, an amido group such as an acetoamido group, a butylamido group, a hexylamido group and an octylamido group, and a non-aromatic heterocyclic group such as a morpholyl group and a pyradinyl group.

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferable. The alkyl moiety of the alkylamino group, the alkoxycarbonyl group, the alkoxy group and the alkylthio group, and the alkyl group each may further have a substituent. Examples of the substituent of the alkyl moiety or the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. The halogen atom, the hydroxyl group, an amino group, an alkylamino group, an acyl group, an acyloxy group, an acylamino group, an alkoxycarbonyl group and an alkoxy group are preferable as the substituent of the alkyl moiety or the alkyl group.

In Formula (10), L¹ is a di-valent bonding group selected from the group consisting of an alkylene group, an alkenylene group, an alkynylene group, a di-valent saturated heterocyclic group, an —O— atom, a —CO— group and a combination of them. The alkylene group may have a cyclic structure. As the cyclic alkylene group, a cyclohexylene group is preferable, and 1,4-cyclohexylene group is more preferable. As the chain-shaped alkylene group, a straight-chain alkylene group is more preferable than a branched-chain alkylene group. The number of carbon atoms of the alkylene group is preferably 1-20, more preferably 1-15, further preferably 1-10, further more preferably 1-8, and most preferably 1-6.

The alkenylene group and the alkynylene group each having a cyclic structure are more preferable than those having a chain structure, and a straight-chain structure is more preferably to a branched-chain structure. The number of carbon atom of the alkenylene group and the alkynylene group is preferably 2-10, more preferably 2-8, further preferably 2-6, and further more preferably 2-4, and most preferably 2, namely a vinylene or an ethynylene group. The di-valent saturated heterocyclic group is preferably from a 3- to 9-member heterocyclic ring. The hetero atom of the heterocyclic ring is preferably an oxygen atom, a nitrogen atom, a boron atom, a sulfur atom, a silicon atom, a phosphor atom or a germanium atom. Examples of the saturated heterocyclic ring include a piperidine ring, a piperazine ring, a morpholine ring, a pyrrolidine ring, an imidazolidine ring, a tetrahydrofuran ring, a tetrahydropyrane ring, a 1-3-dioxane ring, a 1,4-dioxane ring, a terahydrothiophene ring, a 1,3-thiazolidine ring, a 1,3-oxazolidine ring, a 1,3-dioxoran ring, a 1,3-dithiosilane ring and a 1,3,2-dioxoboran ring. Particularly preferable di-valent saturated heterocyclic group is a piperazine-1,4-diylene group, a 1,3-dioxane-2,5-diylene group and a 1,3,2-dioxobororane-2,5-diylene group.

Examples of divalent bonding group composed of a combination of groups are listed as follows.

L-1: —O—CO-alkylene-CO—O—

L-2: —CO—O-alkylene-O—CO—

L-3: —O—CO-alkenylene-CO—O—

L-4: —CO—O-alkenylene-O—CO—

L-5: —O—CO-alkynylene-CO—O—

L-6: —CO—O-alkynylene-O—CO—

L-7: —O—CO-divalent saturated heterocyclic group-CO—

L-8: —CO—O— divalent saturated heterocyclic group —O—CO—

In the structure of Formula (10), the angle formed by Ar¹ and Ar² through L¹ is preferably not less than 140°. Compounds represented by Formula (11) are further preferable as the rod-shaped compound.

Ar¹-L²-X-L³-Ar² Formula (11)

In Formula (11), Ar¹ and Ar² are each independently an aromatic group. The definition and the example are the same as Ar¹ and Ar² in Formula (10).

In Formula (11), L² and L³ are each independently a di-valent bonding group selected from the group consisting of an alkylene group, an —O— atom, a —CO— group and a combination of them. The alkylene group having a chain structured is preferably to that having a cyclic structure, and a straight-chain structure is more preferably to a branched-chain structure. The number of carbon atoms in the alkylene group is preferably 1-10, more preferably from 1 to 8, further preferably from 1 to 6, further more preferably 1-4, and most preferably 1 or 2, namely a methylene group or an ethylene group. L² and L³ are particularly preferably an —O—CO— group or a-CO—O— group.

In Formula (11), X is 1,4-cyclohexylene group, a vinylene group or a ethynylene group. Concrete examples of the compound represented by Formula (10) are listed below.

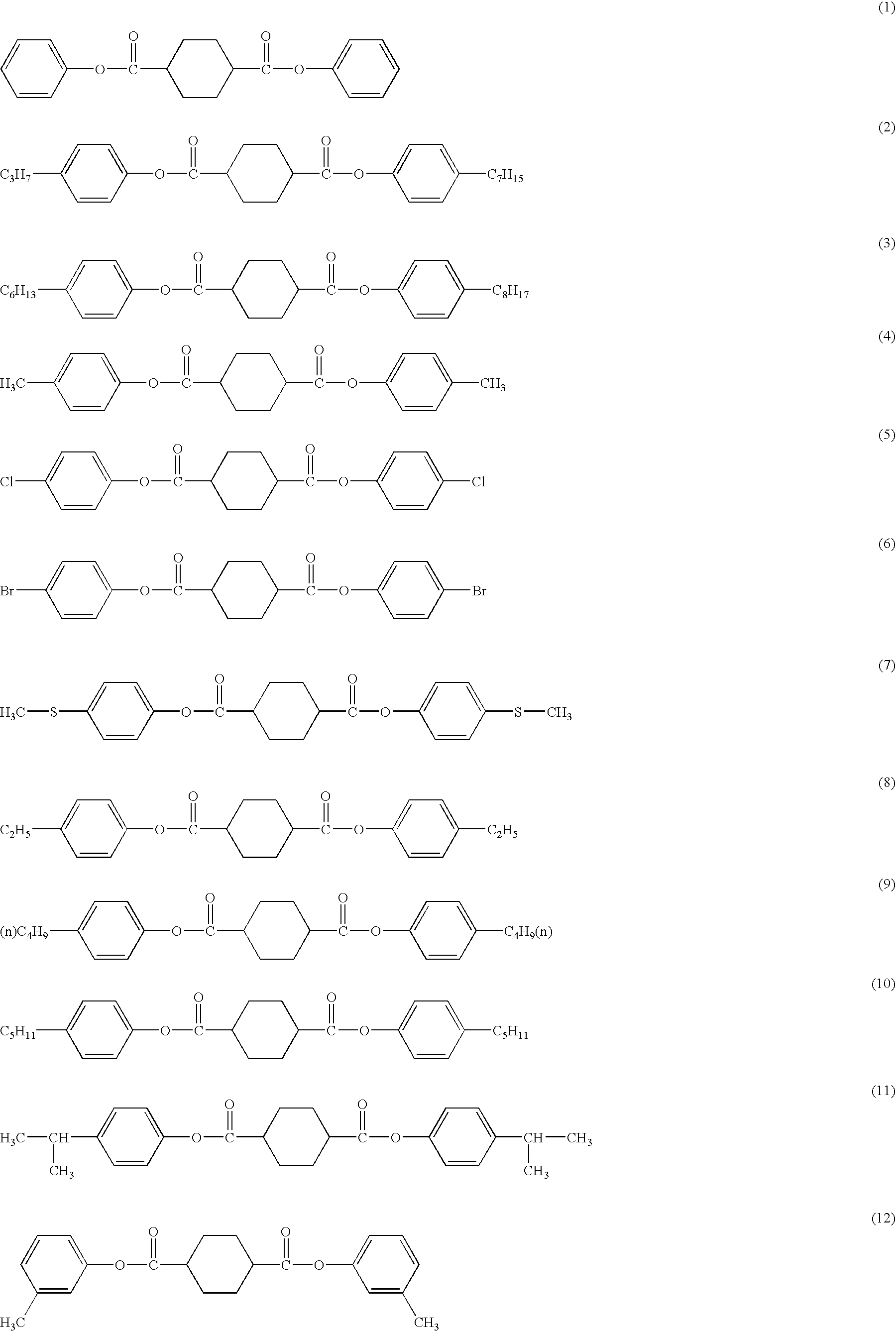

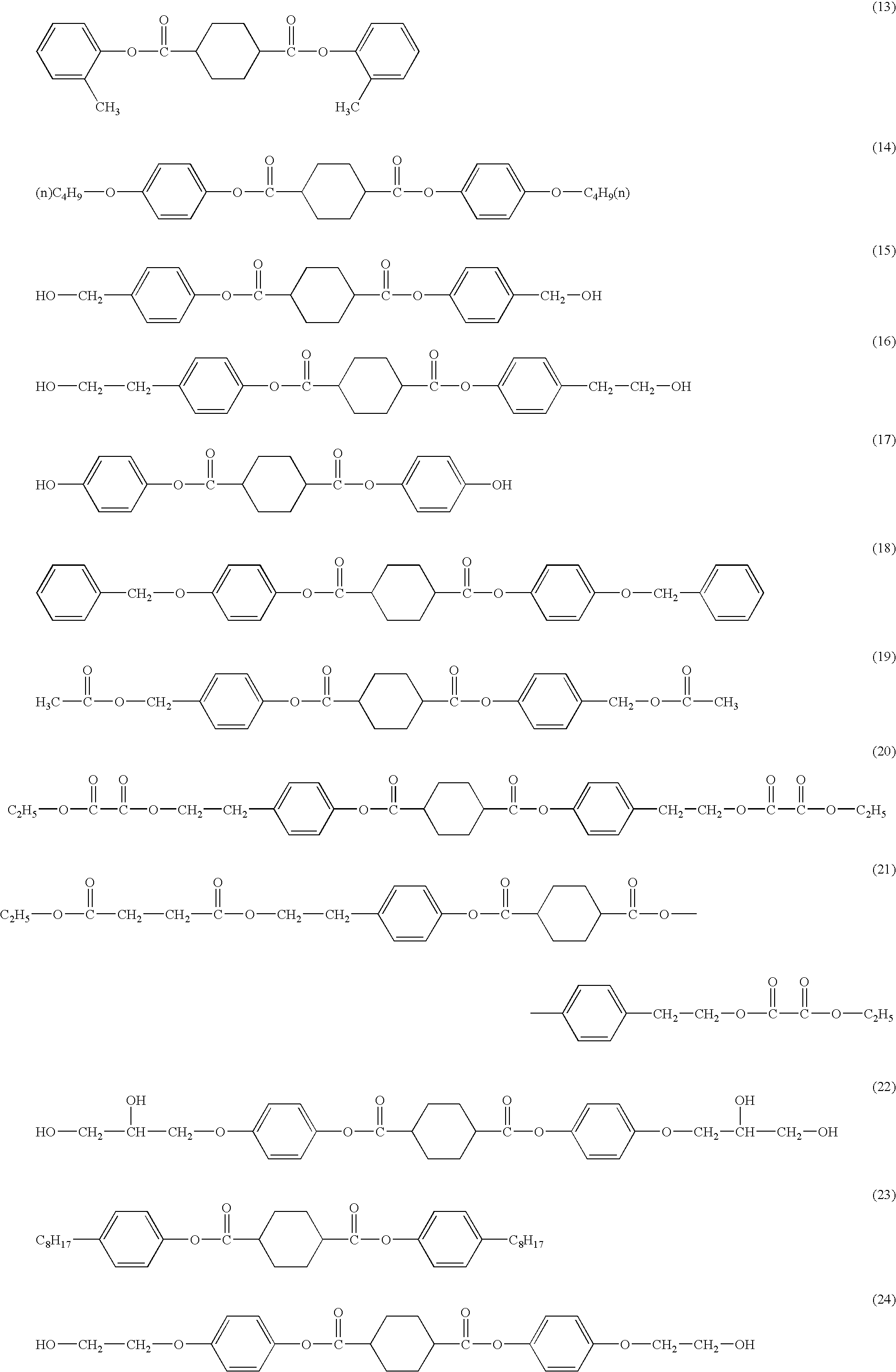

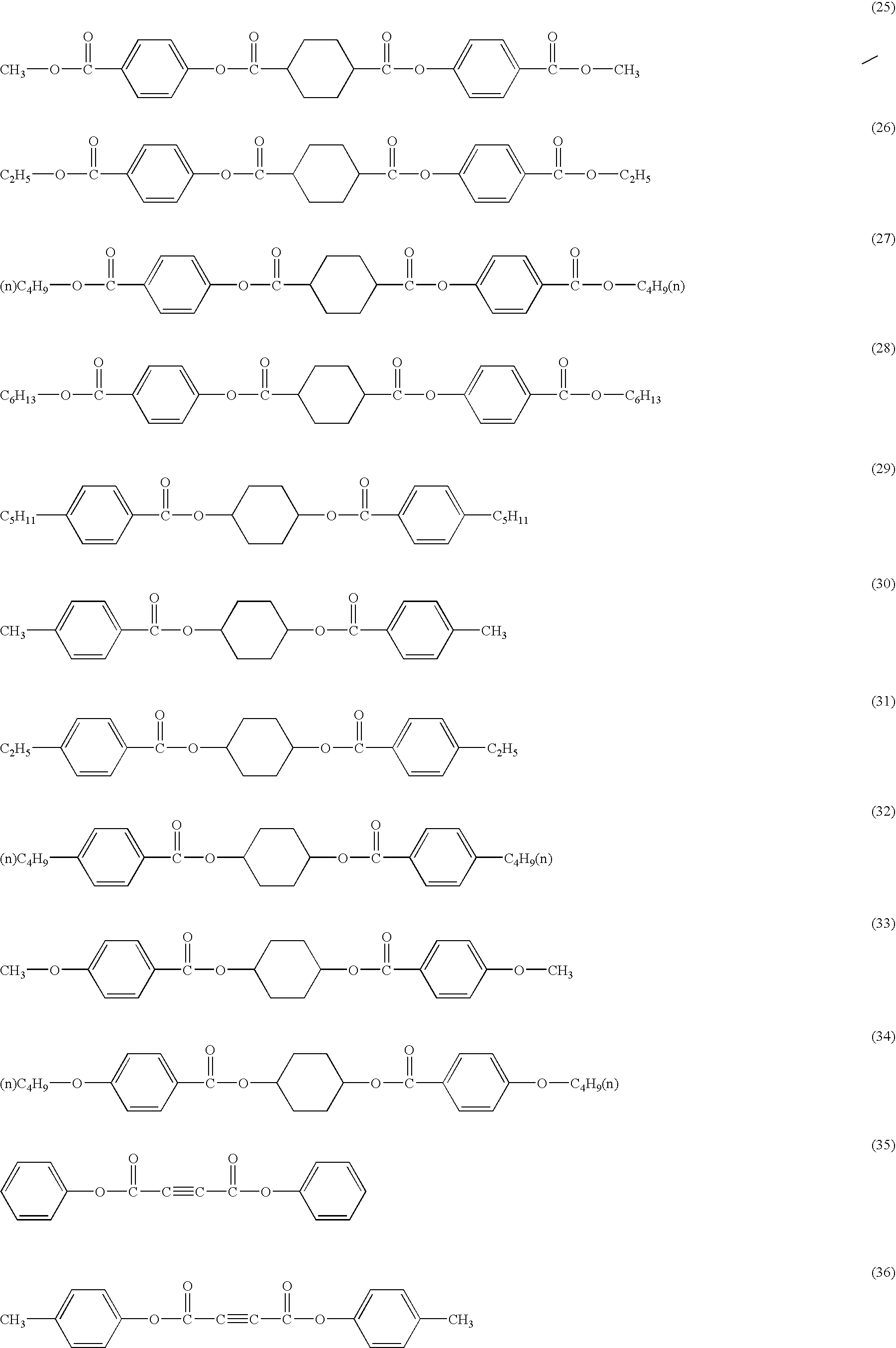

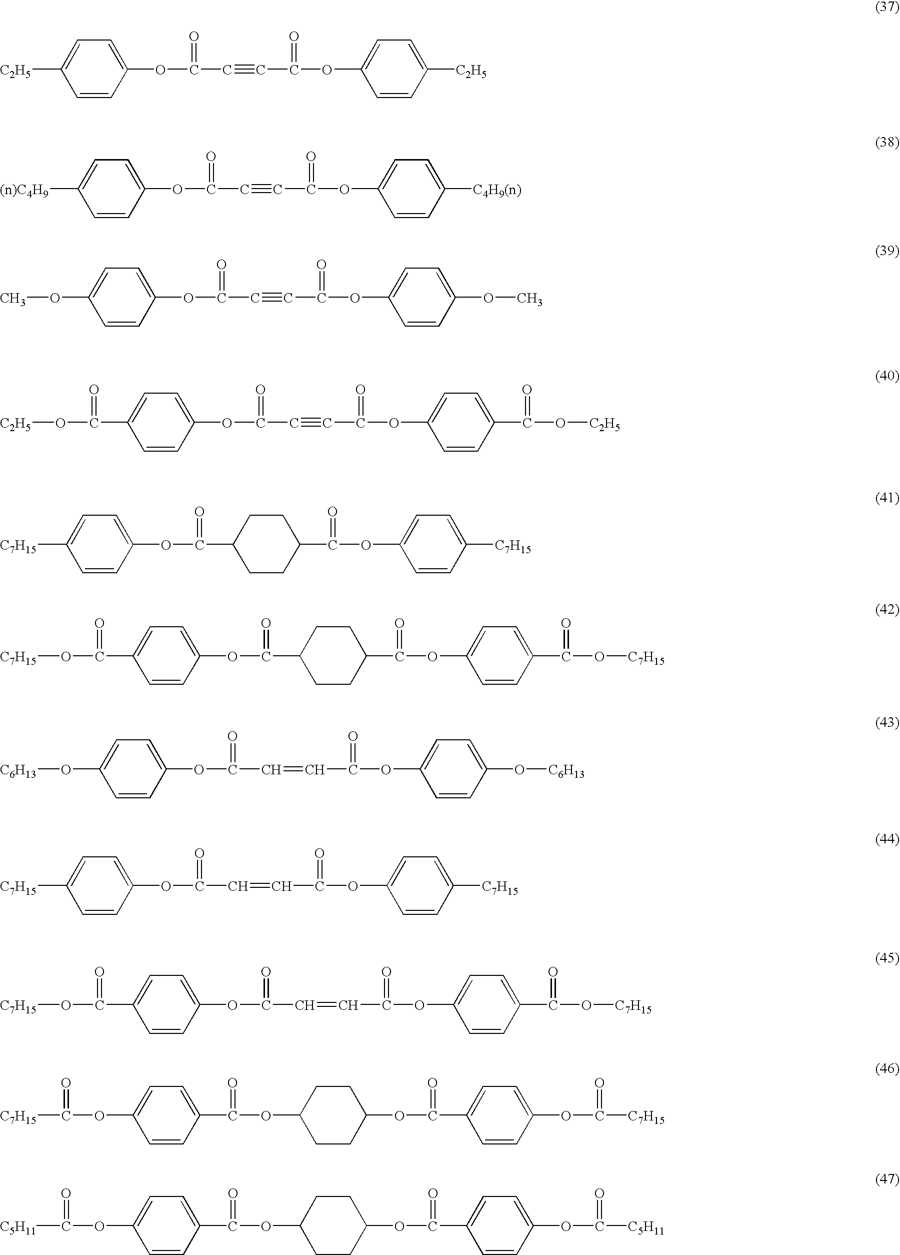

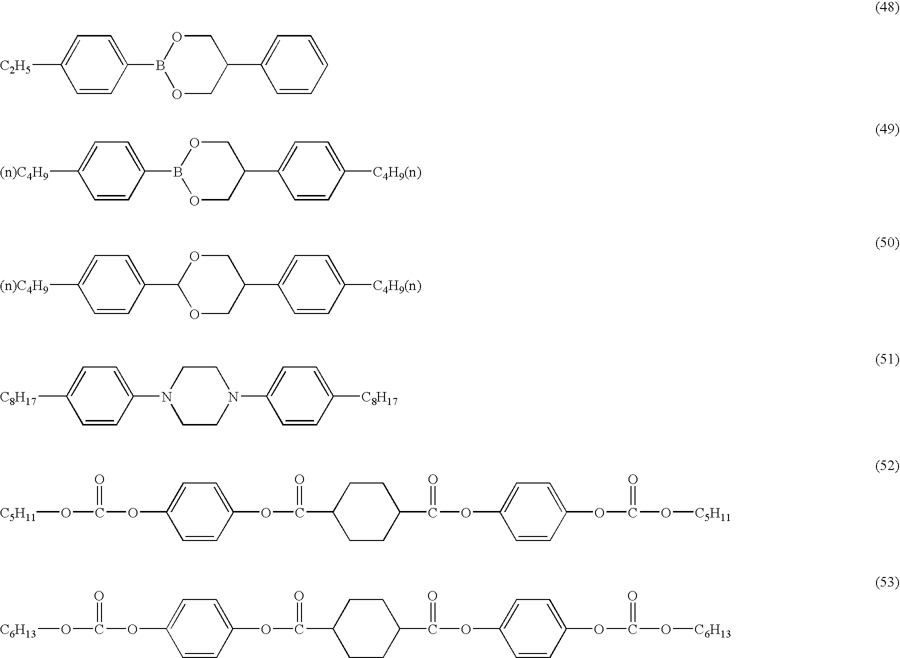

Exemplified compounds (1)-(34), (41), (42), (46), (47), (52) and (53) each has two asymmetric carbon atoms at 1- and 4-positions of the cyclohexane ring. However, Exemplified compounds (1), (4)-(34), (41), (42), (46), (47), (52) and (53) have no optical isomerism (optical activity) since they have symmetrical meso form molecular structure, and there are only geometric isomers thereof. Exemplified compound 1 in trans-form (1-trans) and that in cis-form (1-cis) are shown below.

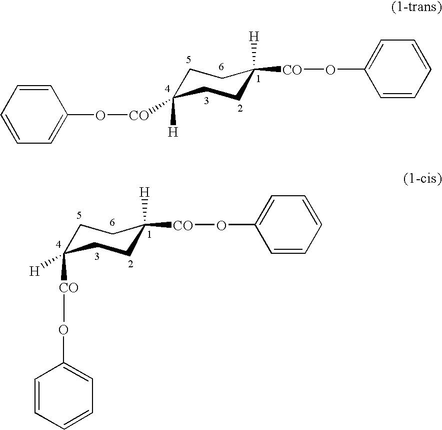

As above-mentioned, the rod-shaped compound preferably has a linear molecular structure. Therefore, the trans form is preferably to the cis-form. Exemplified compounds (2) and (3) have optical isomers additionally to the geometric isomers (four isomers in total). Regarding the geometric isomers, the trans-form is more preferable than the cis-form. There is no difference between the optical isomers and D-, L- and racemic-body are all employable. In Exemplified compounds (43)-(45), cis-form and trans-form are formed at the vinylene bond. The trans-form is preferable than the cis-form by the above-described reason.

Two kinds of the rod-shaped compounds each having the maximum absorption at a wavelength shorter than 250 nm may be employed in combination. “Mol. Cryst. Liq. Cryst.” vol. 53, p. 229, 1979, ibid. vol. 89, p. 93, 1982, ibid. vol. 145, p. 111, 1987, and ibid. vol. 170, p. 43, 1989, “J. Am. Chem. Soc.” Vol. 113, p. 1349, 1991, ibid. vol. 118, p. 5346, 1996, and ibid. vol. 92, p. 1582, 1970, “J. Org. Chem.” Vol. 40, p. 420, 1975, and “Tetrahedron” vol. 48, No. 16, p. 3437, 1992 can be cited as relating documents.

A phenyl benzoate derivative is preferably used in a polarizing plate protective film A of the present invention.

### (Phenyl Benzoate Ester Compound)

The following describes the details of the compound expressed by Formula (12) used in the present invention:

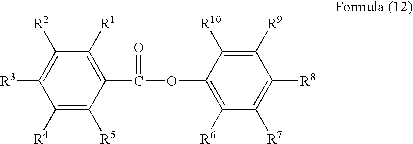

(In the formula, R⁰, R¹, R², R³, R⁴, R⁵, R⁶, R⁷, R⁹ and R¹⁰ independently represent a hydrogen atom or substituent. At least one of the R¹, R², R³, R⁴ and R⁵ denotes an electron-donating group.)

In Formula (12), R⁰, R¹, R², R³, R⁴, R⁵, R⁶, R⁷, R⁹ and R¹⁰ independently represent a hydrogen atom or a substituent. A substituent T (to be described later) can be applied to the substituent.

At least one of the R¹, R², R³, R⁴ and R⁵ expresses an electron-donating group. At least one of the R¹, R³ and ⁵ preferably represents an electron-donating group, and R³ is more preferably an electron-donating group.

The electron-donating group indicates the group wherein the σp value of Hammett does not exceed 0. Preferably used is the electron-donating group described in Chem. Rev., 91, 165 (1991) wherein the σp value of Hammett does not exceed 0. More preferably used is the group wherein the σp value is in the range from −0.85 through 0. For example, an alkyl group, alkoxy group, amino group and hydroxyl group can be mentioned.

The electron-donating group preferably used in the present invention is exemplified by an alkyl group and alkoxy group. The more preferably used one is exemplified by an alkoxy group (containing preferably 1 through 12 carbon atoms, more preferably 1 through 8 carbon atoms, still more preferably 1 through 6 carbon atoms, and particularly preferably 1 through 4 carbon atoms).

R¹ preferably represents a hydrogen atom or electron-donating group; more preferably an alkyl group, alkoxy group, amino group and hydroxyl group; still more preferably an alkyl group having 1 through 4 carbon atoms and an alkoxy group or hydroxyl group having 1 through 12 carbon atoms; particularly preferably an alkoxy group (containing preferably 1 through 12 carbon atoms, more preferably 1 through 8 carbon atoms, still more preferably 1 through 6 carbon atoms, particularly preferably 1 through 4 carbon atoms); and most preferably a methoxy group.

R² preferably represents a hydrogen atom, alkyl group, alkoxy group, amino group and hydroxyl group, more preferably a hydrogen atom, alkyl group and alkoxy group, and still more preferably hydrogen atom, alkyl group (containing preferably 1 through 4 carbon atoms, and more preferably a methyl group), and alkoxy group (containing preferably 1 through 12 carbon atoms, more preferably 1 through 8 carbon atoms, still more preferably 1 through 6 carbon atoms, and particularly 1 through 4 carbon atoms). The hydrogen atom, methyl group and methoxy group are used with particular preference. The hydrogen atom is most preferably utilized.

R³ preferably represents a hydrogen atom or electron-donating group, more preferably a hydrogen atom, alkyl group, alkoxy group, amino group and hydroxyl group, still more preferably an alkyl group and alkoxy group, and particularly an alkoxy group (containing preferably 1 through 12 carbon atoms, more preferably 1 through 8 carbon atoms, still more preferably 1 through 6 carbon atoms, and particularly preferably 1 through 4 carbon atoms). The most preferred groups are an n-propoxy group, ethoxy group and methoxy group.

R⁴ preferably represents a hydrogen atom or electron-donating group; more preferably hydrogen atom, alkyl group, alkoxy group, amino group and hydroxyl group; still more preferably a hydrogen atom, alkyl group having 1 through 4 carbon atoms, and alkoxy group having 1 through 12 carbon atoms (containing preferably 1 through 12 carbon atoms, more preferably 1 through 8 carbon atoms, still more preferably 1 through 6 carbon atoms, and particularly 1 through 4 carbon atoms); particularly hydrogen atom, alkyl group having 1 through 4 carbon atoms and alkoxy group having 1 through 4 carbon atoms; and most preferably a hydrogen atom, methyl group and methoxy group.

R⁵ preferably represents a hydrogen atom, alkyl group, alkoxy group, amino group and hydroxyl group; more preferably a hydrogen atom, alkyl group and alkoxy group; still more preferably hydrogen atom, alkyl group (containing preferably 1 through 4 carbon atoms, and more preferably methyl group) and alkoxy group (containing preferably 1 through 12 carbon atoms, more preferably 1 through 8 carbon atoms, still more preferably 1 through 6 carbon atoms, and preferably 1 through 4 carbon atoms); particularly hydrogen atom, methyl group and methoxy group; and most preferably a hydrogen atom.

R⁶, R⁷, R⁹ and R¹⁰ preferably represent a hydrogen atom, an alkyl group containing 1 through 12 carbon atoms, an alkoxy group containing 1 through 12 carbon atoms, and a halogen atom; more preferably, hydrogen atom and halogen atom; and still more preferably hydrogen atom.

R⁰ denotes a hydrogen atom or substituent. R⁰ preferably represents a hydrogen atom, alkyl group containing 1 through 4 carbon atoms, alkynyl group containing 2 through 6 carbon atoms, aryl group containing 6 through 12 carbon atoms, alkoxy group containing 1 through 12 carbon atoms, aryloxy group containing 6 through 12 carbon atoms, alkoxy carbonyl group containing 2 through 12 carbon atoms, acyl amino group containing 2 through 12 carbon atoms, cyano group, carbonyl group or halogen atom.

In Formula (12), the following Formula (13) is more preferably employed.

The following describes the details of the compounds given in Formula (13):

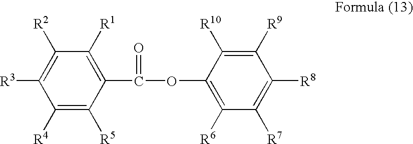

In the formula, R¹, R², R³, R⁴, R⁵, R⁶, R⁷, R⁹ and R¹⁰ independently represent a hydrogen atom or substituent. At least one of the R¹, R², R³, R⁴ and R⁵ denotes an electron-donating group. R⁸ indicates a hydrogen atom, an alkyl group containing 1 through 4 carbon atoms, alkynyl group containing 2 through 6 carbon atoms, aryl group containing 6 through 12 carbon atoms, alkoxy group containing 1 through 12 carbon atoms, aryloxy group containing 6 through 12 carbon atoms, alkoxy carbonyl group containing 2 through-12 carbon atoms, acyl amino group containing 2 through 12 carbon atoms, cyano group, carbonyl group or halogen atom.

R⁸ indicates a hydrogen atom, an alkyl group containing 1 through 4 carbon atoms, alkynyl group containing 2 through 12 carbon atoms, aryl group containing 6 through 12 carbon atoms, alkoxy group containing 1 through 12 carbon atoms, aryloxy group containing 6 through 12 carbon atoms, alkoxy carbonyl group containing 2 through 12 carbon atoms, acyl amino group containing 2 through 12 carbon atoms, cyano group, carbonyl group or halogen atom. If possible, a substituent may be contained. The substituent T to be described later can be used as a substituent. Further replacement by a substituent is also permitted.

R⁸ preferably represents an alkyl group containing 1 through 4 carbon atoms, alkynyl group containing 2 through 12 of carbon atoms, aryl group containing 6 through 12 of carbon atoms, alkoxy group containing 1 through 12 of carbon atoms, alkoxy carbonyl group containing 2 through 12 of carbon atoms, acyl amino group containing 2 through 12 of carbon atoms and cyano group; more preferably an alkynyl group containing 2 through 12 carbon atoms, aryl group containing 6 through 12 carbon atoms, alkoxy carbonyl group containing 2 through 12 carbon atoms, acyl amino group containing 2 through 12 carbon atoms, and cyano group; still more preferably an alkynyl group containing 2 through 7, aryl group containing 6 through 12 carbon atoms, alkoxy carbonyl group containing 2 through 6 carbon atoms, acyl amino group containing 2 through 7 carbon atoms, and cyano group; particularly a phenyl ethynyl group, phenyl group, p-cyanophenyl group, p-methoxyphenyl group, benzoylamino group, n-propoxy carbonyl group, ethoxy carbonyl group, methoxy carbonyl group, and cyano group.

In Formula (13), the following Formula (13-A) is more preferred:

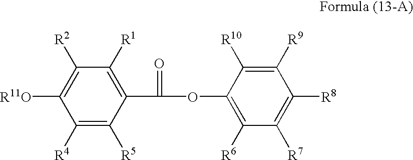

In the formula, R¹, R², R⁴, R⁵, R⁶, R⁷, R⁹ and R¹⁰ independently represent a hydrogen atom or substituent. R⁸ represents a hydrogen atom, alkyl group containing 1 through 4 carbon atoms, alkynyl group containing 2 through 12 carbon atoms, aryl group containing 6 through 12 carbon atoms, alkoxy group containing 1 through 12 carbon atoms, aryloxy group containing 6 through 12 carbon atoms, alkoxy carbonyl group containing 2 through 12 carbon atoms, acyl amino group containing 2 through 12 carbon atoms, cyano group, carbonyl group or halogen atom. R¹¹ denotes an alkyl group containing 1 through 12 carbon atoms.

In Formula (13-A), R¹, R², R⁴, R⁵, R⁶, R⁷, R⁸, R⁹ and R¹⁰ each are synonymous with those in the Formula (13). Their preferred ranges are also the same.

In Formula (13-A), R¹¹ denotes an alkyl group containing 1 through 12 carbon atoms. The alkyl group represented by R¹¹ can be either a straight chain or branched chain group. Further, it may contain a substituent. R¹¹ is preferably an alkyl group containing 1 through 12 carbon atoms, more preferably alkyl group containing 1 through 8 carbon atoms, still more preferably alkyl group containing 1 through 6 carbon atoms, particularly alkyl group containing 1 through 4 carbon atoms (exemplified by a methyl group, ethyl group, n-propyl group, iso-propyl group, n-butyl group, iso-butyl group and tert-butyl group).

In Formula (13), the following Formula (13-B) is more preferred:

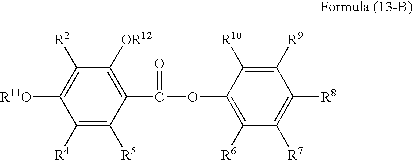

In the formula, R², R⁴, R⁵, R⁶, R⁷, R⁹ and R¹⁰ independently represent a hydrogen atom or substituent. R⁸ denotes a hydrogen atom, alkyl group containing 1 through 4 carbon atoms, alkynyl group containing 2 through 12 carbon atoms, aryl group containing 6 through 12 carbon atoms, alkoxy group containing 1 through 12 carbon atoms, aryloxy group containing 6 through 12 carbon atoms, alkoxy carbonyl group containing 2 through 12 carbon atoms, acyl amino group containing 2 through 12 carbon atoms, cyano group, carbonyl group or halogen atom. R¹¹ indicates an alkyl group containing 1 through 12 carbon atoms. R¹² shows a hydrogen atom or alkyl group containing 1 through 4 carbon atoms.

In Formula (13-B), R², R⁴, R⁵, R⁶, R⁷, R⁷, R⁸, R¹⁰ and R¹¹ are synonymous with those in the Formula (13-A). Their preferred ranges are also the same.

In Formula (13-B), R¹² shows a hydrogen atom or alkyl group containing 1 through 4 carbon atoms, preferably hydrogen atom or alkyl group containing 1 through 3 carbon atoms, more preferably a hydrogen atom, methyl group and ethyl group, still more preferably a hydrogen atom or methyl group, particularly methyl group.

In Formula (13-B), the following Formula (14) or (13-C) is more preferred.

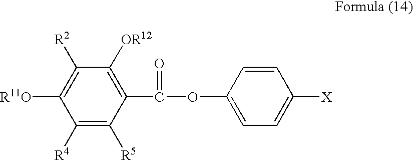

In the formula, R², R⁴, R⁵, R¹¹ and R¹² are synonymous with those in Formula (13-B). Their preferred ranges are also the same. X denotes an alkynyl group containing 2 through 7 carbon atoms, aryl group containing 6 through 12 carbon atoms, alkoxy carbonyl group containing 2 through 6 carbon atoms, acyl amino group containing 2 through 7 carbon atoms or cyano group.

In Formula (14), X denotes an alkynyl group containing 2 through 7 carbon atoms, aryl group containing 6 through 12 carbon atoms, alkoxy carbonyl group containing 2 through 6 carbon atoms, acyl amino group containing 2 through 7 carbon atoms and cyano group; preferably a phenylethyl group, phenyl group, p-cyanophenyl group, p-methoxyphenyl group, benzoylamino group, alkoxy carbonyl group containing 2 through 4 carbon atoms and cyano group; more preferably a phenyl group, p-cyano phenyl group, p-methoxy phenyl group, alkoxy carbonyl group containing 2 through 4 carbon atoms or cyano group.

The following describes Formula (13-C).

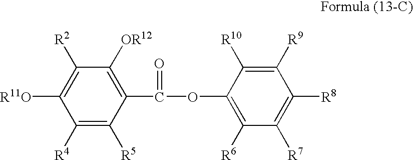

In the formula, R², R⁴ and R⁵ are synonymous with those in Formula (13-B). Their preferred ranges are also the same. However, one of them pertains to a group represented by —OR¹³ (wherein R¹³ denotes an alkyl group containing 1 through 4 carbon atoms). R⁶, R⁷, R⁸, R⁹, R¹⁰, R¹¹ and R¹² are synonymous with those in Formula (13-B). Their preferred ranges are also the same.

In Formula (13-C), R², R⁴ and R⁵ are synonymous with those in Formula (13-B). Their preferred ranges are also the same. However, one of them is a group represented by —OR¹³ (wherein R¹³ denotes an alkyl group containing 1 through 4 carbon atoms), preferably a group wherein R⁴ and R⁵ are represented by —OR¹³, more preferably a group wherein R⁴ is represented by —OR¹³.

R¹³ represents an alkyl group containing 1 through 4 carbon atoms, preferably an alkyl group containing 1 through 3 carbon atoms, more preferably an ethyl group and methyl group, still more preferably a methyl group.

In Formula (13-C), the following Formula (13-D) is more preferred.

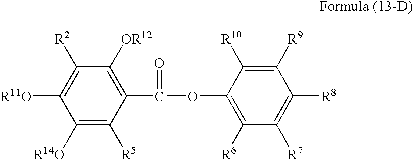

In the formula, R², R⁵, R⁶, R⁷, R⁸, R⁹, R¹⁰, R¹¹ and R¹² are synonymous with those in the Formula (13-C). Their preferred ranges are also the same. R¹⁴ represents an alkyl group containing 1 through 4 carbon atoms.

R¹⁴ is an alkyl group containing 1 through 4 carbon atoms, preferably an alkyl group containing 1 through 3 carbon atoms, more preferably ethyl group and methyl group, still more preferably a methyl group.

In Formula (13-D), the following Formula (13-E) is more preferred:

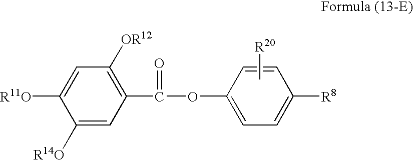

In the formula, R⁸, R¹¹, R¹² and R¹⁴ are synonymous with those in Formula (13-D). Their preferred ranges are also the same. R²⁰ indicates a hydrogen atom or substituent.

R²⁰ represents a hydrogen atom or substituent. The substituent T to be described later can be used as a substituent. The R²⁰ can be replaced at any position of the benzene ring directly connected thereto, but R²⁰ does not occur in the plural. R²⁰ preferably represents a substituent wherein the number of the constituent atoms except for hydrogen from the number of all atoms of the hydrogen atom or substituent does not exceed 4. More preferably it represents a substituent wherein the number of the constituent atoms except for hydrogen from the number of all atoms of the hydrogen atom or substituent does not exceed 3. Still more preferably it represents a substituent wherein the number of the constituent atoms except for hydrogen from the number of all atoms of the hydrogen atom or substituent does not exceed 2. It is particularly preferred that it should represent a hydrogen atom, methyl group, methoxy group, halogen atom, formyl group and cyano group. Of these, a hydrogen atom is used in particular preference.

The following describes the aforementioned substituent T:

The aforementioned substituent T is exemplified by followings:

an alkyl group (preferably containing 1 through 20 carbon atoms, more preferably containing 1 through 12 carbon atoms, particularly containing 1 through 8 carbon atoms, wherein methyl, ethyl, iso-propyl, tert-butyl, n-octyl, n-decyl, n-hexadecyl, cyclopropyl, cyclopentyl and cyclohexyl can be mentioned as specific examples); an alkenyl group (preferably containing 2 through 20 carbon atoms, more preferably containing 2 through 12 carbon atoms, particularly containing 2 through 8 carbon atoms, wherein vinyl, allyl, 2-butenyl and 3-pentenyl can be mentioned as specific examples); an alkynyl group (preferably containing 2 through 20 carbon atoms, more preferably containing 2 through 12 carbon atoms, particularly containing 2 through 8 carbon atoms, wherein propargyl and 3-pentynyl can be mentioned as specific examples); an aryl group (preferably containing 6 through 30 carbon atoms, more preferably containing 6 through 20 carbon atoms, particularly containing 6 through 12 carbon atoms, wherein phenyl, p-methylphenyl and naphthyl can be mentioned as specific examples); a substituted or unsubstituted amino group (preferably containing 0 through 20 carbon atoms, more preferably containing 0 through 10 carbon atoms, particularly containing 0 through 6 carbon atoms, wherein amino, methylamino, dimethyl amino, diethyl amino and dibenzylamino can be mentioned as specific examples); an alkoxy group (preferably containing 1 through 20 carbon atoms, more preferably containing 1 through 12 carbon atoms, particularly containing 1 through 8 carbon atoms, wherein methoxy, ethoxy and butoxy can be mentioned as specific examples); an aryloxy group (preferably containing 6 through 20 carbon atoms, more preferably containing 6 through 16 carbon atoms, particularly containing 6 through 12 carbon atoms, wherein phenyloxy and 2-naphthyloxy can be mentioned as specific examples); an acyl group (preferably containing 1 through 20 carbon atoms, more preferably containing 1 through 16 carbon atoms, particularly containing 1 through 12 carbon atoms, wherein acetyl, benzoyl, formyl and pivaloyl can be mentioned as specific examples); an alkoxy carbonyl group (preferably containing 2 through 20 carbon atoms, more preferably containing 2 through 16 carbon atoms, particularly containing 2 through 12 carbon atoms, wherein methoxy carbonyl and ethoxy carbonyl can be mentioned as specific examples); an aryloxy carbonyl group (preferably containing 7 through 20 carbon atoms, more preferably containing 7 through 16 carbon atoms, particularly containing 7 through 10 carbon atoms, wherein phenyloxy carbonyl can be mentioned as specific examples); an acyloxy group (preferably containing 2 through 20 carbon atoms, more preferably containing 2 through 16 carbon atoms, particularly containing 2 through 10 carbon atoms, wherein acetoxy and benzoyloxy can be mentioned as specific examples); an acyl amino group (preferably containing 2 through 20 carbon atoms, more preferably containing 2 through 16 carbon atoms, particularly containing 2 through 10 carbon atoms wherein acetylamino and benzoylamino can be mentioned as specific examples); an alkoxy carbonyl amino group (preferably containing 2 through 20 carbon atoms, more preferably containing 2 through 16 carbon atoms, particularly containing 2 through 12 carbon atoms wherein methoxy carbonyl amino can be mentioned as specific examples); an aryloxy carbonyl amino group (preferably containing 7 through 20 carbon atoms, more preferably containing 7 through 16 carbon atoms, particularly containing 7 through 12 carbon atoms wherein phenyloxy carbonyl amino can be mentioned as specific examples); a sulfonyl amino group (preferably containing 1 through 20 carbon atoms, more preferably containing 1 through 16 carbon atoms, particularly containing 1 through 12 carbon atoms wherein methane sulfonylamino and benzenesulfonyl amino can be mentioned as specific examples); a sulfamoyl group (preferably containing 0 through 20 carbon atoms, more preferably containing 0 through 16 carbon atoms, particularly containing 0 through 12 carbon atoms wherein sulfamoyl, methylsulfamoyl, dimethyl sulfamoyl and phenyl sulfamoyl can be mentioned as specific examples); a carbamoyl group (preferably containing 1 through 20 carbon atoms, more preferably containing 1 through 16 carbon atoms, particularly containing 1 through 12 carbon atoms wherein carbamoyl, methylcarbamoyl, diethylcarbamoyl and phenyl carbamoyl can be mentioned as specific examples); an alkylthio group (preferably containing 1 through 20 carbon atoms, more preferably containing 1 through 16 carbon atoms, particularly containing 1 through 12 carbon atoms wherein methylthio and ethylthio can be mentioned as specific examples); an arylthio group (preferably containing 6 through 20 carbon atoms, more preferably containing 6 through 16 carbon atoms, particularly containing 6 through 12 carbon atoms wherein phenylthio can be mentioned as specific examples); a sulfonyl group (preferably containing 1 through 20 carbon atoms, more preferably containing 1 through 16 carbon atoms, particularly containing 1 through 12 carbon atoms wherein mesyl and tosyl can be mentioned as specific examples); a sulfinyl group (preferably containing 1 through 20 carbon atoms, more preferably containing 1 through 16 carbon atoms, particularly containing 1 through 12 carbon atoms wherein methane sulfinyl and benzenesulfinyl can be mentioned as specific examples); an ureido group (preferably containing 1 through 20 carbon atoms, more preferably containing 1 through 16 carbon atoms, particularly containing 1 through 12 carbon atoms wherein ureido, methylureido and phenyl ureido can be mentioned as specific examples); a phosphoramide group (preferably containing 1 through 20 carbon atoms, more preferably containing 1 through 16 carbon atoms, particularly containing 1 through 12 carbon atoms wherein diethyl phosphoramide, phenyl phosphoramide can be mentioned as specific examples); a hydroxy group; a mercapto group; a halogen atom (fluorine atom, chlorine atom, bromine atom and iodine atom can be mentioned as specific examples); a cyano group; a sulfo group; a carboxyl group; a nitro group; a hydroxamic acid group; a sulfino group; a hydrazino group; an imino group; a heterocyclic group (preferably containing 1 through 30 carbon atoms, more preferably containing 1 through 12 carbon atoms wherein the hetero atom is exemplified by a nitrogen atom, oxygen atom and sulfur atom, specifically by imidazolyl, pyridyl, quinolyl, furyl, piperidyl, morpholino, benzooxazolyl, benzimidazol and benzthiazolyl can be mentioned as specific examples); and a silyl group (preferably containing 3 through 40 carbon atoms, more preferably containing 3 through 30 carbon atoms, particularly containing 3 through 24 carbon atoms wherein trimethylsilyl and triphenylsilyl can be mentioned as specific examples).

Their substituents can be further replaced.

Two or more substituents, if any, can be the same or different from each other. Further, they may form a ring through mutual bondage wherever possible.

The following describes the specific examples of the compounds represented by Formula (12) without the present invention being restricted thereto.

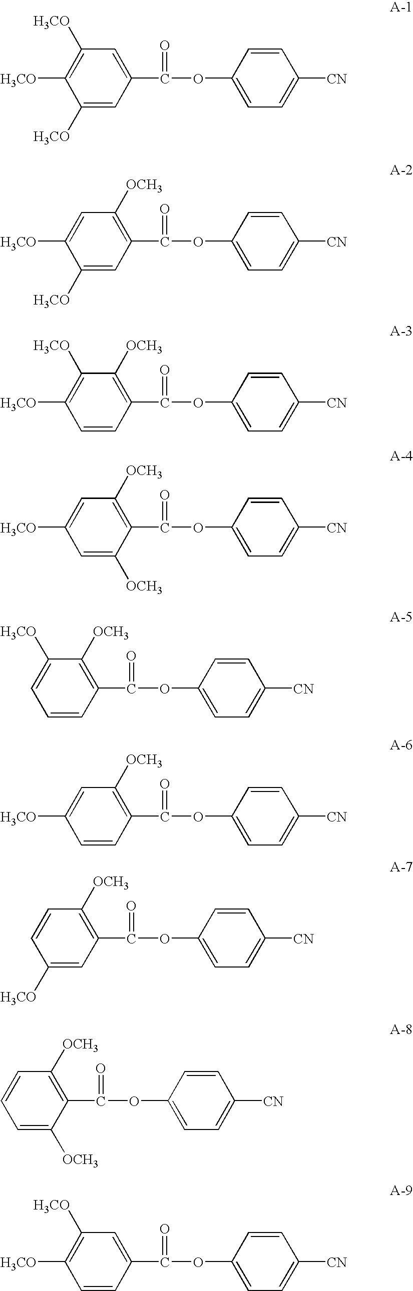

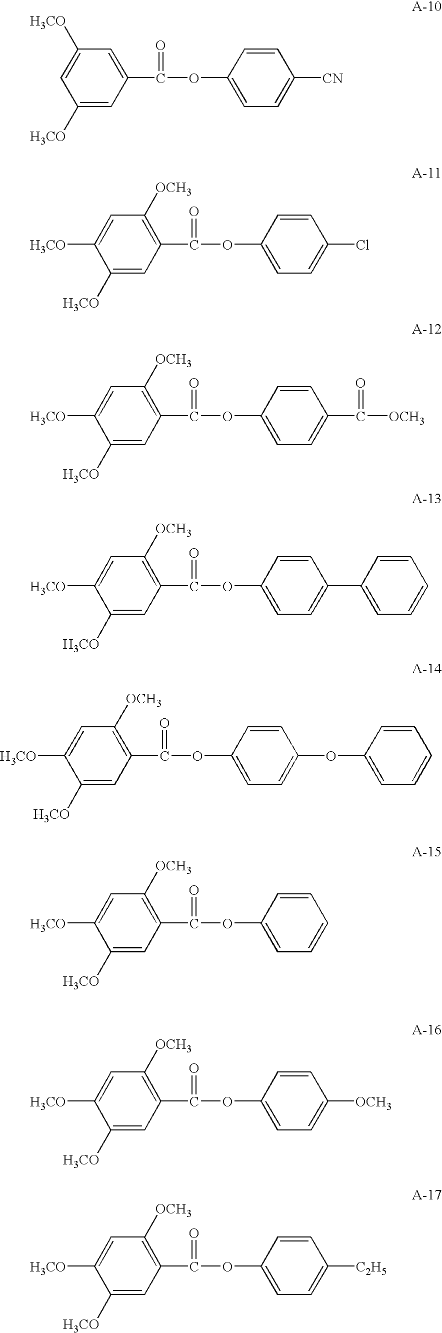

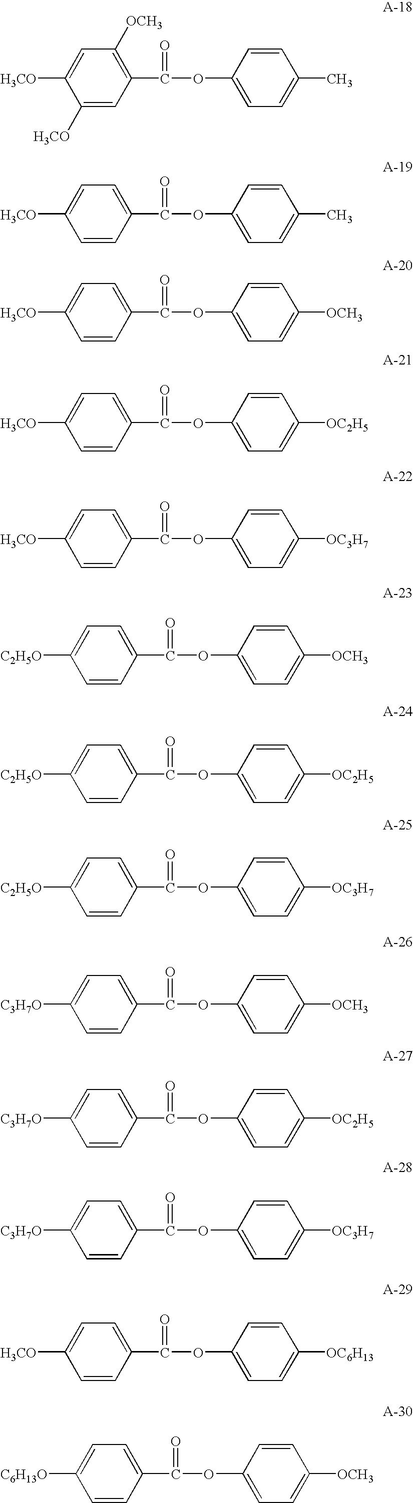

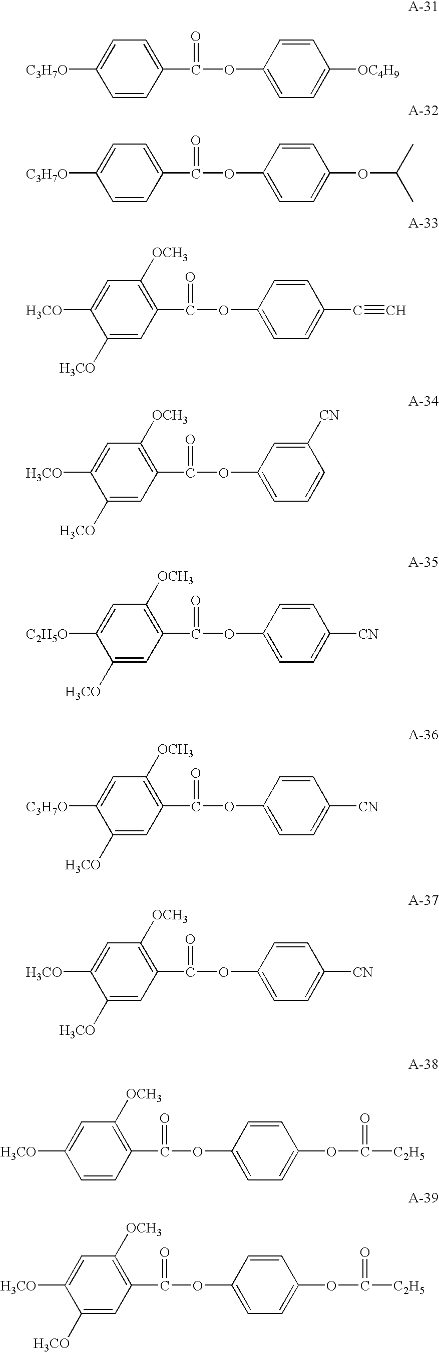

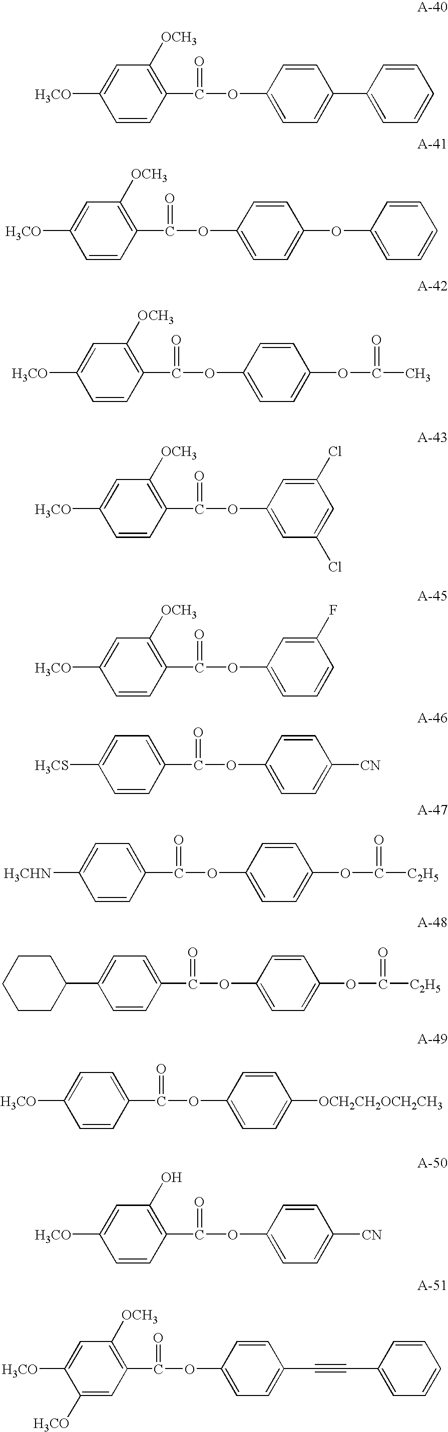

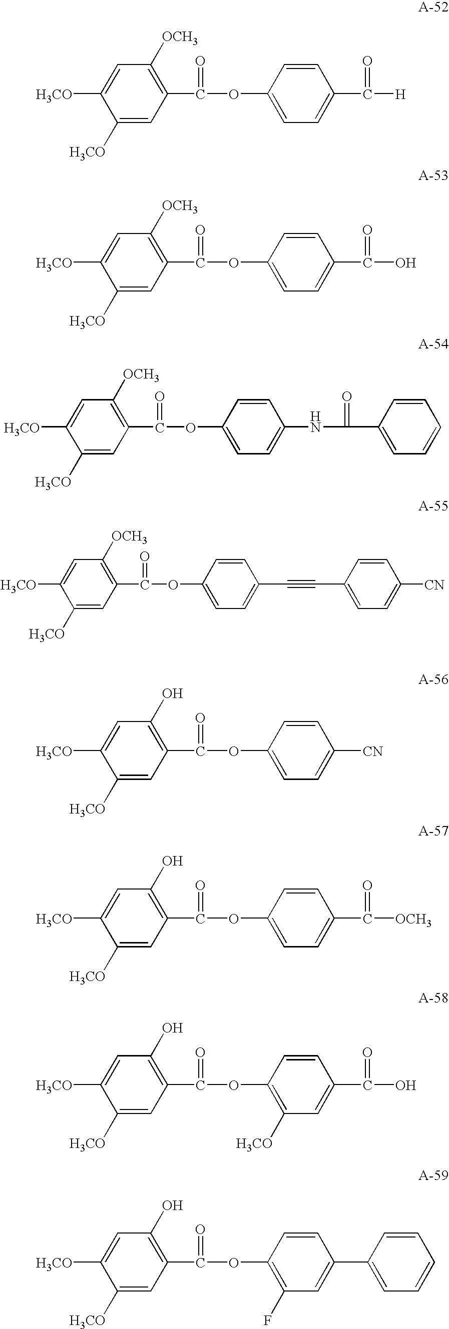

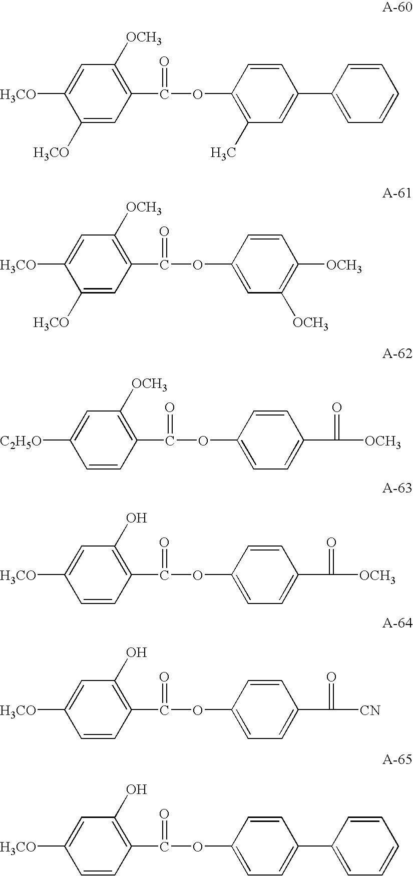

The compound expressed by Formula (12) can be synthesized by the general ether linkage reaction between a substituted benzoic acid and phenol derivative, wherein any form of reaction can be used if only the reaction forms an ester linkage. For example, it is possible to use the method for condensation with phenol subsequent to functional conversion of the substituted benzoic acid into an acid halide. Further, it is also possible to use the method for dehydration and condensation of the substituted benzoic acid and phenol derivative utilizing a condensing agent or catalyst.

When the manufacturing process is taken into account, it is preferred to use the method for condensation with phenol subsequent to functional conversion of the substituted benzoic acid into an acid halide.

A hydrocarbon solvent (preferably toluene and xylene), ether based solvent (preferably dimethyl ether, tetrahydrofuran, dioxane), ketone based solvent, ester based solvent, acetonitrile, dimethylformamide, and dimethylacetamide can be used as a reaction solvent. These solvents can be used independently or as a mixture. The reaction solvent is preferably exemplified by toluene, acetonitrile, dimethylformamide and dimethylacetamide.

The reaction temperature is preferably 0° C. through 150° C., more preferably 0° C. through 100° C., still more preferably 0° C. through 90° C., and particularly 20° C. through 90° C.

It is preferred in this reaction that a salt group should not be utilized. When the salt group is used, either an organic or inorganic salt group can be employed. However, the organic salt group is preferably used, and is exemplified by pyridine and tertiary alkylamine (preferably triethylamine and ethyl diisopropylamine).

The following describes a specific method of synthesizing the compound, without the present invention being restricted thereto:

### EXAMPLE OF SYNTHESIS 1

### Synthesis of Illustrated Compound A-1

After heating 24.6 g (0.116 mol) of 3,4,5-trimethoxybenzoic acid, 100 ml of toluene and 1 ml of N—N-dimethylformamide to 60° C., 15.2 g (0.127 mol) of thionyl chloride was slowly added dropwise, and this mixture was heated at 60° C. for two hours. Then 15.1 g (0.127 mol) of 4-cyanophenol dissolved previously into 50 ml of acetonitrile was slowly added dropwise into this solution. After that, the solution was heated and stirred at 60° C. for 3 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 100 ml of acetonitrile was added to the solid having been obtained, thereby recrystallizing the mixture. The acetonitrile solution was cooled down to the room temperature, and the crystal having been precipitated was recovered by filtration, whereby 11.0 g (yield 11%) of the target compound was obtained as a white crystal. In this case, the compound was identified by 1H-NMR (400 MHz) and mass spectrum.

1H-NMR (CDCl₃) δ3.50 (br, 9H), 7.37 (d, 2H), 7.45 (s, 2H), 7.77 (s, 2H),

Mass spectrum: m/z 314 (M+

The compound having been obtained has a melting point of 172° C. through 173° C.

### EXAMPLE OF SYNTHESIS 2

### Synthesis of Illustrated Compound A-2

After heating 106.1 g (0.5 mol) of 2,4,5-trimethoxybenzoic acid, 340 ml of toluene and 1 ml of dimethylformamide to 60° C., 65.4 g (0.55 mol) of thionyl chloride was slowly added dropwise, and this mixture was heated for 2 hours at 65° C. through 70° C. Then 71.5 g (0.6 mol) of 4-cyanophenol previously dissolved into 150 ml of acetonitrile was slowly added dropwise into this solution. After that, the solution was heated and stirred at 80° C. through 85° C. for 2 hours, and the reaction solution was cooled down to the room temperature. Then ethyl acetate (1 L) and water were used to perform liquid separation, and sodium sulfate was used to remove water from the organic phase having been obtained. Approximately 500 ml of solvent was distilled off under reduced pressure, and 1 L of methanol was added to the solid having been obtained, thereby recrystallizing the mixture. The crystal having been precipitated was recovered by filtration, whereby 125.4 g (yield 80%) of the target compound was obtained as a white crystal. In this case, the compound was identified by 1H-NMR (400 MHz) and mass spectrum.

1H-NMR (CDCl₃) δ3.91 (s, 3H), 3.93 (s, 3H), 3.98 (s, 3H), 6.59 (s, 1H), 7.35 (d, 2H), 7.58 (s, 1H), 7.74 (d, 2H),

Mass spectrum: m/z 314 (M+H)⁺,

The compound having been obtained has a melting point of 116° C.

### EXAMPLE OF SYNTHESIS 3

### Synthesis of Illustrated Compound A-3

After heating 10.1 g (47.5 mM) of 2,3,4-trimethoxybenzoic acid, 40 ml of toluene and 0.5 ml of dimethylformamide to 80° C., 6.22 g (52.3 mM) of thionyl chloride was slowly added dropwise, and this mixture was heated and stirred for 2 hours at 80° C. Then 6.2 g (52.3 mM) of 4-cyanophenol previously dissolved into 20 ml of acetonitrile was slowly added dropwise into this solution. After that, the solution was heated and stirred at 80° C. through 85° C. for 2 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 50 ml of methanol was added, thereby recrystallizing the mixture. The crystal having been precipitated was recovered by filtration, whereby 11.9 g (yield 80%) of the target compound was obtained as a white crystal. In this case, the compound was identified by 1H-NMR (400 MHz) and mass spectrum.

1H-NMR (CDCl₃): δ3.50 (br, 9H), 7.37 (d, 2H), 7.45 (s, 2H), 7.77 (s, 2H),

Mass spectrum: m/z 314 (M+H)⁺,

The compound having been obtained has a melting point of 102° C. through 103° C.

### EXAMPLE OF SYNTHESIS 4

### Synthesis of Illustrated Compound A-4

After heating 25.0 g (118 mM) of 2,4,6-trimethoxybenzoic acid, 100 ml of toluene and 1 ml of dimethylformamide to 60° C., 15.4 g (129 mM) of thionyl chloride was slowly added dropwise, and this mixture was heated and stirred for 2 hours at 60° C. Then 15.4 g (129 mM) of 4-cyanophenol previously dissolved into 50 ml of acetonitrile was slowly added dropwise into this solution. After that, the solution was heated and stirred at 80° C. through 85° C. for 4.5 hours, and the reaction solution was cooled down to the room temperature. Then ethyl acetate and water were used to perform liquid separation, and sodium sulfate was used to remove water from the organic phase having been obtained. The solvent was distilled off under reduced pressure, and 500 mL of methanol and 100 ml of acetonitrile were added, thereby recrystallizing the mixture. The crystal having been precipitated was recovered by filtration, whereby 10.0 g (yield 27%) of the target compound was obtained as a white crystal. In this case, the compound was identified by mass spectrum.

Mass spectrum: m/z 314 (M+H)⁺,

The compound having been obtained has a melting point of 172° C. through 173° C.

### EXAMPLE OF SYNTHESIS 5

### Synthesis of Illustrated Compound A-5

After heating 15.0 g (82.3 mM) of 2,3-dimethoxybenzoic acid, 60 ml of toluene and 0.5 ml of dimethylformamide to 60° C., thionyl chloride 10.7 (90.5 mM) was slowly added dropwise, and this mixture was heated and stirred for 2 hours at 60° C. Then 10.8 g (90.5 mM) of 4-cyanophenol previously dissolved into 30 ml of acetonitrile was slowly added dropwise into this solution. After that, the solution was heated and stirred at 70° C. through 80° C. for 7 hours, and the reaction solution was cooled down to the room temperature. Then 90 ml of isopropyl alcohol was added, and the crystal having been precipitated was recovered by filtration, whereby 12.3 g (yield 53%) of the target compound was obtained as a white crystal. In this case, the compound was identified by mass spectrum.

Mass spectrum: m/z 284 (M+H)⁺,

The compound having been obtained has a melting point of 104° C.

### EXAMPLE OF SYNTHESIS 6

### Synthesis of Illustrated Compound A-6

The compound A-6 was synthesized according to the same procedure as that in the Example of synthesis 5, except that 2,3-dimethoxybenzoic acid of the Example of synthesis 5 was replaced by 2,4-dimethoxybenzoic acid. The compound was identified by mass spectrum.

Mass spectrum: m/z 284 (M+H)⁺,

The compound having been obtained has a melting point of 134° C. through 136° C.

### EXAMPLE OF SYNTHESIS 7

### Synthesis of Illustrated Compound A-7

After heating 25.0 g (137 mM) of 2,5-dimethoxybenzoic acid, 100 ml of toluene and 1.0 ml of dimethylformamide to 60° C., 18.0 (151 mM) of thionyl chloride was slowly added dropwise, and this mixture was heated and stirred for 2 hours at 60° C. Then 18.0 g (151 mM) of 4-cyanophenol previously dissolved in 50 ml of acetonitrile was slowly added dropwise into this solution. After that, the solution was heated and stirred at 70° C. through 80° C. for 7.5 hours, and the reaction solution was cooled down to the room temperature. Then ethyl acetate and saturated saline solution were used to perform liquid separation, and sodium sulfate was used to remove water from the organic phase having been obtained. The solvent was distilled off under reduced pressure, and silica gel column chromatography (hexane-ethyl acetate (9/1, V/V)) was used for purification, whereby 18.8 g (yield 48%) of the target compound was obtained as a white crystal. In this case, the compound was identified by mass spectrum.

Mass spectrum: m/z 284 (M+H)⁺,

The compound having been obtained has a melting point of 79° C. through 80° C.

### EXAMPLE OF SYNTHESIS 8

### Synthesis of Illustrated Compound A-8

The compound A-8 was synthesized according to the same procedure as that in the Example of synthesis 5, except that 2,3-dimethoxybenzoic acid of the Example of synthesis 5 was replaced by 2,6-dimethoxybenzoic acid. The compound was identified by mass spectrum.

Mass spectrum: m/z 284 (M+H)⁺,

The compound having been obtained has a melting point of 130° C. through 131° C.

### EXAMPLE OF SYNTHESIS 9

### Synthesis of Illustrated Compound A-11

The compound A-11 was synthesized according to the same procedure as that in the Example of synthesis 2, except that 71.5 g of 4-cyanophenol of the Example of synthesis 2 was replaced by 76.9 g of 4-chlorophenol. The compound was identified by 1H-NMR (400 MHz) and mass spectrum.

1H-NMR (CDCl₃) δ3.90 (s, 3H), 3.94 (s, 3H), 3.99 (s, 3H), 6.58 (s, 1H), 7.15 (d, 2H), 7.37 (d, 2H), 7.56 (s, 1H),

Mass spectrum: m/z 323 (M+H)⁺,

The compound having been obtained has a melting point of 127° C. through 129° C.

### EXAMPLE OF SYNTHESIS 10

### Synthesis of Illustrated Compound A-121

After heating 45.0 g (212 mM) of 2,4,5-trimethoxybenzoic acid, 180 ml of toluene and 1.8 ml of dimethylformamide to 60° C., 27.8 g (233 mM) of thionyl chloride was slowly added dropwise, and this mixture was heated and stirred for 2.5 hours at 60° C. Then 35.4 g (233 mM) of methyl 4-hydroxybenzoate previously dissolved in 27 ml of dimethylformamide was slowly added dropwise into this solution. After that, the solution was heated and stirred at 80° C. for 3 hours, and the reaction solution was cooled down to the room temperature. Then 270 ml of methanol was added, and the crystal having been precipitated was recovered by filtration, whereby 64.5 g (yield 88%) of the target compound was obtained as a white crystal. In this case, the compound was identified by 1H-NMR (400 MHz) and mass spectrum.

1H-NMR (CDCl₃) δ3.95 (m, 9H), 3.99 (s, 3H), 6.57 (s, 1H), 7.28 (d, 2H), 7.57 (s, 1H) 8.11 (d, 2H),

Mass spectrum: m/z 347 (M+H)⁺,

The compound having been obtained has a melting point of 121° C. through 123° C.

### EXAMPLE OF SYNTHESIS 11

### Synthesis of Illustrated Compound A-133

After heating 20.0 g (94.3 mM) of 2,4,5-trimethoxybenzoic acid, 100 ml of toluene and 1 ml of dimethylformamide to 60° C., 12.3 g (104 mM) of thionyl chloride was slowly added dropwise, and this mixture was heated and stirred for 3.5 hours at 60° C. Then 17.7 g (104 mM) of 4-phenyl phenol previously dissolved in 150 ml of toluene was slowly added dropwise into this solution. After that, the solution was heated and stirred at 80° C. for 3 hours, and the reaction solution was cooled down to the room temperature. Then 250 ml of methanol was added, and the crystal having been precipitated was recovered by filtration, whereby 21.2 g (yield 62%) of the target compound was obtained as a white crystal. In this case, the compound was identified by 1H-NMR (400 MHz) and mass spectrum.

1H-NMR (CDCl₃) δ3.93 (s, 3H), 3.96 (s, 3H), 3.99 (s, 3H), 6.59 (s, 1H), 7.26-7.75 (m, 10H),

Mass spectrum: m/z 365 (M+H)⁺,

The compound having been obtained has a melting point of 131° C. through 132° C.

### EXAMPLE OF SYNTHESIS 12

### Synthesis of Illustrated Compound A-14

After heating 12.9 g (61 mM) of 2,4,5-trimethoxybenzoic acid, 50 ml of toluene and 0.6 ml of dimethylformamide to 60° C., 8.0 g (67 mM) of thionyl chloride was slowly added dropwise, and this mixture was heated and stirred for 3.5 hours at 60° C. Then 17.7 g (104 mM) of 4-phenoxyphenol previously dissolved in 25 ml of acetonitrile was slowly added dropwise into this solution. After that, the solution was heated and stirred at 80° C. for 3 hours, and the reaction solution was cooled down to the room temperature. Then 100 ml of methanol was added, and the crystal having been precipitated was recovered by filtration, whereby 21.6 g (yield 93%) of the target compound was obtained as a white crystal. In this case, the compound was identified by mass spectrum.

Mass spectrum: m/z 381 (M+H)⁺,

The compound having been obtained has a melting point of 91° C. through 92° C.

### EXAMPLE OF SYNTHESIS 13

### Synthesis of Illustrated Compound A-15

The compound A-15 was synthesized according to the same procedure as that in the Example of synthesis 2, except that 71.5 g of 4-cyanophenol of the Example of synthesis 2 was replaced by 56.4 g of phenol. The compound was identified by 1H-NMR (400 MHz) and mass spectrum.

1H-NMR (CDCl₃) δ3.91 (s, 3H), 3.93 (s, 3H), 3.99 (s, 3H), 6.58 (s, 1H), 7.19-7.27 (m, 3H), 7.42 (m, 2H), 7.58 (s, 1H)

Mass spectrum: m/z 289 (M+H)⁺,

The compound having been obtained has a melting point of 105° C. through 108° C.

### EXAMPLE OF SYNTHESIS 14

### Synthesis of Illustrated Compound A-161

The compound A-16 was synthesized according to the same procedure as that in the Example of synthesis 2, except that 71.5 g of 4-cyanophenol of the Example of synthesis 2 was replaced by 74.4 g of 4-methoxy phenol. In this case, the compound was identified by 1H-NMR (400 MHz) and mass spectrum.

1H-NMR (CDCl₃) δ3.84 (s, 3H), 3.92 (s, 3H), 3.93 (s, 3H), 3.99 (s, 3H), 6.58 (s, 1H), 6.92 (d, 2H), 7.12 (d, 2H), 7.42 (m, 2H), 7.58 (s, 1H),

Mass spectrum: m/z 319 (M+H)⁺,

The compound having been obtained has a melting point of 102° C. through 103° C.

### EXAMPLE OF SYNTHESIS 15

### Synthesis of Illustrated Compound A-17

The compound A-17 was synthesized according to the same procedure as that in the Example of synthesis 2, except that 71.5 g of 4-cyanophenol of the Example of synthesis 2 was replaced by 73.3 g of 4-ethyl phenol. The compound was identified by 1H-NMR (400 MHz) and mass spectrum.

Mass spectrum: m/z 317 (M+H)⁺,

The compound having been obtained has a melting point of 70° C. through 71° C.

### EXAMPLE OF SYNTHESIS 16

### Synthesis of Illustrated Compound A-24

After heating 27.3 g (164 mM) of 4-ethoxybenzoic acid, 108 ml of toluene and 1 ml of dimethylformamide to 60° C., 21.5 g (181 mM) of thionyl chloride was slowly added dropwise, and this mixture was heated and stirred for 2 hours at 60° C. Then 25.0 g (181 mM) of 4-ethoxy phenol previously dissolved into 50 ml of acetonitrile was slowly added dropwise into this solution. After that, the solution was heated and stirred at 80° C. for 4 hours, and the reaction solution was cooled down to the room temperature. Then 100 ml of methanol was added, and the crystal having been precipitated was recovered by filtration, whereby 30.6 g (yield 65%) of the target compound was obtained as a white crystal. In this case, the compound was identified by 1H-NMR (400 MHz) and mass spectrum.

1H-NMR (CDCl₃) δ1.48-1.59 (m, 6H), 4.05 (q, 2H), 4.10 (q, 2H), 6.89-7.00 (m, 4H), 7.10 (d, 2H), 8.12 (d, 2H),

Mass spectrum: m/z 287 (M+H)⁺,

The compound having been obtained has a melting point of 113° C. through 114° C.

### EXAMPLE OF SYNTHESIS 17

### Synthesis of Illustrated Compound A-25

After heating 24.7 g (149 mM) of 4-ethoxybenzoic acid, 100 ml of toluene and 1 ml of dimethylformamide to 60° C., 19.5 g (164 mM) of thionyl chloride was slowly added dropwise, and this mixture was heated and stirred for 2 hours at 60° C. Then 25.0 g (165 mM) 4-propoxy phenol previously dissolved into 50 ml of acetonitrile was slowly added dropwise into this solution. After that, the solution was heated and stirred at 80° C. for 4 hours, and the reaction solution was cooled down to the room temperature. Then 100 ml of methanol was added, and the crystal having been precipitated was recovered by filtration. 100 ml of acetonitrile was added to the solid having been obtained, thereby recrystallizing the mixture. The crystal having been obtained was recovered by filtration, whereby 33.9 g (yield 76%) of the target compound was obtained as a white crystal. In this case, the compound was identified by 1H-NMR (400 MHz) and mass spectrum.

1H-NMR (CDCl₃) δ1.04 (t, 3H), 1.45 (t, 3H), 1.82 (q, 2H), 3.93 (q, 2H), 4.04 (q, 2H), 6.89-7.00 (m, 4H), 7.10 (d, 2H), 8.12 (d, 2H), mass spectrum: m/z 301 (M+H)⁺,

The compound having been obtained has a melting point of 107° C.

### EXAMPLE OF SYNTHESIS 18

### Synthesis of Illustrated Compound A-27

The compound A-27 was synthesized according to the same procedure as that in the Example of synthesis 16 (Synthesis of A-24), except that 27.3 g of 4-ethoxybenzoic acid of the Example of synthesis 1 was replaced by 29.5 g of 4-propoxybenzoic acid. In this case, the compound was identified by mass spectrum.

Mass spectrum: m/z 301 (M+H)⁺,

The compound having been obtained has a melting point of 88° C. through 89° C.

### EXAMPLE OF SYNTHESIS 19

### Synthesis of Illustrated Compound A-28

The compound A-28 was synthesized according to the same procedure as that in the Example of synthesis 17 (Synthesis of A-25), except that 24.7 g of 4-ethoxybenzoic acid of the Example of synthesis 1 was replaced by 26.8 g of 4-propoxybenzoic acid. In this case, the compound was identified by mass spectrum.

Mass spectrum: m/z 315 (M+H)⁺,

The compound having been obtained has a melting point of 92° C.

### EXAMPLE OF SYNTHESIS 20

### Synthesis of Illustrated Compound A-40

After heating 20.0 g (109 mM) of 2,4-dimethoxybenzoic acid, 80 ml of toluene and 0.8 ml of dimethylformamide to 60° C., 14.4 g (121 mM) of thionyl chloride was slowly added dropwise, and this mixture was heated and stirred for 3.5 hours at 60° C. Then 20.5 g (121 mM) of 4-phenyl phenol previously dissolved into 50 ml of dimethylformamide was slowly added dropwise into this solution. After that, the solution was heated and stirred at 80° C. for 6 hours, and the reaction solution was cooled down to the room temperature. Then 100 ml of methanol was added, and the crystal having been precipitated was recovered by filtration, whereby 31.7 g (yield 86%) of the target compound was obtained as a white crystal. In this case, the compound was identified by mass spectrum.

Mass spectrum: m/z 335 (M+H)⁺,

The compound having been obtained has a melting point of 161° C. through 162° C.

### EXAMPLE OF SYNTHESIS 21

### Synthesis of Illustrated Compound A-42

After heating 30.0 g (165 mM) of 2,4-dimethoxybenzoic acid, 120 ml of toluene and 1.2 ml of dimethylformamide to 60° C., 21.6 g (181 mM) of thionyl chloride was slowly added dropwise, and this mixture was heated and stirred for 2 hours at 60° C. Then 27.6 g (181 mM) of methyl 4-hydroxybenzoate previously dissolved into 40 ml of dimethylformamide was slowly added dropwise into this solution. After that, the solution was heated and stirred at 80° C. for 6 hours, and the reaction solution was cooled down to the room temperature. Then 140 ml of methanol was added, and the crystal having been precipitated was recovered by filtration, whereby 24.4 g (yield 47%) of the target compound was obtained as a white crystal. In this case, the compound was identified by 1H-NMR (400 MHz) and mass spectrum.

Mass spectrum: m/z 317 (M+H)⁺,

The compound having been obtained has a melting point of 122° C. through 123° C.

### EXAMPLE OF SYNTHESIS 22

### Synthesis of Illustrated Compound A-51

20.7 g (50 mM) of 2,4,5-trimethoxybenzoic acid 4-iodophenyl, 5.61 g (55 mM) of ethynyl benzene, 27.8 ml (200 mM) of triethylamine and 40 ml of tetrahydrofuran was stirred in an atmosphere of nitrogen at the room temperature, and 114 mg (0.6 mM) of cuprous chloride, 655 mg (2.5 mM) of triphenyl phosphine and 351 mg (0.5 mM) of bis(triphenyl phosphine) palladium dichloride were added to this mixture. The mixture was heated and stirred at 60° C. for 6 hours. After that, the reaction solution was cooled down to the room temperature, and 400 ml of water was added. The crystal having been obtained was filtered, and 160 ml of methanol 160 ml was added for recrystallization, whereby 17.2 g (yield 89%) of the target compound was obtained as a yellowish white crystal.

In this case, the compound was identified by 1H-NMR (400 MHz) and mass spectrum.

1H-NMR (CDCl₃) δ3.92 (s, 3H), 3.95 (s, 3H) 4.00 (s, 3H) 6.58 (s, 1H), 7.22 (m, 2H), 7.32 (m, 3H), 7.53-7.62 (m, 5H),

Mass spectrum: m/z 389 (M+H)⁺,

The compound having been obtained has a melting point of 129° C. through 130° C.

### EXAMPLE OF SYNTHESIS 23

### Synthesis of Illustrated Compound A-52

After heating 42.4 g (0.2 mol) of 2,4,5-trimethoxybenzoic acid, 26.8 g (0.22 mol) of 4-hydroxybenzaldehyde, 170 ml of toluene and 1.7 ml of N,N-dimethylformamide to 80° C., 26.0 g (0.22 mol) of thionyl, chloride was slowly added dropwise. The mixture was heated at 80° C. for 6 hours, and the reaction solution was cooled down to the room temperature. After that, ethyl acetate, water and saturated saline solution were added for liquid separation. Water was removed from the organic phase having been obtained by sodium sulfate. After that, the solvent was distilled off under reduced pressure. 240 ml of isopropyl alcohol was added to the solid having been obtained, thereby recrystallizing the mixture. The solution was cooled down to the room temperature and the crystal having been obtained was recovered by filtration, whereby 40.8 g (yield 65%) of the target compound was obtained as a white crystal. In this case, the compound was identified by 1H-NMR (400 MHz) and mass spectrum.

1H-NMR (CDCl₃) δ3.92 (s, 3H), 3.95 (s, 3H) 4.00 (s, 3H), 6.58 (s, 1H), 7.34 (d, 2H), 7.59 (s, 1H), 8.17 (d, 2H),

Mass spectrum: m/z 317 (M+H)⁺,

The compound having been obtained has a melting point of 103° C. through 105° C.

### EXAMPLE OF SYNTHESIS 24

### Synthesis of Illustrated Compound A-53

After adding 3.93 g (25.2 mM) of sodium dihydrogen phosphate dissolved in 5 ml of water was added dropwise into 40 g (126 mM) of 2,4,5-trimethoxybenzoic acid 4-formyl phenyl and 400 ml of acetonitrile, 18.3 g of 35% hydrogen peroxide solution was added to the mixture dropwise for 20 minutes. This was followed by the step of adding 14.1 g (126 mM) of 80% sodium chlorite (by Wako Junyaku Co., Ltd.) dissolved in 43 ml of water for 20 minutes, and stirring the mixture for 4.5 hours at the room temperature. After that, 100 ml of water was added and the mixture was cooled down to 10° C. The crystal having been obtained was filtered out and was recrystallized by addition of 500 ml of methanol, whereby 25.4 g (yield 60%) of the target compound was obtained as a white crystal.

The compound was identified by 1H-NMR (400 MHz) and mass spectrum.

1H-NMR (CDCl₃) δ3.92 (s, 3H), 3.95 (s, 3H) 4.00 (s, 3H), 6.59 (s, 1H), 7.40 (d, 2H), 7.57 (s, 1H), 7.96 (d, 2H), 10.0 (s, 1H),

Mass spectrum: m/z 333 (M+H)⁺,

The compound having been obtained has a melting point of 188° C. through 189° C.

### EXAMPLE OF SYNTHESIS 25

### Synthesis of Illustrated Compound A-54

After heating 5.00 g (23.5 mM) of 2,4,5-trimethoxybenzoic acid, 5.52 g (23.5 mM) of benzoic acid (4-hydroxy)-anilide, 50 ml of acetonitrile and 1.0 ml of N,N-dimethylformamide to 70° C., 3.4 g (28.5 mM) of thionyl chloride was slowly added, and the mixture was heated at 70° C. for 3 hours. The reaction solution was cooled down to the room temperature, and 50 ml of methanol was added thereafter. The crystal having been precipitated was recovered by filtration, whereby 8.1 g (yield 84%) of the target compound was obtained as a white crystal. In this case, the compound was identified by 1H-NMR (400 MHz) and mass spectrum.

1H-NMR (CDCl₃) δ3.92 (s, 3H), 3.95 (s, 3H) 4.00 (s, 3H), 6.60 (s, 1H), 7.12-8.10 (m, 10H),

Mass spectrum: m/z 408 (M+H)⁺,

The compound having been obtained has a melting point of 189° C. through 190° C.

### EXAMPLE OF SYNTHESIS 26

### Synthesis of Illustrated Compound A-56

After heating 8.50 g (42.8 mM) of 2-hydroxy-4,5-dimethoxybenzoic acid, 5.62 g (42.8 mM) of 4-cyanophenol, 45 ml of toluene and 0.5 ml of N,N-dimethylformamide to 70° C., 5.6 g (47.1 mM) of thionyl chloride was slowly added dropwise, and this mixture was heated and stirred for 3 hours at 80° C. The reaction solution was cooled down to the room temperature. Then 50 ml of methanol was added, and the crystal having been precipitated was recovered by filtration, whereby 5.8 g (yield 45%) of the target compound was obtained as a white crystal. In this case, the compound was identified by 1H-NMR (400 MHz).

1H-NMR (CDCl₃) δ3.92 (s, 3H), 3.97 (s, 3H), 6.67 (s, 1H), 7.38 (m, 3H), 7.77 (d, 2H), 10.28 (s, 1H),

Mass spectrum: m/z 333 (M+H)⁺,

The compound having been obtained has a melting point of 145° C. through 146° C.

### EXAMPLE OF SYNTHESIS 27

### Synthesis of Illustrated Compound A-57

After heating 8.50 g (42.8 mM) of 2-hydroxy-4,5-dimethoxybenzoic acid, 7.17 g (42.8 mM) of methyl 4-hydroxybenzoate, 45 ml of toluene and 0.5 ml of N,N-dimethylformamide to 70° C., 6.1 g (51.2 mM) of thionyl chloride was slowly added dropwise, and this mixture was heated and stirred for 3 hours at 80° C. Then the reaction solution was cooled down to the room temperature. Thus, 50 ml of methanol was added, and the crystal having been precipitated was recovered by filtration, whereby 6.9 g (yield 49%) of the target compound was obtained as a white crystal. In this case, the compound was identified by 1H-NMR (400 MHz).

1H-NMR (CDCl₃) δ3.92 (s, 3H), 3.97 (s, 6H), 6.55 (s, 1H), 7.31 (d, 2H), 7.41 (s, 1H), 8.16 (d, 2H), 10.41 (s, 1H),

Mass spectrum: m/z 333 (M+H)⁺,

The compound having been obtained has a melting point of 128° C.

### EXAMPLE OF SYNTHESIS 28

### Synthesis of Illustrated Compound A-58

The compound A-58 was synthesized according to the same procedure as that in the Example of synthesis 2, except that dicyanophenol of the Example of synthesis 2 was replaced by vanillic acid. The compound having been obtained has a melting point of 201° C. through 203° C.

### EXAMPLE OF SYNTHESIS 29

### Synthesis of Illustrated Compound A-82

The compound A-62 was synthesized according to the same procedure as that in the Example of synthesis 10, except that 2,4,5-trimethoxybenzoic acid of the Example of synthesis 10 was replaced by 4-ethoxy-2-methoxybenzoic acid. The compound having been obtained has a melting point of 88° C. through 89° C.

### EXAMPLE OF SYNTHESIS 30

### Synthesis of Illustrated Compound A-63

The compound A-63 was synthesized according to the same procedure as that in the Example of synthesis 10, except that 2,4,5-trimethoxybenzoic acid of the Example of synthesis 10 was replaced by 4-hydroxy-2-methoxybenzoic acid. The compound having been obtained has a melting point of 108° C. through 113° C.

### EXAMPLE OF SYNTHESIS 31

### Synthesis of Illustrated Compound A-65

The compound A-65 was synthesized according to the same procedure as that in the Example of synthesis 2, except that 2,4-dimethoxybenzoic acid of the Example of synthesis 2 was replaced by 4-hydroxy-2-methoxybenzoic acid. The compound having been obtained has a melting point of 142° C. through 144° C.

0.1 through 20 percent by mass of at least one of the compounds expressed by Formulae (12), (13), (13-A) through (13-E) and (14) is preferably added to cellulose, wherein the amount of the aforementioned compound is more preferably 0.5 through 16 percent by mass, still more preferably 1 through 12 percent by mass, particularly 2 through 8 percent by mass, most preferably 3 through 7 percent by mass.

As a retardation control agent, a compound having a 1,3,5-triazine ring is preferably used.

Among compounds having a 1,3,5-triazine ring, compounds represented by the following Formula (15) are preferable.

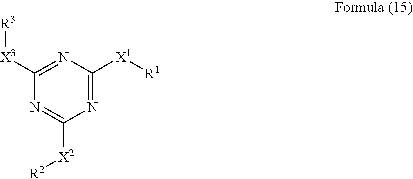

In Formula (15), X¹ is a single bond, an —NR₄— group, an —O— atom or an —S— atom; X² is a single bond, an —NR₅— group, an —O— atom or an —S— atom; X³ is a single bond, an —NR₆— group, an —O— atom or an —S— atom; R¹, R² and R³ are each an alkyl group, an alkenyl group, an aryl group or a heterocyclic group; and R₄, R₅ and R₆ are each a hydrogen atom, an alkyl group, an alkenyl group, an aryl group or a heterocyclic group. The compound represented by Formula (15) is particularly preferably a melamine compound.

In the melamine compound of Formula (15), it is preferable that the X¹, X² and X³ are each the —NR₄—, —NR₅— and —HR₆—, respectively, or the X¹, X² and X³ are each a single bond and the R¹, R² and R³ are each a heterocyclic group having a free valency at the nitrogen atom thereof. The —X¹—R¹, —X²—R² and —X³—R³ are preferably the same substituting group. The R¹, R² and R³ are particularly preferably an aryl group. The R₄, R₅ and R₆ are each particularly preferably a hydrogen atom.

The above alkyl group is more preferably a chain alkyl group than a cyclic alkyl group. A straight-chain alkyl group is more preferably than a branched-chain alkyl group.

The number of carbon atom of the alkyl group is preferably 1-30, more preferably 1-20, further preferably 1-10, further more preferably 1-8, and most preferably 1-6. The alkyl group may have a substituent.

Concrete examples of the substituent include a halogen atom, an alkoxy group such as a methoxy group, an ethoxy group and an epoxyethyloxy group, and a acyloxy group such as an acryloyl group and a methacryloyl group. The alkenyl group is more preferably a chain alkenyl group than a cyclic alkenyl group. A straight-chain alkenyl group is preferably to a branched-chain alkenyl group. The number of carbon atom of the alkenyl group is preferably 2-30, more preferably 2-20, further preferably 2-10, further more preferably 2-8, and most preferably 2-6. The alkyl group may have a substituent.

Concrete examples of the substituent include a halogen atom, an alkoxy group such as a methoxy group, an ethoxy group and an epoxyethyloxy group, and an acyloxy group such as an acryloyloxy group and a methacryloyloxy group.

The aryl group is preferably a phenyl group or a naphthyl group, and the phenyl group is particularly preferable. The aryl group may have a substituent.

Concrete examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamido group, a carbamoyl group, an alkyl-substituted carbamoyl group, an alkenyl-substituted carbamoyl group, an aryl-substituted carbamoyl group, an amido group, an alkylthio group, an alkenylthio group, an arylthio group and an acyl group. The above alkyl group is the same as the foregoing alkyl group.

The alkyl moiety of the alkoxyl group, acyloxy group, alkoxycarbonyl group, alkyl-substituted sulfamoyl group, sulfonamido group, alkyl-substituted carbamoyl group, amido group, alkylthio group and acyl group is the same as the foregoing alkyl group.

The above alkenyl group is the same as the forgoing alkenyl group.

The alkenyl moiety of the alkenyloxy group, acyloxy group, alkenyloxycarbonyl group, alkenyl-substituted sulfamoyl group, sulfonamido group, alkenyl-substituted carbamoyl group, amido group, alkenylthio group and acyl group is the same as the foregoing alkenyl group.

Concrete examples of the aryl group include a phenyl group, an α-naphthyl group, a β-naphthyl group, a 4-methoxyphenyl group, a 3,4-diethoxyphenyl group, a 4-octyloxyphenyl group and a 4-dodecyloxyphenyl group.

The aryl moiety of the aryloxy group, acyloxy group, aryloxycarbonyl group, aryl-substituted sulfamoyl group, sulfonamido group, aryl-substituted carbamoyl group, amido group, arylthio group and acyl group is the same as the foregoing aryl group.

The heterocyclic group is preferably has aromaticity, when the X¹, X² and X³ are an —NR— group, an —O— atom or an —S— group.

The heterocycle in the heterocyclic group having aromaticity is usually an unsaturated heterocycle, preferably a heterocycle having highest number of double bond. The heterocycle is preferably a 5-, 6- or 7-member ring, more preferably the 5- or 6-member ring and most preferably the 6-member ring.

The heteroatom in the heterocycle is preferably a nitrogen atom, a sulfur atom or an oxygen atom, and the nitrogen atom is particularly preferable.

As the heterocycle having aromaticity, a pyridine ring such as a 2-pyridyl group and a 4-pyridyl group is particularly preferable. The heterocyclic group may have a substituent. Examples of the substituent are the same as the substituent of the foregoing aryl moiety.

When X¹, X² and X³ are each the single bond, the heterocyclic group preferably has a free valency at the nitrogen atom. The heterocyclic group having the free valency at the nitrogen atom is preferably 5-, 6- or 7-member ring, more preferably the 5- or 6-member ring, and most preferably the 5-member ring. The heterocyclic group may have plural nitrogen atoms.

The heterocyclic group may have a hetero-atom other than the nitrogen atom such as an oxygen atom and a sulfur atom. The heterocyclic group may have a substituent. Concrete examples of the heterocyclic group are the same as those of the aryl moiety.

Examples of the heterocyclic group having the free valency at the nitrogen atom are listed below.

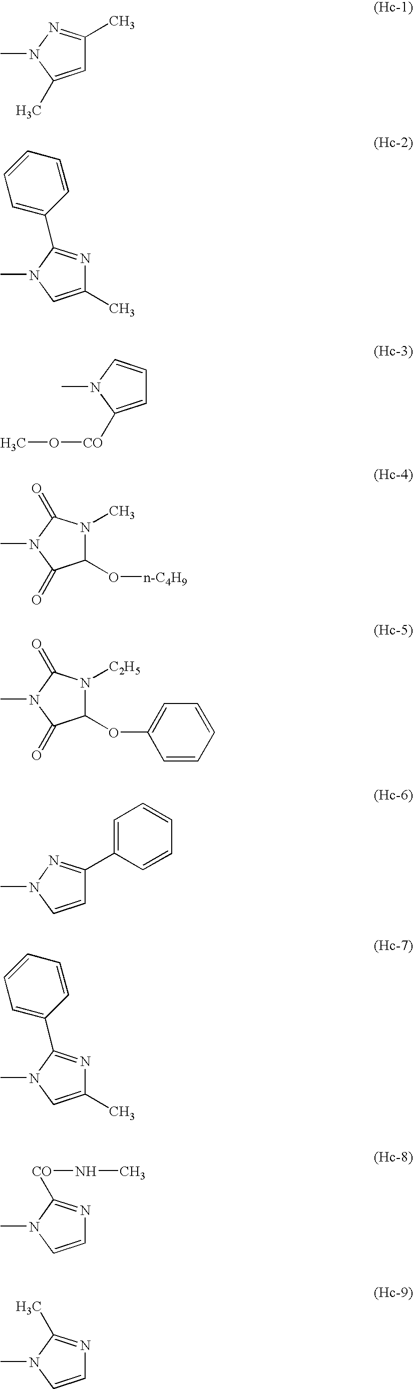

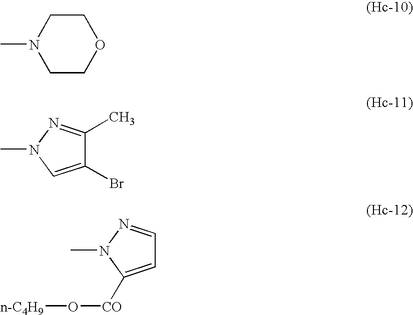

The molecular weight of the compound having a 1.3.5-triazine ring is preferably 300-2,000. The boiling point of these compounds is preferably not less than 260° C. The boiling point can be measured by a measuring apparatus available on the market such as TG/DTA100, manufactured by Seiko Instruments Inc.

Concrete examples of the compound having the 1,3,5-triazine ring are shown below.

In the following, plural R each represent the same group.

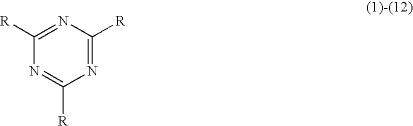

### (1) Butyl

(2) 2-methoxy-2-ethoxyethyl

### (3) Undecenyl

### (4) Phenyl

(5) 4-ethoxycarbonylphenyl
(6) 4-butozyphenyl
(7) p-biphenylyl
(8) 4-pyridyl
(9) 2-naphthyl
(10) 2-methylphenyl
(11) 3,4-dimethoxyphenyl
(12) 2-furyl
(13)

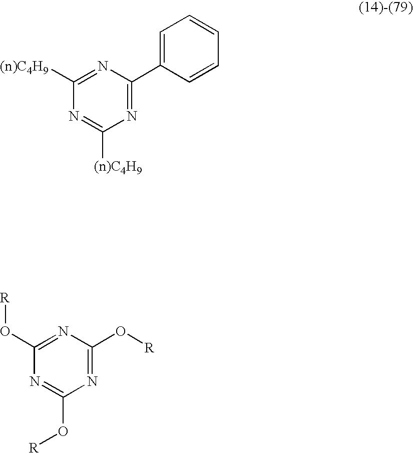

(14) phenyl
(15) 3-ethoxycarbonylphenyl
(16) 3-butoxyphenyl
(17) m-biphenyryl
(18) 3-phenylthiophenyl
(19) 3-chlorophenyl
(20) 3-benzoylphenyl
(21) 3-acetoxyphenyl
(22) 3-benzoyloxyphenyl
(23) 3-phenoxycarbonylphenol
(24) 3-methoxyphenyl
(25) 3-anilinophenyl
(26) 3-isobutyrylaminophenyl
(27) 3-phenoxycarbonylaminophenyl
(28) 3-(3-ethylureido)phenyl
(29) 3-(3,3-diethylureido)phenyl
(30) 3-methylphenyl
(31) 3-phenoxyphenyl
(32) 3-hydroxyphenyl
(33) 4-ethoxycarbonylphenyl
(34) 4-butoxyphenyl
(35) p-biphenyryl
(36) 4-phenylthiophenyl
(37) 4-chlorophenyl
(38) 4-benzoylphenyl
(39) 4-actoxyphenyl
(40) 4-benzoyloxyphenyl
(41) 4-phenoxycarbonylphenyl
(42) 4-methoxyphenyl
(43) 4-anilinophenyl
(44) 4-isobutyrylaminophenyl
(45) 4-phenoxycarbonylaminophenyl
(46) 4-(3-ethylureido)phenyl
(47) 4-(3,3-diethylureido)phenyl
(48) 4-methylphenyl
(49) 4-phenoxyphenyl
(50) 4-hydroxyphenyl
(51) 3,4-diethoxycarbonylphenyl
(52) 3,4-dibutoxyphenyl
(53) 3,4-diphenylphenyl
(54) 3,4-diphenylthiophenyl
(55) 3,4-dichlorophenyl
(56) 3,4-dibenzoylphenyl
(57) 3,4-diactoxyphenyl
(58) 3,4-dibenzoyloxyphenyl
(59) 3,4-diphenoxycarbonylphenyl
(60) 3,4-dimethoxyphenyl
(61) 3,4-dianilinophenyl
(62) 3,4-dimethylphenyl
(63) 3,4-diphenoxyphenyl
(64) 3,4-dihydroxyphenyl
(65) 2-naphthyl
(66) 3,4,5-triethoxycarbonylphenyl
(67) 3,4,5-tributoxyphenyl
(68) 3,4,5-triphenylpenyl
(69) 3,4,5-triphenylthiophenyl
(70) 3,4,5-trichlorophenyl
(71) 3,4,5-tribenzoylphenyl
(72) 3,4,5-triacetoxyphenyl
(73) 3,4,5-tribenzoyloxyphenyl
(74) 3,4,5-triphenoxycarbonylphenyl
(75) 3,4,5-trimethoxyphenyl
(76) 3,4,5-trianilinophenyl
(77) 3,4,5-trimethylphenyl
(78) 3,4,5-triphenoxyphenyl
(79) 3,4,5-trihydroxyphenyl

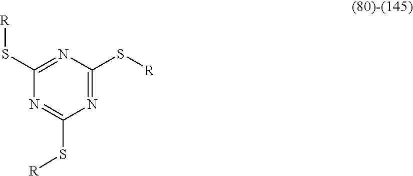

(80) phenyl
(81) 3-ethoxycarbonylphenyl
(82) 3-butoxyphenyl
(83) m-biphenyryl
(84) 3-phenylthiophenyl
(85) 3-chlorophenyl
(86) 3-benzoylphenyl
(87) 3-acetoxyphenyl
(88) 3-benzoyloxyphenyl
(89) 3-phenoxycarbonylphenol
(90) 3-methoxyphenyl
(91) 3-anilinophenyl
(92) 3-isobutyrylaminophenyl
(93) 3-phenoxycarbonylaminophenyl
(94) 3-(3-ethylureido)phenyl
(95) 3-(3,3-diethylureido)phenyl
(96) 3-methylphenyl
(97) 3-phenoxyphenyl
(98) 3-hydroxyphenyl
(99) 4-ethoxycarbonylphenyl
(100) 4-butoxyphenyl
(101) p-biphenyryl
(102) 4-phenylthiophenyl
(103) 4-chlorophenyl
(104) 4-benzoylphenyl
(105) 4-actoxyphenyl
(106) 4-benzoyloxyphenyl
(107) 4-phenoxycarbonylphenyl
(108) 4-methoxyphenyl
(109) 4-anilinophenyl
(110) 4-isobutyrylaminophenyl
(111) 4-phenoxycarbonylaminophenyl
(112) 4-(3-ethylureido)phenyl
(113) 4-(3,3-diethylureido)phenyl
(114) 4-methylphenyl
(115) 4-phenoxyphenyl
(116) 4-hydroxyphenyl
(117) 3,4-diethoxycarbonylphenyl
(118) 3,4-dibutoxyphenyl
(119) 3,4-diphenylphenyl
(120) 3,4-diphenylthiophenyl
(121) 3,4-dichlorophenyl
(122) 3,4-dibenzoylphenyl
(123) 3,4-diactoxyphenyl
(124) 3,4-dibenzoyloxyphenyl
(125) 3,4-diphenoxycarbonylphenyl
(126) 3,4-dimethoxyphenyl
(127) 3,4-dianilinophenyl
(128) 3,4-dimethylphenyl
(129) 3,4-diphenoxyphenyl
(130) 3,4-dihydroxyphenyl
(131) 2-naphthyl
(132) 3,4,5-triethoxycarbonylphenyl
(133) 3,4,5-tributoxyphenyl
(134) 3,4,5-triphenylpenyl
(135) 3,4,5-triphenylthiophenyl
(136) 3,4,5-trichlorophenyl
(137) 3,4,5-tribenzoylphenyl
(138) 3,4,5-triacetoxyphenyl
(139) 3,4,5-tribenzoyloxyphenyl
(140) 3,4,5-triphenoxycarbonylphenyl
(141) 3,4,5-trimethoxyphenyl
(142) 3,4,5-trianilinophenyl
(143) 3,4,5-trimethylphenyl
(144) 3,4,5-triphenoxyphenyl
(145) 3,4,5-trihydroxyphenyl

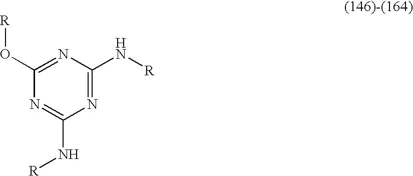

(146) phenyl
(147) 4-ethoxycarbonylphenyl
(148) 4-butoxyphenyl
(149) p-biphenyryl
(150) 4-phenylthiophenyl
(151) 4-chlorophenyl
(152) 4-benzoylphenyl
(153) 4-acetoxyphenyl
(154) 4-benzoyloxyphenyl
(155) 4-phenoxycarbonylphenol
(156) 4-methoxyphenyl
(157) 4-anilinophenyl
(158) 4-isobutyrylaminophenyl
(159) 4-phenoxycarbonylaminophenyl
(160) 4-(3-ethylureido)phenyl
(161) 4-(3,3-diethylureido)phenyl
(162) 4-methylphenyl
(163) 4-phenoxyphenyl
(164) 4-hydroxyphenyl

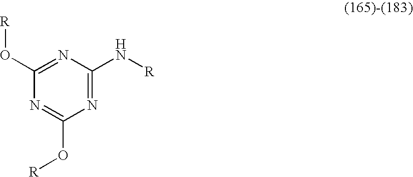

(165) phenyl
(166) 4-ethoxycarbonylphenyl
(167) 4-butoxyphenyl
(168) p-biphenyryl
(169) 4-phenylthiophenyl
(170) 4-chlorophenyl
(171) 4-benzoylphenyl
(172) 4-acetoxyphenyl
(173) 4-benzoyloxyphenyl
(174) 4-phenoxycarbonylphenol
(175) 4-methoxyphenyl
(176) 4-anilinophenyl
(177) 4-isobutyrylaminophenyl
(178) 4-phenoxycarbonylaminophenyl
(179) 4-(3-ethylureido)phenyl
(180) 4-(3,3-diethylureido)phenyl
(181) 4-methylphenyl
(182) 4-phenoxyphenyl
(183) 4-hydroxyphenyl

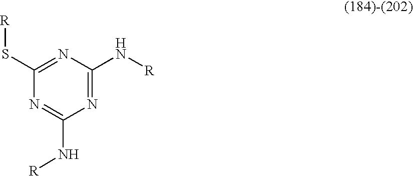

(184) phenyl
(185) 4-ethoxycarbonylphenyl
(186) 4-butoxyphenyl
(187) p-biphenyryl
(188) 4-phenylthiophenyl
(189) 4-chlorophenyl
(190) 4-benzoylphenyl
(191) 4-acetoxyphenyl
(192) 4-benzoyloxyphenyl
(193) 4-phenoxycarbonylphenol
(194) 4-methoxyphenyl
(195) 4-anilinophenyl
(196) 4-isobutyrylaminophenyl
(197) 4-phenoxycarbonylaminophenyl
(198) 4-(3-ethylureido)phenyl
(199) 4-(3,3-diethylureido)phenyl
(200) 4-methylphenyl
(201) 4-phenoxyphenyl
(202) 4-hydroxyphenyl

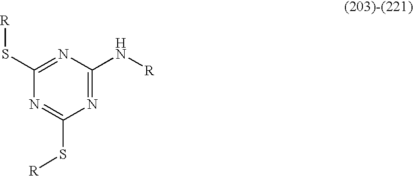

(203) phenyl
(204) 4-ethoxycarbonylphenyl
(205) 4-butoxyphenyl
(206) p-biphenyryl
(207) 4-phenylthiophenyl
(208) 4-chlorophenyl
(209) 4-benzoylphenyl
(210) 4-acetoxyphenyl
(211) 4-benzoyloxyphenyl
(212) 4-phenoxycarbonylphenol
(213) 4-methoxyphenyl
(214) 4-anilinophenyl
(215) 4-isobutyrylaminophenyl
(216) 4-phenoxycarbonylaminophenyl
(217) 4-(3-ethylureido)phenyl
(218) 4-(3,3-diethylureido)phenyl
(219) 4-methylphenyl
(220) 4-phenoxyphenyl
(221) 4-hydroxyphenyl

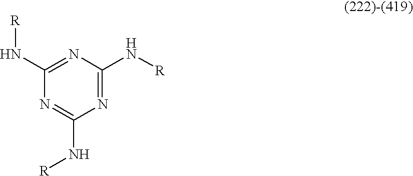

(222) phenyl
(223) 4-butylphenyl
(224) 4-2-methoxy-2-ethoxyethyl)phenyl
(225) 4-(5-nenenyl)phenyl
(226) p-biphenyryl
(227) 4-ethoxycarbonylphenyl
(228) 4-butoxyphenyl
(229) 4-methylphenyl
(230) 4-chlorophenyl
(231) 4-phenylthiophenyl
(232) 4-benzoylphenyl
(233) 4-aceoxyphenyl
(234) 4-benzoyloxyphenyl
(235) 4-phenoxycarbonylphenyl
(236) 4-methoxyphenyl
(237) 4-anilinophenyl
(238) 4-isobutyrylaminophenyl.
(239) 4-phenoxycarbonylaminophenyl
(240) 4-(3-ethylureido)phenyl
(241) 4-(3,3-diethylureido)phenyl
(242) 4-phenoxyphenyl
(243) 4-hydroxyphenyl
(244) 3-butylphenyl
(245) 3-(2-methoxy-2-ethoxyethyl)phenyl
(246) 3-(5-nonenyl)phenyl
(247) m-biphenyryl
(248) 3-ethoxycarbonylphenyl
(249) 3-butoxyphenyl
(250) 3-methylphenyl
(251) 3-chlorophenyl
(252) 3-phenylthiophenyl
(253) 3-benzoylphenyl
(254) 3-actoxyphenyl
(255) 3-benzoyloxyphenyl
(256) 3-phenoxycarbonylphenyl
(257) 3-methoxyphenyl
(258) 3-anilinophenyl
(259) 3-isobutyrylaminophenyl
(260) 3-phenoxycarbonylaminophenyl
(261) 3-(3-ethylureido)phenyl
(262) 3-(3,3-diethylureido)phenyl
(263) 3-phenoxyphenyl
(264) 3-hydroxyphenyl
(265) 2-butylphenyl
(266) 2-(2-methoxy-2-ethoxyethyl)phenyl
(267) 2-(5-nonenyl)phenyl
(268) o-biphenyryl
(269) 2-ethoxycarbonylphenyl
(270) 2-butoxyphenyl
(271) 2-methylphenyl
(272) 2-chlorophenyl
(273) 2-phenylthiophenyl
(274) 2-benzoylphenyl
(275) 2-aceoxyphenyl
(276) 2-benzoyloxyphenyl
(277) 4-phenoxycarbonylphenyl
(278) 2-methoxyphenyl
(279) 2-anilinophenyl
(280) 2-isobutyrylaminophenyl
(281) 2-phenoxycarbonyl aminophenyl
(282) 2-(3-ethylureido)phenyl
(283) 2-(3,3-dimethylureido)phenyl
(284) 2-phenoxyphenyl
(285) 2-hydroxyphenyl
(286) 3,4-dibutylphenyl
(287) 3,4-di(2-methoxy-2-ethoxyethyl)phenyl
(288) 3,4-diphenylphenyl
(289) 3,4-diethoxycarbonylphenyl
(290) 3,4-didodecyloxyphenyl
(291) 3,4-dimethylphenyl
(292) 3,4-dichlorophenyl
(293) 3,4-dibenzoylphenyl
(294) 3,4-diacetoxyphenyl
(295) 3,4-dimethoxyphenyl
(296) 3,4-di-N-methylaminophenyl
(297) 3,4-diisobutyrylaminophenyl
(298) 3,4-diphenoxyphenyl
(299) 3,4-dihydroxyphenyl
(300) 3,5-dibutylphenyl
(301) 3,5-di(2-methoxy-2-ethoxyethyl)phenyl
(302) 3,5-diphenylphenyl
(303) 3,5-diethoxycarbonylphenyl
(304) 3,5-didodecyloxyphenyl
(305) 3,5-dimethylphenyl
(306) 3,5-dichlorophenyl
(307) 3,5-dibenzoylphenyl
(308) 3,5-diacetoxyphenyl
(309) 3,5-dimethoxyphenyl
(310) 3,5-di-N-methylaminophenyl
(311) 3,5-diisobutyrylaminophenyl
(312) 3,5-diphenoxyphenyl
(313) 3,5-dihydroxyphenyl
(314) 2,4-dibutylphenyl
(315) 2,4-di(2-methoxy-2-ethoxyethyl)phenyl
(316) 2,4-diphenylphenyl
(317) 2,4-diethoxycarbonylphenyl
(318) 2,4-didodecyloxyphenyl
(319) 2,4-dimethylphenyl
(320) 2,4-dichlorophenyl
(321) 2,4-dibenzoylphenyl
(322) 2,4-diacetoxyphenyl
(323) 2,4-dimethoxyphenyl
(324) 2,4-di-N-methylaminophenyl
(325) 2,4-diisobutyrylaminophenyl
(326) 2,4-diphenoxyphenyl
(327) 2,4-dihydroxyphenyl
(328) 2,3-dibutylphenyl
(301) 3,5-di(2-methoxy-2-ethoxyethyl)phenyl
(302) 3,5-diphenylphenyl
(303) 3,5-diethoxycarbonylphenyl
(304) 3,5-didodecyloxyphenyl
(305) 3,5-dimethylphenyl
(306) 3,5-dichlorophenyl
(307) 3,5-dibenzoylphenyl
(308) 3,5-diacetoxyphenyl
(309) 3,5-dimethoxyphenyl
(310) 3,5-di-N-methylaminophenyl
(311) 3,5-diisobutyrylaminophenyl
(312) 3,5-diphenoxyphenyl
(313) 3,5-dihydroxyphenyl
(314) 2,4-dibutylphenyl
(315) 2,4-di(2-methoxy-2-ethoxyethyl)phenyl
(316) 2,4-diphenylphenyl
(317) 2,4-diethoxycarbonylphenyl
(318) 2,4-didodecyloxyphenyl
(319) 2,4-dimethylphenyl
(320) 2,4-dichlorophenyl
(321) 2,4-dibenzoylphenyl
(322) 2,4-diacetoxyphenyl
(323) 2,4-dimethoxyphenyl
(324) 2,4-di-N-methylaminophenyl
(325) 2,4-diisobutyrylaminophenyl
(326) 2,4-diphenoxyphenyl
(327) 2,4-dihydroxyphenyl
(328) 2,3-dibutylphenyl
(329) 2,3-di(2-methoxy-2-ethoxyethyl)phenyl
(330) 2,3-diphenylphenyl
(331) 2,3-diethoxycarbonylphenyl
(332) 2,3-didodecyloxyphenyl
(333) 2,3-dimethylphenyl
(334) 2,3-dichlorophenyl
(335) 2,3-dibenzoylphenyl
(336) 2,3-diacetoxyphenyl
(337) 2,3-dimethoxyphenyl
(338) 2,3-di-N-methylaminophenyl
(339) 2,3-diisobutyrylaminophenyl
(340) 2,3-diphenoxyphenyl
(341) 2,3-dihydroxyphenyl
(342) 2,6-dibutylphenyl.
(343) 2,6-di(2-methoxy-2-ethoxyethyl)phenyl
(344) 2,6-diphenylphenyl
(345) 2,6-diethoxycarbonylphenyl
(346) 2,6-didodecyloxyphenyl
(347) 2,6-dimethylphenyl
(348) 2,6-dichlorophenyl
(349) 2,6-dibenzoylphenyl
(350) 2,6-diacetoxyphenyl
(351) 2,6-dimethoxyphenyl
(352) 2,6-di-N-methylaminophenyl
(353) 2,6-diisobutyrylaminophenyl
(354) 2,6-diphenoxyphenyl
(355) 2,6-dihydroxyphenyl
(356) 3,4,5-tributylphenyl
(357) 3,4,5-tri(2-methoxy-2-ethoxyethyl)phenyl
(358) 3,4,5-triphenylphenyl
(359) 3,4,5-triethoxycarbonylphenyl
(360) 3,4,5-tridodecyloxyphenyl
(361) 3,4,5-trimethylphenyl
(362) 3,4,5-trichlorophenyl
(363) 3,4,5-tribenzoylphenyl
(364) 3,4,5-triacetoxyphenyl
(365) 3,4,5-trimethoxyphenyl
(366) 3,4,5-tri-N-methylaminophenyl
(367) 3,4,5-triisobutyrylaminophenyl
(368) 3,4,5-triphenoxyphenyl
(369) 3,4,5-trihydroxyphenyl
(370) 2,4,6-tributylphenyl
(371) 2,4,6-tri(2-methoxy-2-ethoxyethyl)phenyl
(372) 2,4,6-triphenylphenyl
(373) 2,4,6-triethoxycarbonylphenyl
(374) 2,4,6-tridodecyloxyphenyl
(375) 2,4,6-trimethylphenyl
(376) 2,4,6-trichlorophenyl
(377) 2,4,6-tribenzoylphenyl
(378) 2,4,6-triacetoxyphenyl
(379) 2,4,6-trimethoxyphenyl
(380) 2,4,6-tri-N-methylaminophenyl
(381) 2,4,6-triisobutyrylaminophenyl
(382) 2,4,6-triphenoxyphenyl
(383) 2,4,6-trihydroxyphenyl.
(384) pentafluorophenyl.
(385) pentachlorophenyl
(386) pentamethoxyphenyl
(387) 6-N-methylsulfamoyl-8-methoxy-2-naphthyl
(388) 5-N-methylsulfamoyl-2-naphthyl
(389) 6-N-phenylsulfamoyl-2-naphtyl
(390) 5-ethoxy-7-N-methylsulfamoyl-2-naphthyl
(391) 3-methoxy-2-naphthyl
(392) 1-ethoxy-2-naphthyl
(393) 6-N-phenylsulfamoyl-8-methoxy-2-naphthyl
(394) 5-methoxy-7-N-phenylsulfamoyl-2-naphthyl
(395) 1-(4-methylphenyl)-2-naphthyl
(396) 6,8-di-N-methylsulfamoyl-2-naphthyl
(397) 6-N-2-acetoxyethylsulfamoyl-8-methoxy-2-naphthyl
(398) 5-acetoxy-7-N-phenylsulfamoyl-2-naphthyl
(399) 3-benzoyloxy-2-naphthyl
(400) 5-acetylamino-1-naphthyl
(401) 2-methoxy-1-naphthyl
(402) 4-phenoxy-1-naphthyl
(403) 5-N-methylsulfamoyl-1-naphthyl
(404) 3-N-methylcarbamoyl-4-hydroxy-1-naphthyl
(405) 5-methoxy-6-N-ethylsulfamoyl-1-naphthyl
(406) 7-tetradecyloxy-1-naphthyl
(407) 4-(4-methylphenoxy)-1-naphthyl
(408) 6-N-methylsulfamoyl-1-naphthyl
(409) 3-N,N-dimethylcarbamoyl-4-methoxy-1-naphthyl
(410) 5-methoxy-6-N-benzylsulfamoyl-1-naphthyl
(411) 3,6-di-N-phenylsulfamoyl-1-naphthyl
(412) methyl
(413) ethyl
(414) butyl
(415) octyl
(416) dodecyl
(417) 2-butoxy-2-ethoxyethyl
(418) benzyl
(419) 4-methoxybenzyl

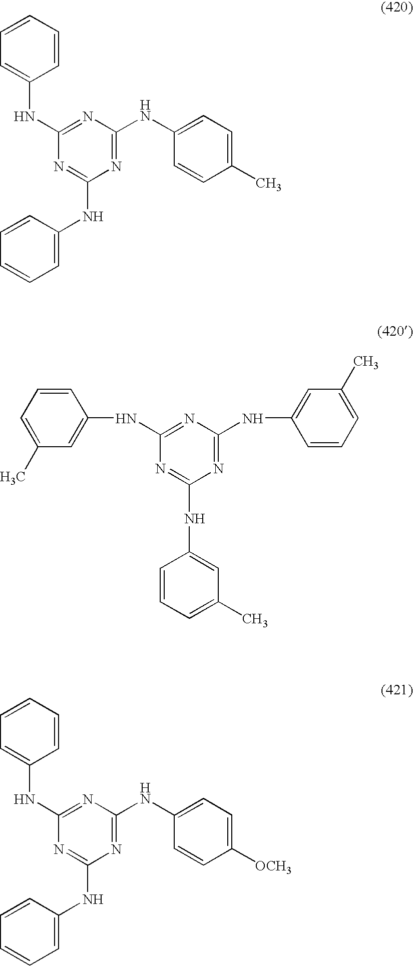

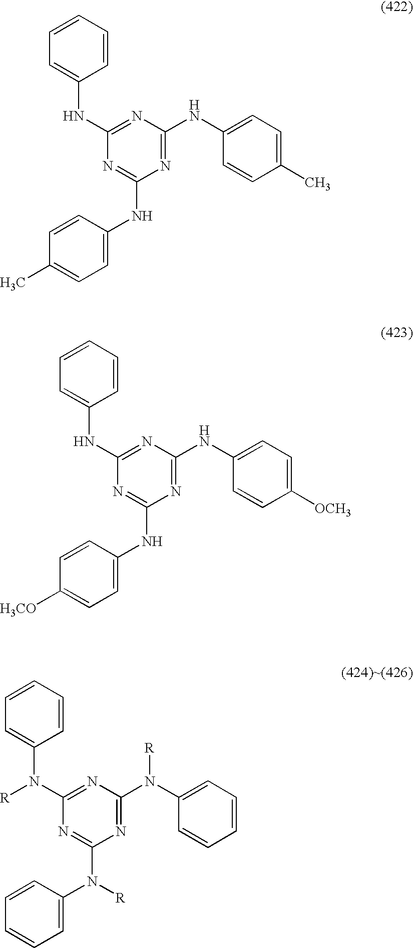

(424) methyl
(425) phenyl
(426) butyl

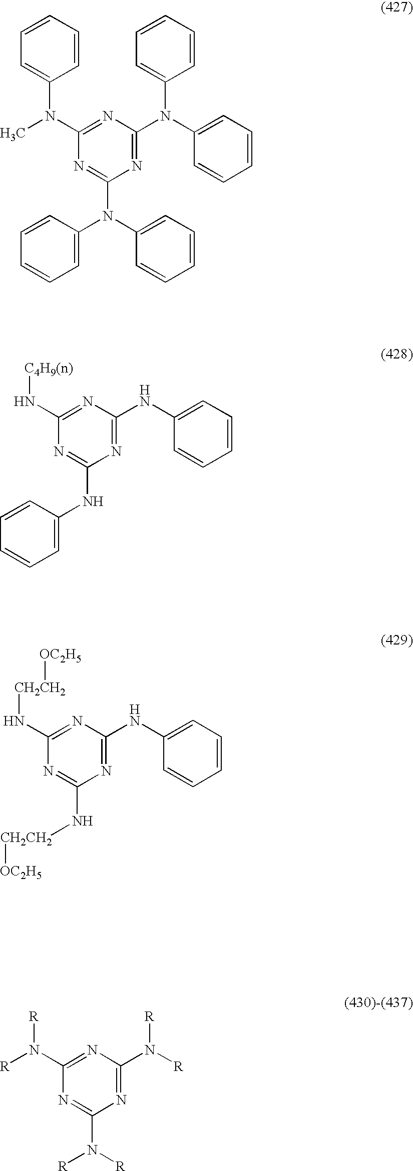

(430) methyl
(431) ethyl
(432) butyl
(433) octyl
(434) dodecyl
(435) 2-butoxy-2-ethoxyethyl
(436) benzyl
(437) 4-methoxybenzyl

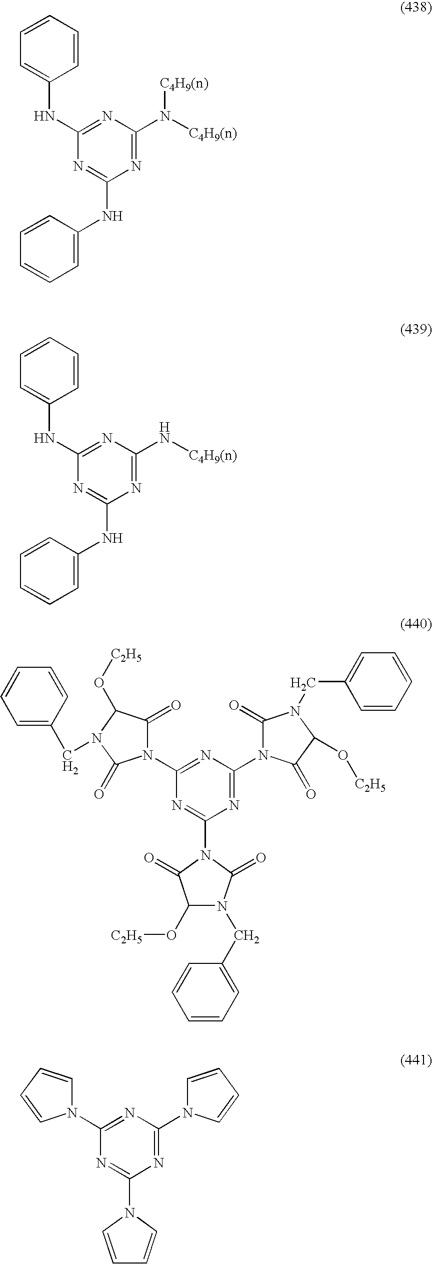

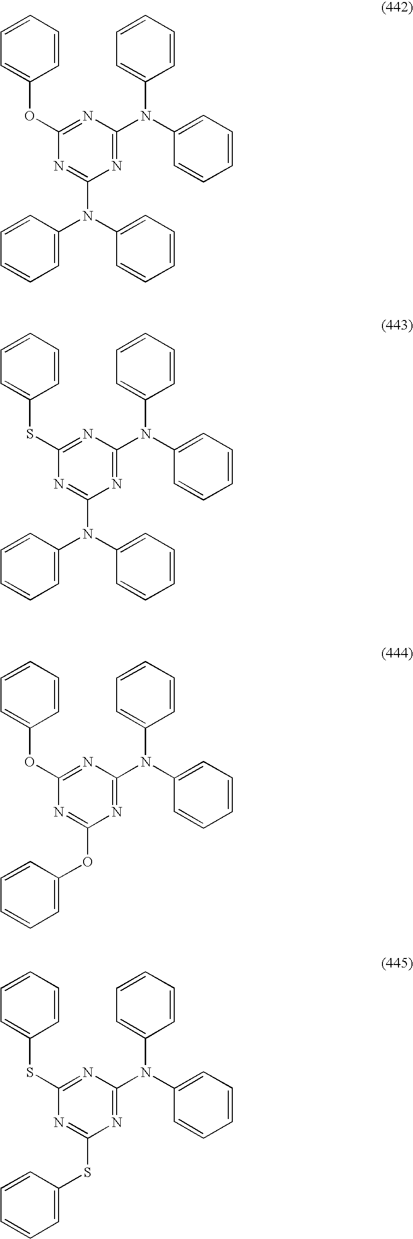

In the present invention, employed as a compound having a 1,3,5-triazine ring may be melamine polymers. It is preferable that the above melamine polymers are synthesized employing a polymerization reaction of the melamine compounds represented by Formula (16) below with carbonyl compounds.

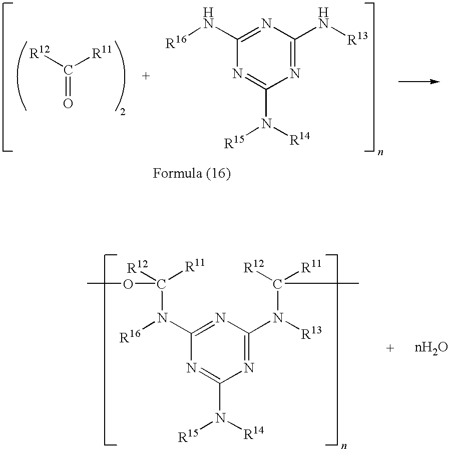

In the above synthesis reaction scheme, R¹¹, R¹², R¹³, R¹⁴, R¹⁵, and R¹⁶ each represent a hydrogen atom, an alkyl group, an alkenyl group, an aryl group or a heterocyclic group.

The above alkyl group, alkenyl group, aryl group, and heterocyclic group, as well as those substituents are as defined for each group and also the substituents described in above Formula (4).

The polymerization reaction of melamine compounds with carbonyl compounds is performed employing the same synthesis method as for common melamine resins-(for example, a melamine-formaldehyde resin). Further, employed may be commercially available melamine polymers (being melamine resins).

The molecular weight of melamine polymers is preferably 2,000-400,000. Specific examples of repeating units of melamine polymers are shown below.

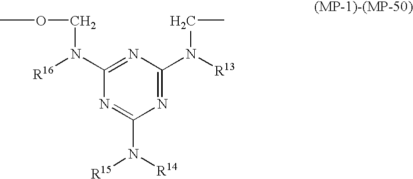

### MP-1: R¹³, R¹⁴, R¹⁵, R¹⁶: CH₂OH

### MP-2: R¹³R¹⁴, R¹⁵, R¹⁶: CH₂OCH₃

### MP-3: R¹³, R¹⁴, R¹⁵, R¹⁶: CH₂O-i-H₉

### MP-4: R¹³, R¹⁴, R¹⁵, R¹⁶: CH₂O-n-C₄H₉

### MP-5: R¹³, R¹⁴, R¹⁵, R¹⁶: CH₂NHCOCH═CH₂

### MP-6: R¹³, R¹⁴, R¹⁵, R¹⁶: H₂NHCO(CH₂)₇CH_CH(CH₂)₇CH₃

### MP-7: R¹³, R¹⁴, R¹⁵: CH₂OH; R¹⁶: CH₂OCH₃

### MP-8: R¹³, R¹⁴, R¹⁶: CH₂OH; R¹⁵: C₂OCH₃,

### MP-9: R¹³, R¹⁴: CH₂OH; R¹⁵, R¹⁶: CH₂OCH₃

### MP-10: R¹³, R¹⁶: CH₂OH; R¹⁴, R¹⁵: CH₂OCH₃

### MP-11: R¹³: CH₂OH; R¹⁴, R¹⁵, R¹⁶: CH₂OCH₃

### MP-12: R¹³, R¹⁴, R¹⁶: CH₂OCH₃; R¹⁵: CH₂OH

### MP-13: R¹³, R¹⁶: CH₂OCH₃; R¹⁴, R¹⁵: CH₂OH

### MP-14: R¹³, R¹⁴, R¹⁵: CH₂OH; R¹⁶: CH₂O-i-C₄H₉

### MP-15: R¹³, R¹⁴, R¹⁶: CH₂OCH₃; R¹⁵: CH₂O-i-C₄H₉

### MP-16: R¹³, R¹⁴: CH₂OH; R¹⁵, R¹⁶: CH₂O-i-C₄H₉

### MP-17: R¹³, R¹⁶: CH₂OH; R¹⁴, R¹⁵: CH₂O-i-C₄H₉

### MP-18: R¹³: CH₂OH; R¹⁴ R¹⁵, R¹⁶: CH₂O-i-CH₄H₉

### MP-19: R¹³, R¹⁴, R¹⁶: CH₂O-i-C₄H₉; R¹⁵: CH₂OH

### MP-20: R¹³, R¹⁶: CH₂O-i-C₄H₉; R¹⁴, R¹⁵: CH₂OH

### MP-21: R¹³, R¹⁴, R¹⁵: CH₂OH; R¹⁶: CH₂O-n-C₄H₉

### MP-22: R¹³, R¹⁴, R¹⁶: CH₂OH; R¹⁵: CH₂O-n-C₄H₉

### MP-23: R¹³, R¹⁴: CH₂OH; R¹⁵, R¹⁶: CH₂O-n-C₄H₉

### MP-24: R¹³, R¹⁶: CH₂OH; R¹⁴, R¹⁵: CH₂O-n-C₄H₉

### MP-25: R¹³: CH₂OH; R¹⁴ R¹⁵, R¹⁶: CH₂O-n-C₄H₉

### MP-26: R¹³, R¹⁴, R¹⁶: CH₂O-n-C₄H₉; R¹⁵: CH₂OH

### MP-27: R¹³, R¹⁶: CH₂O-n-C₄H₉; R¹⁴, R¹⁵: CH₂OH

MP-28: R¹³, R¹⁴: CH₂OH; R¹⁵: CH₂OCH₃; R¹⁶: CH₂O-n-C₄H₉
MP-29: R¹³, R¹⁴: CH₂OH; R¹⁵: CH₂-n-C₄H₉; R¹⁶: CH₂OCH₃
MP-30: R¹³, R¹⁶: CH₂OH; R¹⁴: CH₂OCH₃; R¹⁵: CH₂O-n-C₄H₉
MP-31: R¹³: CH₂OH; R¹⁴, R¹⁵: CH₂OCH₃; R¹⁶: CH₂O-n-C₄H₉
MP-33: R¹³: CH₂OH; R¹⁴: CH₂OCH₃; R¹⁵, R¹⁶: CH₂O-n-C₄H₉
MP-34: R¹³: CH₂OH; R¹⁴, R¹⁵: CH₂O-n-C₄H₉; R¹⁶: CH₂OCH₃
MP-35: R¹³, R¹⁴: CH₂OCH₃; R¹⁵: CH₂OH; R¹⁶: CH₂O-n-C₄H₉
MP-36: R¹³, R¹⁶: CH₂OCH₃; R¹⁴: CH₂OH; R¹⁵: CH₂O-n-C₄H₉
MP-37: R¹³: CH₂OCH₃; R¹⁴, R¹⁵: CH₂OH; R¹⁶: CH₂O-n-C₄H₉
MP-38: R¹³, R¹⁶: CH₂O-n-C₄H₉; R¹⁴: CH₂OCH₃; R¹⁵: CH₂OH
MP-39: R¹³: CH₂OH; R¹⁴: CH₂OCH₃; R¹⁵: CH₂O-n-C₄H₉; R¹⁶: CH₂NHCOCH═CH₂
MP-40: R¹³: CH₂OH; R¹⁴: CH₂OCH₃; R¹⁵: CH₂NHCOCH═CH₂; R¹⁶ CH₂O-n-C₄H₉
MP-41: R¹³: CH₂OH; R¹⁴: CH₂O-n-C₄H₉; R¹⁵: CH₂NHCOCH═CH₂; R¹⁶: CH₂OCH₃
MP-42: R¹³: CH₂OCH₃; R¹⁴: CH₂OH; R¹⁵: CH₂O-n-C₄H₉; R¹⁶: CH₂NHCOCH═CH₂
MP-43: R¹³: CH₂OCH₃; R¹⁴: CH₂OH; R¹⁵: CH₂NHCOCH═CH₂; R¹⁶: CH₂O-n-C₄H₉
MP-44: R¹³: CH₂O-n-C₄H₉; R¹⁴: CH₂OCH₃; R¹⁵: CH₂OH; R¹⁶: CH₂NHCOCH═CH₂
MP-45: R¹³: CH₂OH; R¹⁴: CH₂OCH₃; R¹⁵: CH₂NHCO(CH₂)CH═CH(CH₂)₇CH₃; R¹⁶: CH₂NHCOCH═CH₂
MP-46: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-47: R¹³: CH₂OH; R¹⁴: CH₂NHCO(CH₂)₇CH═CH(CH₂)₇CH₃; R¹⁵ CH₂NHCOCH═CH₂; R¹⁶: CH₂OCH₃
MP-48: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-49: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-50: R¹³: CH₂NHCO(CH₂)₇CH═CH(CH₂)₇CH₃; R¹⁴: CH₂OCH₃; R¹⁵ CH₂OH; R¹⁶: CH₂NHCOCH═CH₂

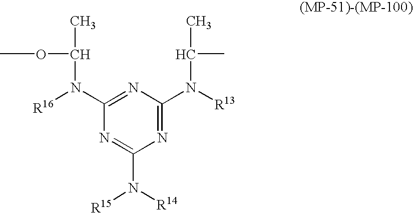

### MP-51: R¹³, R¹⁴, R¹⁵, R¹⁶: CH₂OH

### MP-52: R¹³, R¹⁴, R¹⁵, R¹⁶: CH₂OCH₃

### MP-53: R₁₃, R¹⁴, R¹⁵, R¹⁶: CH₂O-i-C₄H₉

### MP-54: R¹³, R¹⁴, R¹⁵, R¹⁶: CH₂O-n-C₄H₉

### MP-55: R¹³, R¹⁴, R¹⁵, R¹⁶: CH₂NHCOCH═CH₂

### MP-56: R¹³, R₁₄, R¹⁵, R¹⁶: CH₂NHCO(CH₂)₇CH═CH(CH₂)₇CH₃

### MP-57: R¹³, R¹⁴, R¹⁵: CH₂OH; R¹⁶ CH₂OCH₃

### MP-58: R¹³, R¹⁴, R¹⁶: CH₂OH; R¹⁵: CH₂OCH₃,

MP-59: R¹³, R¹⁴: CH₂OH; R¹⁵, R¹⁶: CH₂OCH₃

### MP-60: R¹³, R¹⁶: CH₂OH; R¹⁴, R¹⁵: CH₂OCH₃

### MP-61: R¹³: CH₂OH; R¹⁴ R¹⁵, R¹⁶: CH₂OCH₃

### MP-62: R¹³, R¹⁴, R¹⁶: CH₂OCH₃; R¹⁵: CH₂OH

### MP-63: R¹³, R¹⁶: CH₂OCH₃; R₁₄, R¹⁵: CH₂OH

### MP-64: R¹³, R¹⁴, R¹⁵: CH₂OH; R¹⁶: CH₂O-i-C₄H₉

### MP-65: R¹³, R¹⁴, R¹⁶: CH₂OCH₃; R¹⁵: CH₂O-i-C₄H₉

### MP-66: R¹³, R¹⁴: CH₂OH; R¹⁵, R¹⁶: CH₂O-i-C₄H₉

### MP-67: R¹³, R¹⁶: CH₂OH; R¹⁴, R¹⁵: CH₂O-i-C₄H₂

### MP-68: R¹³: CH₂OH; R¹⁴, R¹⁵, R¹⁶: CH₂O-i-C₄H₉

### MP-69: R¹³, R¹⁴, R¹⁶: CH₂O-i-C₄H₉; R¹⁵: CH₂OH

### MP-70: R¹³, R¹⁶: CH₂O-i-C₄H₉; R¹⁴, R¹⁵: CH₂OH

### MP-71: R¹³, R¹⁴, R¹⁵: CH₂OH; R¹⁶: CH₂O-n-C₄H₉

MP-72: R¹³, R¹⁴, R¹⁶: CH₂OH; R¹⁵: CH₂O-n-C₄H₉

### MP-73: R¹³, R¹⁴: CH₂OH; R¹⁵, R¹⁶: CH₂O-n-C₄H₉

### MP-74: R¹³, R¹⁶: CH₂OH; R¹⁴, R¹⁵: CH₂O-n-C₄H₉

### MP-75: R¹³: CH₂OH; R¹⁴ R¹⁵, R¹⁶: CH₂O-n-C₄H₉

### MP-76: R¹³, R¹⁴, R¹⁶: CH₂O-n-C₄H₉; R¹⁵: CH₂OH

### MP-77: R¹³, R¹⁶: CH₂O-n-C₄H₉; R¹⁴, R¹⁵: CH₂OH

MP-78: R¹³, R¹⁴: CH₂OH; R¹⁵: CH₂OCH₃; R¹⁶: CH₂O-n-C₄H₉
MP-79: R¹³, R¹⁴: CH₂OH; R¹⁵: C₂O-n-C₄H₉; R¹⁶: CH₂OCH₃
MP-80: R¹³, R¹⁶: CH₂OH; R¹⁴: CH₂OCH₃; R¹⁵: CH₂O-n-C₄H₉
MP-81: R¹³: CH₂OH; R¹⁴, R¹⁵: CH₂OCH₃; R¹⁶: CH₂O-n-CH₄H₉
MP-82: R¹³: CH₂OH; R¹⁴, R¹⁶: CH₂OCH₃; R¹⁵: CH₂O-n-C₄H₉
MP-83: R¹³: CH₂OH; R¹⁴: CH₂OCH₃; R¹⁵, R¹⁶: CH₂O-n-C₄H₉
MP-84: R¹³: CH₂OH; R¹⁴, R¹⁵: CH₂O-n-C₄H₉; R¹⁶: CH₂OCH₃
MP-85: R¹³, R¹⁴: CH₂OCH₃; R¹⁵: CH₂OH; R¹⁶: CH₂O-n-C₄H₉
MP-86: R¹³, R¹⁶: CH₂OCH₃; R¹⁴: CH₂OH; R¹⁵: CH₂O-n-C₄H₉
MP-87: R¹³: CH₂OCH₃; R¹⁴, R¹⁵: CH₂OH; R¹⁶: CH₂O-n-C₄H₉
MP-88: R¹³, R¹⁶: CH₂O-n-C₄H; R¹⁴: CH₂OCH₃; R¹⁵: CH₂OH
   MP-89: R¹³: CH₂OH; R¹⁴: CH₂OCH₃; R¹⁵: CH₂O-n-C₄H₉; R¹⁶: CH₂NHCOCH═CH₂
   MP-90: R¹³: CH₂OH; R¹⁴: CH₂OCH₃; R¹⁵: CH₂NHCOCH═CH₂; R¹⁶ CH₂O-n-C₄H₉
   MP-91: R¹³: CH₂OH; R¹⁴: CH₂O-n-C₄H₉; R¹⁵: CH₂NHCOCH═CH₂; R¹⁶: CH₂OCH₃
   MP-92: R¹³: CH₂OCH₃; R¹⁴: CH₂OH; R¹⁵: CH₂O-n-C₄H₉; R¹⁶: CH₂NHCOCH═CH₂
   MP-93: R¹³: CH₂OCH₃; R¹⁴: CH₂OH; R¹⁵: CH₂NHCOCH═CH₂; R¹⁶: CH₂O-n-C₄H₉
   MP-94: R¹³: CH₂O-n-C₄H₉; R¹⁴: CH₂OCH₃; R¹⁵: CH₂OH; R¹⁶: CH₂NHCOCH═CH₂
   MP-95: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
   MP-96: R¹³: CH₂OH; R¹⁴: CH₂OCH₃; R¹⁵: CH₂NHCO═CH₂; R₁₆:
CH₂NHCO(CH₂)₇CH═CH(CH₂)₇CH₃
   MP-97: R¹³: CH₂OH; R¹⁴: CH₂NHCO(CH₂)₇CH═CH(CH₂)₇CH₃; R¹⁵: CH₂NHCOCH═CH₂; R¹⁶: CH₂OCH₃
   MP-98: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
   MP-99: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
   MP-100: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

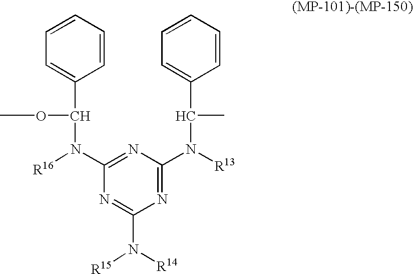

### MP-101: R¹³, R¹⁴, R¹⁵, R¹⁶: CH₂OH

### MP-102: R¹³, R¹⁴, R¹⁵, R¹⁶: CH₂OCH₃

### MP-103: R¹³, R¹⁴, R¹⁵, R¹⁶: CH₂O-i-C₄H₉

### MP-104: R¹³, R¹⁴, R¹⁵, R¹⁶: CH₂O-n-C₄H₉

### MP-105: R¹³, R¹⁴, R¹⁵, R¹: CH₂NHCOCH═CH₂

### MP-106: R¹³, R¹⁵, R¹⁶: CH₂NHCO(CH₂)₇CH═CH(CH₂)₇CH₃

### MP-107: R¹³, R¹⁴, R¹⁵: CH₂OH; R¹⁶: CH₂OCH₃

### MP-108: R¹³, R¹⁴, R¹⁶: CH₂OH; R¹⁵: CH₂OCH₃,

MP-109: R¹³, R¹⁴: CH₂OH; R¹⁵, R¹⁶: CH₂OCH₃

### MP-110: R¹³, R¹⁶: CH₂OH; R¹⁴, R¹⁵: CH₂OCH₃

MP-111: R¹³: CH₂OH; R¹⁴, R¹⁵, R¹⁶: CH₂OCH₃

### MP-112: R¹³, R¹⁴, R¹⁶: CH₂OCH₃; R¹⁵: CH₂OH

### MP-113: R¹³, R¹⁶: CH₂OCH₃; R¹⁴, R¹⁵: CH₂OH

### MP-114: R¹³, R¹⁴, R¹⁵: CH₂OH; R¹⁶: CH₂O-i-C₄H₉

### MP-115: R¹³, R¹⁴, R¹⁶: CH₂OH; R¹⁵: CH₂O-i-C₄H₉

### MP-116: R¹³, R¹⁴: CH₂OH; R¹⁵, R¹⁶: CH₂O-i-C₄H₉

### MP-117: R¹³, R¹⁶: CH₂OH; R¹⁵, R¹⁶: CH₂O-i-C₄H₉

### MP-118: R¹³: CH₂OH; R¹⁴ R¹⁵, R¹⁶: CH₂O-i-C₄H₉

### MP-119: R¹³, R¹⁴, R¹⁶: CH₂O-i-C₄H₉; R¹⁵: CH₂OH

### MP-120: R¹³, R¹⁶: H₂O-i-C₄H₉; R¹⁴, R¹⁵: CH₂OH

### MP-121: R¹³, R¹⁴; R¹⁵: CH₂OH; R¹⁶: CH₂O-n-C₄H₉

### MP-122: R¹³, R¹⁴, R¹⁶: CH₂OH; R¹⁵: CH₂O-n-C₄H₉

### MP-123: R¹³, R¹⁴: CH₂OH; R¹⁵, R¹⁶: CH₂O-n-C₄H₉

### MP124: R¹³, R¹⁶: CH₂OH; R¹⁴; R¹⁵: CH₂O-n-C₄H₉

### MP-125: R¹³: CH₂OH; R¹⁴, R¹⁵, R¹⁶: CH₂O-n-C₄H₉

MP-126: R¹³, R¹⁴, R¹⁶: CH₂-n-C₄H₉; R¹⁵: CH₂OH

### MP-127: R¹³, R¹⁶: CH₂O-n-C₄H₉; R¹⁴, R¹⁵: CH₂OH

MP-128: R¹³, R¹⁴: CH₂OH; R¹⁵: H₂OCH₃; R¹⁶: CH₂O-n-C₄H₉
MP-129: R¹³, R¹⁴: CH₂OH; R¹⁵: CH₂-n-C₄H₉; R¹⁶: CH₂OCH₃
MP-130: R¹³, R¹⁶: CH₂OH; R¹⁴: CH₂OCH₃; R¹⁵: CH₂O-n-C₄H₉
MP-131: R¹³: CH₂OH; R¹⁴, R¹⁵: CH₂OCH₃; R¹⁶: CH₂O-n-C₄H₉
MP-132: R¹³: CH₂OH; R¹⁴, R¹⁶: CH₂OCH₃; R¹⁵: CH₂O-n-C₄H₉
MP-133: R¹³: CH₂OH; R¹⁴: CH₂OCH₃; R¹⁵, R¹⁶: CH₂O-n-C₄H₉
MP-134: R¹³: CH₂OH; R¹⁴, R¹⁵: CH₂O-n-C₄H₉; R¹⁶: CH₂OCH₃
MP-135: R¹³, R¹⁴: CH₂OCH₃; R¹⁵: CH₂OH; R¹⁶: CH₂O-n-C₄H₉
MP-136: R¹³, R¹⁶: CH₂OCH₃; R¹⁴: CH₂OH; R¹⁵: CH₂O-n-C₄H₉
MP-137: R¹³: CH₂OCH₃; R¹⁴, R¹⁵: CH₂OH; R¹⁶: CH₂O-n-C₄H₉
MP-138: R¹³, R¹⁶: CH₂O-n-C₄H₉; R¹⁴: CH₂OCH₃; R¹⁵: CH₂OH
MP-139: R¹³: CH₂OH; R¹⁴: CH₂OCH₃; R¹⁵: CH₂O-n-C₄H₉; R¹⁶: CH₂NHCOCH═CH₂
MP-140: R¹³: CH₂OH; R¹⁴: CH₂OCH₃; R¹⁵: CH₂NHCOCH═CH₂; R¹⁶ CH₂O-n-C₄H₉
MP-141: R¹³: CH₂OH; R¹⁴: CH₂O-n-C₄H₉; R¹⁵: CH₂NHCOCH═CH₂; R¹⁶: CH₂OCH₃
MP-142: R¹³: CH₂OCH₃; R¹⁴: CH₂OH; R¹⁵: CH₂O-n-C₄H₉; R¹⁶: CH₂NHCOCH═CH₂
MP-143: R¹³: CH₂OCH₃; R¹⁴: CH₂OH; R¹⁵: CH₂NHCOCH═CH₂; R¹⁶: CH₂O-n-C₄H₉
MP-144: R¹³: CH₂O-n-C₄H₉; R¹⁴: CH₂OCH₃; R¹⁵: CH₂OH; R¹⁶: CH₂NHCOCH═CH₂
MP-145: R¹³: CH₂OH; R¹⁴: CH₂OCH₃; R¹⁵: CH₂NHCO(CH₂)₇CH═CH(CH₂)₇CH₃; R¹⁶: CH₂NHCOCH═CH₂
MP-146: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-147: R¹³: CH₂OH; R¹⁴: CH₂NHCO(CH₂)₇CH═CH(CH₂)₇CH₃; R¹⁵ CH₂NHCOCH═CH₂; R¹⁶: CH₂OCH₃
MP-148: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-149: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-150: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

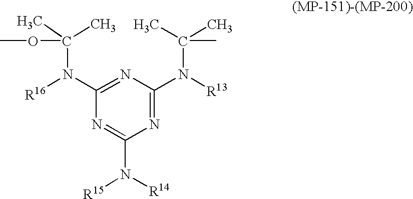

### MP-151: R¹³, R¹⁴, R¹⁵, R¹⁶: CH₂OH

### MP-152: R¹³, R¹⁴, R¹⁵, R¹⁶: CH₂OCH₃

### MP-153: R¹³, R¹⁴, R¹⁵, R¹⁶: CH₂O-i-C₄H₉

### MP-154: R¹³, R¹⁴, R¹⁵, R¹⁶: CH₂O-n-C₄H₉

### MP-155: R¹³, R¹⁴, R¹⁵, R¹⁶: CH₂NHCOCH═CH₂

### MP-156: R¹³, R¹⁴, R¹⁵, R¹⁶: CH₂NHCO(CH₂)₇CH═CH(CH₂)₇CH₃

### MP-157: R¹³, R¹⁴, R¹⁵: CH₂OH; R¹⁶: CH₂OCH₃

### MP-158: R¹³, R¹⁴, R¹⁶: CH₂OH; R¹⁵: CH₂OCH₃

### MP-159: R¹³, R¹⁴, R¹⁶: CH₂OH; R¹⁵, R¹⁶: CH₂OCH₃

### MP-160: R¹³R¹⁶: CH₂OH; R¹⁴, R¹⁵: CH₂OCH₃

### MP-161: R¹³: CH₂OH; R¹⁴ R¹⁵, R¹⁶: CH₂OCH₃

### MP-162: R¹³. R¹⁴, R¹⁶: CH₂OCH₃; R¹⁵: CH₂OH

### MP-163: R¹³, R¹⁶: CH₂OCH₃; R¹⁴, R¹⁵: CH₂OH

### MP-164: R¹³, R¹⁴, R¹⁵: CH₂OH; R¹⁶: CH₂O-i-CH₄H₉

### MP-165: R¹³, R¹⁴, R¹⁶: CH₂OH; R¹⁵: CH₂O-i-CH₄H₉

### MP-166: R¹³, R¹⁴: CH₂OH; R¹⁵, R¹⁶: CH₂O-i-C₄H₉

### MP-167: R¹³, R¹⁶: CH₂OH; R¹⁵, R¹⁶: CH₂O-i-C₄H₉

### MP-168: R¹³: CH₂OH; R¹⁴ R¹⁵, R¹⁶: CH₂O-i-C₄H₉

### MP-169: R¹³, R¹⁴, R¹⁶: CH₂O-i-C₄H₉; R¹⁵: CH₂OH

### MP-170: R¹³, R¹⁶: CH₂O-i-C₄H₉; R¹⁴, R¹⁵: CH₂OH

### MP-171: R¹³, R¹⁴, R¹⁵: CH₂OH; R¹⁶: CH₂O-n-C₄H₉

### MP-172: R¹³, R¹⁴, R¹⁶: CH₂OH; R¹⁵: CH₂O-n-C₄H₉

### MP-173: R¹³, R¹⁴: CH₂OH; R¹⁵, R¹⁶: CH₂O-n-C₄H₉

MP-174: R₁₃, R¹⁶: CH₂OH; R¹⁴, R¹⁵: CH₂O-n-C₄H₉

### MP-175: R¹³: CH₂OH; R¹⁴ R¹⁵, R¹⁶: CH₂O-n-C₄H₉

### MP-176: R¹³, R¹⁴, R¹⁶: CH₂O-n-C₄H₉; R¹⁵: CH₂OH

### MP-177: R¹³, R¹⁶: CH₂O-n-C₄H₉; R¹⁴, R¹⁵: CH₂OH

MP-178: R¹³, R¹⁴: CH₂OH; R¹⁵: CH₂OCH₃; R¹⁶: CH₂O-n-C₄H₉
MP-179: R¹³, R¹⁴: CH₂OH; R¹⁴: CH₂-n-C₄H₉; R¹⁶: CH₂OCH₃
MP-180: R¹³, R¹⁶: CH₂OH; R¹⁴: CH₂OCH₃; R¹⁵: CH₂O-n-C₄H₉
MP-181: R¹³: CH₂OH; R¹⁴, R¹⁵: CH₂OCH₃; R¹⁶: CH₂O-n-C₄H₉
MP-182: R¹³: CH₂OH; R¹⁴, R¹⁶: CH₂OCH₃; R¹⁵: CH₂O-n-C₄H₉
MP-183: R¹³: CH₂OH; R¹⁴: CH₂OCH₃; R¹⁵, R¹⁶: CH₂O-n-C₄H₉
MP-184: R¹³: CH₂OH; R¹⁴, R¹⁵: CH₂O-n-C₄H₉; R¹⁶: CH₂OCH₃
MP-185: R¹³, R¹⁴: CH₂OCH₃; R¹⁵: CH₂OH; R¹⁶: CH₂O-n-C₄H₉
MP-186: R¹³, R¹⁶: CH₂OCH₃; R¹⁴: CH₂OH; R¹⁵: CH₂O-n-C₄H₉
MP-187: R¹³: CH₂OCH₃; R¹⁴, R¹⁵: CH₂OH; R¹⁶: CH₂O-n-C₄H₉
MP-188: R¹³, R¹⁶: CH₂O-n-C₄H₉; R¹⁴: CH₂OCH₃; R¹⁵: CH₂OH
MP-189: R¹³: CH₂OH; R¹⁴: CH₂OCH₃; R¹⁵: CH₂O-n-C₄H₉; R¹⁶: CH₂NHCOCH═CH₂
MP-190: R¹³: CH₂OH; R¹⁴: CH₂OCH₃; R¹⁵: CH₂NHCOCH═CH₂; R¹⁶ CH₂O-n-C₄H₉
MP-191: R¹³: CH₂OH; R¹⁴: CH₂O-n-C₄H₉; R¹⁵: CH₂NHCOCH═CH₂; R¹⁶: CH₂OCH₃
MP-192: R¹³: CH₂OCH₃; R¹⁴: CH₂OH; R¹⁵: CH₂O-n-C₄H₂; R¹⁶: CH₂NHCOCH═CH₂
MP-193: R¹³: CH₂OCH₃; R¹⁴: CH₂OH; R¹⁵: CH₂NHCOCH═CH₂; R¹⁶: CH₂O-n-C₄H₉
MP-194: R¹³: CH₂O-n-C₄H₉; R¹⁴: CH₂OCH₃; R¹⁵: CH₂OH; R¹⁶: CH₂NHCOCH═CH₂
MP-195: R¹³: CH₂OH; R¹⁴: CH₂OCH₃; R¹⁵: CH₂NHCO(CH₂)₇CH═CH(CH₂)₇CH₃; R¹⁶: H₂NHCOCH═CH₂
MP-196: R¹³: CH₂OH; R¹⁴: CH₂OCH₃; R¹⁵: CH₂NHCO═CH₂; R₁₆: CH₂NHCO(CH₂)₇CH═CH(CH₂)₇CH₃
MP-197: R¹³: CH₂OH; R¹⁴: CH₂NHCO(CH₂)₇CH═CH(CH₂)₇CH₃; R¹⁵: CH₂NHCOCH═CH₂; R¹⁶: CH₂OCH₃
MP-198: R¹³: CH₂OCH₃; R¹⁴: CH₂OH; R¹⁵: CH₂NHCO(CH₂)₇CH═CH(CH₂)₇CH₃; R¹⁶: CH₂NHCOCH═CH₂
MP-199: R¹³: CH₂OCH₃; R¹⁴: CH₂OH; R¹⁵: CH₂NHCOCH═CH₂; R¹⁶: CH₂NHCO(CH₂)₇CH═CH(CH₂)₇CH₃
MP-200: R¹³: CH₂NHCO(CH₂)₇CH═CH(CH₂)₇CH₃; R¹⁴: CH₂OCH₃; R¹⁵: CH₂OH; R¹⁶: CH₂NHCOCH═CH₂

In the present invention, employed may be copolymers in which at least two types of the above repeating-units are combined.

Further, simultaneously employed may be at least two types of compounds having a 1,3,5-triazine ring. Also simultaneously employed may be at least two types of disk shaped compounds (for example, compounds having a 1,3,5-triazine ring and compounds having a porphyrin skeleton).

The amount of additives containing a rod-shaped compound or a disc shaped compound is preferably 0.2-30% by weight with respect to the optical compensating film, but is particularly preferably 1-20% by weight.

### (Polymers)

Polymers or oligomers other than cellulose ester may be incorporated in the poralizing plate protective film A of the invention. The polymers or oligomers are preferably those having excellent compatibility with the cellulose ester. Transmittance of the cellulose ester film of the invention is preferably not less than 80%, more preferably not less than 90%, and still more preferably not less than 92%. Cellulose ester in which at least one of the polymers and the oligomers is incorporated has advantages that its melt viscosity can be adjusted and physical properties of the film formed from the cellulose ester are improved. In that case, the above-described additives may be incorporated in the polymer.

### (Film Formation)

The polarizing plate protective film of the present invention can be obtained as follows. The composition of cellulose ester and additive, being subjected to melt extrusion, is extruded as a film from a T-type die to be in contact with a cooling drum using an electrostatic discharge method, and cooled to obtain an unstretched film. The temperature of the cooling drum is preferably maintained at 90 to 150° C.

The melt extrusion may be performed using a monoaxial extruder, a biaxial extruder, or using a biaxial extruder which has a monoaxial extruder connected downstream thereof, but it is preferable that the monoaxial extruder is used in view of the mechanical strength and optical properties of the resulting film. Also, it is preferable that the usual ambient air supplied to the raw material tank, the raw material charge section and the extruder interior and during the melting process is replaced by an inactive gas such as nitrogen, or that the pressure of the ambient air is reduced.

The temperature during melt extrusion is preferably in the range of 150 to 250° C., and more preferably 200 to 240° C.

When film constituent materials are melted, the content of a volatile component is preferably at most 1% by weight, more preferably at most 0.5% by weight, still more preferably 0.2% by weight, yet more preferably 0.1% by weight. In the present invention, a reduced weight by heating from 30° C. to 350° C. is determined using a differential thermogravimetric analyzer (TG/DTA200, produced by Seiko Instruments & Electronics Ltd.) and then the weight is designated as the content of the volatile composition.

The polarizing plate protective film A of the present invention is produced by extruding a melted resin composition into a film, followed by being cooled with a cooling roll.

It is preferable that only a few or no depressed portions such as die lines be present on the surface of the film of the present invention. It is ideal that no depressed portions such as die lines exist. However, it is practically difficult to realize no presence of the depressed portions, not a few of which, therefore, may exist. When a depressed portion is present on the surface, the depth of the depressed portion, when designated as Δd, is preferably at most 0.5 μm, more preferably at most 0.3 μm, still more preferably at most 0.1 μm, yet more preferably at most 0.05 μm, and even yet more preferably at most 0.01 μm.

The polarizing plate protective film A of the present invention is preferably a film formed by stretching in the transverse direction or in the film formation direction as described later.

A stretched film is subjected to slit processing of cutting both of the film edges, followed by being rewound. In the slit edge portion (the returning material), a cellulose resin or an additive may partially be decomposed due to heat generated during melt film formation. In this case, disposal thereof is preferable to reuse, and therefore no returning material will be used as a part of the raw material. However, the returning material composed of the cellulose resin or the additive decomposed to a minor extent can be reused as a part of the raw material. The ratio of the reusable returning material incorporated in a melted substance is preferably from about 1% about 50%. It is preferable to minutely cut the slit film edge portion to a size of 1-30 mm and to use the resulting film for preparation of a melted composition. The film is dried again, if appropriate, and reused as a part of the raw material. The cut material may further be pelletized for preparation of a melted composition. Further, it is also preferable to reuse, as a part of the raw material, a cellulose resin obtained by washing the cut material to eliminate an additive or a decomposed substance thereof. Any returning material is preferably kept so as not to absorb moisture until melted again. For this reason, it is preferable to perform a conveyance process, a cutting process, and a storage process for portions ranging from the slit portion to the film edge portion under low humidity conditions or under an ambience where no moisture exists, namely under a dry air ambience. Further, the concentration of oxygen is also preferably low. The concentration of oxygen is at most 10%, preferably at most 5%, more preferably at most 1%, specifically preferably at most 0.1%. For example, performance under a dry nitrogen ambience is preferable. Processes ranging from a melt extrusion process to a slitting process are preferably conducted under low humidity conditions or under an ambience where no moisture exists. The concentration of oxygen is also preferably low. Specifically, an ambience of the melt extrusion section is preferably maintained under low humidity and low oxygen concentration conditions.

When stretching is carried out while water vapor is directed in a stretching process or when a treated returning material is reused, it is preferable to dry the returning material and eliminate moisture therein for reuse as a part of the raw material.

In order to prepare a polarizing plate protective film A of a laminated structure, it is possible to co-extrude compositions containing cellulose resins each featuring different concentrations of additives such as a plasticizer, a UV absorbent, or fine particles as described above. Herewith, for example, a polarizing plate protective film A featuring a skin layer/core layer/skin layer structure can be produced. For example, a larger amount of fine particles can be incorporated in the skin layer or the fine particles can be incorporated only in the skin layer. A larger amount of a plasticizer or a UV absorbent can be incorporated in the core layer than in the skin layer, or the plasticizer or the UV absorbent may be incorporated only in the core layer. Optionally, different types of plasticizers or UV absorbents each may be incorporated in the core layer and in the skin layer. For example, it is also possible to incorporate at least either of a low volatile plasticizer and a UV absorbent in the skin layer and to incorporate a plasticizer exhibiting enhanced plasticity or a UV absorbent exhibiting enhanced UV absorbability in the core layer. The skin layer and the core layer each may have different Tg's, and Tg of the core layer is preferably lower than that of the skin layer. Further, there may be a difference between the skin layer and the core layer in viscosity, during melt casting, of a melted substance containing a cellulose resin. Further, the relationship either of (the viscosity of the skin layer>the viscosity of the core layer) or of (the viscosity of the core layer≧the viscosity of the skin layer) may be satisfied.

Via a co-extrusion method, the concentration of an additive such as a plasticizer in the film thickness direction can be distributed to decrease the content thereof on the surface. Further, via a single layer extrusion method, a uniform film featuring less distribution of the additive in the film thickness direction can be realized. The thus-produced films can preferably be used.

The width of a polarizing plate protective film used in the present invention is preferably from 1-4 m, more preferably from 1.3-3 m, still more preferably from 1.4-2 m. The thickness thereof is preferably from 10-500 μm, more preferably from 20-200 μm, still more preferably from 30-150 μm, yet more preferably from 60-120 μm. The length per roll is preferably from 300-6000 m, more preferably from 500-5000 m, still more preferably from 1000-4000 m when an individual film is wound. In cases when wound, the film is preferably subjected to knurling for at least either of the edges, preferably for both thereof. The width of knurling is preferably from 3 mm-5 mm, more preferably from 5 mm-30 mm, and the height thereof is preferably from 5-500 μm, more preferably from 8-200 μm, still more preferably from 10-50 μm. In this case, either single-sided or double-sided knurling may be conducted.

### (Stretching Operation)

A preferred stretching operation to obtain the polarizing plate protective film A of the present invention will be described.

Improvement of flatness and control of retardation of the polarizing plate protective film A of the invention can be achieved by stretching appropriately. When the stretching is performed by a factor of 1.01 to 3.0 in one direction of the cellulose ester film and by a factor of 1.01 to 2.5 in the direction in plane of the film perpendicular to that direction, the preferable range of retardation can be obtained.

For example, the film can be successively or simultaneously stretched in the mechanical direction and in the direction (transverse direction) in plane normal to the mechanical direction. In this case, too small stretching magnification in at least one direction provides insufficient optical retardation, while too much stretching magnification results in rupture of the film.

For example, when film is stretched in the casting direction, too much contraction in the transverse direction of the film provides too large refractive index in the thickness direction of the film. In this case, improvement can be carried out by restraining the contraction in the transverse direction of the film or by stretching the film in the transverse direction.

When the film is stretched in the transverse direction, diversion of refractive index may be produced in the transverse direction. This phenomenon is sometimes found in a tenter method, and is considered to be due to so-called bowing phenomenon, which is caused by the fact that the film center shrinks and the film edges are fixed. In this case also, the bowing phenomenon is restrained by stretching the film in the casting direction, whereby diversion of refractive index in the transverse direction is minimized and improved.

Further, stretching in the two directions crossing at right angles each other can minimize variation of film thickness. Too much variation of film thickness of the polarizing plate protective film A will cause unevenness of the optical retardation, resulting in color unevenness of images of a liquid crystal display.

Variation of thickness of the polarizing plate protective film A is preferably in the range within preferably ±3%, and more preferably ±1%. In order to meet the requirements described above, stretching in the two directions crossing at right angles each other is effective, wherein finally, the film is stretched in the casting direction by a magnification of preferably from 1.0 to 2.0, and more preferably from 1.01 to 1.5, and in the transverse direction by a magnification of preferably from 1.01 to 2.5, and more preferably from 1.2 to 2.0.

As a retardation film, in order to control retardation in the in-plane or thickness direction, free edge monoaxial stretching may be carried out in the film formation direction, or unbalanced biaxial stretching may be carried out to stretch the film in the transverse direction and to contract the film in the longitudinal direction. The magnification in the contraction direction is preferably a factor of 0.7-1.0.

When cellulose ester providing a positive birefringence to stress is employed, stretching in the transverse direction can give the delayed phase axis to the transverse direction of cellulose ester film. In order to improve display quality, the delayed phase axis is preferably in accordance with the transverse direction of the polarizing plate protective film A, and it is necessary to meet the relationship (stretching magnification in the transverse direction)>(stretching magnification in the casting direction).

A film, having been prepared by extruding a melted resin composition, followed being cooled with a cooling roll, prior to stretching, is preferably heat-treated (pre-heat treatment) under the following conditions: in a temperature range of 50-200° C., preferably 50-180° C., more preferably 60-160° C., still more preferably 70-150° C.; in a duration range of 5 seconds-3 minutes, preferably 10 seconds-2 minutes, more preferably 15 seconds-90 seconds. This heat treatment is preferably conducted from immediately before holding of the film with a tenter until immediately before initiation of stretching. The heat treatment is specifically preferably carried out from after holding of the film with the tenter until immediate before initiation of stretching.

Stretching is preferably carried out at a rate of 5-300%/minute, more preferably from 10-200%/minute, still more preferably from 15-150%/minute. In this case, stretching is preferably carried out from 80-180° C., more preferably from 90-160° C., still more preferably from 100-150° C. The stretching is preferably conducted while both of the film edges are held using a tenter.

The stretching angle is preferably from 2°-10°, more preferably from 3°-7°, most preferably from 3°-5°. The stretching rate may be constant or varied.

Less distribution of the ambience temperature in a tenter process is preferable. The distribution in the transverse direction is preferably at most ±5°, more preferably at most ±2°, still more preferably at most ±1°, most preferably at most ±5°. Heat treatment in the tenter process is preferably conducted in the range of a heat transfer coefficient of 20 J/m²hr-130×10³ J/m²hr, more preferably from 40 J/m² hr-130×10³ J/m²hr, most preferably from 42 J/m²hr-84×10³ J/m²hr.

The conveyance rate in the longitudinal direction during film formation is preferably from 10-200 m/minute, more preferably from 20-120 m/minute.

The film conveyance tension in a film formation process such as in the tenter process is preferably from 120 N/m-200 N/m, more preferably from 140 N/m-200 N/m, depending on humidity. The most preferable range is from 140 N/m-160 N/m.

In order to prevent unintentional stretching of the film in the film formation process, a tension cut roll is preferably arranged before or after the tenter.

Biaxial stretching employed in the present invention is preferably carried out by providing tension in the longitudinal direction (or in the conveyance direction) during roll conveyance. Preferable methods of providing tension in the conveyance direction include a method of providing tension between conveyance rolls of different circumferential speeds or a method of providing tension between two pairs of nip rolls.

Either or both of the paired nip rolls are preferably covered with rubber. When the moisture content of a stretched film is high, slipping thereof is easy to occur. Therefore, a rubber-covered film is preferably used. Materials of the rubber include natural rubber, synthetic rubber (neoprene rubber, styrene-butadiene rubber, silicone rubber, urethane rubber, butyl rubber, nitrile rubber, and chloroprene rubber). The thickness of the rubber is preferably from 1 mm-50 mm, more preferably from 2 mm-40 mm, still more preferably from 3 mm-30 mm. The diameters of the nip rolls are preferably from 5 cm-100 cm, more preferably from 10 cm-50 cm, still more preferably from 15 cm-40 cm. These nip rolls are also preferably made into a hollow shape to control temperature from the interior thereof.

When two pairs of the nip rolls are used, stretching is preferably conducted so that the temperature in the span between two pairs of the nip rolls is higher than that on the entrance nip rolls by 5-50° C. The distance of the span between the two-pairs of the nip rolls is preferably set 1 time-10 times as long as the width of a film prior to stretching, more preferably 2 times-8 times. Using the two pairs of the nip rolls set as described above, stretching is preferably carried out by allowing the temperature of both edges thereof to be higher than that of the center portion by 5° C.-50° C.

Further, with regard to the stretching rate S in this case, when the width of the film prior to stretching against the conveyance direction is WL1, stretching is preferably carried out at a stretching rate of 0.2WL1≦S≦2WL1 per second, more preferably at a stretching rate of 0.3WL1≦S≦1.8WL1 per second, still more preferably at a stretching rate of 0.4WL1≦S≦1.5WL1 per second. When the span distance falls within the above range and the stretching rate is controlled, a stretched film exhibiting better film thickness uniformity and better retardation uniformity can be realized. The temperature of the span between the two pairs of the nip rolls needs to be kept at a predetermined stretching temperature. Therefore, it is preferable to place the portion between the two pairs of the nip rolls in a thermostatic chamber to allow the film to be kept at the predetermined temperature. The film temperature is preferably controlled by blowing temperature-controlled air on the upper and the lower side of the film stretched. Herein, the temperature in the transverse direction can also be controlled to be uniform, but the temperature of both film edges is preferably higher than that of the center portion by 1-50° C. for stretching, more preferably by 5-40° C., still more preferably by 10-35° C. When stretching is carried out in the presence of temperature distribution in the transverse direction, distribution of retardation (Ro and Rt) in the transverse direction can be reduced. Raising the temperature of the edge portions can be realized via a method such that a radiation heat source such as an infrared heater or a halogen lamp or a slit which locally blows hot air is arranged. Incidentally, the temperature of the stretched portion is preferably from 100-180° C., more preferably from 110-170° C., still more preferably from 120-160° C. in the center portion of the film in the transverse direction. Specifically, the temperature of the center portion between the nip rolls preferably falls within this range.

Stretching is carried out in such a manner that the temperature of the span between two pairs of the nip rolls is higher than that on the entrance nip rolls by 5° C.-50° C., preferably by 7° C.-40° C., still more preferably by 10° C.-30° C. The temperature of the span between the two pairs of the nip rolls refers to an average temperature in a half of the center portion of the nip roll span. In common stretching, the temperature in the longitudinal direction is controlled to be uniform during stretching, but the above temperature distribution can optionally be provided. Namely, when temperature is uniform in the entire stretching zone, stretching is conducted over the entire zone. Specifically, stretching is initiated at the site where the entrance nip rolls are arranged. However, the film is fixed on the nip rolls and therefore no neck-in takes place in the transverse direction, but abrupt neck-in is initiated just after leaving therefrom. In this manner, stress in the transverse direction discontinuously varies, whereby stress non-uniformity in the transverse direction is liable to occur, resulting in a tendency to cause thickness or Re non-uniformity. In the present invention, by raising temperature at the site after the entrance nip rolls, it is possible to shift the point where stretching is initiated after the nip rolls. Accordingly, since the stretching initiation point is not restricted by the nip-rolls, the above discontinuous stress variation tends not to occur, resulting in minimal Re or thickness non-uniformity due to stress non-uniformity. Such temperature distribution in the longitudinal direction is preferably provided at least at either of the center portion in the transverse direction and the edge portions. Temperature control of the entrance nip rolls can easily be realized via the following method: at least one roll of the nip rolls is assigned as a temperature controlling roll, for example, a hollow roll, in which a temperature controlled liquid medium is circulated or a heat source such as an IR heater is placed to control the output heat.

The nip pressure of the nip rolls is preferably from 0.5 t-20 t, more preferably from 1 t-10 t, still more preferably from 2 t-7 t per in terms of 1 m width. In the present invention, stretching is preferably carried out at a temperature of 50° C.-150° C., more preferably from 60° C.-140° C., still more preferably from 70° C.-130° C. Temperature is commonly uniform in the transverse direction and in the longitudinal direction. However, in the present invention, temperature difference is preferably made at least in either direction. The temperature difference is preferably from 1° C.-20° C., more preferably from 2° C.-17° C., still more preferably from 2° C.-15° C. Since a film containing moisture exhibits a decreased glass transition point (Tg), the film can be stretched with a small stress but neck-in tends to occur, resulting in a tendency to cause stretch non-uniformity. To prevent this problem, temperature distribution as described below is effectively provided.

### <Temperature Distribution in the Longitudinal Direction>

In nip roll stretching, since stress tends to be concentrated in the upstream nip roll outlet (namely the stretching initiation point), and then a film is intensively stretched therein, whereby the film is hardly stretched uniformly. Namely, in order to carry out uniform stretching over the entire area, it is preferable that the temperature at the site just after the upstream nip roll be controlled to be lower than the average temperature of the stretching area (that is, the temperature in the center of the stretching area in the longitudinal direction) by the temperature difference described above. Such temperature distribution can be realized as follows: the upstream nip roll is used as a temperature controlling roll whose temperature is lowered, or a divided heat source (a radiation heat source such as an IR heater or a heat blow outlet with plural blow outlet ports) is used.

<temperature Distribution in the Transverse Direction>

Stretching at a small aspect ratio tends to cause stretch non-uniformity in the transverse direction. Namely, both edges of a film are readily stretched, compared to the center portion thereof. Therefore, the temperature of both edges of the film is preferably higher than that of the center portion thereof in the transverse direction by the above temperature. Such temperature distribution can be realized using a divided heat source (a radiation heat source such as an IR heater or a heat blow outlet with plural blow outlet ports) arranged in the transverse direction.

Stretching under these conditions is preferably conducted for 1-30 seconds, more preferably for 2-25 seconds, still more preferably for 3-20 seconds.

After stretching, strain remaining in the film is preferably reduced via heat treatment. The heat treatment is preferably carried out at a temperature of 80-200° C., more preferably from 100-180° C., still more preferably from 130-160° C. In this case, the heat treatment is preferably conducted in the range of a heat transfer coefficient of 20 J/m²hr-130×10³ J/m²hr, more preferably from 40 J/m²hr-130×10³ J/m²hr, most preferably from 42 J/m²hr-84×10³ J/m²hr. Herewith, the residual strain is reduced, whereby dimensional stability under high temperature conditions, e.g. at 90° C., or under high temperature-high humidity conditions, e.g. at 80° C. and 90% RH, is improved.

The stretched film is cooled to room temperature after stretching. The stretched film preferably begins to be cooled while held by a tenter in the transverse direction. During cooling, the width of the film held by the tenter is preferably contracted for relaxation by 1-10%, more preferably by 2-9%, still more preferably by 2-8% based on the width of the film having been stretched. The cooling rate is preferably from 10-300° C./minute, more preferably from 30-250° C./minute, still more preferably from 50-200° C./minute. The film may be cooled to room temperature while held by the tenter, but it is preferable to terminate the holding in mid-course and to switch to roll conveyance. Thereafter, the film is wound into a roll.

The polarizing plate protective film A of the present invention thus produced exhibits the following characteristics.

### (Optical Characteristics)

In the polarizing plate protective film A of the present invention, it is preferable that the retardation value Ro thereof, defined by Formula (1) described below, be in the range of 0-300 nm and the retardation value Rt thereof, defined by Formula (II) described below, be in the range of −600-600 nm. Further, more preferably, the range of the value Ro is from 0-80 nm and the range of the value Rt is from −400-400 nm, while specifically preferably, the range of the value Ro is from 0-40 nm and the range of the value Rt is from −200-200 nm.

When the polarizing plate protective film A of the present invention is employed as a retardation film, specifically as a λ/4 plate, birefringence in a wavelength range of 400-700 nm increases as the wavelength increases. Further, the retardation value (R450) in the in-plane direction determined at a wavelength of 450 nm is from 80-125 nm, and also the retardation value (R590) in the in-plane direction determined at a wavelength of 590 nm is 120-160 nm. In this case, the relationship of R590−R450≧5 nm is more preferably satisfied, and further the relationship of R590−R450≧10 nm is most preferably satisfied. It is preferable that R450 be from 100-120 nm; the retardation value R550 in the in-plane direction determined at a wavelength of 550 nm be from 125-142 nm; R590 be from 130-152 nm; and R590−R550≧2 nm. It is more preferable that R590−R550≧5 nm, and further it is most preferable that R590−R550≧10 nm. It is also preferable that R550−R450≧10 nm.

Ro=(Nx−Ny)×d Formula (I)

Rt={(Nx+Ny)/2−Nz}×d Formula (II)

wherein Nx represents a refractive index in the direction where the in-plane refractive index is maximum; Ny represents a refractive index in plane with a film in the direction at right angles to Nx; Nz represents a refractive index in the thickness direction of the film; and d represents a film thickness (nm).

By controlling the retardation values in the above ranges, it is possible that optical performance, specifically as a polarizing plate retardation film, is sufficiently satisfied.

In the film of the present invention, it is preferable that a refractive index Nx in the delayed phase axis direction in plane with the film determined at a wavelength of 590 nm, a refractive index Ny in the direction at right angles to the delayed phase axis in plane with the film, and a refractive index Nz in the thickness direction preferably satisfy the relationship of 0.3≦(Nx−Nz)/(Nx−Ny)≦2, however, more preferably the relationship of 1≦(Nx−Nz)/(Nx−Ny)≦2.

Further, the difference between the refractive index Nx in the delayed phase axis direction and the refractive index Ny in the advanced phase direction in plane with the polarizing plate protective film A of the present invention is preferably from 0-0.0050, more preferably from 0.0010-0.0030. Additionally, an absolute value of (Nx+Ny)/2−Nz is preferably at most 0.005.

The ratio Rt/Ro is preferably from −10-10, more preferably from −2-2, still more preferably from −1.5-1.5, specifically preferably from −1-1. A preferable range is selected depending on the application.

Humidity dependence of the values Ro and Rt of the polarizing plate protective film A of the present invention determined at a wavelength of 590 nm is preferably at most 2%/% RH and at most 3%/% RH, respectively, in terms of an absolute value in the range of 30° C. and 15% RH−30° C. and 85% RH.

A value Rt (Rt450) determined at a wavelength of 450 nm and a value Rt (Rt650) determined at a wavelength of 650 nm preferably satisfy the relationship of the following formula.

0≦|Rth450−Rth650|≦35 (nm)

Temperature dependence of the values Ro and Rt in the range of 5-85° C. is preferably at most 5%/° C. and at most 6%/° C., respectively, in terms of an absolute value.

In the polarizing plate protective film A of the present invention, humidity dependence of the values Ro and Rt is preferably at most 2%/% RH and at most 3%/% RH, respectively, in terms of an absolute value in the range of 30° C. and 15% RH−30° C. and 85% RH.

Humidity dependence of the values Ro and Rt in the range of 15° C.-40° C. and of 15% RH-85% RH is preferably as small as possible. For the value in the above temperature range at 50% RH, humidity dependence is preferably at most 2%/% RH and 3%/% RH, respectively, in terms of an absolute value. Specifically, humidity dependence in the range of 30° C. and 15% RH−30° C. and 85% RH is preferably at most 2%/% RH and at most 3%/% RH, respectively, in terms of an absolute value, specifically preferably at most 1.5%/% RH and at most 2.5%/% RH, respectively.

It is preferable that these exhibit a smaller difference in equilibrium moisture content at different humidity conditions. For example, at two humidity ambiences of 30° C. and 15% RH as well as 30° C. and 85% RH, the difference WH in equilibrium moisture content, represented by a formula described below, is preferably at most 2.5%, more preferably at most 2%, still more preferably at most 1.5%, yet more preferably at most 1% even yet more preferably at most 0.5%.

WH=equilibrium moisture content at 30° C. and 85% RH−equilibrium moisture content at 30° C. and 15% RH

The content of a plasticizer is increased to reduce variation of the equilibrium moisture content. It is effective to add an additive such as a plasticizer or resin, exhibiting hydrophobic properties, having an aromatic ring, a cycloalkyl ring, or a norbornene ring, or to set a relatively high temperature for heat treatment after stretching (for example, 110-180° C.).

Further, temperature dependence of the values Ro and Rt in the range of 15% RH-85% RH and of 5° C.-85° C. is preferably as small as possible. For the value at 30° C., the variation of the value Ro is preferably at most ±5%/° C. and the variation of the value Rt is preferably at most ±6%/° C. Further, in the range of 5° C. and 55% RH−85° C. and 55% RH, the variations of the values Ro and Rt are more preferably at most ±3%/° C. and at most ±4%/° C., respectively; the variations of the values Ro and Rt are still more preferably at most ±1%/° C. and at most ±2%/° C., respectively; and the variations of the values Ro and Rt are yet more preferably at most ±0.5%/° C. and at most ±1%/° C., respectively.

In the polarizing plate protective film A of the present invention, with respect to the value Ro determined by allowing the film to stand at 23° C. and 55% RH for 24 hours, the value Ro determined by allowing the film to stand at 23° C. and 55% RH for 24 hours again after having been allowed to stand under an ambience of the range of a temperature of −30° C.-80° C. and a relative humidity of 10% RH-80% RH for 600 hours is preferably at most ±10%, more preferably at most ±3%. Similarly, with respect to the value Rt determined by allowing the film to stand at 23° C. and 55% RH for 24 hours, the value Rt determined by allowing the film to stand at 23° C. and 55% RH for 24 hours again after having been allowed to stand in an ambience of the range of a temperature of −30° C.-80° C. and a relative humidity of 10% RH-80% RH for 600 hours is preferably at most ±10%, more preferably at most ±3%. It is more preferable that the variation fall within the above range even after the film is allowed to stand for a long time such as at least 1000 hours.

The polarizing plate protective film A of the present invention preferably exhibits increasing phase difference in the range of a wavelength of 400-700 nm, as the wavelength increases. Specifically, when each retardation in plane with the film determined at wavelengths of 450 nm, 590 nm, and 650 nm is designated as R450, R590, and R650, the following relationships are preferably satisfied:

0.5<R450/R590<1.0

1.0<R650/R590<1.5

The relationships of 0.7<R450/R590<0.95 and 1.01<R650/R590<1.2 are more preferably satisfied, while the relationships of 0.8<R450/R590<0.93 and 1.02<R650/R590 <1.1 are specifically preferably satisfied.

Each birefringence at wavelengths of 450, 590, and 650 nm under an ambience of 23° C. and 55% RH was determined using automatic birefringence meter KOBURA-21ADH (produced by Oji Scientific Instruments Co., Ltd.), and the resulting values were designated as R450, R590, or R650, respectively. Further, also with regard to retardation in the thickness direction, increasing phase difference is preferably exhibited, as the wavelength increases. Each ratio of retardation in the thickness direction at wavelengths of 450, 590, and 650 nm is preferably similar to each ratio of retardation in the above in-plane direction.

The retardation values (Ro and Rt) and each distribution were determined as follows. Automatic birefringence determination was conducted under an ambience of 23° C. and 55% RH at a wavelength of 590 nm at 1 cm intervals in the transverse direction of a sample using automatic birefringence meter KOBURA-21ADH (produced by Oji Scientific Instruments Co., Ltd.). The standard deviation of each retardation determined in the in-plane direction and in the thickness direction was obtained based on the (n−1) method. The variation coefficient (CV) of the retardation distribution shown below was obtained and designated as an index. In practical measurement, the number 130 was set as n.

Variation coefficient (CV)=standard deviation/retardation average

When the photoelastic coefficients in the longitudinal direction and in the transverse direction of the polarizing plate protective film A of the present invention are designated as C(md) and C(td), respectively, each value is preferably in the range of 1×10⁻⁸-1×10⁻¹⁴ Pa⁻¹, specifically preferably in the range of 1×10⁻⁹-1×10⁻¹³ Pa⁻¹. The photoelastic coefficient can be determined as follows. The retardation (Ro) in plane with a film is determined while applying a load to the film, followed by dividing the resulting retardation by the film thickness (d) to obtain Δn(=R/d). While varying the applied load, Δn is determined. Then, a load versus Δn curve is prepared and the resulting inclination is designated as the photoelastic coefficient. By applying the load to the film in the longitudinal direction or in the transverse direction, each value can be obtained. The retardation (R) in plane with the film was determined at a wavelength of 590 nm using a retardation measurement instrument (KOBURA 31PR, produced by oji Scientific Instruments Co., Ltd.).

It is preferable that the photoelastic coefficient C(md) be nearly equal to C(td) or C(td) be greater than C(md).

When the delayed phase axis or the advanced phase axis of the polarizing plate protective film A of the present invention is present in plane with the film and the angle to the film formation direction is designated as θ1, θ1 is preferably from −1°-+1°, more preferably from −0.5°-+0.5°. The θ1 is defined as an orientation angle and determined using automatic birefringence meter KOBURA-21ADH (produced by Oji Scientific instruments Co., Ltd.).

Allowing θ1 to satisfy the above relationship makes it possible to contribute to achieve a high luminance of a displayed image and to inhibit or prevent light leakage, as well as to realize faithful color reproduction in a color liquid crystal display device.

Further, the polarizing plate protective film A of the present invention is specifically preferably used on the backlight side.

Other physical properties of the polarizing plate protective film A of the present invention will now be described.

### (Moisture Permeability)

The moisture permeability of the polarizing plate protective film A of the present invention is preferably from 1-250 g/m²·24 hours, more preferably from 10-200 g/m²·24 hours, most preferably from 20-180 g/m²·24 hours under an ambience of 25° C. and 90% RH. The moisture permeability can be determined based on the method described in JIS Z0208.

### (Equilibrium-Moisture Content)

The equilibrium moisture content of the polarizing plate protective film A of the present invention is preferably from 0.1-3%, more preferably from 0.3-2%, specifically preferably from 0.5-1.5% at 25° C. and 60% RH.

The equilibrium moisture content can be determined without difficulty using a measurement instrument based on the Carl Fischer method (such as Carl Fischer moisture measurement instrument CA-05, produced by Mitsubishi Chemical Corp.; water vaporizing device: VA-05, internal liquid: AQUAMICRON CXμ, external liquid: AQUAMICRON AX, nitrogen flow rate: 200 ml/minute, and heating temperature: 150° C.). Specifically, a sample was subjected to moisture conditioning at 25° C. and 60% RH for at least 24 hours, and the collected sample weighing 0.6-1.0 g was precisely determined. Then, determination is carried out using the measurement instrument to obtain the equilibrium moisture content from the resulting amount of water.

The moisture content of the polarizing plate protective film A of the present invention is preferably from 0.3-15 g/m², more preferably from 0.5-10 g/m² at 30° C. and 85% RH to ensure adhesion to polyvinyl alcohol (a polarizer). When the moisture content is more than 15 g/m², retardation variation tends to increase due to temperature or humidity variation.

### (Dimensional Stability)

The polarizing plate protective film A of the present invention preferably exhibits excellent dimensional stability.

### (Dimensional Variation Ratio of Polarizing Plate Protective Film in the Transverse Direction and in the Longitudinal Direction)

When the polarizing plate protective film A is stretched in the transverse direction, stretching is preferably conducted under conditions to control the dimensional variation ratio within a certain range.

When the dimensional variation ratios in the transverse direction (hereinafter also referred to as the TD direction) and in the longitudinal direction (hereinafter also referred to as the MD direction) prior to and after treatment under a dry condition of 90° C. for 24 hours are designated as Std and Smd, respectively, the relationship of −0.4%<Std or Smd<0.4% is preferable; the relationship of −0.2%<Std or Smd<0.2% is more preferable; the relationship of −0.1%<Std or Smd<0.1% is still more preferable; however, the relationship of −0.05%<Std or Smd<0.05% is specifically preferable.

The dimensional variation ratios in the TD direction and in the MD direction prior to and after treatment under high temperature and high humidity conditions of 80° C. and 90% RH for 24 hours are designated in the same manner as described above. The relationship of −0.4%<Std or Smd<0.4% is preferable; the relationship of −0.2%<Std or Smd<0.2% is more preferable; the relationship of −0.1%<Std or Smd<0.1% is still more preferable; however, the relationship of −0.05%<Std or Smd<0.05% is specifically preferable.

### <Determination of Dimensional Variation Ratio>

The film was subjected to moisture conditioning in a room humidity-conditioned at 23° C. and 55% RH for 24 hours. Then, marks were made with a cutter at about 10 cm intervals in the transverse direction and in the longitudinal direction to determine a distance (L1), followed by storing the resulting film in a thermostatic chamber set at a specified temperature and humidity for 24 hours. The film was again subjected to moisture conditioning in the room humidity-conditioned at 23° C. and 55% RH for 24 hours to determine the marked distance (L2). The dimensional variation ratio was evaluated based on the following formula.

Dimensional variation ratio (%)={(L2−L1)/L1}×100

### (Hygroscopic Expansion Coefficient)

The hygroscopic expansion coefficient of the polarizing plate protective film A of the present invention preferably falls within a specified range. The hygroscopic expansion coefficients in the TD and the MD direction may be the same or different. Specifically, the hygroscopic expansion coefficient at 60° C. and 90% RH is preferably in the range of −1-1%, more preferably −0.5-0.5%, still more preferably −0.2-0.2%, most preferably 0-0.1%.

### <Determination of Hygroscopic Expansion Ratio>

The film was subjected to moisture conditioning in a room humidity-conditioned at 23° C. and 55% RH for 24 hours. Then, marks were made with a cutter at about 20 cm intervals in the transverse direction and in the longitudinal direction to determine a distance (L3), followed by storing the resulting film in a thermostatic chamber set at 60° C. and 90% RH for 24 hours. Then, the film was taken out from the thermostatic chamber to determine the marked distance (L4). The hygroscopic expansion ratio was evaluated based on the following formula.

Hygroscopic expansion ratio (%)={(L4−L3)/L3}×100

### (Thermal Contraction Initiating Temperature)

The thermal contraction initiating temperature of the polarizing plate protective film A of the present invention is preferably in the range of 130-220° C., more preferably 135-200° C., still more preferably 140-190° C. The thermal contraction initiating temperature can be determined using a TMA (a thermal mechanical analyzer). Specifically, while a film sample is heated, the length thereof is determined, and then the temperature is recorded when the sample is contracted by 2% with respect to the original length. The thermal contraction initiating temperature varies depending on the stretching ratio. However, the thermal contraction initiating temperature of a sample in the higher stretching ratio direction preferably falls within the above range.

A higher thermal contraction initiating temperature preferably results in minimal dimensional change due to heat. However, when the thermal contraction initiating temperature becomes excessively high, the melt temperature during melt casting also becomes higher. Therefore, it may be difficult to ensure smoothness of the film surface due to decomposition of resins during melting or an increase in melt viscosity. The thermal contraction initiating temperature varies depending on Tg of the film or strain remaining in the formed film. Thereby, the thermal contraction initiating temperature can be adjusted by controlling these factors above. Specifically, to minimize the residual strain in the film, there are preferably controlled stretching conditions (such as a stretching ratio, stretching temperature, or stretching rate), relaxation conditions after stretching, and heat treatment conditions.

### (Determination of Thermal Contraction Initiating Temperature)

A film is cut in the direction to be determined to prepare a sample measuring 35 mm in length and 3 mm in width. Both edges are chucked at 25 mm intervals in the longitudinal direction. Using a TMA measurement instrument (Thermomechanical Analyzer MODEL TMA2940, produced by TA Instruments Co.), dimensional change is determined via application of a force of 0.04 N while raising temperature from 30° C.-200° C. at a rate of 3° C./minute. The length at 30° C. is taken as a base length, and then a temperature at which contraction has been induced by 500 μm from the base length is designated as the contraction initiating temperature.

### (Heat Conductivity)

The heat conductivity of the film of the present invention is preferably from 0.1-15 W/(m·K), more preferably from 0.5-11 W/(m·K). It is preferable to blend a resin of a relatively high heat conductivity or to add relatively highly heat conductive particles in order to control the heat conductivity of the film. It is also possible to prepare the film by coating a highly heat conductive layer or via a co-extrusion. The highly heat conductive particles may include particles composed of aluminum nitride, silicon nitride, boron nitride, magnesium nitride, silicon carbide, aluminum oxide, zinc oxide, magnesium oxide, carbon, diamond, and metals. It is desirable to employ transparent particles to maintain transparency of the film. When a cellulose acetate film is used as a polymer film, the content of highly heat conductive particles is preferably in the range of 5-100 parts by weight based on 100 parts by weight of cellulose acetate. When the content is less than 5 parts by weight, heat conductivity is not adequately enhanced. When more than 50 parts by weight are filled, difficulty in production aspect and a brittle film are produced. The average particle diameter of the highly heat conductive particles is preferably from 0.05-80 μm, more preferably from 0.1-10 μm. The shape of the employed particles may be either spherical or acicular.

### (Tear Strength)

The tear strength of the polarizing plate protective film A of the present invention is preferably from 2-55 g at 30° C. and 85% RH so that handling in the film formation process employing melt casting is not deteriorated.

When the polarizing plate protective film A is stretched in the transverse direction, it is preferable to conduct stretching under conditions to control the ratio of the film tear strength in the machine conveyance direction (identical with the above longitudinal direction, hereinafter referred to as the MD direction) to that in the transverse direction (hereinafter referred to as the TD direction) within a given range. When Htd and Hmd represent the tear strengths in the TD direction and in the MD direction, respectively, the ratio thereof preferably satisfies the relationship of 0.5<Htd/Hmd <2, more preferably 0.6<Htd/Hmd<1, still more preferably 0.8<Htd/Hmd<1, most preferably 0.9<Htd/Hmd<1.

### <Determination of Tear Strength>

The polarizing plate protective film A was subjected to moisture conditioning in a room humidity-conditioned at 23° C. and 55% RH for 4 hours, and then the thus-treated film was cut to give sample pieces of a 50 mm×64 mm size. Subsequently, the tear strength was determined based on ISO 6383/2-1983.

### (Dynamic Friction Coefficient)

The dynamic friction coefficient of the surface of the film is preferably at most 1.0, more preferably at most 0.8, still more preferably at most 0.4, yet more preferably at most 0.35, even yet more preferably at most 0.30, most preferably at most 0.25. As described above, the dynamic friction coefficient can be decreased in such a manner that minute unevenness is formed by adding fine particles to a resin film or by providing a fine particle-containing layer on the surface.

### (Elastic Modulus)

The elastic modulus of the polarizing plate protective film A of the present invention in the TD direction and the MD direction may be the same or different. Specifically, the elastic modulus is preferably in the range of 1 GPa-5 GPa, more preferably 1.8 GPa 4 GPa, specifically preferably 1.9 GPa-3 GPa. The ratio of the elastic modulus of the MD direction to that of the TD direction can be allowed to satisfy the relationship of 0.3≦elastic modulus of the MD direction/elastic modulus of the TD direction≦3, but the relationship of 0.5≦elastic modulus of the MD direction/elastic modulus of the TD direction≦2 is preferable. The elastic modulus in the TD direction and the MD direction can be controlled via conditions for the stretching ratio, the stretching temperature, or the stretching rate in each direction or via relaxation after stretching.

### (Stress at Break)

The stress at break of the polarizing plate protective film A of the present invention is preferably in the range of 50-200 MPa. By maintaining the stress at beak in the above range, dimensional stability and flatness are improved. It is possible to control the stress at break via a stretching ratio or stretching temperature.

The stress at break is more preferably controlled in the range of 70-150 MPa, but is most preferably controlled in the range of 80-100 MPa.

### (Elongation at Break)

The elongation at break of the polarizing plate protective film A of the present invention is preferably from 10-120%. Specifically, in a film prior to stretching, the elongation at break, in any direction in plane with the film, is preferably in the range of 40-100%, more preferably 50-100%, still more preferably 50-100%, yet more preferably in the range of 60-90%. The elongation at break can be controlled by controlling the content of an additive, resin blending, addition of a polymer plasticizer such as polyester or polyurethane, the stretching temperature, the stretching ratio, thermal treatment after stretching, or relaxation conditions.

The elongation at break in the stretching direction tends to decrease compared to that prior to stretching, and to decrease as the stretching ratio increases. In the direction at right angles to the stretching direction at a maximum ratio on the film plane, the elongation at break of the film prior to stretching is preferably maintained as much as possible.

The elongation at break in the direction at right angles to the stretching direction at the maximum ratio on the film plane is preferably 20-120%, more preferably 30-100%. The elongation at break of the film of the present invention in the stretching direction at the maximum ratio is preferably 10-100%, more preferably 12-60%, still more preferably 15-30%.

By controlling the elongation at break to be in the above range, it is possible to realize a film exhibiting excellent flatness and to improve the dimensional stability thereof.

Elongation at break is a ratio (in percent) of the magnitude of elongation until just before the break due to elongation. Determination can be carried out using a tensile tester. A cut sample of a length of 15 cm and a width of 1 cm is prepared with respect to the direction to be determined. The sample, which has been subjected to moisture conditioning at 25° C. and 60% for 24 hours, is elongated under the same conditions and elongation at break is determined. In the tensile tester, the distance between the chucks is set to 10 cm and the pulling rate is set to 10 mm/minute. The ratio (expressed in percent) of the magnitude of elongation at break to the length of the sample prior to elongation is designated as elongation at break (%).

### <Determination Method of Elastic Modulus, Elongation at Break, and Stress at Break of Film>

Determination was carried out at 23° C. and 55% based on the method described in JIS K 7127. A film sample was cut into pieces of a width of 10 mm and a length of 130 mm. Tensile tests were conducted in such a manner that the distance between the chucks was set to 100 mm and the pulling rate was set to 100 mm/minute at an appropriate temperature to determine each value entitled above.

### (Center Line Average Roughness (Ra))

High flatness is required for the polarizing plate protective film A of the present invention. The center line average roughness (Ra) thereof is preferably from 0.0001-0.1 μm, more preferably at most 0.01 μm, specifically preferably at most 0.001 μm. Center line average roughness (Ra) is a numerical value specified by JIS B 0601 and is determined via a method such as a stylus method or an optical method.

Center line average roughness (Ra) was determined using a non-contact surface micro-shape measurement instrument WYKO NT-2000.

### (Thickness)

The thickness of a cellulose ester film produced in the present invention is commonly in the range of 5-500 μm. When used for the polarizing plate protective film A, the range is preferably from 20-200 μm from the viewpoint of dimensional stability and moisture barrier properties of a polarizing plate. Further, the thickness distribution of the film rolled is preferably at most ±3%, more preferably at most ±1%, still more preferably at most ±0.1% in the longitudinal direction and the transverse direction each.

The average thickness of the film can be adjusted to be a desired thickness by controlling the extrusion flow rate, the clearance of the casting outlet of the die, and the cooling roll speed.

### (Film Thickness Distribution)

A film sample was subjected to moisture conditioning in a room humidity-conditioned at 23° C. and 55% RH for 4 hours, and the film thickness was determined at 10 mm intervals in the transverse direction. The film thickness distribution R (%) was calculated from the thus-obtained film thickness distribution data based on the following formula.

R(%)={R(max)−R(min)}×100/R(ave)

wherein R(max) represents the maximum film thickness; R(min) represents the minimum film thickness; and R(ave) represents the average film thickness.

### (Curling)

The value of the gutter-shaped curl (curl in the transverse direction) of the film of the present invention is preferably at most 30 m⁻¹, more preferably 25 m⁻¹, still more preferably at most 20 m⁻¹. The curl value described herein is represented by a reciprocal of the curvature radius (determined in units of m) of the curl. As the value increases, curl is more noticeable. A curl determination method is described below. In cases of large curl, a polymer film may not become a gutter shape but may become a cylindrical shape. Even after the film is subjected to heat treatment, the resulting curl is preferably in the above range. It is possible to increase or decrease the gutter-shaped curl by providing a coating layer. Alternatively, by coating a solvent which swells or dissolves the film, it is possible to allow curling to occur on the interior side with respect to the coating side. Accordingly, via such a cancellation method, the curl can also be controlled to fall within a specified range.

### <Curl Determination Methods>

The film sample was allowed to stand at 25° C. and 55% RH for 3 days, and then cut into a piece of 50 mm in the transverse direction and 2 mm in the longitudinal direction, followed by being subjected to moisture conditioning under an ambience of 23° C.±2° C. and 55% RH for 24 hours. The curl value of the film can be determined using a curvature scale. The curl degree was determined based on Method A of JIS K 7619-1988.

A curl value is expressed by 1/R, wherein R is the curvature radius in units of m.

### (Luminescent Spot Foreign Matter)

A cellulose resin or melted composition used in the present invention preferably incorporates minimal luminescent spot foreign matters. The luminescent spot foreign matters refer to spots which are viewed as lighting spots due to light transmission of a light source wherein a cellulose resin film sample is placed between crossed nicols arranged polarizing plates, and while one side is exposed to light, observation is conducted from the other side. A polarizing plate protective film A for a display device is demanded to incorporate a minimal amount of these luminescent spot foreign matters. The number of luminescent spot foreign matters of a size of at least 10 μm is preferably at most 100/cm², specifically preferably zero substantially. The number of the foreign matters of a size of 5-10 μm is preferably at most 200/cm², more preferably at most 50/cm², specifically preferably zero substantially. Further, it is also desirable that the number of the luminescent spot foreign matters of a size of less than 5 μm be minimal. Luminescent spot foreign matters in the polarizing plate protective film A can be decreased by selecting a cellulose resin as a raw material which incorporates minimal foreign matters or by filtering a cellulose resin solution or cellulose resin melted substance.

### <Determination Method of Luminescent Spot Foreign Matter>

A film sample was interposed by two polarizing plates in an orthogonal state (in a crossed nicols state), and the exterior side of one of the polarizing plates was exposed to light and the number of lighting spots (luminescent spot foreign matters) per 25 mm² was determined from the exterior side of the other plate with a microscope (at a magnification factor of 30 using a transmitting light source). These luminescent spot foreign matters are foreign materials which are viewed as lighting spots generated by light, exposed from the outside, which is transmitted from spots only where the foreign materials are present. Determination was carried out at 10 locations and the number of the luminescent spot foreign matters per 250 mm² in total was determined in terms of the number/cm² for evaluation.

### (Image Definition)

Image definition, defined by JIS K-7105, is preferably at least 90%, more preferably 95%, still more preferably at least 99%, when determined using a 1 mm slit.

A functional layer which may be formed on the surface of the polarizing plate protective film A of the present invention will now be described.

### (Formation of Functional Layer)

During production of the polarizing plate protective film A of the present invention, prior to and after stretching, or prior to or after stretching, there may be coated a functional layer such as a transparent conductive layer, a hard coat layer, an antireflection layer, a lubricating layer, an adhesion aiding layer, an antiglare layer, a barrier layer, or an optical compensating layer. Specifically, it is preferable to arrange at least one layer selected from the group including a transparent conductive layer, an antireflection layer, an adhesion aiding layer, an antiglare layer, and an optical compensating layer. In this case, if appropriate, it is possible to carry out various surface treatments such as a corona discharge treatment, a plasma treatment, or a chemical treatment.

### <Transparent Conductive Layer>

In the film of the present invention, a transparent conductive layer can also preferably be provided, using a surfactant or conductive fine particle dispersion. Conductivity may be provided with the film itself or a transparent conductive layer may be provided. To provide antistatic properties, a transparent conductive layer is preferably provided. The transparent conductive layer can be provided using a method such as a coating method, atmospheric pressure plasma treatment, vacuum deposition, sputtering, or an ion-plating method. Alternatively, via a co-extrusion method, a transparent conductive layer is prepared by incorporating conductive fine particles only in the surface layer or in the interior layer. The transparent conductive layer may be provided on one side of the film or on both sides. Conductive fine particles can be employed together with a matting agent providing lubricating properties or can be employed also as a matting agent. The following metal oxide particles exhibiting conductivity can be employed as a conductive agent.

As examples of metal oxides, there are preferable ZnO, TiO₂, SnO₂, Al₂O₃, In₂O₃, SiO₂, MgO, BaO, MoO₂, and V₂O₅, or composite oxides thereof. Of these, ZnO, TiO₂, and SnO₂ are specifically preferable. As an example of incorporating a different type of atom, it is effective that Al or In is added to ZnO; Nb or Ta are added to TiO₂, or Sb, Nb, or a halogen element is added to SnO₂. The amount of such a different type of atom added is preferably in the range of 0.01-25 mol/%, specifically preferably 0.1-15 mol/%. The particle diameter of the metal oxide particles is preferably from 1-200 nm.

In the present invention, the transparent conductive layer may be formed in such a manner that conductive fine particles are dispersed in a binder and provided on a substrate, or a substrate is subjected to subbing treatment and then conductive fine particles are applied thereon.

Further, it is possible to incorporate an ionene conductive polymer represented by Formulas (1)-(V), described in Paragraph Nos. 0038-0055 of JP-A No. 9-203810, and a quaternary ammonium cationic polymer represented by Formula (1) or (2), described in Paragraph Nos. 0056-0145 of the above patent.

A heat resistant agent, a weather resistant agent, inorganic particles, a water-soluble resin, or an emulsion may optionally be added in the transparent conducive layer composed of a metal oxide to result in a matted surface or to improve film quality to the extent that the amount added does not adversely affect the effects of the present invention.

Binders used in the transparent conductive layer are not specifically limited provided that film forming capability is exhibited thereby, including, for example, protein such as gelatin or casein; cellulose compounds such as carboxymethyl cellulose, hydroxyethyl cellulose, acetyl cellulose, diacetyl cellulose, triacetyl cellulose, or cellulose acetate propionate; a saccharides such as dextran, agar, sodium alginates, or starch derivatives; and synthetic polymers such as polyvinyl alcohol, polyvinyl acetate, polyacrylate, polymethacrylate, polystyrene, polyacrylamide, poly-N-vinylpyrrolidone, polyester, polyvinyl chloride, or polyacrylic acid.

Specifically preferable are gelatin (such as lime-treated gelatin, acid-treated gelatin, oxygen-decomposed gelatin, phthalated gelatin, or acetylated gelatin), acetyl cellulose, diacetyl cellulose, triacetyl cellulose, polyvinyl acetate, polyvinyl alcohol, butyl polyacrylate, polyacrylamide, and dextran.

### <Antireflection Film>

The surface of the polarizing plate protective film A of the present invention is preferably provided with a hard coat layer and an antireflection layer to allow the film to function as an antireflection film.

As the hard coat layer, an actinic radiation curable resin layer or heat curable resin layer is preferably used. The hard coat layer may be provided directly on the support or on the other layer such as an antistatic layer or a subbing layer.

When an actinic radiation curable resin layer is provided as a hard coat layer, an actinic radiation curable resin, capable of being cured via exposure to radiation such as ultraviolet rays, is preferably incorporated.

In view of optical design, the refractive index of the hard coat layer is preferably in the range of 1.4-1.6. Further, from the viewpoint of providing the antireflection film with adequate durability, impact resistance, and appropriate flexibility, as well as from the viewpoint of economics during production, the thickness of the hard coat layer is preferably in the range of 1-20 μm, more preferably 1-10 μm.

The actinic radiation curable resin layer refers to a layer incorporating, as a main component, a resin which has been cured via cross-linking reaction by being exposed to actinic radiation such as ultraviolet rays or electron beams (“actinic radiation” in the present invention includes all electromagnetic waves such as electron beams, neutron beams, X-rays, alpha rays, ultraviolet rays, visible light, or infrared rays). As typical examples of actinic radiation curable resins, an ultraviolet ray curable resin and an electron beam curable resin are cited. However, a resin may optionally be employed which can be cured via exposure to radiation other than ultraviolet rays or electron beams. As the ultraviolet ray curable resin, there can be listed, for example, an ultraviolet ray curable acryl urethane-based resin, an ultraviolet ray curable polyester acrylate-based resin, an ultraviolet ray curable epoxy acrylate-based resin, an ultraviolet ray curable polyol acrylate-based resin, and an ultraviolet ray curable epoxy resin.

There can be listed an ultraviolet ray curable acryl urethane-based resin, an ultraviolet ray curable polyester acrylate-based resin, an ultraviolet ray curable epoxy acrylate-based resin, an ultraviolet ray curable polyol acrylate-based resin, and an ultraviolet ray curable epoxy resins.

Further, it is possible to incorporate a photoreaction initiator and a photosensitizer. Specifically, there can be listed acetophenone, benzophenone, hydroxybenzophenone, Michler's ketone, α-amyloxim ester, and thioxanthone, as well as derivatives thereof. When a photoreaction agent is used in the synthesis of an epoxy acrylate-based resin, it is optionally possible to use a sensitizer such as n-butylamine, triethylamine, or tri-n-butylphosphine. The content of a photoreaction initiator or photosensitizer incorporated in an ultraviolet ray curable resin composition is preferably from 2.5-6% by weight based on the composition from which a volatilized solvent component after coating and drying are removed.

Resin monomers include, for example, as a monomer having one unsaturated double bond, a common monomer such as methyl acrylate, ethyl acrylate, butyl acrylate, vinyl acetate, benzyl acrylate, cyclohexyl acrylate, or styrene. Further, there are listed, as a monomer having at least two unsaturated double bonds, ethylene glycol diacrylate, propylene glycol diacrylate, divinylbenzene, 1,4-cyclohexane diacrylate, and 1,4-cyclohexyldimethyl diacrylate, as well as trimethylolpropane triacrylate and pentaerythritol tetraacrylate as described above.

Further, a UV absorbent may be incorporated in an ultraviolet ray curable resin composition to the extent that actinic radiation curing of the ultraviolet ray curable resin composition is not hindered. As the UV absorbent, a similar UV absorbent usable for the substrate can be used.

To enhance heat resistance of a cured layer, a selected antioxidant which does not inhibit actinic radiation curing reaction can be used. For example, there can be listed a hindered phenol derivative, a thiopropionic acid derivative, and a phosphite derivative. Specific examples include, for example, 4,4′-thiobis(6-t-3-methylphenol), 4,4′-bytylidenebis(6-t-butyl-3-methylphenol), 1,3,5-tris(3,5-di-t-butyl-4-hydroxybenzyl)isocyanurate, 2,4,6-tris(3,5-di-t-butyl-4-hydroxybenzyl)mesitylene and di-octadecyl-4-hydroxy-3,5-di-t-butylbenzyl phosphate.

As the ultraviolet ray curable resin, there can be suitably selected and used, for example, ADEKA OPTOMER KR and BY Series such as KR-400, KR-410, KR-550, KR-566, KR-567, or BY-320B (all produced by Asahi Denka Kogyo Co., Ltd.); KOEIHARD such as A-101-KK, A-101-WS, C-302, C-410-N, C-501, M-101, M-102, T-102, D-102, NS-101, FT-102Q8, MAG-1-P20, AG-106, or M-101-C (all produced by Koei Chemical Co., Ltd.); SEIKABEAM such as PHC2210(S), PHCX-9(K-3), PHC2213, DP-10, DP-20, DP-30, P1000, P1100, P1200, P1300, P1400, P1500, P1600, or SCR900 (all produced by Dainichi Seika Industry Co., Ltd.); KRM7033, KRM7039, KRM7130, KRM7131, UVECRYL29201, and UVECRYL29202 (all produced by Daicel UCB Co., Ltd.); RC-5015, RC-5016, RC-5020, RC-5031, RC-5100, RC-5102, RC-5120, RC-5122, RC-5152, RC-5171, RC-5180, and RC-5181 (all produced by DIC Corp.); ORLEX No. 340 CLEAR (produced by Chugoku Marine Paints, Ltd.); SUNRAD H-601 (produced by Sanyo Chemical Industries, Ltd.); SP-1509 and SP-1507 (produced by Showa Hipolymer Co., Ltd.); RCC-15C (produced by Grace Japan K.K.); ARONIX M-6100, M-8030, and M-8060 (all produced by Toagosei Co., Ltd.), as well as any other commercially available products.

In the coating compositions of the actinic radiation curable resin layer, the solid concentration is preferably from 10-95% by weight, and a suitable concentration is selected depending on the coating method.

As a radiation source to form a cured layer via actinic radiation curing reaction of an actinic radiation curable resin, any radiation source which generates ultraviolet rays can be used. Specifically, the radiation sources described in the above radiation item can be used. Exposure conditions vary depending on each of the lamps. However, the exposure amount is preferably in the range of 20 mJ/cm²-10000 mJ/cm², more preferably 50 mJ/cm²-2000 mJ/cm². From the near ultraviolet region to the visible region, it is possible to use a sensitizer exhibiting the maximum absorption in the region.

A solvent which is used during coating of the actinic radiation curable resin layer is suitably selected and used, for example, from hydrocarbons (toluene and xylene); alcohols (methanol, ethanol, isopropanol, butanol, and cyclohexanol); ketones (acetone, methyl ethyl ketone, and methyl isobutyl ketone); ketone alcohols (diacetone alcohol); esters (methyl acetate, ethyl acetate, and methyl lactate); glycol ethers, and other organic solvents. Appropriate mixtures thereof can also be used. There is preferably used an appropriate organic solvent, described above, containing propylene glycol monoalkyl ether (the number of carbon atoms of the alkyl group being 1-4) or propylene glycol monoalkyl ether acetate (the number of carbon atoms of the alkyl group being 1-4) in an amount of preferably at least 5% by weight or more preferably 5-80% by weight.

As a coating method of an actinic radiation curable resin composition coating liquid, usable are methods known in the art employing coaters such as a gravure coater, a spinner coater, a wire bar coater, a roll coater, a reverse coater, an extrusion coater, or an air-doctor coater, as well as employing an ink-jet method. The amount coated is, in terms of the wet film thickness, appropriately from 0.1-30 μm, preferably from 0.5-15 μm. The coating rate is preferably in the range of 10 m/minute-80 m/minute.

The actinic radiation curable resin composition is coated and then dried, followed by being exposed to ultraviolet rays. The exposure time is preferably from 0.5 second-5 minutes, more preferably 3 seconds-2 minutes from the viewpoint of the curing efficiency of an ultraviolet radiation curable resin as well as operation efficiency.

Thus, a cured coating layer can be obtained. To imparting antiglare properties to the surface of a liquid crystal display panel, to minimize adhesion to other substances, and to enhance abrasion resistance, inorganic or organic fine particles can also be incorporated in a coating composition for a cured coating layer.

For example, the inorganic fine particles can include those composed of silicon oxide, zirconium oxide, titanium oxide, aluminum oxide, tin oxide, zinc oxide, calcium carbonate, barium sulfate, talc, kaolin, and calcium sulfate.

Further, the organic fine particles can include polymethacrylic acid methyl acrylate resin powder, acryl styrene resin powder, polymethyl methacrylate resin powder, silicone resin powder, polystyrene resin powder, polycarbonate resin powder, benzoguanamine resin powder, melamine resin powder, polyolefin resin powder, polyester resin powder, polyamide resin powder, polyimide resin powder, or fluorinated ethylene resin powder. These particles can be used via addition to an ultraviolet ray curable resin composition. The average particle diameter of these fine particle powders is commonly from 0.01 μm-10 μm. The amount used by blending is preferably from 0.1 part by weight parts by weight based on 100 parts by weight of the ultraviolet radiation curable resin composition. In order to provide antiglare properties, fine practices of an average particle diameter of 0.1 μm-1 μm are used in an amount of 1 part by weight 15 parts by weight based on 100 parts by weight of the ultraviolet radiation curable resin composition.

By incorporating such fine particles in an ultraviolet radiation curable resin, an antiglare layer can be formed which exhibits preferable unevenness of a center line average surface roughness Ra of 0.05 μm-0.5 μm. Further, when these fine particles are not incorporated in an ultraviolet radiation curable resin composition, a hard cost layer can be formed which exhibits the preferable smooth surface of a center line average surface roughness Ra of less than 0.05 μm, more preferably from 0.002 μm-less than 0.04 μm.

In addition thereto, as a substance to result in a blocking prevention function, it is possible to use submicron particles of a volume average particle diameter of 0.005 μm-0.1 μm, which are the same component as above, in an amount of 0.1 part by weight-5 parts by weight based on 100 parts by weight of the resin composition.

An antireflection layer is provided on the above hard coat layer. The arrangement method is not specifically limited. A coating method, a sputtering method, a deposition method, a CVD (chemical vapor deposition) method, and an atmospheric pressure plasma method may be used individually or in combination. In the present invention, a coating method is specifically preferably used to provide the antireflection layer.

As methods to form the antireflection layer by coating, there can be listed a method in which metal oxide powder is dispersed in a binder resin dissolved in a solvent, followed by coating and drying; a method in which a polymer having a cross-linked structure as a binder resin; and a method in which an ethylenically unsaturated monomer and a photopolymerization initiator are incorporated and then a layer is formed via exposure to actinic radiation.

In the present invention, an antireflection layer can be arranged on a polarizing plate protective film A provided with an ultraviolet ray curable resin layer. In order to decrease reflectance, it is preferable to form a low refractive index layer on the uppermost layer of the polarizing plate protective film A and then to form a metal oxide layer therebetween which is a high refractive index layer, and further to provide a medium refractive index layer (a metal oxide layer whose refractive index has been adjusted by varying the metal oxide content, the ratio to the resin binder, or the type of metal) between the polarizing plate protective film A and the high refractive index layer. The refractive index of the high refractive index layer is preferably from 1.55-2.30, more preferably 1.57-2.20. The refractive index of the medium refractive index layer is adjusted to be an intermediate value between the refractive index (approximately 1.5) of a cellulose ester film serving as a substrate and the refractive index of the high refractive index layer. The refractive index of the medium refractive index layer is preferably from 1.55-1.80. The thickness of each layer is preferably from 5 nm-0.5 μm, more preferably from 10 nm-0.3 μm, most preferably from 30 nm-0.2 μm. The haze of the metal oxide layer is preferably at most 5%, more preferably at most 3%, most preferably at most 1%. The strength of the metal oxide layer is preferably at least 3H, most preferably at least 4H in terms of pencil hardness when a load of 1 kg is applied. When the metal oxide layer is formed via a coating method, inorganic fine particles and a binder polymer are preferably incorporated therein.

The medium and high refractive index layers in the present invention are preferably layers, featuring refractive indexes of 1.55-2.5, formed in such a manner that coating liquids containing monomers or oligomers of organic titanium compounds represented by Formula (14) described below, or hydrolyzed products thereof are coated and then dried.

Ti(OR¹)₄ Formula (14)

wherein R¹ is an aliphatic hydrocarbon group having 1-8 carbons, but is preferably an aliphatic hydrocarbon group having 1-4 carbons. Further, a monomer or oligomer of the organic titanium compound or a hydrolyzed product thereof results in formation of a cured layer wherein the alkoxide group thereof undergoes hydrolysis to create a cross-linked structure via reaction such as —Ti—O—Ti.

As preferable examples of a monomer and an oligomer of an organic titanium compound used in the present invention, there are cited a dimer—a decamer of Ti(OCH₃)₄, Ti(OC₂H₅)₄, Ti(O-n-C₃H₇)₄, Ti(O-i-C₃H₇)₄ Ti(O-n-C₄H₉)₄, and Ti(O-n-C₃H₇)₄, and a dimer—a decamer of Ti(O-i-C₃H₇)₄, as well as a dimer—a decamaer of Ti(O-n-C₄H₉)₄. These may be used individually or in combinations of at least two types. Of these, a dimer—a decamer of Ti(O-n-C₃H₇)₄, Ti(O-i-C₃H₇)₄, Ti(O-n-C₄H₉)₄, and Ti(O-n-C₃H₇)₄ and a dimer—a decamaer of Ti(O-n-C₄H₉)₄ are specifically preferable.

In the present invention, coating liquids for the medium and high refractive index layer are preferably prepared via addition of the organic titanium compound into a solution to which water and an organic solvent, as described later, have been added in this sequential order. In cases in which water is added later, hydrolysis/polymerization does not progress uniformly, whereby cloudiness is generated or the layer strength is decreased. After adding water and the organic solvent, it is preferable to carry out vigorous stirring for mixing and dissolution to result in a uniform mixture.

Further, an alternative method is employable as a preferred embodiment. Namely, an organic titanium compound and an organic solvent are mixed, and then the resulting mixed solution is added to the above solution having been prepared by stirring the mixture of water and an organic solvent.

Herein, the amount of water is preferably in the range of 0.25-3 mol per mol of the organic titanium compound. When the amount of water is less than 0.25 mol, hydrolysis and polymerization are not sufficiently conducted, resulting in lowered layer strength. When exceeding 3 mol, hydrolysis and polymerization are excessively carried out, and then coarse TiO₂ particles are formed, resulting in cloudiness. Since such amounts of water are not preferable, it is necessary to control the amount of water in the above range.

Further, the content of water is preferably less than 10% by weight based on the total coating liquid. It is not preferable to allow the content of water to be at least 10% by based on the total coating liquid, since temporal stability of the coating liquid is degraded, resulting in the possibility of cloudiness.

An organic solvent used in the present invention is preferably water-miscible. Water-miscible organic solvents include, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monomethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); sulfoxides (for example, dimethylsulfoxide); and sulfones (for example, sulfolane); as well as urea, acetonitrile, and acetone. Of these, alcohols, polyhydric alcohols, and polyhydric alcohol ethers are specifically preferable. As described above, the amount of these organic solvents used may be adjusted so that the content of water is less than 10% by weight based on the total coating liquid by controlling the total used amount of water and the organic solvents.

The content of a monomer or oligomer of an organic titanium compound and a hydrolyzed product thereof used in the present invention, when used individually, is preferably from 50.0% by weight-98.0% by weight based on solids incorporated in the coating liquid. The solid ratio is preferably from 50% by weight-90% by weight, more preferably from 55% by weight-90% by weight. In addition, it is also preferable to add a polymer of an organic titanium compound (herein the organic titanium compound has been previously hydrolyzed, followed by cross-linking) or add titanium oxide fine particles as coating compositions.

The high refractive index layer and the medium refractive index layer of the present invention may incorporate metal oxide particles as fine particles and further may incorporate a binder polymer.

When a hydrolyzed/polymerized organic titanium compound and metal oxide particles are combined in the above method of preparing a coating liquid, the hydrolyzed/polymerized organic titanium compound and the metal oxide particles are allowed to adhere together, whereby it is possible to realize a durable coating layer provided with hardness resulting from the particles together with flexibility of a uniform layer.

The refractive index of metal oxide particles used in the high refractive index layer and the medium refractive index layer is preferably from 1.80-2.80, more preferably from 1.90-2.80. The primary particle weight average diameter of the metal oxide particles is preferably from 1-150 nm, more preferably from 1-100 nm, most preferably from 1-80 nm. The weight average diameter of the metal oxide particles in the layer is preferably from 1-200 nm, more preferably 5-150 nm, still more preferably from 10-100 nm, most preferably from 10-80 nm. When the average particle diameter of the metal oxide particles is at least 20-30 nm, the diameter thereof is determined via a light scattering method, while the diameter is determined using an electron microscope photograph when being at most 20-30 nm. The specific surface area of the metal oxide particles is, as a value determined via the BET method, preferably from 10-400 m²/g, more preferably from 20-200 m²/g, most preferably from 30-150 m²/g.

Examples of the metal oxide particles include metal oxides incorporating at least one element selected from Ti, Zr, Sn, Sb, Cu, Fe, Mn, Pb, Cd, As, Cr, Hg, Zn, Al, Mg, Si, P, and S. Specifically, there are listed titanium dioxide (for example, rutile, rutile/anatase mixed crystal, anatase, and amorphous structured ones), tin oxide, indium oxide, zinc oxide, and zirconium oxide. Of these, titanium oxide, tin oxide, and indium oxide are specifically preferable. The metal oxide particles are composed of an oxide of any of the above metals as a main component and further other metals may be incorporated. The main component refers to a component whose content (% by weight) is the maximum of the particle composing components. Examples of other elements include Ti, Zr, Sn, Sb, Cu, Fe, Mn, Pb, Cd, As, Cr, Hg, Zn, Al, Mg, Si, P, and S.

The metal oxide particles are preferably subjected to surface treatment. It is possible to conduct the surface treatment using an inorganic or organic compound. As examples of the inorganic compound used for the surface treatment, there are cited alumina, silica, zirconium oxide, and iron oxide. Of these, alumina and silica are preferable. Examples of the organic compound used for the surface treatment include polyols, alkanolamines, stearic acid, silane coupling agents, and titanate coupling agents. Of these, silane coupling agents are most preferable.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysiliane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ (β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrimethoxysilane, γ-aminopropyltriethoxysilane, γ-mercaptopropyltrimethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution with respect to silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethyloxysilane, γ-mercaptopropylmethyldiethoxysilane, γ-aminopropylmethyldimethoxysilane, γ-aminopropylmethyldiethoxysilane, methylvinyldimethoxysilane, and methylvinyldiethoxysilane.

Of these, preferable are vinyltrimethoxysilane, vinyltriethoxysilane, vinylacetoxysilane, vinyltrimethoxyethoxysilane, γ-acryloyloxypropylmethoxysilane, and γ-methacryloyloxypropylmethoxysilane any of which has a double bond in the molecule, as well as γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethjoxysilane, methylvinyldimethoxysilane, and methylvinyldiethoxysilane any of which has an alkyl group of 2-substitution with respect to silicon. Of these, specifically preferable are γ-acryloyloxypropyltrimethoxysilane, γ-methacryloyloxypropyltrimethoxysilane, γ-acryloyloxypropylmethyldimethoxysilane, γ-acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be used. In addition to the above silane coupling agents, other silane coupling agents may be used. Other silane coupling agents include alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

Surface treatment employing a coupling agent can be carried out in such a manner that a coupling agent is added to a fine particle dispersion, and then the resulting dispersion is allowed to stand at room temperature—60° C. for several hours—10 days. In order to promote the surface treatment reaction, there may be added, to the above dispersion, an inorganic acid (for example, sulfuric acid, hydrochloric acid, nitric acid, chromic acid, hypochlorous acid, boric acid, orthosilicic acid, phosphoric acid, and carbonic acid), and an organic acid (for example, acetic acid, polyacrylic acid, benzenesulfonic acid, phenol, and polyglutamic acid), or a salt thereof (for example, a metal salt and an ammonium salt).

Such a coupling agent is preferably hydrolyzed using a required amount of water beforehand. In a state where the silane coupling agent has been hydrolyzed, the above organic titanium compound and the surface of metal oxide particles are allowed to be more reactive, whereby a further durable film is formed. A hydrolyzed silane coupling agent is also preferably added in a coating liquid beforehand. It is possible to use the water, having been used for this hydrolysis, in hydrolysis/polymerization of an organic titanium compound.

In the present invention, treatment may be carried out by combining at least two types of surface treatments. The shape of metal oxide particles is preferably rice grain-shaped, spherical, cubic, spindle-shaped, or irregular. At least two types of metal oxide particles may be used in the high refractive index layer and in the medium refractive index layer at the same time.

The contents of metal oxide particles in the high refractive index and the medium refractive index layer are preferably from 5-90% by weight, more preferably from 10-85% by weight, still more preferably from 20-80% by weight. In cases in which fine particles are incorporated, the ratio of a monomer or oligomer of the above organic titanium compound or a hydrolyzed product thereof is, based on solids incorporated in the coating liquid, commonly from 1-50% by weight, preferably from 1-40% by weight, more preferably from 1-30% by weight.

The above metal oxide particles in the form of being dispersed in a medium are fed to coating liquids to form a high refractive index layer and a medium refractive index layer. As a dispersion medium of metal oxide particles, a liquid featuring a boiling point of 60-170° C. is preferably used. Specific examples of the dispersion medium include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate, and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylformamide, diethylacetamide, and n-methylpyrrolidone), ethers (for example, diethyl ether, dioxane, and tetrahydrofuran), and ether alcohols (for example, 1-methoxy-2-propanol). Of these, specifically preferable are toluene, xylene, methyl ethyl ketone, methyl isobutyl ketone, cyclohexane, and butanol.

Further, metal oxide particles can be dispersed in a medium using a homogenizer. Examples of the homogenizer include a sand grinder mill (for example, a bead mill with pins), a high speed impeller mill, a pebble mill, a roller mill, an attritor, and a colloid mill. Of these, the sand grinder and the high speed impeller mill are specifically preferable. Preliminary dispersion may optionally be conducted. Examples of appropriate homogenizers used for the preliminary dispersion include a ball mill, a three-roll mill, a kneader, and an extruder.

A polymer featuring a cross-linked structure (hereinafter also referred to as a cross-linked polymer) is preferably used as a binder polymer in the high refractive index and the medium refractive index layer of the present invention. Examples of the cross-linked polymer include cross-linked products of a polymer having a saturated hydrocarbon chain such as polyolefin (hereinafter referred to as polyolefin), polyether, polyurea, polyurethane, polyester, polyamine, polyamide, or a melamine resin. Of these, cross-linked products of polyolefin, polyether, and polyurethane are preferable. Cross-linked products of polyolefin and polyether are more preferable, but cross-linked products of polyolefin are most preferable. Further, a cross-linked polymer having an anionic group is more preferable. The anionic group functions to maintain a dispersion state of inorganic fine particles, and the cross-linked structure exhibits a function to strengthen a film by imparting film-forming capability to a polymer. The above anionic group may directly bond to a polymer chain or may bond to a polymer chain via a linking group. However, the anionic group preferably bonds, as a side chain, to the main chain via a linking group.

Examples of the anionic group include a carboxylic acid group (carboxyl), a sulfonic acid group (sulfo), and phosphoric acid group (phosphono). Of these, a sulfonic acid group and a phosphoric acid group are preferable. Herein, the anionic group may be in a salt form. A cation which forms a salt with the anionic group is preferably an alkali metal ion. Further, protons of the anionic group may be dissociated. The linking group which bonds the anionic group to a polymer chain is preferably a bivalent group selected from —CO—, —O—, an alkylene group, and an arylene group, as well as combinations thereof. A cross-linked polymer which is a preferable binder polymer is preferably a copolymer having a repeating unit having an anionic group and also a repeating unit having a cross-linked structure. In this case, the ratio of the repeating unit having an anionic group in a copolymer is preferably from 2-96% by weight, more preferably from 4-94% by weight, most preferably from 6-92% by weight. The repeating unit may have at least two anionic groups.

In a cross-linked polymer having an anionic group, another repeating unit (a repeating unit having neither an anionic group nor a cross-linked structure) may be contained. As another repeating unit, preferable are a repeating unit having an amino group or a quaternary ammonium group and a repeating unit having a benzene ring. The amino group or the quaternary ammonium group functions to maintain a dispersion state of inorganic fine particles, similarly to the above anionic group. The benzene ring functions to enhance the refractive index of the high refractive index layer. Incidentally, even when the amino group, quaternary ammonium group or benzene ring is contained in the repeating unit having an anionic group or in the repeating unit having a cross-linked structure, similar effects are achieved.

In a cross-linked polymer containing, as a constituent unit, a repeating unit having an amino group or a quaternary ammonium group, the amino group or the quaternary ammonium group may directly bond to a polymer chain or may bond to a polymer chain as a side chain via a linking group. However, the latter is preferable. The amino group or the quaternary ammonium group is preferably a secondary amino group, a tertiary amino group, or a quaternary ammonium group, more preferably a tertiary amino group or a quaternary ammonium group. A group bonding to the nitrogen atom of the secondary amino group, the tertiary amino group, or the quaternary ammonium group is preferably an alkyl group, more preferably an alkyl group having 1-12 carbons, still more preferably an alkyl group having 1-6 carbons. The counter ion of the quaternary ammonium group is preferably a halide ion. The linking group which bonds the amino group or the quaternary ammonium group to a polymer chain is preferably a bivalent group selected from —CO—, —NH—, —O—, an alkylene group, and an arylene group, as well as combinations thereof. When the cross-linked polymer contains a repeating unit having an amino group or an quaternary ammonium group, the ratio is preferably from 0.06-32% by weight, more preferably from 0.08-30% by weight, most preferably from 0.1-28% by weight.

Cross-linked polymers are preferably formed via polymerization reaction during or after coating of coating liquids, wherein the coating liquids are prepared for a high refractive index and a medium refractive index layer by blending monomers to form cross-linked polymers. Each layer is formed along with the formation of the cross-linked polymers. A monomer having an anionic group functions as a dispersing agent for inorganic fine particles in a coating liquid. The used amount of the monomer having an anionic group is, based on the inorganic fine particles, preferably from 1-50% by weight, more preferably from 5-40% by weight, still more preferably from 10-30% by weight. Further, a monomer having an amino group or a quaternary ammonium group functions as a dispersing aid in a coating liquid. The used amount of the monomer having an amino group or a quaternary ammonium group is preferably from 3-33% by weight based on the monomer having an anionic group. These monomers can be allowed to effectively function prior to coating of a coating liquid via a method in which a cross-linked polymer is formed during or after coating of the coating liquid.

Monomers used in the present invention are most preferably those having at least two ethylenically unsaturated groups. Examples thereof include esters of polyhydric alcohols with (meth)acrylic acid (for example, ethylene glycol di(meth)acrylate, 1,4-cyclohexane diacrylate, pentaerythritol tetra(meth)acrylate, pentaerythritol tri-(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene, 4-vinylbenzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be used. The commercially available monomers having an anionic group preferably used include KAYAMAR PM-21 and PM-2 (produced by Nihon Kayaku Co., Ltd.); ANTOX MS-60, MS-2N, and MS-NH4 (produced by Nippon Nyukazai Co., Ltd.); ARONIX M-5000, M-6000, and M-8000 Series (produced by Toagosei Co., Ltd.); BISCOAT #2000 Series (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Further, the commercially available monomers having an amino group or a quaternary ammonium group preferably used include DMAA (produced by Osaka Organic Chemical Industry Ltd.); DMAEA and DMAPAA (produced by Kohjin Co., Ltd.); BLENMER QA (produced by NOF Corp.); and NEW FRONTIER C-1615 (produced by Dia-ichi Kogyo Seiyaku Co. Ltd.).

It is possible to conduct polymerization reaction of a polymer via photopolymerization reaction or thermal polymerization reaction. The photopolymerization reaction is specifically preferable. A polymerization initiator is preferably used for the polymerization reaction. The polymerization initiator includes, for example, a thermal polymerization initiator and a photopolymerization initiator, described later, which are used to form a binder polymer for a hard coat layer.

Commercially available polymerization initiators may be used as the polymerization initiator. In addition to the polymerization initiator, an appropriate polymerization promoter may optionally be used. The amounts of the polymerization initiator and the polymerization promoter used are preferably in the range of 0.2-10% by weight of the total amount of the monomers. Polymerization of a monomer (or an oligomer) may be promoted by heating a coating liquid (an inorganic fine particle dispersion incorporating a monomer). Further, by heating after the photopolymerization reaction conducted after coating, heat curing reaction for the formed polymer may be carried out as an additional treatment.

Relatively high refractive index polymers are preferably used for the medium refractive index and the high refractive index layer. Examples of polymers exhibiting a high refractive index include polystyrene, styrene copolymers, polycarbonates, melamine resins, phenol resins, epoxy resins, and polyurethanes obtained via reaction of cyclic (alicyclic or aromatic) isocyanates with polyols. It is also possible to use polymers having another cyclic (aromatic, heterocyclic, or alicyclic) group and polymers having a halogen atom other than fluorine as a substituent since a high refractive index is exhibited thereby.

A low refractive index layer usable in the present invention includes a low refractive index layer formed by cross-linking of a fluorine-containing resin (hereinafter also referred to as “fluorine-containing resin prior to cross-linking”) which undergoes cross-linking by heat or ionizing radiation; a low refractive index layer formed via a sol-gel method; and a low refractive index layer formed with fine particles and a binder polymer, having voids among the fine particles or in the interior of the fine particles. A low refractive index layer applicable to the present invention is preferably one formed mainly with fine particles and a binder polymer. Specifically, the low refractive index layer having voids in the interior of the particles (also called the hollow fine particles) is preferable, since the refractive index can be lowered further. However, a decrease in the refractive index of the low refractive index layer is preferable due to an improvement of antireflection performance, which, however, makes it difficult to provide required strength. In view of the balance therebetween, the refractive index of the low refractive index layer is preferably at most 1.45, more preferably from 1.30-1.50, still more preferably from 1.35-1.49, specifically preferably from 1.35-1.45.

Further, preparation methods of the low refractive index layer may suitably be combined.

Preferable fluorine-containing resins prior to coating include fluorine-containing copolymers formed with fluorine-containing vinyl monomers and cross-linkable group-providing monomers. Specific examples of the fluorine-containing vinyl monomer units include fluoroolefins (for example, fluoroethylene, vinylidene fluoride, tetrafluoroethylene, hexafluoroethylene, hexafluoropropylene, and perfluoro-2,2-dimethyl-1,3-dioxol); partially- or completely-fluorinated alkyl ester derivatives of (meth)acrylic acid (for example, BISCOAT 6FM (produced by Osaka Organic Chemical Industry Ltd.) and M-2020 (produced by Daikin Industries, Ltd.)); and completely- or partially-fluorinated vinyl ethers. The cross-linkable group-providing monomers include vinyl monomers previously having a cross-linkable functional group in the molecule such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfonic acid group (for example, (meth)acrylic acid, methylol(meth)acrylate, hydroxyalkyl(meth)acrylate, allyl acrylate, hydroxyalkyl vinyl ether, and hydroxyalkyl allyl ether). JP-A Nos. 10-25388 and 10-147739 describe that a cross-linked structure is introduced into the latter by adding, after copolymerization, a compound having a group reactive to the functional group in the polymer, as well as having at least another reactive group. Examples of the cross-linkable group include an acryloyl, a methacryloyl, an isocyanate, an epoxy, an aziridine, an oxazoline, an aldehyde, a carbonyl, a hydrazine, a carboxyl, a methylol, and an active methylene group. When a fluorine-containing copolymer is subjected to thermal cross-linking in the presence of a thermally-reactive cross-linking group or in combination of an ethylenically unsaturated group with a thermally radical generating agent or of an epoxy group with a thermally acid generating agent, the above polymer is of a thermally curable type. In contrast, when cross-linking is performed via exposure to radiation (preferably ultraviolet rays or electron beams) in combination of an ethylenically unsaturated group with a photo-radical generating agent or of an epoxy group with a photolytically acid generating agent, the polymer is of an ionizing radiation curable type.

Further, in addition to the above polymers, as the fluorine-containing resin prior to coating, there may be used a fluorine-containing copolymer formed in combination of a fluorine-containing vinyl monomer with a monomer other than a cross-linkable group-providing monomer. Monomers usable in combination are not specifically limited, including, for examples, olefins (ethylene, propylene, isoprene, vinyl chloride, and vinylidene chloride); acrylates (methyl acrylate, ethyl acrylate, 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, to provide lubricating properties and antistaining properties, a polyorganosiloxane skeleton or a perfluoropolyether skeleton is also preferably introduced into a fluorine-containing copolymer. The introduction can be carried out, for example, via polymerization of the above monomer with a polyorganosiloxane or perfluoropolyether having, at a terminal, an acryl group, a methacryl group, a vinyl ether group, or a styryl group; via polymerization of the polymer with a polyorganosiloxane or perfluoropolyether having a radical generating group at a terminal; or via reaction of a fluorine-containing copolymer with a polyorganosiloxane or perfluoropolyether having a functional group.

The ratio of each monomer used to form the fluorine-containing copolymer prior to coating is described below. The ratio of a fluorine-containing vinyl monomer is preferably from 20-7.0 mol %, more preferably from 40-70 mol %; the ratio of a cross-linkable group-providing monomer used is preferably from 1-20 mol %, more preferably from 5-20 mol %; and the ratio of the other monomers used together is preferably from 10-70 mol %, more preferably from 10-50 mol %.

The fluorine-containing copolymer can be obtained by polymerizing these monomers via a method such as a solution polymerization method, a block polymerization method, an emulsion polymerization method, or a suspension polymerization method.

Fluorine-containing resins prior to coating are commercially available and possible to employ. Examples of the fluorine-containing resins prior to coating available on the market include SAITOP (produced by Asahi Glass Co., Ltd.), TEFLON (a registered trade name) AF (produced by E.I. du Pont de Nemours and Company), vinylidene polyfluoride and RUMIFRON (produced by Asahi Glass Co., Ltd.), and OPSTAR (produced by JSR Corp.).

The dynamic friction coefficient and the contact angle to water of the low refractive index layer composed of a cross-linked fluorine-containing resin are in the range of 0.03-0.15 and in the range of 90-120 degrees, respectively.

The low refractive index layer composed of a cross-linked fluorine-containing resin preferably incorporates inorganic fine particles described later from the viewpoint of adjusting the refractive index. Further, the inorganic fine particles are preferably used after being surface-treated. Surface treatment methods include physical surface treatment such as plasma discharge treatment or corona discharge treatment, as well as chemical surface treatment employing a coupling agent. However, a coupling agent is preferably employed. As the coupling agent, an organoalkoxy metal compound (for example, a titanium coupling argent and a silane coupling agent) is preferably used. In cases in which inorganic fine particles are composed of silica, silane coupling agent-treatment is specifically effective.

Further, various types of sol-gel materials can also preferably be used as a material for the low refractive index layer. As such a sol-gel material, there can be used metal alcoholates (alcoholates of silane, titanium, aluminum, or zirconium), organoalkoxy metal compounds, and hydrolysis products thereof. Specifically, alkoxysilanes, organoalkoxysilanes, and hydrolysis products thereof are preferable. Examples thereof include tetraalkoxysilanes (such as tetramethoxysilane or tetraethoxysilane), alkyltrialkoxysilanes (such as methyltrimethoxysilane or ethyltrimethoxysilane), aryltrialkoxysilanes (such as phenyltrimethoxysilane), dialkyldialkoxysilanes, and diaryldialkoxysilanes. Further, there are also preferably used organoalkoxysilanes having various types of functional groups (such as vinyltrialkoxysilanes, methylvinyldialkoxysilanes, γ-glycidyloxypropyltrialkoxysilanes, γ-glycidyloxypropylmethyldialkoxysilanes, β-(3,4-epoxydicyclohexyl)ethyltrialkoxysilanes, γ-methacryloyloxypropyltrialkoxysilanes, γ-aminopropyltrialkoxysilanes, γ-mercaptopropyltrialkoxysilanes, or γ-chloropropyltrialkoxysilanes); and perfluoroalkyl group-containing silane compounds (for example, (heptadecafluoro-1,1,2,2-tetradecyl)triethoxysilane, 3,3,3-trifluoropropyltrimethoxysilane). Specifically, fluorine-containing silane compounds are preferably used from the viewpoint of decreasing the refractive index of the layer and of providing water repellency and oil repellency.

As a low refractive index layer, there is preferably used a layer wherein inorganic or organic fine particles are used to form micro-voids among the fine particles or in the interior of the fine particles. The average particle diameter of the fine particles is preferably from 0.5-200 nm, more preferably from 1-100 nm, still more preferably form 3-70 nm, most preferably from 5-40 nm. Further, the particle diameter of the fine particles is preferably as uniform (monodispersed) as possible.

Inorganic fine particles are preferably noncrystalline. The inorganic fine particles are preferably composed of metal oxides, metal nitrides, metal sulfides, or metal halides, more preferably composed of metal oxides or metal halides, but most preferably composed of metal oxides or metal fluorides. As metal atoms, preferable are Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb, and Ni. Of these, Mg, Ca, B, and Si are more preferable. Inorganic compounds containing two types of metals may also be used. Specific examples of preferable inorganic compounds include SiO₂ or MgF₂, but SiO₂ is specifically preferable.

Such particles having micro-voids in the interior of inorganic fine particles can be formed, for example, by allowing silica molecules which form the particles to be cross-linked. When silica molecules are subjected to cross-linking, the resulting volume is reduced, resulting in porous particles. It is possible to directly synthesize microvoid-containing (porous) inorganic fine particles as a dispersion via a sol-gel method (described in JP-A Nos. 53-112732 and Examined Japanese Patent Application Publication No. 57-9051) or a deposition method (described in Applied Optics, Volume 27, page 3356 (1988)). Alternatively, a dispersion can also be obtained by mechanically pulverizing powder prepared via a drying/precipitation method. Commercially available porous inorganic fine particles (for example, SiO₂ sol) may be used.

In order to form a low refractive index layer, these inorganic fine particles are preferably used in such a state as dispersed in an appropriate medium. As a dispersion medium, preferable are water, alcohol (for example, methanol, ethanol, and isopropyl alcohol), and ketone (for example, methyl ethyl ketone and methyl isobutyl ketone).

Organic fine particles are preferably noncrystalline. The organic fine particles are also preferably polymer fine particles which are synthesized via polymerization reaction (for example, an emulsion polymerization method) of a monomer. The polymer of the organic fine particles preferably contains fluorine atoms. The ratio of the fluorine atoms in the polymer is preferably from 35-80% by weight, more preferably from 45-75% by weight. Further, microvoids are also preferably-formed in the organic fine particle, for example, by allowing a particle-forming polymer to be cross-linked to result in a reduced volume. In order to allow the particle-forming polymer to be cross-linked, a multifunctional monomer preferably accounts for at least 20 mol % based on a monomer used to synthesize the polymer. The ratio of the multifunctional monomer is more preferably from 30-80 mol %, most preferably 35-50 mol %. As monomers used to synthesize the organic fine particles, examples of fluorine-containing monomers used to synthesize the fluorine-containing polymers include fluoroolefins (for example, fluoroethylene, vinylidene fluoride, tetrafluoroethylene, hexafluoropropylene, and perfluoro-2,2-dimethyl-1,3-dioxol), fluorinated alkyl esters of acrylic acid or methacrylic acid, and fluorinated vinyl ethers. Copolymers of monomers with and without fluorine atoms may be used. Examples of the monomers without fluorine atoms include olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, and butyl methacrylate), styrenes (for example, styrene, vinyltoluene, and α-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Examples of the multifunctional monomers include dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, bisacrylamides (for example, methylenebisacrylamide), and bismethacrylamides.

Microvoids among particles can be formed by piling at least two fine particles. Incidentally, when spherical fine particles of an equal diameter (being completely monodispersed) are close-packed, microvoids of a 26% void ratio by volume are formed among the fine particles. When spherical fine particles of an equal diameter are subjected to simple cubic packing, microvoids of a 48% void ratio by volume are formed among the fine particles. In a low refractive index layer practically used, the void ratio significantly shifts from the theoretical value due to distribution of the diameters of the fine particles or the presence of microvoids in the interior of the particles. The refractive index of the low refractive index layer decreases as the void ratio increases. When microvoids are formed by piling fine particles, the size of the microvoids among the particles can easily be controlled to an appropriate value (a value minimizing scattering light and resulting in no problem in the strength of the low refractive index layer) by controlling the diameter of the fine particles. Further, by controlling the diameter of the fine particles to be uniform, an optically uniform low refractive index layer, also featuring the uniform size of microvoids among the particles, can be realized. Herewith, the resulting low refractive index layer is controlled to be optically or macroscopically a uniform layer, though being microscopically a microvoid-containing porous layer. Microvoids among particles are preferably confined in the low refractive index layer by fine particles and a polymer. The confined voids also exhibit an advantage such that light scattering on the surface of the low refractive index layer is reduced, as compared to unconfined voids.

By forming microvoids, the macroscopic refractive index of the low refractive index layer becomes lower than the sum total of the refractive indexes of the components constituting the low refractive index layer. The refractive index of a layer is the sum total of the refractive indexes per volume of layer constituent elements. The refractive indexes of components such as fine particles or polymers of the low refractive index lay are larger than 1, while the refractive index of air is 1.00. Therefore, by forming microvoids, a low refractive index layer exhibiting a significantly lower refractive index can be realized.

Further, in the present invention, an embodiment is also preferable in which hollow fine particles of SiO₂ are used.

Hollow fine particles described in the present invention refer to particles which have a particle wall, the interior of which is hollow. Exemplified are particles which are formed in such a manner that the above SiO₂ particles having microvoids in the interior of the particles are surface-coated with organic silicon compounds (alkoxysilanes such as tetraethoxysilane) to close their pore inlets. Alternatively, voids in the interior of the wall of the particles may be filled with a solvent or gas. For example, in the case of air, the refractive index of hollow fine particles can remarkably be lowered (to a refractive index of 1.2-1.4), as compared to common silica (refractive index: 1.46). Via addition of such hollow fine particles of SiO₂, the refractive index of the low refractive index layer can further be lowered.

Preparation methods of allowing particles having microvoids in the above inorganic fine particles to be hollow may be based on the methods described in JP-A Nos. 2001-167637 and 2001-233611. Commercially available hollow fine particles of SiO₂ can optionally be used in the present invention. As the commercially available hollow fine particles, hollow silica fine particles (produced by Catalists & Chemicals Ind. Co., Ltd.) are specifically exemplified.

The low refractive index layer preferably incorporates a polymer of an amount of 5-50% by weight. The polymer functions to allow fine particles to adhere and to maintain a structure of the low refractive index layer having voids. The amount of the polymer used is controlled so that the strength of the low refractive index layer may be maintained without filling voids. The amount of the polymer is preferably from 10-30% by weight based on the total weight of the low refractive index layer. To achieve adhesion of fine particles using a polymer, it is preferable that (1) a polymer be allowed to bond to a surface treatment agent for fine particles; (2) a polymer shell be allowed to form around a fine particle serving as a core; or (3) a polymer be used as a binder among fine particles. The polymer which is bonded to a surface treatment agent in (1) is preferably a shell polymer of (2) or a binder polymer of (3). The polymer of (2) is preferably formed around fine particles via polymerization reaction prior to preparation of a low refractive index layer coating liquid. The polymer of (3) is preferably formed in such a manner that a monomer is added to a low refractive index layer coating liquid, followed by polymerization reaction during or after coating of the low refractive index layer. At least two of (1), (2), and (3) or all thereof are preferably employed in appropriate combinations. Of these, performance in combination of (1) and (3) or of (1), (2), and (3) is specifically preferable. Each of (1) Surface Treatment, (2) Shell, and (3) Binder will now sequentially be described.

### (1) Surface Treatment

Fine particles (specifically, inorganic fine particles) are preferably subjected to surface treatment to improve affinity with a polymer. The surface treatment is classified into physical surface treatment such as plasma discharge treatment or corona discharge treatment and chemical surface treatment using a coupling agent. The chemical surface treatment is preferably conducted alone, or the physical surface treatment and the chemical surface treatment are also preferably performed in combination. As the coupling agent, an organoalkoxy metal compound (for example, a titanium coupling agent and a silane coupling agent) is preferably used. When fine particles are composed of SiO₂ surface treatment using a silane coupling agent can specifically effectively be carried out. As specific examples of the silane coupling agent, those described above are preferably used.

Surface treatment using a coupling agent can be carried out in such a manner that a coupling agent is added to a fine particle dispersion and the resulting mixture is allowed to stand at a temperature of room temperature—60° C. for a period of several hours—10 days. To facilitate the surface treatment reaction, there may be added, to the dispersion, an inorganic acid (for example, sulfuric acid, hydrochloric acid, nitric acid, chromic acid, hypochloric acid, boric acid, orthosilicic acid, phosphoric acid, and carbonic acid), an organic acid (for example, acetic acid, polyacrylic acid, benzenesulfonic acid, phenol, and polyglutamic acid), or a salt thereof (for example, a metal salt and an ammonium salt).

### (2) Shell

Shell forming polymers are preferably polymers having a saturated hydrocarbon as the main chain. Polymers containing fluorine atoms in the main chain or side chains are preferable, but the polymers containing fluorine atoms in side chains are more preferable. Polyacrylates or polymethacrylates are preferable, but esters of fluorine-substituted alcohols with polyacrylic acid or polymethacrylic acid are most preferable. The refractive index of a shell polymer decreases as the content of fluorine atoms therein increases. To lower the refractive index of a low refractive index-layer, a shell polymer preferably contains fluorine atoms of an amount of 35-80% by weight, more preferably an amount of 45-75% by weight. A fluorine atom-containing polymer is preferably synthesized via polymerization reaction of a fluorine atom-containing ethylenically unsaturated monomer. Examples of the fluorine atom-containing ethylenically unsaturated monomer include fluoroolefins (for example, fluoroethylene, vinylidene fluoride, tetrafluoroethylene, hexafluoropropylene, perfluoro-2,2-dimethyl-1,3-dioxol), fluorinated vinyl ethers, and esters of fluorine substituted alcohols with acrylic acid or methacrylic acid.

A shell forming polymer may be a copolymer having repeating units with and without fluorine atoms. The repeating unit without fluorine atoms is preferably prepared via polymerization reaction of an ethylenically unsaturated monomer containing no fluorine atoms. Examples of the ethylenically unsaturated monomer containing no fluorine atoms include olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tert-butylacrylamide and N-cyclohexylacrylamide), methacrylamides, and acrylonitriles.

When a binder polymer, described in (3) below, is used in combination, a cross-linkable functional group may be introduced into a shell polymer to allow the shell polymer and the binder polymer to chemically bind together via cross-linking. The shell polymer may be crystalline. When the glass transition point (Tg) of the shell polymer is higher than the temperature during formation of a low refractive index layer, microvoids in the low refractive index layer are easily maintained. Incidentally, when the Tg is higher than the temperature during formation of the low refractive index layer, fine particles are not fused, whereby the resulting low refractive index layer may not be formed as a continuous layer (resulting in a decrease in strength). In this case, it is desirable that the low refractive index layer be formed as a continuous layer with a binder polymer, described in (3) below, which is simultaneously used. A polymer shell is formed around the fine particle, resulting in a core/shell fine particle. A core composed of an inorganic fine particle is preferably incorporated in the core/shell fine particle in the range of 5-90% by volume, more preferably 15-80% by volume. At least two types of core/shell fine particles may simultaneously be used. Further, an inorganic fine particle incorporating no shell and a core/shell particle may be used at the same time.

### (3) Binder

A binder polymer is preferably a polymer having a saturated hydrocarbon or a polyether as the main chain, but is more preferably a polymer having a saturated hydrocarbon as the main chain. The binder polymer is preferably a cross-linked one. The polymer having a saturated hydrocarbon as the main chain is preferably prepared via polymerization reaction of an ethylenically unsaturated monomer. In order to prepare a cross-linked binder polymer, a monomer having at least two ethylenically unsaturated groups is preferably used. Examples of the monomer having at least two ethylenically unsaturated groups include esters of polyhydric alcohols with (meth)acrylic acid (for example, ethylene glycol di(meth)acrylate, 1,4-dicyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. A polymer having a polyether as the main chain is preferably synthesized via ring-opening polymerization reaction. A cross-linked structure may be introduced into a binder polymer via reaction of a cross-linkable group instead of or in addition to a monomer having at least two ethylenically unsaturated groups. Examples of the cross-linkable functional group include an isocyanate group, an epoxy group, an aziridine group, an oxazoline group, an aldehyde group, a carbonyl group, a hydrazine group, a carboxyl group, a methylol group, and an active methylene group. As a monomer to introduce a cross-linked structure, there can also be used vinylsulfonic acid, acid anhydrides, cyanoacrylate derivatives, melamine, etherified methylol, esters and urethane. There may be used a functional group such as a block isocyanate group, which exhibits cross-linking properties as a result of decomposition reaction thereof. Further, the cross-linkable group is not limited to the above compounds, including those which become reactive as a result of decomposition of the above functional group. As a polymerization initiator used for polymerization reaction and cross-linking reaction of a binder polymer, a thermal polymerization initiator or a photopolymerization initiator is used, but the photopolymerization initiator is preferable. Examples of the photopolymerization initiator include acetophenones, benzoins, benzophenones, phosphine oxides, ketals, antharaquinones, thioxanthones, azo compounds, peroxides, 2,3-dialkyldione compounds, disulfide compounds, fluoroamine compounds, and aromatic sulfoniums. Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophene, and 2-benzyl-2-dimethylamino-1-(4-morpholinophenyl)-butanone. Examples of the benzoins include benzoin methyl ether, benzoin ethyl ether, and benzoin ethylisopropyl ether. Examples of the benzophenones include benzophenone, 2,4-dichlorobenzophenone, 4,4-dichlorobenzophenone, and p-chlorobenzophenone. An example of the phosphine oxides includes 2,4,6-trimethylbenzoyldiphenylphosphine oxide.

The binder polymer is preferably formed in such a manner that a monomer is added to a low refractive index layer coating liquid, followed by polymerization reaction (and further cross-linking reaction, if appropriate) during or after coating of the low refractive index layer. A small amount of a polymer (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer coating liquid.

Further, a slipping agent is preferably added to the low refractive index layer of the present invention or other refractive index layers. Abrasion resistance can be improved by providing appropriate slipping properties. As a slipping agent, silicone oil or a waxy substance is preferably used. For example, compounds represented by the following formula are preferable.

R₁COR₂ Formula

wherein R₁ represents a saturated or unsaturated aliphatic hydrocarbon group having at least 12 carbon atoms. An alkyl group or an alkenyl group is preferable, but an alkyl group or an alkenyl group having at least 16 carbon atoms is more preferable. R₂ represents —OM₁ group (M₁ represents an alkali metal such as Na or K), —OH group, —NH₂ group, or —OR₃ group (R₃ represents a saturated or unsaturated aliphatic hydrocarbon group having at least 12 carbon atoms but preferably represents an alkyl group or an alkenyl group). R₂ is preferably —OH group, —NH₂ group or —OR₃ group. Specifically, there can also preferably be used higher fatty acids or derivatives thereof such as behenic acid, stearic acid amide, or pentacosanoic acid, as well as natural products, containing a large amount of such components, such as carnauba wax, beeswax, or montan wax. Further, there can be exemplified polyorganosiloxane disclosed in Examined Japanese Patent Application Publication No. 53-292; higher fatty acid amides disclosed in U.S. Pat. No. 4,275,146; higher fatty acid esters (esters of a fatty acid having 10-24 carbons with alcohol having 10-24 carbons) disclosed in Examined Japanese Patent Application Publication No. 58-33541, British Patent No. 927,446 specification, or JP-A Nos. 55-126238 and 58-90633; higher fatty acid metal salts disclosed in U.S. Pat. No. 3,933,516; polyester compounds composed of dicarboxylic acids having at most 10 carbons and aliphatic or alicyclic diols disclosed in JP-A No. 51-37217; and oligopolyesters composed of dicarboxylic acids and diols disclosed in JP-A No. 7-13292.

For example, the amount of a slipping agent used in the low refractive index layer is preferably from 0.01 mg/m²-10 mg/m².

There may be added, to each of the layers of an antireflection film or coating liquids therefor, a polymerization inhibitor, a leveling agent, a thickener, an anti-coloring agent, a UV absorbent, a silane coupling agent, an antistatic agent, or an adhesion providing agent, in addition to a metal oxide particle, a polymer, a dispersion medium, a polymerization initiator, or a polymerization accelerator.

Each of the layers of the antireflection film can be formed via a coating method such as a dip coating method, an air-knife coating method, a curtain coating method, a roller coating method, a wire bar coating method, a gravure coating method, an ink-jet method, or an extrusion coating method (U.S. Pat. No. 2,681,294). At least two layers may be simultaneously coated. Simultaneous coating methods are described in U.S. Pat. Nos. 2,761,791, 2,941,898, 3,508,947, and 3,526,528; and Yuji Harazaki, coating Kogaku (Coating Engineering), page 253, Asakura Shoten (1973).

In the present invention, in the production of an antireflection film, drying is carried out preferably at 60° C. or higher, more preferably at 80° C. or higher, after coating of the above-prepared coating liquid on a support. Further, drying is conducted preferably at a dew point of 20° C. or lower, more preferably at a dew point of 15° C. or lower. Drying is preferably initiated within 10 seconds after the support is coated. Combining the above conditions results in a preferable production method to achieve the effects of the present invention.

The polarizing plate protective film A of the present invention is preferably used by providing an appropriate layer as an antireflection film, a hard coat film, an antiglare film, a retardation film, an optical compensating film, an antistatic film, a light-scattering protecting film, or a luminance enhancing film.

### (Polarizing Plate Protective Film B)

A polarizing plate protective film B of the present invention will now be described.

The polarizing plate protective film B of the present invention is characterized by incorporating a noncrystalline polyolefin resin, which is preferably a cycloolefin resin.

Cycloolefin resin (hereinafter, it is also called as cycloolefin polymer) film preferably utilized in the present invention will now be explained.

Cycloolefin polymer utilized in the present invention is comprised of polymer resin containing an alicyclic structure.

Preferable cycloolefin polymer is resin in which cycloolefin is polymerized or copolymerized. Cycloolefin includes unsaturated hydrocarbon having a polycyclic structure and derivatives thereof such as norbornene, cyclopentadiene, tetracyclododecene, ethyl tetracyclododecene, ethylidene tetracyclododecene and tetracyclo[7.4.0.110,13.02,7]trideca-2,4,6,11-tetraene; and unsaturated hydrocarbon having a monocyclic structure and derivatives thereof such as cyclobutene, cyclopentene, cyclohexene, 3,4-dimethylcyclopentene, 3-methylcyclohexene, 2-(2-methylbutyl)-1-cyclohexene, cyclooctene, 3a,5,6,7a-tetrahydro-4,7-methano-1H-indene, cycloheptene, cyclopentadiene and cyclohexadiene. These cyclolefin may be provided with a polar group as a substituent. A polar group includes a hydroxyl group, a carboxyl group, an alkoxyl group, an epoxy group, a glycidyl group, an oxycarbonyl group, a carbonyl group, an amino group, an ester group and a carbonic acid anhydride group, and specifically preferable is an ester group, a carboxyl group or a carbonic acid anhydride group.

Preferable cycloolefin polymer may be those in which monomer other than cycloolefin being addition copolymerized. Monomer capable of addition copolymerization includes ethylene such as ethylene, propylene, 1-butene and 1-pentene; or dien such as α-olefin-1,4-hexadiene, 4-methyl-1,4-hexadiene, 5-methyl-1,4-hexadiene and 1,7-octadiene.

Cycloolefin is prepared by an addition polymerization reaction or a metathesis open ring polymerization reaction. Polymerization is preformed in the presence of a catalyst. A catalyst for addition polymerization includes, for example, a catalyst comprising a vanadium compound and an organoaluminum compound. A catalyst for open ring polymerization includes a polymerization catalyst comprising a halogenide, nitrate or an acetylacetone compound of metal such as ruthenium, rhodium, palladium, osmium, iridium and platinum, and a reducing agent; or a polymerization catalyst comprising a halogenide or acetylacetone compound of metal such as titanium, vanadium, zirconium, tungsten and molybdenum, and an organoaluminum compound. Such as polymerization temperature and pressure are not specifically limited, however, polymerization is generally performed at a polymerization temperature of −50-100° C. and under a polymerization pressure of 0-490 N/cm².

Cycloolefin polymer utilized in the present invention is preferably those in which cycloolefin is polymerized or copolymerized followed by being subjected to a hydrogen addition reaction to convert unsaturated bonds in the molecule into saturated bonds. A hydrogen addition reaction is performed by blowing hydrogen in the presence of a hydrogenation catalyst well known in the art. A hydrogenation catalyst includes a homogeneous catalyst comprising a combination of a transition metal compound/an alkyl metal compound such as cobalt acetate/triethyl aluminium, nickel acetylacetonato/triisobutyl aluminum, titanocene dichloride/n-butyl lithium, zirconocene dichloride/sec-butyl lithium and tetrabutoxy titanate/dimethyl magnesium; an inhomogeneous catalyst such as nickel, palladium and platinum; and an inhomogeneous solid carrying catalyst comprising a metal catalyst held by a carrier such as nickel/silica, nickel/diatomaceous earth, nickel/alumina, palladium/carbon, palladium/silica, palladium/diatomaceous earth and palladium/alumina.

In addition, cycloolefin polymer also includes the following norbornene type polymer. Norbornene type polymer is preferably provided with a norbornene skeleton as a repeating unit, and specific examples thereof include those described in such as JP-A Nos. 62-252406, 62-252407, 2-133413, 63-145324, 63-264626 and 1-240517, Examined Japanese Patent Application Publication No. 57-8815, JP-A Nos. 5-39403, 5-43663, 5-43834, 5-70655, 5-279554, 6-200985, 7-62028, 8-176411 and 9-241484, however, is not limited thereto. Further, these may be utilized alone or in combination of at least two types.

In the present invention, among the above-described norbornene type polymer, preferable are those provided with a repeating unit represented by any one of following structural formulas (I)-(IV).

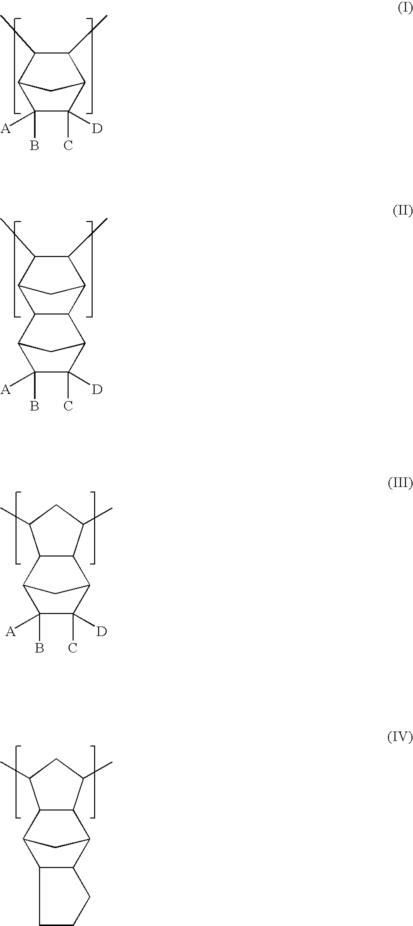

A, B, C and D, in above structural formula (1)-(IV), each independently represent a hydrogen atom or a monovalent organic group.

Further, among the aforesaid norbonene type polymer, also preferable is hydrogenated polymer prepared by hydrogenation of polymer, which is prepared by metathesis polymerization of at least one compound represented by following chemical structure (V) or (VI) and an unsaturated cyclic compound which is copolymeizabele with this.

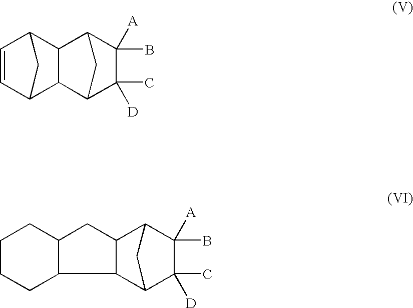

In the aforesaid chemical structures, A, B, C and D each independently represent a hydrogen atom or a monovalent organic group.

Herein, the above-described A, B, C and D are not specifically limited, however, are preferably a hydrogen atom, a halogen atom, a monovalent organic group or an organic group connected via a connecting group of at least divalent, and these may be identical to or different from each other. Further, A or B, and C or D may form a monocyclic ring or polycyclic ring structure. Herein, the above-described connecting group of at least divalent contains a hetero atom such as an oxygen atom, a sulfur atom and a nitrogen atom, and includes ether, ester, carbonyl, urethane, amide and thioether, however, is not limited thereto. Further, the above described organic group may be further substituted via the above-described connecting group.

Further, as other monomer copolymerizable with norbornene type monomer, utilized are α-olefin having a carbon number of 2-20 such as ethylene, propylene, 1-butene, 1-pentene, 1-hexene, 1-octene, 1-decene, 1-dodecene, 1-tetradecene, 1-hexadecene, 1-octadecene and 1-eicosene, and derivatives thereof; cycloolefin such as cyclobutene, cyclopentene, cyclohexene, cyclooctene and 3a,5,6,7a-tetrahydro-4,7-methano-1H-indene, and derivatives thereof; non-conjugated diene such as 1,4-hexadiene, 4-methyl-1,4-hexadiene, 5-methyl-1,4-hexadiene and 1,7-octadiene. Among them, α-olefin and ethylene are specifically preferable.

These other monomers copolymerizable with norbornene type monomer may be utilized each alone or in combination of at least two types. In the case of addition polymerization of norbornene type monomer and other monomer copolymerizable therewith, a ratio of a structural unit arising from norbornen type monomer and a structural unit arising from copolymerizable other monomer is suitably selected to be in a range of generally 30/70-99/1, preferably 50/50-97/3 and more preferably 70/30-95/5, based on a weight ratio.

When unsaturated bonds remaining in a polymer molecule chain are saturated by a hydrogenation reaction, the hydrogenation degree is preferably set to not less than 90%, preferably not less than 95% and specifically preferably not less than 99%, with respect to light stability and weather-proofing.

In addition, cycloolefin polymer utilized in the present invention includes such as thermoplastic saturated norbornene type resin described in paragraph Nos. [0014]-[0019] of JP-A 5-2108, thermoplastic norbornene type resin described in paragraph Nos. [0015]-[0031] of JP-A 2001-277430, thermoplastic norbornene type resin described in paragraph Nos. [0008]-[0045] of JP-A 2003-14901, norbornene type-resin compositions described in paragraph Nos. [0014]-[0028] of JP-A 2003-139950, norbornene type resin described in paragraph Nos. [0029]-[0037] of JP-A 2003-161832, norbornene type resin described in paragraph Nos. [0027]-[0036] of JP-A 2003-195268, alicyclic structure containing polymer resin described in paragraph Nos. [0009]-[0023] of JP-A 2003-211589 and norbornen type polymer resin or vinyl alicyclic hydrocarbon polymer resin described in paragraph Nos. [0008]-[0024] of JP-A 2003-211588.

Specifically, such as Zeonex and Zeonoa, manufactured by Nippon Zeon Co., Ltd.; Arton manufactured by JSR Co., Ltd; Apel (such as APL 8008T, APL 6509T, APL 6013T, APL 5014DP and APL 6015T) manufactured by Mitsui Chemicals Co., Ltd. are preferably utilized.

A molecular weight of cycloolefin polymer utilized in the present invention is appropriately selected according to the application, however, it is preferred to achieve a highly balanced mechanical strength and a mold processing behavior of a molded product, when it is in a range of generally 5,000-500,000, preferably 8,000-200,000 and more preferably 10,000-100,000 based on a weight average molecular weight of converted polyisobutylene or polystyrene, measured by a gel permeation chromatography method.

A cycloolefin polymer can be produced via the following method.

Under an ambience of nitrogen, 1.2 parts of 1-hexene, 0.15 part of dibutyl ether, and 0.30 part of triisobutyl aluminum were mixed with 500 parts of dewatered cyclohexane in a reaction container at room temperature. While the resulting mixture is kept at 45° C., there were sequentially added a norbornene-based monomer mixture, composed of 20 parts of tricyclo[4.3.0.12,5]deca-3,7-diene(dicyclopentadiene) (hereinafter referred to as DCP), 140 parts of 1,4-methano-1,4,4a,9a-tetrahydrofluorene (hereinafter referred to as MTF), and 8-methyl-tetracyclo[4.4.0.12,5.17,10]-dodeca-3-ene (hereinafter referred to as MTD), as well as 40 parts of tungsten hexachloride over 2 hours to conduct polymerization. Then, the polymerization reaction was terminated by deactivating a polymerization catalist via addition of 1.06 parts of butyl glycidyl ether and 0.52 part of isopropyl alcohol to the polymerization solution.

Subsequently, 270 parts of cyclohexane was added to 100 parts of the thus-prepared reaction solution containing a ring-opend polymer, and then 5 parts of a nickel-alumina catalist (procuded by Nikki Chemical Co., Ltd.) was added as a hydrogenating catalist. Thereafter, the temperature of the reaction system was raised up to 200° C. while being stirred at a pressure of 5 MPa using hydrogen, followed by conducting reaction for 4 hours to give a reaction solution containing a hydrogenated DCP/MTF/MTD ring-opened polymer of a concentration of 20%. The hydrogenating catalist was removed via filtration, and a soft polymer (SEPTON2002, produced by Kuraray Co., Ltd.) and an antioxidant (IRGANOX1010, produced by Ciba Specialty Chemicals AG) were added and dissolved in the resulting solution (0.1 part of each was added based on 100 parts of the above-prepared polymer). Subsequently, the cyclohexane serving as the solvent and the other volatile components were removed from the solution using a cylindrical concentration drier (produced by Hitachi, Ltd.), and then a melted hydrogenated polymer was extruded from an extruder into a strand form and cooled, followed by being pelletized to produce a cycloolefin polymer.

Further, it is possible to effectively prevent polymer from such as decomposition and coloring at mold processing from, by blending a low volatile anti-oxidant at a ratio of 0.01-5 weight parts against 100 weight parts of cycloolefin polymer.

As an antioxidant, those having a vapor pressure at 20° C. of not more than 10⁻⁵ Pa and specifically not more than 10⁻⁸ Pa are preferred. An antioxidant having a vapor pressure of over 10⁻⁵ Pa will cause problems of foaming at extrusion molded and of evaporation of an antioxidant from the surface of a molded product when being exposed to high temperature.

An antioxidant utilizable in the present invention includes the following and these may be utilized alone or in combination of a few types.

Hindered phenol type: such as 2,6-di-t-butyl-4-methylphenol, 2,6-di-t-butylphenol, 4-hydroxymethyl-2,6-di-t-butylphenol, 2,6-di-t-butyl-α-methoxy-p-dimethyl-phenol, 2,4-di-t-aminophenol, t-butyl-m-cresol, 4-t-butylphenol, styrenized phenol, 3-t-butyl-4-hydroxyanisol, 2,4-dimethyl-6-t-butylphenol, octadecyl-3-(3,5-di-t-butyl-4-hydroxyphenyl)propionate, 3,5-di-t-butyl-hyroxybenzylphosphonate-diethylester, 4,4′-bisphenol, 4,4′-bis-(2,6-di-t-butylphenol), 2,2′-methylene-bis-(4-methyl-6-t-butylphenol), 2,2′-methylene-bis-4(4-methyl-6-α-methylcyclohexylphenol), 4,4′-methylene-bis-(2,6-di-t-butylphenol), 1,1′-methylene-bis-(2,6-di-t-butylnaphthol), 4,4′-butylidene-bis-(2,6-di-t-butyl-metha-cresol), 2,2′-thio-bis-(4-methyl-6-t-butylphenol), di-o-cresol sulfide, 2,2′-thio-bis-(2-methyl-6-t-butylphenol), 4,4′-thio-bis(3-methyl-6-t-butylphenol), 4,4′-thio-bis-(2,3-di-t-sec-amylphenol), 1,1′-thio-bis-(2-naphthol), 3,5-di-t-butyl-4-hydroxybenzylether, 1,6-hexanediol-bis[3,(3,5-di-t-butyl-4-hydroxyphenyl)propionate], 2,4-bis-(n-octylthio)-6-(4-hydroxy-3,5-di-t-butylanilino)-1,3,5-triazine, 2,2-thio-diethylenebis[3-(3,5-di-t-butyl-4-hydroxyphenyl)propionate], 2,2-thiobis(4-methyl-6-t-butylphenol), N,N′-hexamethylenebis(3,5-di-t-butyl-4-hydrocynamide), bis(3,5-di-t-butyl-4-hydroxybenzyl ethylphsphonate)calcium, 1,3,5-trimethyl-2,4,6-tris-(3,5-di-t-butyl-4-hydroxybenzyl)benzene, triethyleneglycol-bis[3,(3-t-butyl-5-methyl-4-hydroxyphenyl)propionate], 1,3,5-trimethyl-2,4,6-tris(3,5-di-t-butyl-4-hydroxybenzyl)benzene, tris-(3,5-di-t-butyyl-4-hydrovybenzyl)-isocyanulate and pentaerythlityl-tetrakis[3-(3,5-di-t-butyl-4-hydroxyphenyl)propionate].

Aminophenols: such as normalbutyl-p-aminophenol, normalbutyloyl-p-aminophenol, normalpelargonoyl-p-aminophenol, normallauroyl-p-amnophenol, normalstearoyl-p-aminophenol, 2,6-di-t-butyl-α-dimethyl and amino-p-cresol.

Hydroquinone type: such as hydroquinone, 2,5-di-t-butylhaydroquinone, 2,5-di-t-amylhydroquinone, hydroquinone methylether and hydroquinone monobenzylether.

Phosphite type triphosphite: such as tris(3,4-di-t-butylephenyl)phosphite, tris(nonylphenyl)phosphite, tetrakis(2,4-di-t-butylphenyl)-4,4′-biphenylenephosphite and 2-ethylhexyloctylphosphite.

Others: such as 2-mercaptobenzothiazole zinc salt, dicatecolborate-di-o-triguanidine salt, nickel-dimethyldithiocarbamate, nickel-pentamethylene dithiocarbamate, mercaptobenzimidazole and 2-mercaptobenzimidazole zinc salt.

Cycloolefin polymer film used as a polarizing plate protective film B of the present invention may be incorporated with an additive which can be generally blended in plastic film. Such an additive includes such as a thermal stabilizer, a light stabilizer, an ultraviolet absorber, an antistatic agent, a sliding agent, a plastisizer and a filling agent, and the content can be selected in a range of not disturbing the object of the present invention.

A forming method of cycloolefin polymer film used as a polarizing plate protective film B of the present invention is not specifically limited, and either a heat fused molding method or a solution casting method can be utilized. A heat fused molding method can be classified, in further details, into such as an extrusion molding method, a press molding method, an inflation molding method, an ejection molding method, a blow molding method and a stretching molding method, however, among these methods, to prepare film being excellent in such as mechanical strength and surface precision, preferable are an extrusion molding method, an inflation molding method and a press molding method, and most preferable is an extrusion molding method. The molding condition is appropriately selected depending on an application purpose and a molding method, however, in the case of applying a heat fused molding method, cylinder temperature is appropriately set generally in a range of 150-400° C., preferably of 200-350° C. and more preferably of 230-330° C. There is a possibility of causing molding defects such as a shrink mark or distortion in film due to deteriorated fluidity when the resin temperature is excessively low, while voids or silver streaks or yellowing of film may be generated when the resin temperature is excessively high. Thickness of film is generally in a range of 5-300 μm, preferably of 10-200 μm and more preferably of 20-100 μm. Handling at accumulation becomes difficult when the thickness is excessively thin, while drying time after accumulation becomes long to deteriorate productivity when the thickness is excessively thick.

Cycloolefin polymer film used as a polarizing plate protective film B of the present invention is preferably has a wetting tension of the surface of preferably not less than 40 mN/m, more preferably not less than 50 mN/m and furthermore preferably not less than 55 mN/m. When the wetting tension of the surface is in the above-described range, adhesion strength between the film and polarizer film will be increased. To adjust the wetting tension of the surface, for example, it is possible to apply film with a corona discharge treatment, ozone blowing, ultraviolet ray irradiation, a flame treatment, a chemical treatment and other surface treatments well known in the art.

Thickness of a sheet before stretching is required to be approximately 50-500 μm; and thickness unevenness is preferably as small as possible and is within ±8%, preferably within ±6% and more preferably within ±4%, in the whole surface.

To prepare a retardation film from cycloolefin polymer film used as a polarizing plate protective film B of the present invention, it is possible to prepare by a manufacturing method similar to the aforesaid polarizing plate protective film A.

The stretching ratio of the main stretching in Third Process is 1.1-10 times and preferably 1.3-8 times, and in this range, retardation is adjusted to be a desired value. The absolute value of retardation is not increased not to achieve the predetermined value when the stretching magnification is excessively small, while the sheet may be broken when it is excessively large.

Thus obtained film is comprised of molecules being oriented by stretching to be provided with a desired amount of retardation. In the present invention, retardation in the plane Ro at 589 nm is preferably 30-100 nm and more preferably 50-100 nm. Further, retardation in the thickness direction Rt is preferably 70-300 nm and specifically preferable is 100-250 nm. The Rt/Ro value is preferably 2-5.

Retardation can be controlled by: a retardation of a sheet before stretching, a stretching ratio, a stretching temperature and a thickness of the film oriented by stretching. When a sheet before stretching has a constant thickness, since there is a tendency that an absolute value of retardation is increased as the stretching ratio of film is large, stretching oriented film having a desired retardation can be obtained by adjusting the stretching ratio.

The smaller is scattering of retardation, the more preferable, and cycloolefin film used as a polarizing plate protective film B of the present invention has a scattering of retardation at a wavelength of 589 nm as small as generally within ±10 nm, preferably within ±5 nm and more preferably within ±1 nm.

Scattering of in-plane retardation or retardation in the thickness direction, or unevenness in thickness can be minimized by the following methods: (i) using a sheet having a smaller retardation scattering or a smaller thickness variation before stretching; and (ii) making stress to be uniformly applied to the sheet when the sheet is stretched. For this purpose, the sheet is preferably stretched under a uniform temperature distribution, that is, in an environment of controlled temperature of within ±5° C., preferably within ±2° C. and specifically preferably within ±0.5° C.

### (Polarizing Plate)

A polarizing plate of the present invention is described.

A polarizing plate can be prepared by a general method. A polarizing plate protective film A of the present invention, the back side of which has been subjected to an alkali saponification treatment, is preferably pasted up on at least one surface of polarizer film prepared by being emersion stretched in an iodine solution, by use of a completely saponified type polyvinyl alcohol aqueous solution. On the other surface, a polarizing plate protective film B of the present invention is utilized. As a polarizing plate protective film B, cyclic olefin polymer films available on the market (e.g., ZEONOAFILM (produced by NIHON ZEON Co.), ARTON FILM (produced by JSR Co.) can be used. In addition to these, also preferably utilized for a polarizing plate protective film B is polarizing plate protective film which combines optical compensation film having an optical anisotropic layer formed by orientating a liquid crystal compound such as discotic liquid crystal, bar-form liquid crystal and cholesteric liquid crystal. For example, an optical anisotropic layer can be formed by a method described in JP-A 2003-98348. Combination use with a polarizing plate of the present invention can provide a polarizing plate having improved a front view contrast.

Polarizer film as a primary constituent element of a polarizing plate is an element which passes light having a polarized wave plane in a predetermined direction, and typical polarizer film commonly known at present is polyvinyl alcohol type polarizer film, which is classified into polyvinyl alcohol type film being dyed with iodine and one being dyed with dichroic dye. Polarizer film is prepared by film formation from polyvinyl alcohol aqueous solution, and the obtained film is monoaxially stretched and dyed, or is monoaxially stretched after dying, preferably followed by being subjected to a durability treatment with a boron compound. One surface of optical film of the present invention is pasted up on the surface of said polarizer film to prepare a polarizing plate. Pasting up is preferably carried out by use of a water-based adhesive comprising completely saponified polyvinyl alcohol as a primary component.

The polarizing film is stretched in the monoaxial direction (commonly in the longitudinal direction). Thereby, when being allowed to stand under a high humidity and high temperature ambience, the polarizing plate tends to contract in the stretching direction (commonly in the longitudinal direction) and to elongate in the direction perpendicular to the stretching direction (commonly in the transverse direction). As the thickness of a polarizing plate protective film decreases, the degree of elongation and contraction of the polarizing plate increases, and specifically the magnitude of contraction of the polarizing film increases in the stretching direction. A polarizing film is commonly laminated to a polarizing plate protective film so as to allow the stretching direction of the former and the longitudinal direction (the MD direction) of the latter to coincide with each other. Therefore, when the polarizing plate protective film is formed to be thin, it is important to control the degree of elongation and contraction thereof specifically in the stretching direction. As such a polarizing plate protective film, the polarizing plate protective film of the present invention is preferably used due to excellent dimensional stability.

Namely, wavy unevenness does not increase even in a durability test under a 60° C. and 90% RH condition, and even a polarizing plate having an optical compensating film on the rear side thereof can exhibit excellent visibility with no variation of viewing angle characteristics after the durability test.

Specifically, it is preferable that the polarizing plate protective film B serve as a retardation film featuring a delayed phase axis in the transverse direction and the elasticity of the polarizing plate protective film A in the longitudinal direction be higher than that in the transverse direction. In particular, a liquid crystal display, in which a polarizing plate of such a structure is laminated to the backlight side of a liquid crystal cell, is specifically preferable, since distortion of the polarizing plate protective film A is reduced, whereby adverse effects of heat caused by the backlight tends not to be produced and also a decrease in front contrast due to heat caused by long-time backlight lighting is minimized.

A polarizing plate can further be structured in such a manner that a protective film is laminated to one side of the polarizing plate and a separate film is laminated to the opposite side thereof. The protective film and the separate film are used to protect the polarizing plate in shipping of the polarizing plate and in product inspection thereof. In this case, the protective film is laminated to protect the surface of the polarizing plate, and applied on one surface thereof opposite to the other surface laminated to a liquid crystal plate. Further, the separate film is used to cover an adhesive layer laminated to the liquid crystal plate, and applied on one surface side of the polarizing plate to be laminated to the liquid crystal cell.

### (Display Device)

By incorporating the polarizing plate of the present invention into display devices, various types of display devices of the present invention, exhibiting excellent visibility, can be prepared. The polarizing plate of the present invention is preferably used for reflection-type, transparent-type, and translucent-type LCDs, as well as LCDs featuring various driving systems such as a TN type, a STN type, an OCB type, a HAN type, a VA type (a PVA type and a MVA type), and an IPS type. Specifically, in a large display device of 30 or larger diagonal inches, uneven color and wavy unevenness are minimized, whereby an effect is noted in that eye fatigue is minimal even for viewing of an extended period of time.

### EXAMPLES

The present invention will now specifically be described with reference to the following examples that by no means limit the scope of the present invention.

### Example 1

### Synthesis Example of Polymer UV Agent P-1

Via a method described below, 2(2′-hydroxy-5′-t-butyl-phenyl)-5-carboxylic acid-(2-methacryloyloxy)ethylester-2H-benzotriazol (the following exemplified compound: MUV-19) was synthesized.

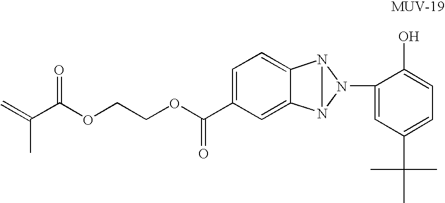

There was dissolved 20.0 g of 3-nitro-4-amino-benzoic acid in 160 ml of water, followed by addition of 43 ml of concentrated hydrochloric acid. Then, 8.0 g of sodium nitrite dissolved in 20 ml of water was added at 0° C., followed by being stirred for 2 hours while the reaction system was kept at 0° C. The resulting solution was dripped into a solution, prepared by dissolving 17.3 g of 4-t-butylphenol in 50 ml of water and 100 ml of ethanol, at 0° C. while maintained to be alkaline using potassium carbonate. The resulting solution was stirred at 0° C. for one hour and then stirred at room temperature for an additional one hour. The reaction liquid was acidified with hydrochloric acid. Then, the formed precipitates were collected via filtration and were well washed with water.

The precipitates collected by filtration were dissolved in 500 ml of a 1 mol/l aqueous NaOH solution, followed by adding 35 g of zinc powder and by dripping 110 g of a 40% aqueous NaOH solution. After dripping, stirring was carried out for about 2 hours, and the resulting solution was filtered and washed with water. Then, the filtrate was neutralized via hydrochloric acid neutralization. Deposited precipitates were collected by filtration, washed with water, and dried. Thereafter, recrystallization was conducted using a mixed solvent of ethyl acetate and acetone to give 2(2′-hydroxy-5′-t-butyl-phenyl)-5-carboxylic acid-2H-benzotriazole.

Subsequently, there were added, to 100 ml of toluene, 10.0 g of 2(2′-hydroxy-5′-t-butyl-phenyl)-5-carboxylic acid-2H-benzotriazole, 0.1 g of hydroquinone, 4.6 g of 2-hydroxyethyl methacrylate, and 0.5 g of p-toluenesulfonic acid, and the resulting mixture was subjected to heat refluxing for 10 hours in a reaction container fitted with an cooling tube. The reaction solution was poured into water, and deposited crystals were collected via filtration, washed with water, dried, and recrystallized with ethyl acetate to give 2(2′-hydroxy-5′-t-butyl-phenyl)-5-carboxylic acid-(2-methacryloyloxy)ethylester-2H-benzotriazole which was the exemplified compound MUV-19.

Subsequently, a copolymer (Polymer UV Agent P-1) of 2(2′-hydroxy-5′-t-butyl-phenyl)-5-carboxylic acid-(2-methacryloyloxy)ethylester-2H-benzotriazole with methyl methacrylate was synthesized via the following method.

There were added, to 250 ml of tetrahydrofuran, 4 g of 2(2′-hydroxy-5′-t-butyl-phenyl)-5-carboxylic acid-(2-methacryloyloxy)ethylester-2H-benzotriazole, having been synthesized in the above method, 5 g of methyl methacrylate, and 1 g of hydroxyethyl methacrylate. Thereafter, 2 g of azoisobutyronitrile was added, followed by heat refluxing under an ambience of nitrogen for 8 hours. Then, tetrahydrofuran was distilled out under reduced pressure and the resulting product was redissolved in 20 ml of tetrahydrofuran, followed by being dripped into a largely excessive amount of methanol. The deposited precipitates were collected via filtration and dried at 40° C. under vacuum to give Polymer UV Agent P-1 in the form of a gray-white powdery polymer. The weight average molecular weight of this copolymer was determined to be 3,000 via GPC analysis in which the standard polystyrene was employed as a standard.

Based on NMR and UV spectra, the composition of the above copolymer was almost certainly identified as follows: 2(2′-hydroxy-5′-t-butyl-phenyl)-5-carbocylic acid-(2-methacryloyloxy)ethylester-2H-benzotriazol:methyl methacrylate:hydroxyethyl methacrylate=40:50:10.

(Preparation of Polarizing Plate Protective Film A)

There were further dried, while mixed at 1 Torr for 3 hours using a vacuum Nauta mixer, 100 parts by weight of cellulose acetate propionate featuring an acetyl group substitution degree of 1.95, a propionyl group substitution degree of 0.7, and a number average molecular weight of 60000, having been dried at 80° C. for 6 hours (moisture ratio: 160 ppm); 10 parts by weight of trimethylolpropane tribenzoate; 1.0 part by weight of Polymer UV Agent P-1; 0.1 part by weight of 2,6-di-t-butyl-p-crezol; 0.1 part by weight of pentaerythlytyl-tetrakis[3-(3,5-di-t-butyl-4-hydroxyphenyl)propionate]; 0.1 part by weight of triisodecyl phosphite; and 0.1 part by weight of Seahostar KEP-10 (produced by Nippon Shokubai Co., Ltd.). The thus-prepared mixture was melt-mixed to form a pellet at 235° C. using a biaxial extruder (PCM30, produced by Ikegai Corp.). In this case, to reduce heat generation due to shearing during kneading, an all screw-type screw was employed instead of a kneading disc. Further, vacuuming was conducted through the vent hole to suction and remove volatile components generated during kneading. Incidentally, the feeder and the hopper feeding materials into the extruder and the portion ranging from the extruder die to the cooling tank were controlled to be in an ambience of dry nitrogen to prevent moisture from being absorbed into the resin.

Film formation was carried out using the production apparatus shown in FIG. 1. Herein, the numbers shown in FIG. 1 represent the following ones.
1 extruder
2 filter
3 static mixer
4 die (including a thickness controlling member)
5 touch roll
6 first cooling roll
6′ second cooling roll
7 peeling roll
8 dancer roll
9 stretcher
10 slitter
11 thickness measurement member
12 embossing ring and back roll
13 winder
14 wound film

A first cooling roll and a second cooling roll was a stainless steel roll of a diameter of 40 cm and both of the surfaces were subjected to hard chromium plating. Further, a temperature controlling oil (cooling fluid) was circulated in the interior thereof to control the roll surface temperature. The touch roll featured a diameter of 20 cm, whose inner and outer cylinders were made of stainless steel, and the surface of the outer cylinder underwent hard chromium plating. The wall thickness of the outer cylinder was 2 mm, and a temperature controlling oil (cooling fluid) was circulated in the space between the inner and the outer cylinder to control the surface temperature of the touch roll.

Using a monoaxial extruder, the thus-prepared pellet (moisture ratio: 50 ppm) was melt-extruded from a T die at a melt temperature of 250° C. into a film onto the first cooling roll of a surface temperature of 100° C. The T die, used in this case, featured a lip clearance of 1.5 mm and a lip section average surface roughness Ra of 0.01 μm. Further, the film on the first cooling roll was pressed against the touch roll of a 2 mm thick metal surface at a line pressure of 10 kg/cm. The film temperature on the touch roll side was 180° C.±1° C. (the film temperature on the touch roll side, as described herein, referred to the average value of surface temperatures of the film determined at 10 locations in the transverse direction, provided that the surface temperatures of the film portion, on the first cooling roll, which the touch roll contacted, were determined using a non-contact thermometer from a distance of 10 cm in a state where the film was not in contact with the touch roll having been taken backward). The glass transition point Tg of the film was 136° C. (the glass transition point of the film extruded from the dice was determined using DSC6200 produced by Seiko Instruments Inc. based on a DSC method (in nitrogen at a temperature raising rate of 10° C./minute)). Incidentally, the surface temperature of the touch roll was 100° C. and the surface temperature of the second cooling roll was 30° C. The surface temperature of each of the touch roll, the first roll (cooling roll), and the second cooling roll was the average value of temperatures determined at 10 locations on the roll surface in the transverse direction using a non-contact thermometer, provided that determination was carried out at a point of 90° in the reverse rotational direction from the initial touching portion of the film and the roll.

The obtained film was introduced into a tenter having a preheating zone, a stretching zone, a holding zone, and a cooling zone (a neutral zone was also provided between each of the two zones to ensure heat insulation); stretched at 160° C. by a factor of 1.3 in the transverse direction; and cooled to 30° C. while being relaxed by 2% in the transverse direction. Thereafter, the resulting film was released from the clips and the clip-held portions were cut off to prepare Polarizing Plate Protective Film 1 which was a polarizing plate protective film A of a thickness of 60 μm. In this case, bowing phenomena due to stretching were prevented by controlling the preheating temperature and the maintaining temperature. No residual solvents were detected in thus-prepared Polarizing Plate Protective Film 1.

Polarizing Plate Protective Films 2-7 and Comparative Polarizing Plate Protective Films 1-5 were prepared, each of which was a polarizing plate protective film A of the present invention featuring a film thickness of 60 μm, in the same manner as for Polarizing Plate Protective Film 1 of the present invention except that the lip clearance, the touch roll line pressure, and the film temperature during pressing were changed as shown in Table 1.

### (Preparation of Polarizing Plate Protective Film B)

A thermoplastic saturated norbornene-based resin (trade name “ZEONOR#1600”, produced by Zeon Corp.) was used as a noncrystalline polyolefin resin, which was fed into a monoaxial extruder, melted, kneaded, and melt-extruded from a T die provided at the tip of the monoaxial extruder to prepare a noncrystalline polyolefin resin film of an average thickness of 120 μm in the form of a long roll.

Subsequently, the thus-prepared long-roll noncrystalline polyolefin resin film was continuously unrolled, and preheated to 155° C., stretched at 160° C. by a factor of 1.3 in the transverse direction, and then cooled to continuously wind the film into a roll. The Ro and Rt of the resulting noncrystalline polyolefin resin film were 60 nm and 230 nm, respectively.

The retardation (Rt) in the thickness direction and the retardation (Ro) in the in-plane direction were determined via birefringence measurement under an ambience of 23° C. and 55% RH at a wavelength of 590 nm using automatic birefringence meter KOBRA-21ADH (produced by Oji Scientific Instruments Co., Ltd.).

Ro=(Nx−Ny)×d

Rt{(Nx+Ny)/2−Nz}

wherein Nx represents the refractive index in the delayed phase direction of the film; Ny represents the refractive index in the advanced phase direction thereof; Nz represents the refractive index in the thickness direction thereof; and d (nm) represents the thickness thereof.

(Preparation of Polarizing Plate)

While being unrolled, a rolled polyvinyl alcohol film of a thickness of 120 μm was immersed in a solution containing 1 part by weight of iodine and 4 parts by weight of boric acid based on 100 parts by weight of the solution, and then longitudinally stretched at 50° C. by a factor of 6 to prepare a polarizer (a polarizing film).

An adhesive mixture, having been prepared via a method described below, was coated on both surfaces of the polarizer within 1 minute after adhesive mixing. On one surface of the resulting polarizer, one-side corona treatment was carried out under a condition of 250 W·min/m² while a polarizing plate protective film B, composed of the noncrystalline polyolefin resin film in a roll form, was unrolled on the surface of the polarizer to achieve lamination on the corona-treated side within 30 seconds after the corona treatment. Then, the other side thereof was laminated to the surface of a polarizing plate protective film A composed of the cellulose resin film in a roll form provided that the surface had been subjected to saponification treatment, followed by being dried at 70° C. for 5 minutes to prepare a polarizing plate.

The saponification of the cellulose resin film was carried out in such a manner that a rolled cellulose resin film produced via the method of the present invention was immersed in a sodium hydroxide aqueous solution of a concentration of 2 mol/l at 60° C. for 1 minute while being unrolled, followed by being washed with water and dried.

### <Preparation of Adhesive Mixture>

There were blended, as a urethane-based adhesive, 100 parts of “EL-436A” (produced by Toyo-Morton, Ltd.) (an aqueous solution of a solid concentration of 35%) which was a polyester polyol prepolymer serving as the main component and 30 parts of “EL-436B” (an article of an effective component of 100%) (produced by Toyo-Morton, Ltd.) which was an isocyanate-based curing agent, and then diluted by adding water to a solid concentration of 20%. On the other hand, there was prepared, as a polyvinyl alcohol-based adhesive, a 3% aqueous solution of carboxyl group-modified polyvinyl alcohol “KURARAY POVAL KL318” (produced by Kuraray Co., Ltd.) (a saponificated product of a copolymer featuring an about 98:2 mole ratio of vinyl acetate to sodium itaconate; saponification degree: 85-90 mol %; and molecular weight: about 85,000). The thus-prepared urethane-based adhesive and the polyvinyl alcohol-based adhesive were mixed at a weight ratio of 1:1 (solid weight ratio: 20:3) to give an adhesive mixture.

The obtained polarizing plate was cut into 100 sheets for use in a 30 diagonal inch liquid crystal display device, and then each sheet was visually examined. Then, the number of polarizing plates with defects such as air bubbles or lines noted was determined for ranking.

A The number of plates with defects noted: less than 10 of 100 sheets

B The number of plates with defects noted: 10 sheets-less than 20 sheets of 100 sheets

C The number of plates with defects noted: 20 sheets-less than 30 sheets of 100 sheets

D The number of plates with defects noted: 30 sheets-less than 40 sheets of 100 sheets

E The number of plates with defects noted: at least 40 sheets of 100 sheets.

The polarizing plate, having been bonded to the backlight side of a commercially available VA-type liquid crystal display device, was peeled off carefully, and instead, the obtained polarizing plate of the present invention was bonded provided that the polarizing plate was prepared so as to correspond to the transmission axis of the above polarizing plate having been previously bonded. In this case, bonding was conducted so as to allow the noncrystalline polyolefin resin film to be on the cell side. A polarizing plate, employing an 80 μm cellulose triacetate film (Konica Minolta TAC KC8UX2MW, produced by Konica Minolta Opto, Inc.) as a polarizing plate protective film, was bonded to the front side of the device. Further, a liquid crystal display device for comparison was prepared in the same manner as described above except that only the polarizing plate on the backlight side was exchanged to a comparative polarizing plate.

### <<Evaluation>>

### (Front Contrast Evaluation)

The backlight of the liquid crystal display device was continuously turned on for 1 week under an ambience of 23° C. and 55% RH, and then determination was conducted. The determination was carried out using EZ-Contrast160D (produced by Eldim SA) in such a manner that luminances in the normal line direction to the image display plane of a white and a black image displayed on the liquid crystal display device were determined, and the ratio was ranked as front contract. Under the same measurement conditions, a higher value obtained is ranked to be superior with respect to the contrast, enabling relative evaluation.

Front contrast=luminance of white display determined in the normal line direction of the display device/luminance of black display determined in the normal line direction of the display device

A 1200-less than 1300

B 1100-less than 1200

C 1000-less than 1100

D 800-less than 1000.

E less than 800

TABLE 1

| | | Touch | Film | | | | |
|---|---|---|---|---|---|---|---|
| | | Roll | Temperature | | | Polarizing | |
| | Draw | Line | during | | | Plate | Front |
| | Ratio | Pressur | Pressing | R0 | Rt | Yield | Contrast |
| | — | kg/cm | ° C. | nm | nm | Rank | Rank |
| Polarizing Plate | 18.8 | 10 | 180 ± 1 | 10 | 130 | A | A |
| Protective Film 1 of | | | | | | | |
| the Present Invention | | | | | | | |
| Polarizing Plate | 18.8 | 1 | 180 ± 1 | 15 | 100 | A | A |
| Protective Film 2 of | | | | | | | |
| the Present Invention | | | | | | | |
| Polarizing Plate | 18.8 | 15 | 180 ± 1 | 5 | 120 | A | A |
| Protective Film 3 of | | | | | | | |
| the Present Invention | | | | | | | |
| Comparative Polarizing | 18.8 | No touch | (180 ± 1) | 20 | 140 | E | D |
| Plate Protective Film 1 | | roll | | | | | |
| | | used | | | | | |
| Polarizing Plate | 10 | 10 | 180 ± 1 | 45 | 125 | A | A |
| Protective Film 4 of | | | | | | | |
| the Present Invention | | | | | | | |
| Polarizing Plate | 30 | 10 | 180 ± 1 | 1 | 130 | A | A |
| Protective Film 5 of | | | | | | | |
| the Present Invention | | | | | | | |
| Comparative Polarizing | 18.8 | 20 | 180 ± 1 | 5 | 130 | D | E |
| Plate Protective Film 2 | | | | | | | |
| Comparative Polarizing | 5 | 10 | 180 ± 1 | 50 | 110 | D | D |
| Plate Protective Film 3 | | | | | | | |
| Comparative Polarizing | 35 | 10 | 180 ± 1 | 3 | 150 | D | E |
| Plate Protective Film 4 | | | | | | | |
| Comparative Polarizing | 18.8 | 10 | 120 ± 1 | 15 | 120 | E | E |
| Plate Protective Film 5 | | | | | | | |
| Polarizing Plate | 18.8 | 10 | 140 ± 1 | 8 | 125 | A | B |
| Protective Film 6 of | | | | | | | |
| the Present Invention | | | | | | | |
| Polarizing Plate | 18.8 | 10 | 245 ± 1 | 50 | 120 | A | A |
| Protective Film 7 of | | | | | | | |
| the Present Invention | | | | | | | |

The above table shows that any of Polarizing Plates 1-7 of the present invention exhibits reduced defects in the polarizing plate and an improved yield thereof, and also any of the liquid crystal display devices employing the plate of the present invention exhibits enhanced front contrast, compared to the comparative plates.

### Example 2

There were further dried, while mixed at 1 Torr for 3 hours using a vacuum Nauta mixer, 100 parts by weight of cellulose acetate propionate featuring an acetyl group substitution degree of 1.6, a propionyl group substitution degree of 1.2, and a number average molecular weight of 75000, having been dried at 80° C. for 6 hours (moisture ratio: 150 ppm); 11 parts by weight of trimethylolpropane tribenzoate; 1.0 part by weight of Polymer UV Agent P-1; 0.2 part by weight of IRGANOX1010 (produced by Ciba Specialty Chemicals AG); and 0.1 part by weight of triisodecyl phosphite. Under a dry nitrogen ambience, the thus-prepared mixture was melt-mixed to form a pellet at 235° C. using the biaxial extruder. In this case, to reduce heat generation due to shearing during kneading, an all screw-type screw was employed instead of a kneading disc. Further, vacuuming was conducted through the vent hole to suction and remove volatile components generated during kneading. Incidentally, the feeder and the hopper feeding materials into the extruder and the portion ranging from the extruder die to the cooling rolls were controlled to be in an ambience of dry nitrogen to prevent moisture from being absorbed into the resin.

Polarizing Plate Protective Films 2-1-2-22 of the present invention and Comparative Polarizing Plate Protective Films 3-1-3-12 shown in Table 2 were prepared in the same manner as in Example 1 except that the pellet prepared via the above method was used. The glass transition point of each film was 132° C.

Polarizing plates were prepared in the same manner as in Example 1 except that the thus-prepared polarizing plate protective films were used as polarizing plate protective films A. Furthers liquid crystal display devices were prepared using the obtained polarizing plates for evaluation. The results are shown in Table 2.

TABLE 2

| | | | Film | | |
|---|---|---|---|---|---|
| | | Touch | Temperature | Polarizing | |
| | | Roll Line | during | Plate | Front |
| | Draw Ratio | Pressure | Pressing | Yield | Contrast |
| | — | kg/cm | ° C. | Rank | Rank |
| Polarizing Plate Protective | 18.8 | 10 | 175 | A | A |
| Film 2-1 of the Present | | | | | |
| Invention | | | | | |
| Polarizing Plate Protective | 18.8 | 1 | 175 | A | A |
| Film 2-2 of the Present | | | | | |
| Invention | | | | | |
| Polarizing Plate Protective | 18.8 | 15 | 180 | A | A |
| Film 2-3 of the Present | | | | | |
| Invention | | | | | |
| Polarizing Plate Protective | 18.8 | 10 | 140 | A | B |
| Film 2-4 of the Present | | | | | |
| Invention | | | | | |
| Polarizing Plate Protective | 18.8 | 15 | 133 | A | B |
| Film 2-5 of the Present | | | | | |
| Invention | | | | | |
| Polarizing Plate Protective | 18.8 | 15 | 160 | A | A |
| Film 2-6 of the Present | | | | | |
| Invention | | | | | |
| Polarizing Plate Protective | 18.8 | 5 | 220 | A | A |
| Film 2-7 of the Present | | | | | |
| Invention | | | | | |
| Polarizing Plate Protective | 18.8 | 8 | 200 | A | A |
| Film 2-8 of the Present | | | | | |
| Invention | | | | | |
| Polarizing Plate Protective | 18.8 | 10 | 220 | A | A |
| Film 2-9 of the Present | | | | | |
| Invention | | | | | |
| Polarizing Plate Protective | 10 | 5 | 200 | A | A |
| Film 2-10 of the Present | | | | | |
| Invention | | | | | |
| Polarizing Plate Protective | 10 | 1 | 240 | A | A |
| Film 2-11 of the Present | | | | | |
| Invention | | | | | |
| Polarizing Plate Protective | 10 | 10 | 150 | A | B |
| Film 2-12 of the Present | | | | | |
| Invention | | | | | |
| Polarizing Plate Protective | 10 | 15 | 140 | A | B |
| Film 2-13 of the Present | | | | | |
| Invention | | | | | |
| Polarizing Plate Protective | 10 | 1 | 175 | A | A |
| Film 2-14 of the Present | | | | | |
| Invention | | | | | |
| Polarizing Plate Protective | 10 | 5 | 175 | A | A |
| Film 2-15 of the Present | | | | | |
| Invention | | | | | |
| Polarizing Plate Protective | 10 | 10 | 175 | A | A |
| Film 2-16 of the Present | | | | | |
| Invention | | | | | |
| Polarizing Plate Protective | 10 | 15 | 175 | A | A |
| Film 2-17 of the Present | | | | | |
| Invention | | | | | |
| Polarizing Plate Protective | 30 | 1 | 175 | A | B |
| Film 2-18 of the Present | | | | | |
| Invention | | | | | |
| Polarizing Plate Protective | 30 | 5 | 175 | A | B |
| Film 2-19 of the Present | | | | | |
| Invention | | | | | |
| Polarizing Plate Protective | 30 | 5 | 190 | A | A |
| Film 2-20 of the Present | | | | | |
| Invention | | | | | |
| Polarizing Plate Protective | 30 | 10 | 180 | A | B |
| Film 2-21 of the Present | | | | | |
| Invention | | | | | |
| Polarizing Plate Protective | 30 | 15 | 180 | A | B |
| Film 2-22 of the Present | | | | | |
| Invention | | | | | |
| **3-1 | 18.8 | 20 | 175 | D | E |
| **3-2 | 10 | 20 | 175 | D | E |
| **3-3 | 30 | 20 | 175 | D | E |
| **3-4 | 30 | 20 | 125 | E | E |
| **3-5 | 5 | 10 | 175 | D | D |
| **3-6 | 5 | 20 | 175 | D | D |
| **3-7 | 35 | 10 | 175 | D | E |
| **3-8 | 18.8 | 10 | 130 | E | E |
| **3-9 | 18.8 | *1 | 175 | E | D |
| **3-10 | 10 | *1 | 175 | E | D |
| **3-11 | 10 | *1 | 245 | E | E |
| **3-12 | 30 | *1 | 175 | E | D |

**Comparative Polarizing Plate Protective Film
*1: (No touch roll used)

The above table shows that the results of Example 1 are reproducible; any of the polarizing plates prepared employing Polarizing Plate Protective Films 2-1-2-22 of the present invention exhibits reduced defects; and the front contract of any of the display devices is significantly improved, compared to the comparative examples.

### INDUSTRIAL APPLICABILITY OF THE INVENTION

According to the present invention, it is possible to significantly improve the yield of a polarizing plate employing, as a polarizing plate protective film, a noncrystalline polyolefin resin film and a cellulose ester resin film produced via a melt casting method; and also to provide the polarizing plate and a liquid crystal display exhibiting significantly improved front contrast employing the polarizing plate protective film.

1-8. (canceled)

9. A method for producing a polarizing plate comprising the steps of:
laminating a polarizing plate protective film A on one side of a polarizer; and
laminating a polarizing plate protective film B on the other side of the polarizer,
wherein the polarizing plate protective film B comprises a noncrystalline polyolefin resin; and
the polarizing plate protective film A is a solidified film produced in such a manner that a melted film prepared by extruding a melted substance containing a cellulose resin from a die is conveyed while pressed against a cooling roll by a touch roll so as to have a draw ratio of 10 to 30 and to be solidified on the cooling roll,
provided that the touch roll has an outer metal cylinder, an inner metal cylinder and a space formed therebetween for accommodating a cooling medium, a line pressure of the touch roll while pressing the melted film is from 1 kg/cm to 15 kg/cm, and the draw ratio is defined as a value obtained by dividing a lip clearance C of the die by an average film thickness of the film solidified on the cooling roll.

10. The method for producing the polarizing plate of claim 9,
wherein the draw ratio is from 10 to 20.

11. The method for producing the polarizing plate of claim 9,
wherein the line pressure of the touch roll is from 2 kg/cm to less than 10 kg/cm.

12. The method for producing the polarizing plate of claim 9,
wherein a surface temperature T (° C.) of the melted film on a side of the touch roll satisfies the relationship:
Tg<T<Tg+110,
provide that Tg is a glass transition point of the melted film determined via DSC measurement.

13. The method for producing the polarizing plate of claim 9,
wherein the touch roll is a crown roll.

14. The method for producing the polarizing plate of claim 9,
wherein a surface temperature of the touch roll is controlled to be uniform via any one of the following methods:
(1) allowing a temperature controlling roll to be in contact with the touch roll;
(2) spraying the touch roll with temperature-controlled air; and
(3) allowing a heating medium to be in contact with the touch roll.

15. A polarizing plate produced via the method for producing the polarizing plate of claim 9.

16. A liquid crystal display produced by laminating the polarizing plate of claim 15 to at least one side of a liquid crystal cell.
